(19) United States
(12) Patent Application Publication
(10) Pub. No.: US 2025/0268293 A1
(43) Pub. Date: Aug. 28, 2025

(54) PROTEIN SWEETENERS

(71) Applicant: AMAI PROTEINS LTD., Rehovot (IL)

(72) Inventors: Ilan SAMISH, Ness Ziona (IL); Lior BEN-ASAF, Kiryat Ono (IL); Adva YEHESKEL, Atzmon-Segev (IL); Naama KOPELMAN, Givatayim (IL)

(73) Assignee: AMAI PROTEINS LTD., Rehovot (IL)

(21) Appl. No.: 18/879,051

(22) PCT Filed: Jun. 29, 2023
(86) PCT No.: PCT/IL2023/050681

§ 371 Date: Dec. 26, 2024

Related U.S. Application Data
(60) Provisional application No. 63/367,297, filed on Jun. 29, 2022.

(51) Int. Cl. A23L 27/30; A23C 11/10; A23G 3/44; A23L 7/10; A23L 25/10; C07K 14/43

(52) U.S. Cl. CPC A23L 27/31; A23C 11/10; A23C 11/103; A23G 3/44; A23L 7/101; A23L 25/10; C07K 14/43

(57) ABSTRACT

The present disclosure relates to modified protein having an amino acid sequence comprising at least one amino acid deletion and at least one amino acid substitution as compared to a reference protein and having improved stability.

### TECHNOLOGICAL FIELD

The present disclosure relates to protein sweeteners and uses thereof.

### BACKGROUND ART

References considered to be relevant as background to the presently disclosed subject matter are listed below:
Weiffert T, Linse S. Protein stabilization with retained function of monellin using a split GFP system. Sci Rep. 2018 Aug. 24; 8(1):12763. doi: 10.1038/s41598-018-31177-z. PMID: 30143736; PMCID: PMC6109104.
Delfi, M.; Emendato, A.; Leone, S.; Lampitella, E. A.; Porcaro, P.; Cardinale, G.; Petraccone, L.; Picone, D. A Super Stable Mutant of the Plant Protein Monellin Endowed with Enhanced Sweetness. Life 2021, 11, 236. https://doi.org/10.3390/life11030236
Zhao, M. et al. Structure basis of the improved sweetness and thermostability of a unique double-sites single-chain sweet-tasting protein monellin (MNEI) mutant. Biochimie 2018, 154, 156-163. doi: https://doi.org/10.1016/j.biochi.2018.08.010
Somoza, J. R. et al. The Taste-active Regions of Monellin, a Potently Sweet Protein. Chem Senses. 1995, 20(1), 61-68. https://doi.org/10.1093/chemse/20.1.61
Yang et al. The flexible loop is a new sweetness determinant site of the sweet-tasting protein: Characterization of novel sweeter mutants of the single-chain Monellin (MNEI). Chemical Senses 2019, 44(8), 607-614. doi: 10.1093/chemse/bjz057
Liu et al., Functional characterization of the heterodimeric sweet taste receptor T1R2 and T1R3 from a New World monkey species (squirrel monkey) and its response to sweet-tasting proteins. Biochemical and Biophysical Research Communications 2012, 427(2), 431-437. doi: 10.1016/j.bbrc.2012.09.083.
Leone et al., Sweeter and stronger: enhancing sweetness and stability of the single chain monellin MNEI through molecular design. Scientific Reports 2016, 6(1). doi: 10.1038/srep34045.

Acknowledgement of the above references herein is not to be inferred as meaning that these are in any way relevant to the patentability of the presently disclosed subject matter.

### BACKGROUND

Sweet proteins are a class of proteins that interact with sweet taste receptor T1R2/T1R3 and stimulate a sweet sensation. Single-chain Monellin, MNEI, is an example of such sweet proteins, however, it's use in food and beverage products is limited due to its low stability.

Weiffert T. et al. describes functionality studies showing that the S76Y substitution has retained sweetness and has potential use within the food industry.

Delfi, M. et al. describes a new construct of MNEI, which has increased sweetness and stability as compared with MNEI.

Zhao, M. et al. describes the effect of E2N and E23A substitutions on MNEI. Namely their effect of thermostability, protein structure and sweetness.

Somoza, J. R. et al. describes mutagenesis work on monellin and suggest at least four residues which participate in the taste-active region of monellin.

Yang et al. describes the effect of substitutions in the flexible loop (L23) of MNEI on the sweetness of MNEI.

Liu et al. describes hybridization of human and squirrel monkey sweet receptor subunits. These hybrids highlight the importance of the interaction between the native receptor subunits and the electrostatics involved in the MNEI:receptor interaction.

Leone et al. describes substitutions in MNEI with increased sweetness and thermostability.

### GENERAL DESCRIPTION

The present disclosure provides in accordance with some aspects, a modified protein having an amino acid sequence comprising at least one amino acid deletion and at least one amino acid substitution as compared to a reference protein, wherein the reference protein is represented by an amino acid sequence set forth in SEQ ID NO:1, wherein the at least one amino acid deletion is at one or more amino acids located between T46 and I56 of the reference protein, and wherein the at least one amino acid substitution is at amino acid S76 of the reference protein.

The present disclosure provides in accordance with some other aspects, a modified protein having an amino acid sequence comprising at least one amino acid deletion and at least one amino acid substitution as compared to a reference protein, wherein the reference protein is represented by an amino acid sequence set forth in SEQ ID NO:1, wherein the at least one amino acid deletion is at one or more amino acids at least amino acid E50, F52 and R53 of the reference protein, and wherein the at least one amino acid substitution is at amino acid S76 of the reference protein.

The present disclosure provides in accordance with some further aspects, a modified protein having an amino acid sequence comprising at least one amino acid deletion and at least one amino acid substitution as compared to a reference protein, wherein the reference protein is represented by an amino acid sequence set forth in SEQ ID NO:1, wherein the at least one amino acid deletion is at one or more amino acids E50, F52 and R53 of the reference protein, and wherein the at least one amino acid substitution is in at least amino acids E2, E23, Y65, L70, S76 of the reference protein.

The present disclosure provides in accordance with some yet further aspects, a modified protein having an amino acid sequence comprising at least one amino acid deletion and at least one amino acid substitution as compared to a reference protein, wherein the reference protein is represented by an amino acid sequence set forth in SEQ ID NO:1, wherein the at least one amino acid deletion is at amino acids E50, F52 and R53 of the reference protein, wherein the at least one amino acid substitution is at least E2N, E23A, Y65R, L70I and at amino acid S76 of the reference protein.

The present disclosure provides in accordance with some aspects, a modified protein having an amino acid sequence comprising at least one amino acid deletion and at least one amino acid substitution as compared to a reference protein, wherein the reference protein is represented by an amino acid sequence set forth in SEQ ID NO:1, wherein the at least one amino acid deletion is at one or more amino acids located between T46 and I56 of the reference protein, wherein the at least one amino acid substitution is at amino acid S76 of the reference protein and wherein the modified protein has at least an increase stability as compared to the reference protein.

The present disclosure provides in accordance with some other aspects, a modified protein having an amino acid sequence comprising at least one amino acid deletion and at least one amino acid substitution as compared to a reference protein, wherein the reference protein is represented by an amino acid sequence set forth in SEQ ID NO:1, wherein the at least one amino acid deletion is at one or more amino acids at least amino acid E50, F52 and R53 of the reference protein, wherein the at least one amino acid substitution is at amino acid S76 of the reference protein and wherein the modified protein has at least an increase stability as compared to the reference protein.

The present disclosure provides in accordance with some further aspects, a modified protein having an amino acid sequence comprising at least one amino acid deletion and at least one amino acid substitution as compared to a reference protein, wherein the reference protein is represented by an amino acid sequence set forth in SEQ ID NO:1, wherein the at least one amino acid deletion is at one or more amino acids E50, F52 and R53 of the reference protein, wherein the at least one amino acid substitution is in at least amino acids E2, E23, Y65, L70, S76 of the reference protein and wherein the modified protein has at least an increase stability as compared to the reference protein.

The present disclosure provides in accordance with some yet further aspects, a modified protein having an amino acid sequence comprising at least one amino acid deletion and at least one amino acid substitution as compared to a reference protein, wherein the reference protein is represented by an amino acid sequence set forth in SEQ ID NO:1, wherein the at least one amino acid deletion is at amino acids E50, F52 and R53 of the reference protein, wherein the at least one amino acid substitution is at least E2N, E23A, Y65R, L70I and at amino acid S76 of the reference protein and wherein the modified protein has at least an increase stability as compared to the reference protein.

The present disclosure provides in accordance with some aspects, a stabilized modified protein as described herein.

The present disclosure provides in accordance with some aspects, a food product comprising the modified protein as described herein.

The present disclosure provides in accordance with some aspects, a method of increasing stability of a reference protein, said method comprising deleting at least one amino acid of the reference protein and substituting at least one amino of the reference protein, wherein the reference protein is represented by an amino acid sequence set forth in SEQ ID NO:1, wherein the at least one deleted amino acid is at one or more amino acids located between T46 and I56 of the reference protein, and wherein the at least one substituted amino acid is at amino acid S76 of the reference protein.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A and 1B presents the structure of DM89 (ΔE50, ΔF52, ΔR53, E2N, E23A, Y65R, L70I, S76Y) protein, FIG. 1A Amino acids Y76 (cyan) E59 (yellow) in proximity to the loop (magenta); FIG. 1B Amino acids Y76 (cyan) R84 (orange) in proximity to the loop (magenta).

FIG. 2 presents the structure of DM652 (ΔE50, ΔF52, ΔR53, E2N, E23A, Y65R, L70I, E59V, S76V) protein. Marked in color are residues V59 (yellow) and V76 (cyan). The loop is also marked (magenta), The modification of residues 59 and 76 to valine prevents water molecules from interacting with the backbone.

FIG. 3 presents Anisotropic Network Model (ANM) analysis of global movement for DM31; the movement of Ca of residues is shown as arrows, with their lengths representing movement size, the parts of the protein that move the most are the β-hairpins comprised of β-strands 2 & 3, and β-strands 4 & 5. These drive the motion of the β-sheet, the helix, and helix's C-terminal loop.

FIGS. 4A-4F presents electrostatic potentials contour maps representing iso-potential surfaces of DM31 based variants, with +/−1 kT/e for positive (blue) and negative (red) potentials, FIG. 4A DM222 (ΔE50, ΔF52, ΔR53, E2N, E23A, Y65R, L70I, T33R, S76Y); FIG. 4B DM479 (ΔE50, ΔF52, ΔR53, E2N, E23A, Y65R, L70I, K25R, D68N, S76Y); FIG. 4C DM31; FIG. 4D DM224 (ΔE50, ΔF52, ΔR53, E2N, E23A, Y65R, L70I, D68N, S76Y); FIG. 4E DM606 (ΔE50, ΔF52, ΔR53, E2N, E23A, Y65R, L70I, S76R); FIG. 4F DM89 (ΔE50, ΔF52, ΔR53, E2N, E23A, Y65R, L70I, S76Y), substitutions of specific DMs, and additional residues which are known for their importance for sweetness, are labeled and presented as spheres.

FIG. 5 is a RMSF plot of variants DM89 (ΔE50, ΔF52, ΔR53, E2N, E23A, Y65R, L70I, S76Y), DM653 (ΔE50, ΔF52, ΔR53, E2N, E23A, Y65R, L70I, E59I, S76V), DM656 (ΔE50, ΔF52, ΔR53, E2N, E23A, Y65R, L70I, E59I, S76I), DM663 (ΔE50, ΔF52, ΔR53, E2N, E23A, Y65R, L70I, S76V), DM31, and MNEI.

### DETAILED DESCRIPTION OF EMBODIMENTS

The present disclosure relates to novel sweet proteins that are characterized by high stability. The novel proteins were designed using a sequence of computational optimization methods. Specifically, the computational methods were based on computational identification of specific regions and amino acid residues in a protein that may be considered to affect protein features, including, inter alia, stability and sweetness and as such obtaining novel proteins with improved features as further described herein.

As shown below, the inventors have found that introducing specific modifications, such as deletions or substitutions in the amino acid sequence of a reference protein, resulted in novel proteins (denoted herein as “modified protein” or “designer protein”) having at least improved stability compared to the reference protein. Based on these results, it was suggested that the new proteins having improved stability can be used in food and beverage applications for preparation of a variety of edible products.

Thus, in its broadest aspect, the present disclosure relates to a modified protein comprising an amino acid sequence that has at least one of (i) at least one amino acid deletion, (ii) at least one amino acid replacement (substitution), (iii) at least one amino acid insertion or (iv) any combination thereof, as compared with an amino acid sequence of a reference protein. As described herein, the modified protein has at least improved thermal stability as compared with the reference protein.

In the following text, when referring to the modified protein it is to be understood as also referring to the food products disclosed herein. Thus, whenever providing a feature with reference to the modified protein, it is to be understood as defining the same feature with respect to the food product mutatis mutandis.

In the present disclosure, the modified protein also denoted at times as a designer protein may be considered as a variant of a reference protein. The term “variant” as used herein refers to a sequence that contains at least one amino acid modification (e.g. at least one substitution, at least one deletion, at least one insertion or any combination thereof) as compared to the reference protein. It should be noted that as results of the modification, the modified/variant sequence is obtained.

The present disclosure also encompasses a modified nucleic acid sequence, including corresponding substitution, deletion or insertion of codons similar to the ones in the modified protein. In other words. the same modification apply to the nucleic acid sequence resulting in a modified sequence, including corresponding substitution, deletion or insertion of codons.

The present disclosure is not limited to a specific number of amino acid modifications made in the reference protein that eventually results in the formation of the modified protein.

A modification as used herein refers to a modification in one or more amino acids of the reference protein and encompasses amino acid substitution (replacement), amino acid deletion, amino acid insertion or any combination thereof.

In some examples, a modification may be an amino acid insertion.

In some embodiments, the modified protein comprises an amino acid sequence having at least one, at least two, at least three, at least four, at least five amino acid insertions as compared to the reference protein.

In some examples, a modification may be an amino acid deletion.

In some embodiments, the modified protein comprises an amino acid sequence having at least two, at least three, at least four, at least five amino acid deletions as compared to the reference protein.

In some examples, a modification may be an amino acid substitution.

In some embodiments, the modified protein comprises an amino acid sequence having at least one, at least two, at least three, at least four, at least five amino acid substitutions as compared to a reference protein.

As described herein, the modified protein may result from amino acid modifications (substitutions or deletions) at various regions of the protein. “Regions of the protein” as used herein, refers to an amino acid sequence or structural motif that is part of the protein sequence (amino acid sequence) or structure. Non-limiting examples of protein regions include protein surface, protein core, protein loop, secondary structure elements, secondary structure capping, disulfide, binding-site, linker, hydrophobic-patch, or protein hydrophobic region.

As shown in the Examples below, molecular dynamics tools were used for designing new modified proteins based on optimization of various regions of the reference protein. Specifically, using Rosetta Energy Unit (REU) scores for the newly designed modified proteins, it was possible to predict those proteins that would exhibit improved properties, specifically at least the stability of the modified proteins. As part of the computational optimization process, the modified proteins may be selected from a large output population of amino acid sequences following computational-bioinformatic- or structural-biology analysis, based on energetic considerations, i.e. those sequences with low energy.

Energetic calculations can be applied to the entire amino acid sequence or, alternatively, be restricted to specific regions or selected amino acids within the protein. In the latter (different regions or selected amino acids), the information may be integrated to measure the entire protein.

Calculation of each one of the amino acid sequences (e.g., a modified protein) may be done by combining physico-based (also known as biophysical methods) and statistics-based potentials (also known as knowledge-based potentials or informatics methods), such as by using the Rosetta Energy Unit (REU). Rosetta Energy Unit (REU) is an algorithm of the Rosetta software, a package of algorithms for computational modeling and protein structures analysis. The Rosetta software enables notable scientific advances in computational biology, including de novo protein design, enzyme design, ligand docking, and structure prediction of biological macromolecules and macromolecular complexes. Rosetta energy function is a combination of physical and statistical based potentials that does not match with any actual physical energy units. Rosetta energies are on an arbitrary scale and sometimes referred to as REU (for “Rosetta Energy Unit”).

In some embodiments, the REU may be calculated for the entire protein sequence comprising of at least one amino acid modification. In some other embodiments, the REU may be calculated for at least one region comprising of at least one amino acid modification of the entire protein sequence. In some other embodiments, the REU may be calculated for at least one amino acid modification in the entire protein sequence.

In some embodiments, the modified protein has an energy lower than about −315 given in REU.

In some embodiments, the modified protein has an energy lower than about −321 given in REU.

In some embodiments, the modified protein has an energy lower than −316 given in REU. In some embodiments, the modified protein has an energy lower than −317 given in REU. In some embodiments, the modified protein has an energy lower than −318 given in REU. In some embodiments, the modified protein has an energy lower than −319 given in REU. In some embodiments, the modified protein has an energy lower than −320 given in REU. In some embodiments, the modified protein has an energy lower than −321 given in REU. In some embodiments, the modified protein has an energy lower than −322 given in REU. In some embodiments, the modified protein has an energy lower than −323 given in REU. In some embodiments, the modified protein has an energy lower than −324 given in REU. In some embodiments, the modified protein has an energy lower than −325 given in REU. In some embodiments, the modified protein has an energy lower than −326 given in REU. In some embodiments, the modified protein has an energy lower than −327 given in REU. In some embodiments, the modified protein has an energy lower than −328 given in REU. In some embodiments, the modified protein has an energy lower than −329 given in REU. In some embodiments, the modified protein has an energy lower than −330 given in REU.

In some embodiments, the modified protein has an energy of about −315 and about −330 given in REU.

In some embodiments, the modified protein comprises an amino acid sequence 40% to 98% identical to an amino acid sequence of a reference protein. In some embodiments, the modified protein comprises an amino acid sequence 90% to 98% identical to a reference amino acid sequence.

In some embodiments, the modified protein comprises an amino acid sequence 60% to 90% identical to a reference amino acid sequence. In some embodiments, the modified protein comprises an amino acid sequence 70% to 90% identical to a reference amino acid sequence.

In some embodiments, the modified protein comprises an amino acid sequence having at least 60%, at least 65%, at least 70%, at least 75%, at least 80%, at least 85%, at least 90%, at least 95%, or at least 98% identity to a reference amino acid sequence.

In some embodiments, the modified protein comprises an amino acid sequence having 90% to 98% identity to a reference amino acid sequence.

The % identity between two or more amino acid sequences is determined when the two or more sequences are compared and aligned for maximum correspondence. In the context of the present disclosure, sequences (amino acid) as described herein having % identity are considered to have the same function/activity as the reference sequence to which identity is calculated.

In some embodiments, the modified protein comprises an amino acid sequence with 40% to 98% similarity to an amino acid sequence of a reference protein. In some embodiments, the modified protein comprises an amino acid sequence with 90% to 98% similarity to a reference amino acid sequence.

In some embodiments, the modified protein comprises an amino acid sequence with 60% to 90% similarity to a reference amino acid sequence. In some embodiments, the modified protein comprises an amino acid sequence with 70% to 90% similarity to a reference amino acid sequence.

In some embodiments, the modified protein comprises an amino acid sequence having at least 60%, at least 65%, at least 70%, at least 75%, at least 80%, at least 85%, at least 90%, at least 95%, or at least 98% similarity to a reference amino acid sequence.

In some embodiments, the modified protein comprises an amino acid sequence having 90% to 98% similarity to a reference amino acid sequence.

In Sequence similarity or sequence homology as used herein refers to the amount (%) of amino acids that conserved with similar physicochemical properties, e.g. leucine and isoleucine.

In determining the sequence identity, the gaps are not counted, and the sequence identity is relative to the shorter sequence of the two. In this connection, it should be noted that the length of the reference protein (amino acid sequence) may be the same as the modified protein (amino acid sequence) or may be different than the modified protein (amino acid sequence).

As described herein, the reference protein serving as basis for the computational analysis is a sweet protein. The reference sweet protein may be a naturally occurring protein or a synthetic protein.

In some examples, the reference protein is a synthetic protein. When referring to a synthetic protein it should be understood as protein that was not found in nature and is thus considered as a synthetic protein.

In accordance with the present disclosure the reference protein is MNEI or a modified protein based on MNEI.

In some embodiments, the reference protein is MNEI.

As appreciated, MNEI is a synthetic protein made of a combination of chain A Monellin (GenBank Entry No. P02881) and chain B Monellin (GenBank Entry No. P02882).

MNEI is represented herein by SEQ ID NO:1 and has the following amino acid sequence:
GEWEIIDIGPFTQNLGKFAVDEENKIGQYGRLTFNKVIRPCMKKTIYENEGFREI KGYEYQLYVYASDKLFRADISEDYKTRGRKLLRFNGPVPPP

In some embodiments, the reference protein is represented herein by SEQ ID NO:1.

The modified protein in accordance with the present disclosure can be considered as a variant of MNEI. It should be noted that the variant sequence (modified) is considered as such as long as it includes a sequence that is different as compared to a reference sequence, in such case, MNEI, regardless of how it was synthesized.

As shown in the Examples below, substitution in a reference protein, at least in an amino acid S76, located at a beta strand, that is exposed to solvent, resulted in a modified protein having improved stability. As further shown in the Examples below, combining substitution in S76 with one or more amino acid modifications including, inter alia, amino acid deletion and/or amino acid substitutions improved the stability of the modified protein.

In some embodiments, the modified protein comprises an amino acid substitution in at least amino acid S76 of SEQ ID NO:1.

Hence, in accordance with some aspects, the present disclosure provides a modified protein comprising an amino acid sequence that has at least one amino acid substitution in at least amino acid S76 as compared to a reference protein, wherein the reference protein is denoted as SEQ ID NO:1.

In accordance with some other aspects, the present disclosure provides a modified protein comprising an amino acid sequence that has at least one amino acid substitution in at least amino acid S76 as compared to a reference protein, wherein the modified protein has at least improved stability as compared to the reference protein, wherein the reference protein is denoted as SEQ ID NO:1.

The term stability as used herein refers to ability of a protein to maintain a three-dimensional structure. In the context of the present disclosure, the term stability encompasses thermal stability, short-term and long-term functional stability (structure and/or function), long-term functional stability (shelf-life stability), pH stability, salt concentration stability, ionic strength stability or stability in a fat-containing or protein-containing matrix, and stability in the presence of different preservatives.

In some embodiments, the stability is thermal stability.

The term “thermal stability” as used herein refers to the ability of a modified protein to retain its 3D structure at temperatures above that of a reference protein. The 3D structural stability of a protein can be measured by any method known in the art, such as Circular Dichroism (CD), or thermal shift assays such as Differential Scanning Fluorimetry (DSF) or Differential Scanning Calorimetry (DSC). The 3D structure of a protein may influence the function of the protein.

In some embodiments the modified protein has thermal stability being equal or higher relative to the reference protein.

The term “functional stability” as used herein refers to the ability of the modified protein to retain its function after exposure to high temperatures compared with the reference protein.

In some embodiments, the modified protein herein may maintain sweetness effect at higher temperature or after exposure to higher temperature for a time which may be limited. In other words, there is significant sensed change in the sweetness- or sensory-profile after exposure of the product to a temperature above room temperature, at times, up to 50° C., at times up to 100° C., or even up to 150° C. The protein function, e.g. sweetest may be measured by sensational tests.

In some embodiments the modified protein has pH stability being equal or higher relative to the reference protein. The pH stability refers to a stability of the modified protein at a wider pH range relative to the reference protein, namely the modified protein maintains the 3D structure (and/or function) after exposure of the product to any pH from 3 to 8, at times, at a pH of between 4 to 8. For example, a soda like cola has a pH of 2.3-2.5 where some of the sweet proteins are not stable and lose functionality immediately or after a time that is shorter than the regular shelf-life of the beverage.

In some embodiments the modified protein has a solubility being higher relative to the reference protein. Solubility may be in an aqueous, partly aqueous or non-aqueous milieu such as foods containing fat.

In some embodiments the modified protein has improved shelf life relative to the reference protein. Improved shelf life refers to no sensed change in the sweetness (function) or physical deterioration of a product comprising the composition (e.g. color change, phase separation etc.) after exposure of the product to any temperature up to 45° C., at times, to any temperature between 4° C. to 32°, or to 45°.

In some embodiments the modified protein has a PI value of between 7.8 to 8.4.

In some other embodiments, the modified protein is characterized by at least one of the following being equal or improved relative to the reference protein (1) folding kinetics, (2) post-translational modification (e.g. glycosylation) pattern of the protein is different relative to the reference protein.

In some embodiments the modified protein has a folding kinetics equal or higher relative to the reference protein. Namely, the protein folding rate from an unfolded or partially-folded structure is faster (as assessed in silico e.g. by molecular dynamics or by experimental in vitro or in vivo methods). Alternatively, faster folding kinetics also refers to slower unfolding kinetics in denaturation experiments e.g. by denaturant titrations (e.g. guanidinium chloride and/or high-concentration urea) or other methods.

In some embodiments, the modified protein is characterized by expression yield equal or higher relative to the reference protein in the host organism assessed.

Notably, the shelf-life and functional stability required for food and beverage products may be related to the structural thermal stability and consists of different measurables e.g. pasteurization can be applied by different protocols, heat resistance and functional properties may be measured over a very short time, or extended times.

As described herein, in some examples, the reference protein is MNEI protein.

In some embodiments, the amino acid substitutions comprise amino acid S76 as compared to MNEI.

In some embodiments, the modified protein is MNEI protein having SEQ ID NO:1 including a substitution in amino acid residue S76.

In some embodiments, the modified protein comprises an amino acid substitution S76Y, S76F, S76T, S76W, S76R, S76V, S76I, S76H or S76A having an improved stability as compared to SEQ ID NO:1.

In some embodiments, the modified protein is represented by an amino acid denoted herein as DM129. In some embodiments, the modified protein is represented by an amino acid denoted herein as DM147. In some embodiments, the modified protein is represented by an amino acid denoted herein as DM89. In some embodiments, the modified protein is represented by an amino acid denoted herein as DM658. In some embodiments, the modified protein is represented by an amino acid denoted herein as DM137. In some embodiments, the modified protein is represented by an amino acid denoted herein as DM114. In some embodiments, the modified protein is represented by an amino acid denoted herein as DM606. In some embodiments, the modified protein is represented by an amino acid denoted herein as DM663. In some embodiments, the modified protein is represented by an amino acid denoted herein as DM659. In some embodiments, the modified protein is represented by an amino acid denoted herein as DM690.

In some embodiments, the modified protein comprises an amino acid substitution S76F or S76Y having an improved stability as compared to SEQ ID NO:1. In some embodiments, the modified protein is represented by an amino acid denoted herein as DM129. In some embodiments, the modified protein is represented by an amino acid denoted herein as DM147.

As can be seen from Tables 2 and 4, modifications in amino acid S76 increased the Tm value. For example, the experimental Tm value of DM89 was 101° C., of DM137 was 97° C., of DM114 was 101.5° C., of DM89 was 101° C. Further, the predicted Tm value of DM658 was 96° C., of DM663 was 98° C., of DM664 was 99° C., of DM659 was 93.6° C. and of DM690 was 98.5° C.

Based on these results, it was suggested that different modifications in this amino acid are highly effective as they significantly increase the stability of the protein.

As shown in Table 2, substitution of S76 and at least one additional amino acid resulted in a modified protein having at least an improved stability.

In some embodiments, the modified protein is MNEI protein having SEQ ID NO:1 including a substitution in amino acid residue S76 and at least one amino acid substitution.

In accordance with some other aspects, the present disclosure provides a modified protein comprising an amino acid sequence that has a substitution in at least amino acid S76 as compared to SEQ ID NO:1 and an additional modification in at least one amino acid residues of SEQ ID NO:1, wherein the modified protein has at least improved stability as compared to SEQ ID NO:1.

In accordance with some aspects, the present disclosure provides a modified protein comprising an amino acid sequence that has a substitution in at least amino acid S76 as compared to SEQ ID NO:1 and an additional modification in at least one amino acid residues of SEQ ID NO:1, wherein the at least additional modification in at least one of (i) an alpha helix of the reference protein, (ii) a core of the reference protein, (iii) a sweet loop of the reference protein, (iv) a linker region of the reference protein or (v) any combination thereof.

In accordance with some aspects, the present disclosure provides a modified protein comprising an amino acid sequence that has a substitution in at least amino acid S76 as compared to SEQ ID NO:1 and an additional modification in at least one amino acid residues of SEQ ID NO:1, wherein the at least additional modification is a modification that stabilizes alpha helix structure and helix end and wherein the modified protein has at least improved stability as compared to SEQ ID NO:1.

The term stabilizes alpha helix structure as used herein refers to any modification that affect MNEI alpha helix structure. Such modifications include modifications in any one of amino acids residues K25, I26, Q28 of MNEI.

In some embodiments, the modified protein is MNEI protein having SEQ ID NO:1 including a substitution in amino acid residue S76 and comprising at least one additional substitution in at least one amino acid residue K25, I26, Q28 or any combination thereof.

In some embodiments, the modified protein is MNEI protein having SEQ ID NO:1 including a substitution in amino acid residue S76 and comprising at least one additional substitution in at least one amino acid residue E23.

In accordance with some aspects, the present disclosure provides a modified protein comprising an amino acid sequence that has a substitution in at least amino acid S76 as compared to SEQ ID NO:1 and an additional modification in at least one amino acid residues of SEQ ID NO:1, wherein the at least additional modification is a modification that stabilizes the linker region and wherein the modified protein has at least one improved food-related property as compared to SEQ ID NO:1.

The term stabilizes linker region as used herein refers to any modification that affects MNEI linker region.

In some embodiments, the modified protein is MNEI protein having SEQ ID NO:1 including a substitution in amino acid residue S76 and a deletion in at least one of E50, F52, R53 or any combination thereof.

In accordance with some aspects, the present disclosure provides a modified protein comprising an amino acid sequence that has a substitution in at least amino acid S76 as compared to SEQ ID NO:1 and an additional modification in at least one amino acid residues of SEQ ID NO:1, wherein the at least additional modification is a modification that affect aggregation and wherein the modified protein has at least improved stability as compared to SEQ ID NO:1. In some embodiments, the at least one modification is a modification that reduced protein aggregation.

The term reduce protein aggregation as used herein refers to any modification that affect protein aggregation. It is suggested that the two chains of MNEI may form disulfide bond between two cysteine residues (C41). Hence, such modification include modification in amino acid residue C41.

In some embodiments, the modified protein is MNEI protein having SEQ ID NO:1 comprising a substitution in amino acid residue S76 and comprising at least one additional substitution in C41. Based on the computational analysis, it was suggested that C41 is prone to disulfide bond and promoting aggregation and hence any modification in this residue may reduce protein aggregation.

In accordance with some aspects, the present disclosure provides a modified protein comprising an amino acid sequence that has a substitution in at least amino acid S76 as compared to SEQ ID NO:1 and an additional modification in at least one amino acid residues of SEQ ID NO:1, wherein the at least additional modification is a modification that affect core repacking and wherein the modified protein has at least improved stability as compared to SEQ ID NO:1.

The term core repacking as used herein refers to any modification that affect core repacking and thus decreased accessibility to water, making the modified protein stable. It is suggested that there are holes that make the core accessible to surface water (the protein is small so the core may be half exposed.

MNEI core is partially (half) exposed to the surface and is prone to water interferences and hence the suggested modification stabilizes the protein. Such modification include modification in at least one amino acid residue T12, C41, A19, V20, V64, A73, I75, F89 or any combinations thereof.

In some embodiments, the modified protein is MNEI protein having SEQ ID NO:1 comprising a substitution in amino acid residue S76 and comprising a substitution in at least one amino acid residue T12, C41, A19, V20, V64, A73, I75, F89 or any combination thereof.

In accordance with some aspects, the present disclosure provides a modified protein comprising an amino acid sequence that has a substitution in at least amino acid S76 as compared to SEQ ID NO:1 and an additional modification in at least one amino acid residues of SEQ ID NO:1, wherein the at least additional modification is a modification that affect electrostatics and hydrophobicity and wherein the modified protein has at least improved stability as compared to SEQ ID NO:1.

The term electrostatics as used herein refers to any modification that affect electrostatics. Such modification include modification in at least one amino acid residue T33, E4 or any combinations thereof.

In some embodiments, the modified protein is MNEI protein having SEQ ID NO:1 comprising a substitution in amino acid residue S76 and comprising a substitution in at least one amino acid residue T33, E4 or any combination thereof.

In some embodiments, the modified protein is MNEI protein having SEQ ID NO:1 comprising a substitution in amino acid residue S76 and comprising a substitution in at least one of E2, Y65, D68 or any combination thereof.

In some embodiments, the modified protein is MNEI protein having SEQ ID NO:1 comprising a substitution in amino acid residue S76 and comprising a substitution in at least one of R31, Q61, N35 or any combination thereof.

In some embodiments, the modified protein is MNEI protein having SEQ ID NO:1 comprising a substitution in amino acid residue S76 and comprising a substitution in at least R84.

In some embodiments, the modified protein is MNEI protein having SEQ ID NO:1 comprising a substitution in amino acid residue S76 and comprising a modification in at least one amino acid residue selected from E23, K25, I26, Q28, E50, F52, R53, C41, T12, C41, A19, V20, A73, I75, F89, T33, E4, E2, Y65, D68, R31, Q61, N35, R84, V64 or any combination thereof.

In some embodiments, the modified protein is MNEI protein having SEQ ID NO:1 including a substitution in amino acid residue S76 and at least one amino acid substitution in at least one residue selected from E23, K25, I26, Q28, T12, C41, A19, V20, V64, A73, I75, F89, E2, Y65, D68, R84, T33, E4, R31, Q61, N35 or any combination thereof.

In some embodiments, the modified protein is MNEI protein having SEQ ID NO:1 including a substitution in amino acid residue S76 and at least one amino acid substitution in E23, K25, I26, Q28 or any combinations thereof.

In some embodiments, the modified protein is MNEI protein having SEQ ID NO:1 including a substitution in amino acid residue S76 and at least one amino acid substitution in T12, C41, A19, V20, V64, A73, I75, F89 or any combinations thereof.

In some embodiments, the modified protein is MNEI protein having SEQ ID NO:1 including a substitution in amino acid residue S76 and at least one amino acid substitution in E2, Y65, D68 or any combinations thereof.

As shown in Table 2, computational analysis suggested that substitutions of S76 and at least one other amino acid in the amino acid sequence of MNEI results in a modified protein having at least an improved stability as compared to MNEI.

In some embodiments, the modified protein comprises a substitution in amino acid S76 and at least one amino acid substitution as compared to MNEI, wherein the modified protein has at least an improved stability as compared to MNEI.

In some embodiments, the amino acid substitutions comprise amino acids S76 and R84. In some embodiments, the modified protein comprises an amino acid sequence that has at least two amino acid substitutions in at least amino acids R84 and S76 as compared to SEQ ID NO:1.

In some embodiments, the modified protein having at least two amino acid substitutions R84L and S76Y has an improved stability as compared to SEQ ID NO:1.

In some embodiments, the modified protein is represented by an amino acid denoted herein as DM298.

The main difference between wild-type Monellin and MNEI is a region in which the two Monellin subunits are connected into a single-chain Monellin termed MNEI.

The amino acid sequence between amino acid T46 and amino acid 156 is denoted as a loop region, connecting the two Monellin subunits.

As shown herein, CPD analysis have identified specific amino acid residues/regions in MNEI protein which can be modified in order to obtain a modified protein with improved properties, including, inter alia, stability and taste.

For example, MD simulations of MNEI have suggested that the beta sheet of MNEI is less stable. Without being bound by theory, it was suggested that Loops of the beta, and especially the loop between strands 2 & 3 of the beta, do not have a defined secondary structure, and their movement reduces stability. Further, it was suggested that backbone of the beta which is exposed to water. Simulation analyses of MNEI at high temperatures showed that the main weak point of MNEI is the edge of the interface and backbone between strands 3 & 4. The backbone atoms are exposed to water. The simulation also shows that water enter and interference with an hydrogen bond in that area.

As shown in the examples below, modification in the loop region of the modified protein increased the sweetness and/or stability of the reference protein.

Specifically, deletion of amino acids residues in the protein loop and beta strand edges results in a modified protein that is stable as compared to the reference protein, being in some examples, MNEI.

In some embodiments, the modified protein comprises modification in amino acids located the linker (loop) region as compared to SEQ ID NO:1.

In some embodiments, the modified protein is MNEI protein having SEQ ID NO:1 including a substitution in amino acid residue S76 and at least one amino acid deletion.

In some embodiments, the modified protein comprises modification in one or more amino acids located between amino acid T46 and amino acid 156 as compared to SEQ ID NO:1.

In some embodiments, the amino acid sequence of the reference protein may be modified in a linker region of the reference protein.

The amino acid sequence of the reference protein may be modified in a linker region of the reference protein such that that at least one amino acid is deleted.

The modified protein comprises at least one, at times at least two, at times at least three amino acid deletions in the reference protein.

Hence, the present disclosure provides in accordance with some aspects, a modified protein having an amino acid sequence comprising at least one amino acid deletion and at least one amino acid substitution as compared to a reference protein, wherein the reference protein is represented by an amino acid sequence set forth in SEQ ID NO:1, wherein the at least one amino acid deletion is at one or more amino acids located between amino acid T46 and amino acid 156 of the reference protein, and wherein the at least one amino acid substitution is at amino acid S76 of the reference protein.

As noted above, in some examples, the reference protein is MNEI denoted herein by SEQ ID NO:1.

Hence, in accordance with some aspects, the present disclosure provides a modified protein comprising an amino acid sequence that has amino acid deletions in at least three amino acids located between amino acid T46 and amino acid 156, as compared to a reference protein, and wherein the reference protein has an amino acid sequence as set forth in SEQ ID NO:1.

As shown in the Examples below that form part of this patent application, deletion of three amino acids E50, F52 and R53 from the amino acid sequence of MNEI (DM29 denoted herein as SEQ ID NO:33) suggested that the modified protein would have increased stability based on REU value of −319.65 as compared to the REU value of MNEI of −315.35. Deletion of amino acids E50, F52 and R53 is at times referred herein as ΔE50, ΔF52 and ΔR53.

In some embodiments, the at least one amino acids deletion is at one or more of E50, F52, R53 or any combination thereof of SEQ ID NO:1.

Hence, in accordance with some aspects, the present disclosure provides a modified protein having an amino acid sequence comprising at least one amino acid deletion and at least one amino acid substitution as compared to a reference protein, wherein the reference protein is represented by an amino acid sequence set forth in SEQ ID NO:1, wherein the at least one amino acid deletion is at one or more amino acids at least amino acid E50, F52 and R53 of the reference protein, and wherein the at least one amino acid substitution is at amino acid S76 of the reference protein.

As shown in Table 2 below, combining an amino acid substitution at S76 and amino acid deletions in at least amino acid E50, F52 and R53 as compared to SEQ ID NO:1 resulted in a modified protein with at least an improved stability. In some embodiments, the modified protein comprises an amino acid substitution S76Y and amino acid deletions in amino acid E50, F52 and R53 as compared to SEQ ID NO:1 and has an improved stability as compared to SEQ ID NO:1. In some embodiments, the modified protein is represented by an amino acid denoted herein as DM148.

As shown in Table 2 below, combining at least a substitution of amino acid residue S76 of MNEI protein with other amino acid substitutions in the protein as well as with amino acid deletions as described herein significantly increase protein stability as indicated by computational modeling and optimization methods.

In some examples, the modified protein comprises deletion of amino acids E50, F52 and R53, amino acid substitution in S76 and at least one amino acid substitution in one or more of G1, E2, E4, T12, A19, V20, E23, K25, I26, G27, Q28, T33, N35, C41, Q61, V64, Y65, D68, L70, A73, I75, R84, F89 or any combination thereof.

In some examples, the modified protein comprises deletion of amino acids E50, F52 and R53, amino acid substitution in S76 and at least one amino acid substitution in one or more of K25, I26, Q28, C41, E23, D68, E2, L70, Y65, E4, G1 or any combination thereof.

In some embodiments, the modified protein comprises an amino acid substitution S76Y, S76F, S76T, S76W, S76R, S76V, S76I, S76H or S76A having an improved stability as compared to SEQ ID NO:1. In some embodiments, the modified protein comprises an amino acid substitution S76F or S76Y having an improved stability as compared to SEQ ID NO:1.

In some examples, the modified protein comprises deletion of amino acids E50, F52 and R53, amino acid substitution in S76 and at least one amino acid substitution one or more of (i) K25R, (ii) at least one of I26W, I26V, I26T or any combination thereof (iii) at least one of Q28K, Q28R, Q28S, Q28E or any combination thereof, (iv) at least one of C41A, C41V, C41T, C41S or any combination thereof, (v) E23A or E23Q, (vi) at least one of D68N or D68T, (vii) E2M or E2N, (viii) L70I, (ix) Y65R, (x) E4Q, (xi) G1M or (xii) any combination thereof. In some embodiments, the amino acid substitution in S76 comprises one or more of S76Y, S76F, S76T, S76W, S76R, S76V, S76I, S76H or S76A. In some embodiments, the amino acid substitution in S76 is S76Y.

In some embodiments, the amino acid substitutions comprise amino acids S76, Q28 and E23 and deletions in amino acid E50, F52 and R53 as compared to SEQ ID NO:1. In some embodiments, the modified protein having at least three amino acid substitutions E23A, Q28K and S76Y and deletions in amino acid E50, F52 and R53 as compared to SEQ ID NO:1 and has an improved stability as compared to SEQ ID NO:1. In some embodiments, the modified protein is represented by an amino acid denoted herein as DM335.

In some embodiments, the amino acid substitutions comprise amino acids S76, K25, D68, E2, L70, and E23 and deletions in amino acid E50, F52 and R53 as compared to SEQ ID NO:1. In some embodiments, the modified protein having at least amino acid substitutions S76Y, K25R, D68N, E2N, L70I, and E23A and deletions in amino acid E50, F52 and R53 as compared to SEQ ID NO:1 and has an improved stability as compared to SEQ ID NO:1. In some embodiments, the modified protein is represented by an amino acid denoted herein as DM480.

In some embodiments, the amino acid substitutions comprise amino acids S76, D68, and E23 and deletions in amino acid E50, F52 and R53 as compared to SEQ ID NO:1. In some embodiments, the modified protein having at least amino acid substitutions S76Y, D68N and E23A and deletions in amino acid E50, F52 and R53 as compared to SEQ ID NO:1 and has an improved stability as compared to SEQ ID NO:1. In some embodiments, the modified protein is represented by an amino acid denoted herein as DM362.

In some embodiments, the amino acid substitutions comprise amino acids S76, E2 and E23 and deletions in amino acid E50, F52 and R53 as compared to SEQ ID NO:1. In some embodiments, the modified protein having at least amino acid substitutions S76Y, E2N and E23A and deletions in amino acid E50, F52 and R53 as compared to SEQ ID NO:1 and has an improved stability as compared to SEQ ID NO:1. In some embodiments, the modified protein is represented by an amino acid denoted herein as DM364.

In some embodiments, the amino acid substitutions comprise amino acids 576, E23, C41, Y65 and deletions in amino acid E50, F52 and R53 as compared to SEQ ID NO:1. In some embodiments, the modified protein having at least amino acid substitutions S76Y, E23A, C41A, Y65R and deletions in amino acid E50, F52 and R53 as compared to SEQ ID NO:1 and has an improved stability as compared to SEQ ID NO:1. In some embodiments, the modified protein is represented by an amino acid denoted herein as DM126.

In some embodiments, the amino acid substitutions comprise amino acids S76, E4, and E23 and deletions in amino acid E50, F52 and R53 as compared to SEQ ID NO:1. In some embodiments, the modified protein having at least amino acid substitutions S76Y, E23A, E4Q and deletions in amino acid E50, F52 and R53 as compared to SEQ ID NO:1 and has an improved stability as compared to SEQ ID NO:1. In some embodiments, the modified protein is represented by an amino acid denoted herein as DM365.

In some embodiments, the amino acid substitutions comprise amino acids S76, D68, E2, and E23 and deletions in amino acid E50, F52 and R53 as compared to SEQ ID NO:1. In some embodiments, the modified protein having at least amino acid substitutions S76Y, D68N, E2N, E23A and deletions in amino acid E50, F52 and R53 as compared to SEQ ID NO:1 and has an improved stability as compared to SEQ ID NO:1. In some embodiments, the modified protein is represented by an amino acid denoted herein as DM397.

In some embodiments, the amino acid substitutions comprise amino acids S76, E23, Y65 and L70 and deletions in amino acid E50, F52 and R53 as compared to SEQ ID NO:1. In some embodiments, the modified protein having at least amino acid substitutions S76Y, E23A, Y65R, L70I and deletions in amino acid E50, F52 and R53 as compared to SEQ ID NO:1 and has an improved stability as compared to SEQ ID NO:1. In some embodiments, the modified protein is represented by an amino acid denoted herein as DM122.

In some embodiments, the amino acid substitutions comprise amino acids S76, E2, E23 and Y65 and deletions in amino acid E50, F52 and R53 as compared to SEQ ID NO:1. In some embodiments, the modified protein having at least amino acid substitutions S76Y, E2N, E23A, Y65R and deletions in amino acid E50, F52 and R53 as compared to SEQ ID NO:1 and has an improved stability as compared to SEQ ID NO:1. In some embodiments, the modified protein is represented by an amino acid denoted herein as DM124.

In some embodiments, the amino acid substitutions comprise amino acids S76, E2, E23 and L70 and deletions in amino acid E50, F52 and R53 as compared to SEQ ID NO:1. In some embodiments, the modified protein having at least amino acid substitutions S76Y, E2N, E23A, L70I and deletions in amino acid E50, F52 and R53 as compared to SEQ ID NO:1 and has an improved stability as compared to SEQ ID NO:1.

In some embodiments, the modified protein is represented by an amino acid denoted herein as DM123.

In some embodiments, the amino acid substitutions comprise amino acids S76, D68, E2, E23 and L70 and deletions in amino acid E50, F52 and R53 as compared to SEQ ID NO:1. In some embodiments, the modified protein having at least amino acid substitutions S76Y, D68N, E2N, E23A, L70I and deletions in amino acid E50, F52 and R53 as compared to SEQ ID NO:1 and has an improved stability as compared to SEQ ID NO:1. In some embodiments, the modified protein is represented by an amino acid denoted herein as DM361.

In some embodiments, the amino acid substitutions comprise amino acids S76, Q28, E2, E23 and L70 and deletions in amino acid E50, F52 and R53 as compared to SEQ ID NO:1. In some embodiments, the modified protein having at least amino acid substitutions S76Y, Q28K, E2N, E23A, L70I and deletions in amino acid E50, F52 and R53 as compared to SEQ ID NO:1 and has an improved stability as compared to SEQ ID NO:1. In some embodiments, the modified protein is represented by an amino acid denoted herein as DM473.

In some embodiments, the amino acid substitutions comprise amino acids S76, Q28, D68, E2, E23 and L70 and deletions in amino acid E50, F52 and R53 as compared to SEQ ID NO:1. In some embodiments, the modified protein having at least amino acid substitutions S76Y, Q28R, D68N, E2N, E23A, L70I and deletions in amino acid E50, F52 and R53 as compared to SEQ ID NO:1 and has an improved stability as compared to SEQ ID NO:1. In some embodiments, the modified protein is represented by an amino acid denoted herein as DM521.

In some embodiments, the amino acid substitutions comprise amino acids S76, C41, D68, E2, E23 and L70 and deletions in amino acid E50, F52 and R53 as compared to SEQ ID NO:1. In some embodiments, the modified protein having at least amino acid substitutions S76Y, C41T, D68N, E2N, E23A, L70I and deletions in amino acid E50, F52 and R53 as compared to SEQ ID NO:1 and has an improved stability as compared to SEQ ID NO:1. In some embodiments, the modified protein is represented by an amino acid denoted herein as DM477.

In some embodiments, the amino acid substitutions comprise amino acids S76, 126, Q28, D68, E2, E23 and L70 and deletions in amino acid E50, F52 and R53 as compared to SEQ ID NO:1. In some embodiments, the modified protein having at least amino acid substitutions S76Y, I26T, Q28K, D68N, E2N, E23A, L70I and deletions in amino acid E50, F52 and R53 as compared to SEQ ID NO:1 and has an improved stability as compared to SEQ ID NO:1. In some embodiments, the modified protein is represented by an amino acid denoted herein as DM486.

In some embodiments, the amino acid substitutions comprise amino acids S76, Q28, E23, and deletions in amino acid E50, F52 and R53 as compared to SEQ ID NO:1. In some embodiments, the modified protein having at least amino acid substitutions S76Y, Q28K, E23Q, and deletions in amino acid E50, F52 and R53 as compared to SEQ ID NO:1 and has an improved stability as compared to SEQ ID NO:1. In some embodiments, the modified protein is represented by an amino acid denoted herein as DM334.

In some embodiments, the amino acid substitutions comprise amino acids S76, D68 and deletions in amino acid E50, F52 and R53 as compared to SEQ ID NO:1. In some embodiments, the modified protein having at least amino acid substitutions S76Y, D68N and deletions in amino acid E50, F52 and R53 as compared to SEQ ID NO:1 and has an improved stability as compared to SEQ ID NO:1. In some embodiments, the modified protein is represented by an amino acid denoted herein as DM333.

In some embodiments, the amino acid substitutions comprise amino acids S76, E2 and deletions in amino acid E50, F52 and R53 as compared to SEQ ID NO:1. In some embodiments, the modified protein having at least amino acid substitutions S76Y, E2N and deletions in amino acid E50, F52 and R53 as compared to SEQ ID NO:1 and has an improved stability as compared to SEQ ID NO:1. In some embodiments, the modified protein is represented by an amino acid denoted herein as DM338.

In some embodiments, the amino acid substitutions comprise amino acids S76, L70 and deletions in amino acid E50, F52 and R53 as compared to SEQ ID NO:1. In some embodiments, the modified protein having at least amino acid substitutions S76Y, L70I and deletions in amino acid E50, F52 and R53 as compared to SEQ ID NO:1 and has an improved stability as compared to SEQ ID NO:1. In some embodiments, the modified protein is represented by an amino acid denoted herein as DM125.

In some embodiments, the amino acid substitutions comprise amino acids S76, E4 and deletions in amino acid E50, F52 and R53 as compared to SEQ ID NO:1. In some embodiments, the modified protein having at least amino acid substitutions S76Y, E4Q and deletions in amino acid E50, F52 and R53 as compared to SEQ ID NO:1 and has an improved stability as compared to SEQ ID NO:1. In some embodiments, the modified protein is represented by an amino acid denoted herein as DM337.

In some embodiments, the amino acid substitutions comprise amino acids S76, G1, E2 and deletions in amino acid E50, F52 and R53 as compared to SEQ ID NO:1. In some embodiments, the modified protein having at least amino acid substitutions S76Y, G1M, E2M and deletions in amino acid E50, F52 and R53 as compared to SEQ ID NO:1 and has an improved stability as compared to SEQ ID NO:1. In some embodiments, the modified protein is represented by an amino acid denoted herein as DM332.

In some examples, the modified protein comprises deletion of amino acids E50, F52 and R53, amino acid substitution in S76 and at least one amino acid substitution in one or more of E2, E23, Y65, L70.

In some examples, the modified protein comprises deletion of amino acids E50, F52 and R53, and amino acid substitution in at least E2, E23, Y65, L70 and S76 as compared to MNEI (SEQ ID NO:1).

In some examples, the modified protein comprises deletion of amino acids E50, F52 and R5 and amino acid substitution in at least E2, E23, Y65, L70 and S76 as compared to MNEI (SEQ ID NO:1), the amino acid substitution in E2 is E2M or E2N, the amino acid substitution in E23 is E23A or E23Q, the amino acid substitution in Y65 is Y65R, the amino acid substitution in L70 is L70I and the amino acid substitution in S76 is one or more of S76Y, S76F, S76T, S76W, S76R, S76V, S76I, S76H or S76A.

In some examples, the modified protein comprises deletion of amino acids E50, F52 and R54 and amino acid substitution in at least E2M, E23A, Y65R, L70I, and S76Y as compared to MNEI (SEQ ID NO:1). In some examples, the modified protein comprises deletion of amino acids E50, F52 and R54 and amino acid substitution in E2M, E23A, Y65R, L70I, and S76Y as compared to MNEI (SEQ ID NO:1) is denoted herein as DM396.

In some examples, the modified protein comprises deletion of amino acids E50, F52 and R54 and amino acid substitution in E2, E23, Y65, L70, and S76 and in one or more amino acids G1, A19, V20, K25, I26, Q28, R31, T33, N35, C41, E59, D68, A73, D74, I75, E77, R84 as compared to MNEI (SEQ ID NO:1).

In some examples, the modified protein comprises deletion of amino acids E50, F52 and R54 and amino acid substitution in E2, E23, Y65, L70, and S76 and in one or more amino acids G1, E2, A19, V20, K25, I26, Q28, R31, T33, N35, C41, E59, D68, A73, D74, I75, E77, R84 as compared to MNEI (SEQ ID NO:1), the amino acid substitution in E2 is E2M or E2N, the amino acid substitution in E23 is E23A or E23Q, the amino acid substitution in Y65 is Y65R, the amino acid substitution in L70 is L70I, the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in K25 is K25R, the amino acid substitution in I26 is one or more of I26W, I26V, I26T, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in C41 is one or more of C41A, C41V, C41T, C41S, the amino acid substitution in E59 is one or more of E59T, E59V, E59I, E59Y, E59F, E59W, E59R, the amino acid substitution in D68 is D68N or D68T, the amino acid substitution in A73 is A73F or A73V, the amino acid substitution in D74 is D74V, the amino acid substitution in I75 is I75V or I75L, the amino acid substitution in E77 is E77V, the amino acid substitution in R84 is R84L.

In some examples, the modified protein comprises deletion of amino acids E50, F52 and R54 and amino acid substitution in at least G1, E2, E23, Y65, L70, Y76 as compared to SEQ ID NO:1. In some examples, the modified protein comprises deletion of amino acids E50, F52 and R5 and amino acid substitutions, at least G1M, E2M, E23A, Y65R, L70I, S76Y as compared to SEQ ID NO:1. In some examples, the modified protein comprises deletion of amino acids E50, F52 and R5 and amino acid substitutions G1M, E2M, E23A, Y65R, L70I, S76Y as compared to SEQ ID NO:1. In some examples, the modified protein is represented by SEQ ID NO:360.

In some examples, the modified protein comprises deletion of amino acids E50, F52 and R54 and amino acid substitution in at least E2, E23, Y65, L70 as compared to SEQ ID NO:1. In some examples, the modified protein comprises deletion of amino acids E50, F52 and R5 and amino acid substitution in at least E2N, E23A, Y65R, L70I as compared to SEQ ID NO:1.

In some examples, the modified protein comprises deletion of amino acids E50, F52 and R54 and amino acid substitution in at least E2N, E23A, Y65R, L70I and S76Y as compared to MNEI (SEQ ID NO:1).

In some examples, the modified protein comprises deletion of amino acids E50, F52 and R54 and amino acid substitution in at least E2N, E23A, Y65R, L70I as compared to SEQ ID NO:1 is denoted herein as DM31 and is represented herein by SEQ ID NO:34.

In accordance with some aspects, it is provided a modified protein having an amino acid sequence comprising at least one amino acid deletion and at least one amino acid substitution as compared to a reference protein, wherein the reference protein is represented by an amino acid sequence set forth in SEQ ID NO:1, wherein the at least one amino acid deletion is at one or more amino acids E50, F52 and R53 of the reference protein, and wherein the at least one amino acid substitution is in at least amino acids E2, E23, Y65, L70, S76 of the reference protein.

In accordance with some aspects, it is provided a modified protein having an amino acid sequence comprising at least one amino acid deletion and at least one amino acid substitution as compared to a reference protein, wherein the reference protein is represented by an amino acid sequence set forth in SEQ ID NO:1, wherein the at least one amino acid deletion is at amino acids E50, F52 and R53 of the reference protein, and wherein the at least one amino acid substitution is in amino acids E2, E23, Y65, L70, S76 of the reference protein. In some examples, the amino acid substitution in S76 is one or more of S76Y, S76F, S76T, S76W, S76R, S76V, S76I, S76H or S76A.

In accordance with some aspects, it is provided a modified protein having an amino acid sequence comprising at least one amino acid deletion and at least one amino acid substitution as compared to a reference protein, wherein the reference protein is represented by an amino acid sequence set forth in SEQ ID NO:1, wherein the at least one amino acid deletion is at amino acids E50, F52 and R53 of the reference protein, and wherein the at least one amino acid substitution is at least E2N, E23A, Y65R, L70I and at S76 of the reference protein. In some examples, the amino acid substitution in S76 is one or more of S76Y, S76F, S76T, S76W, S76R, S76V, S76I, S76H or S76A.

As shown in the examples below, substituting amino acid S76 in DM31, improved the stability as comparted to DM31.

In some examples, the modified protein comprises an amino acid sequence having amino acid deletions in amino acids E50, F52 and R54 and amino acid substitution in E2N, E23A, Y65R, L70I, S76Y as compared to SEQ ID NO:1. In some examples, the modified protein is denoted herein as DM89.

In some examples, the modified protein comprises an amino acid sequence having amino acid deletions in amino acids E50, F52 and R54 and amino acid substitution in E2N, E23A, Y65R, L70I, S76F as compared to SEQ ID NO:1. In some examples, the modified protein is denoted herein as DM114.

In some examples, the modified protein comprises an amino acid sequence having amino acid deletions in amino acids E50, F52 and R54 and amino acid substitution in E2N, E23A, Y65R, L70I, S76W as compared to SEQ ID NO:1. In some examples, the modified protein is denoted herein as DM137.

In some examples, the modified protein comprises an amino acid sequence having amino acid deletions in amino acids E50, F52 and R54 and amino acid substitution in E2N, E23A, Y65R, L70I, S76T as compared to SEQ ID NO:1. In some examples, the modified protein is denoted herein as DM658.

In some examples, the modified protein comprises an amino acid sequence having amino acid deletions in amino acids E50, F52 and R54 and amino acid substitution in E2N, E23A, Y65R, L70I, S76R as compared to SEQ ID NO:1. In some examples, the modified protein is denoted herein as DM606.

In some examples, the modified protein comprises an amino acid sequence having amino acid deletions in amino acids E50, F52 and R54 and amino acid substitution in E2N, E23A, Y65R, L70I, S76I as compared to SEQ ID NO:1. In some examples, the modified protein is denoted herein as DM664.

In some examples, the modified protein comprises an amino acid sequence having amino acid deletions in amino acids E50, F52 and R54 and amino acid substitution in E2N, E23A, Y65R, L70I, S76V as compared to SEQ ID NO:1. In some examples, the modified protein is denoted herein as DM663.

In some examples, the modified protein comprises an amino acid sequence having amino acid deletions in amino acids E50, F52 and R54 and amino acid substitution in E2N, E23A, Y65R, L70I, S76H as compared to SEQ ID NO:1. In some examples, the modified protein is denoted herein as DM659.

In some examples, the modified protein comprises an amino acid sequence having amino acid deletions in amino acids E50, F52 and R54 and amino acid substitution in E2N, E23A, Y65R, L70I, S76A as compared to SEQ ID NO:1. In some examples, the modified protein is denoted herein as DM690.

In some examples, the modified protein is denoted by one or more of DM89, DM114, DM137, DM658, DM606, DM664, DM663, DM659 or DM690. In some examples, the modified protein is denoted by one or more of DM89, DM114 or DM137.

In some examples, the modified protein comprises deletion of amino acids E50, F52 and R54 and amino acid substitution in E2N, E23A, Y65R, L70I, and S76 and in one or more amino acids G1, A19, V20, K25, I26, Q28, R31, T33, N35, C41, E59, D68, A73, D74, I75, E77, R84 as compared to MNEI (SEQ ID NO:1).

In some examples, the modified protein comprises deletion of amino acids E50, F52 and R54 and amino acid substitution in E2N, E23A, Y65R, L70I, and S76 and in one or more amino acids G1, E2, A19, V20, K25, I26, Q28, R31, T33, N35, C41, E59, D68, A73, D74, I75, E77, R84 as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in K25 is K25R, the amino acid substitution in I26 is one or more of I26W, I26V, I26T, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in C41 is one or more of C41A, C41V, C41T, C41S, the amino acid substitution in E59 is one or more of E59T, E59V, E59I, E59Y, E59F, E59W, E59R, the amino acid substitution in D68 is D68N or D68T, the amino acid substitution in A73 is A73F or A73V, the amino acid substitution in D74 is D74V, the amino acid substitution in I75 is I75V or I75L, the amino acid substitution in E77 is E77V, the amino acid substitution in R84 is R84L.

In some examples, the modified protein comprises deletion of amino acids E50, F52 and R54 and amino acid substitutions E2N, E23A, Y65R, L70I, and an amino acid substitution in S76 and in one or more amino acids G1, E2, A19, V20, K25, I26, Q28, R31, T33, N35, C41, E59, D68, A73, D74, I75, E77, R84 as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in K25 is K25R, the amino acid substitution in I26 is one or more of I26W, I26V, I26T, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in C41 is one or more of C41A, C41V, C41T, C41S, the amino acid substitution in E59 is one or more of E59T, E59V, E59I, E59Y, E59F, E59W, E59R, the amino acid substitution in D68 is D68N or D68T, the amino acid substitution in A73 is A73F or A73V, the amino acid substitution in D74 is D74V, the amino acid substitution in I75 is I75V or I75L, the amino acid substitution in E77 is E77V, the amino acid substitution in R84 is R84L.

In some examples, the modified protein deletion of amino acids E50, F52 and R54 and amino acid substitutions E2N, E23A, Y65R, L70I, and an amino acid substitution in S76, A19 and in one or more amino acids G1, E2, A19, V20, K25, I26, Q28, R31, T33, N35, C41, E59, D68, A73, D74, I75, E77, R84 as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in K25 is K25R, the amino acid substitution in I26 is one or more of I26W, I26V, I26T, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in C41 is one or more of C41A, C41V, C41T, C41S, the amino acid substitution in E59 is one or more of E59T, E59V, E59I, E59Y, E59F, E59W, E59R, the amino acid substitution in D68 is D68N or D68T, the amino acid substitution in A73 is A73F or A73V, the amino acid substitution in D74 is D74V, the amino acid substitution in I75 is I75V or I75L, the amino acid substitution in E77 is E77V, the amino acid substitution in R84 is R84L.

In some examples, the modified protein comprises deletion of amino acids E50, F52 and R54 and amino acid substitutions E2N, E23A, Y65R, L70I, and an amino acid substitution in S76, A19 and in one or more amino acids Q28, T33, N35, R84 as compared to MNEI (SEQ ID NO:1), the amino acid substitution in S76 is one or more of S76Y, S76F, S76T, S76W, S76R, S76V, S76I, S76H or S76A, the amino acid substitution in A19 is A19V, the amino acid substitution in Q28 is one or more of Q28R, Q28K, Q28S, Q28E, the amino acid substitution in T33 is T33R, the amino acid substitution in R84 is R84L.

In some examples, the modified protein comprises deletion of amino acids E50, F52 and R54 and amino acid substitutions E2N, E23A, Y65R, L70I, and an amino acid substitution in S76, V20 and in one or more amino acids G1, E2, A19, V20, K25, I26, Q28, R31, T33, N35, C41, E59, D68, A73, D74, I75, E77, R84 as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in K25 is K25R, the amino acid substitution in I26 is one or more of I26W, I26V, I26T, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in C41 is one or more of C41A, C41V, C41T, C41S, the amino acid substitution in E59 is one or more of E59T, E59V, E59I, E59Y, E59F, E59W, E59R, the amino acid substitution in D68 is D68N or D68T, the amino acid substitution in A73 is A73F or A73V, the amino acid substitution in D74 is D74V, the amino acid substitution in I75 is I75V or I75L, the amino acid substitution in E77 is E77V, the amino acid substitution in R84 is R84L.

In some examples, the modified protein comprises deletion of amino acids E50, F52 and R54 and amino acid substitutions E2N, E23A, Y65R, L70I, and an amino acid substitution in 576, V20 and in one or more amino acids Q28, R31, T33, N35, D68, R84 as compared to MNEI (SEQ ID NO:1), the amino acid substitution in S76 is one or more of S76Y, S76F, S76T, S76W, S76R, S76V, S76I, S76H or S76A, the amino acid substitution in V20 is V20I, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in D68 is D68N or D68T, the amino acid substitution in R84 is R84L.

In some examples, the modified protein comprises deletion of amino acids E50, F52 and R54 and amino acid substitutions E2N, E23A, Y65R, L70I, and an amino acid substitution in S76 and K25 and in one or more amino acids G1, E2, A19, V20, 126, Q28, R31, T33, N35, C41, E59, D68, A73, D74, I75, E77, R84 as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in K25 is K25R, the amino acid substitution in I26 is one or more of I26W, I26V, I26T, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in C41 is one or more of C41A, C41V, C41T, C41S, the amino acid substitution in E59 is one or more of E59T, E59V, E59I, E59Y, E59F, E59W, E59R, the amino acid substitution in D68 is D68N or D68T, the amino acid substitution in A73 is A73F or A73V, the amino acid substitution in D74 is D74V, the amino acid substitution in I75 is I75V or I75L, the amino acid substitution in E77 is E77V, the amino acid substitution in R84 is R84L.

In some examples, the modified protein comprises deletion of amino acids E50, F52 and R54 and amino acid substitutions E2N, E23A, Y65R, L70L, and an amino acid substitution in S76 and K25 and in one or more amino acids Q28, T33, C41, D68, as compared to MNEI (SEQ ID NO:1), the amino acid substitution in S76 is one or more of S76Y, S76F, S76T, S76W, S76R, S76V, S76I, S76H or S76A, the amino acid substitution in K25 is K25R, the amino acid substitution in Q28 is one or more of Q28R, Q28K, Q28S, Q28E, the amino acid substitution in T33 is T33R, the amino acid substitution in C41 is one or more of C41A, C41V, C41T, C41S, the amino acid substitution in D68 is D68N or D68T.

In some examples, the modified protein comprises deletion of amino acids E50, F52 and R54 and amino acid substitutions E2N, E23A, Y65R, L70I, and an amino acid substitution in S76, I26 and in one or more amino acids G1, E2, A19, V20, K25, Q28, R31, T33, N35, C41, E59, D68, A73, D74, I75, E77, R84 as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in K25 is K25R, the amino acid substitution in I26 is one or more of I26W, I26V, I26T, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in C41 is one or more of C41A, C41V, C41T, C41S, the amino acid substitution in E59 is one or more of E59T, E59V, E59I, E59Y, E59F, E59W, E59R, the amino acid substitution in D68 is D68N or D68T, the amino acid substitution in A73 is A73F or A73V, the amino acid substitution in D74 is D74V, the amino acid substitution in I75 is I75V or I75L, the amino acid substitution in E77 is E77V, the amino acid substitution in R84 is R84L.

In some examples, the modified protein comprises deletion of amino acids E50, F52 and R54 and amino acid substitutions E2N, E23A, Y65R, L70I, and an amino acid substitution in S76, I26 and Q28, as compared to MNEI (SEQ ID NO:1), the amino acid substitution in S76 is one or more of S76Y, S76F, S76T, S76W, S76R, S76V, S76I, S76H or S76A, the amino acid substitution in I26 is one or more of I26W, I26V, I26T, the amino acid substitution in Q28 is one or more of Q28R, Q28K, Q28S, Q28E.

In some examples, the modified protein comprises deletion of amino acids E50, F52 and R54 and amino acid substitutions E2N, E23A, Y65R, L70L, and an amino acid substitution in S76 and Q28 and in one or more amino acids G1, E2, A19, V20, K25, I26, R31, T33, N35, C41, E59, D68, A73, D74, I75, E77, R84 as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in K25 is K25R, the amino acid substitution in I26 is one or more of I26W, I26V, I26T, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in C41 is one or more of C41A, C41V, C41T, C41S, the amino acid substitution in E59 is one or more of E59T, E59V, E59I, E59Y, E59F, E59W, E59R, the amino acid substitution in D68 is D68N or D68T, the amino acid substitution in A73 is A73F or A73V, the amino acid substitution in D74 is D74V, the amino acid substitution in I75 is I75V or I75L, the amino acid substitution in E77 is E77V, the amino acid substitution in R84 is R84L.

In some examples, the modified protein comprises deletion of amino acids E50, F52 and R54 and amino acid substitutions E2N, E23A, Y65R, L70I, and an amino acid substitution in S76 and Q28 and in one or more amino acids A19, V20, K25, I26, R31, T33, C41, D68, as compared to MNEI (SEQ ID NO:1), the amino acid substitution in S76 is one or more of S76Y, S76F, S76T, S76W, S76R, S76V, S76I, S76H or S76A, the amino acid substitution in A19 is A19V, the amino acid substitution in V20 is V20I, the amino acid substitution in K25 is K25R, the amino acid substitution in I26 is one or more of I26W, I26V, I26T, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in C41 is one or more of C41A, C41V, C41T, C41S, the amino acid substitution in D68 is D68N or D68T.

In some examples, the modified protein comprises deletion of amino acids E50, F52 and R54 and amino acid substitutions E2N, E23A, Y65R, L70I, and an amino acid substitution in S76 and R31 and in one or more amino acids G1, E2, A19, V20, K25, I26, Q28, R31, T33, N35, C41, E59, D68, A73, D74, I75, E77, R84 as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in K25 is K25R, the amino acid substitution in I26 is one or more of I26W, I26V, I26T, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in C41 is one or more of C41A, C41V, C41T, C41S, the amino acid substitution in E59 is one or more of E59T, E59V, E59I, E59Y, E59F, E59W, E59R, the amino acid substitution in D68 is D68N or D68T, the amino acid substitution in A73 is A73F or A73V, the amino acid substitution in D74 is D74V, the amino acid substitution in I75 is I75V or I75L, the amino acid substitution in E77 is E77V, the amino acid substitution in R84 is R84L.

In some examples, the modified protein comprises deletion of amino acids E50, F52 and R54 and amino acid substitutions E2N, E23A, Y65R, L70I, and an amino acid substitution in S76 and R31 and in one or more amino acids V20, Q28, T33, D68, as compared to MNEI (SEQ ID NO:1), the amino acid substitution in S76 is one or more of S76Y, S76F, S76T, S76W, S76R, S76V, S76I, S76H or S76A, the amino acid substitution in V20 is V20I, the amino acid substitution in Q28 is one or more of Q28R, Q28K, Q28S, Q28E, the amino acid substitution in R31 is R31T, the amino acid substitution in T33 is T33R, the amino acid substitution in D68 is D68N or D68T.

In some examples, the modified protein comprises deletion of amino acids E50, F52 and R54 and amino acid substitutions E2N, E23A, Y65R, L70I, and an amino acid substitution in S76 and T33 and in one or more amino acids G1, E2, A19, V20, K25, I26, Q28, R31, N35, C41, E59, D68, A73, D74, I75, E77, R84 as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in K25 is K25R, the amino acid substitution in I26 is one or more of I26W, I26V, I26T, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in C41 is one or more of C41A, C41V, C41T, C41S, the amino acid substitution in E59 is one or more of E59T, E59V, E59I, E59Y, E59F, E59W, E59R, the amino acid substitution in D68 is D68N or D68T, the amino acid substitution in A73 is A73F or A73V, the amino acid substitution in D74 is D74V, the amino acid substitution in I75 is I75V or I75L, the amino acid substitution in E77 is E77V, the amino acid substitution in R84 is R84L.

In some examples, the modified protein comprises deletion of amino acids E50, F52 and R54 and amino acid substitutions E2N, E23A, Y65R, L70I, and an amino acid substitution in S76 and T33 and in one or more amino acids A19, V20, K25, Q28, D68, as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in K25 is K25R, the amino acid substitution in Q28 is one or more of Q28R, Q28K, Q28S, Q28E, the amino acid substitution in T33 is T33R, the amino acid substitution in D68 is D68N or D68T.

In some examples, the modified protein comprises deletion of amino acids E50, F52 and R54 and amino acid substitutions E2N, E23A, Y65R, L70I, and an amino acid substitution in S76 and N35 and in one or more amino acids G1, E2, A19, V20, K25, I26, Q28, R31, T33, N35, C41, E59, D68, A73, D74, I75, E77, R84 as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in K25 is K25R, the amino acid substitution in I26 is one or more of I26W, I26V, I26T, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in C41 is one or more of C41A, C41V, C41T, C41S, the amino acid substitution in E59 is one or more of E59T, E59V, E59I, E59Y, E59F, E59W, E59R, the amino acid substitution in D68 is D68N or D68T, the amino acid substitution in A73 is A73F or A73V, the amino acid substitution in D74 is D74V, the amino acid substitution in I75 is I75V or I75L, the amino acid substitution in E77 is E77V, the amino acid substitution in R84 is R84L.

In some examples, the modified protein comprises deletion of amino acids E50, F52 and R54 and amino acid substitutions E2N, E23A, Y65R, L70I, and an amino acid substitution in S76 and N35 and in one or more amino acids A19, V20, as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in N35 is N35T.

In some examples, the modified protein comprises deletion of amino acids E50, F52 and R54 and amino acid substitutions E2N, E23A, Y65R, L70I, and an amino acid substitution in S76 and C41 and in one or more amino acids G1, E2, A19, V20, K25, I26, Q28, R31, T33, N35, C41, E59, D68, A73, D74, I75, E77, R84 as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in K25 is K25R, the amino acid substitution in I26 is one or more of I26W, I26V, I26T, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in C41 is one or more of C41A, C41V, C41T, C41S, the amino acid substitution in E59 is one or more of E59T, E59V, E59I, E59Y, E59F, E59W, E59R, the amino acid substitution in D68 is D68N or D68T, the amino acid substitution in A73 is A73F or A73V, the amino acid substitution in D74 is D74V, the amino acid substitution in I75 is I75V or I75L, the amino acid substitution in E77 is E77V, the amino acid substitution in R84 is R84L.

In some examples, the modified protein comprises deletion of amino acids E50, F52 and R54 and amino acid substitutions E2N, E23A, Y65R, L70I, and an amino acid substitution in S76 and C41 and in one or more amino acids K25, Q28, as compared to MNEI (SEQ ID NO:1), the amino acid substitution in S76 is one or more of S76Y, S76F, S76T, S76W, S76R, S76V, S76I, S76H or S76A, the amino acid substitution in K25 is K25R, the amino acid substitution in Q28 is one or more of Q28R, Q28K, Q28S, Q28E, the amino acid substitution in C41 is one or more of C41A, C41V, C41T, C41S.

In some examples, the modified protein comprises deletion of amino acids E50, F52 and R54 and amino acid substitutions E2N, E23A, Y65R, L70I, and an amino acid substitution in S76 and E59 and in one or more amino acids G1, E2, A19, V20, K25, I26, Q28, R31, T33, N35, C41, D68, A73, D74, I75, E77, R84 as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in K25 is K25R, the amino acid substitution in I26 is one or more of I26W, I26V, I26T, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in C41 is one or more of C41A, C41V, C41T, C41S, the amino acid substitution in E59 is one or more of E59T, E59V, E59I, E59Y, E59F, E59W, E59R, the amino acid substitution in D68 is D68N or D68T, the amino acid substitution in A73 is A73F or A73V, the amino acid substitution in D74 is D74V, the amino acid substitution in I75 is I75V or I75L, the amino acid substitution in E77 is E77V, the amino acid substitution in R84 is R84L.

In some examples, the modified protein comprises deletion of amino acids E50, F52 and R54 and amino acid substitutions E2N, E23A, Y65R, L70I, and an amino acid substitution in S76, E59 and D74, as compared to MNEI (SEQ ID NO:1), the amino acid substitution in S76 is one or more of S76Y, S76F, S76T, S76W, S76R, S76V, S76I, S76H or S76A, the amino acid substitution in E59 is one or more of E59T, E59V, E59I, E59Y, E59F, E59W, E59R, the amino acid substitution in D74 is D74V.

In some examples, the modified protein comprises deletion of amino acids E50, F52 and R54 and amino acid substitutions E2N, E23A, Y65R, L70I, and an amino acid substitution in S76 and D68 and in one or more amino acids G1, E2, A19, V20, K25, I26, Q28, R31, T33, N35, C41, E59, A73, D74, I75, E77, R84 as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in K25 is K25R, the amino acid substitution in I26 is one or more of I26W, I26V, I26T, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in C41 is one or more of C41A, C41V, C41T, C41S, the amino acid substitution in E59 is one or more of E59T, E59V, E59I, E59Y, E59F, E59W, E59R, the amino acid substitution in D68 is D68N or D68T, the amino acid substitution in A73 is A73F or A73V, the amino acid substitution in D74 is D74V, the amino acid substitution in I75 is I75V or I75L, the amino acid substitution in E77 is E77V, the amino acid substitution in R84 is R84L.

In some examples, the modified protein comprises deletion of amino acids E50, F52 and R54 and amino acid substitutions E2N, E23A, Y65R, L70I, and an amino acid substitution in S76 and D68 and in one or more amino acids V20, K25, Q28, T33, as compared to MNEI (SEQ ID NO:1), the amino acid substitution in S76 is one or more of S76Y, S76F, S76T, S76W, S76R, S76V, S76I, S76H or S76A, the amino acid substitution in V20 is V20I, the amino acid substitution in K25 is K25R, the amino acid substitution in Q28 is one or more of Q28R, Q28K, Q28S, Q28E, the amino acid substitution in T33 is T33R, the amino acid substitution in N35 is N35T, the amino acid substitution in D68 is D68N or D68T.

In some examples, the modified protein comprises deletion of amino acids E50, F52 and R54 and amino acid substitutions E2N, E23A, Y65R, L70I, and an amino acid substitution in S76, D74 and in one or more amino acids G1, E2, A19, V20, K25, I26, Q28, R31, T33, N35, C41, E59, D68, A73, I75, E77, R84 as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in K25 is K25R, the amino acid substitution in I26 is one or more of I26W, I26V, I26T, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in C41 is one or more of C41A, C41V, C41T, C41S, the amino acid substitution in E59 is one or more of E59T, E59V, E59I, E59Y, E59F, E59W, E59R, the amino acid substitution in D68 is D68N or D68T, the amino acid substitution in A73 is A73F or A73V, the amino acid substitution in D74 is D74V, the amino acid substitution in I75 is I75V or I75L, the amino acid substitution in E77 is E77V, the amino acid substitution in R84 is R84L.

In some examples, the modified protein comprises deletion of amino acids E50, F52 and R54 and amino acid substitutions E2N, E23A, Y65R, L70I, and an amino acid substitution in 576, D74 and E59, as compared to MNEI (SEQ ID NO:1), the amino acid substitution in S76 is one or more of S76Y, S76F, S76T, S76W, S76R, S76V, S76I, S76H or S76A, the amino acid substitution in E59 is one or more of E59T, E59V, E59I, E59Y, E59F, E59W, E59R, the amino acid substitution in D74 is D74V.

In some examples, the modified protein comprises deletion of amino acids E50, F52 and R54 and amino acid substitutions E2N, E23A, Y65R, L70I, and an amino acid substitution in S76, I75 and in one or more amino acids G1, E2, A19, V20, K25, I26, Q28, R31, T33, N35, C41, E59, D68, A73, D74, E77, R84 as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in K25 is K25R, the amino acid substitution in I26 is one or more of I26W, I26V, I26T, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in C41 is one or more of C41A, C41V, C41T, C41S, the amino acid substitution in E59 is one or more of E59T, E59V, E59I, E59Y, E59F, E59W, E59R, the amino acid substitution in D68 is D68N or D68T, the amino acid substitution in A73 is A73F or A73V, the amino acid substitution in D74 is D74V, the amino acid substitution in I75 is I75V or I75L, the amino acid substitution in E77 is E77V, the amino acid substitution in R84 is R84L.

In some examples, the modified protein comprises deletion of amino acids E50, F52 and R54 and amino acid substitutions E2N, E23A, Y65R, L70I, and an amino acid substitution in S76, E77 and in one or more amino acids G1, E2, A19, V20, K25, I26, Q28, R31, T33, N35, C41, E59, D68, A73, D74, I75, R84 as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in K25 is K25R, the amino acid substitution in I26 is one or more of I26W, I26V, I26T, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in C41 is one or more of C41A, C41V, C41T, C41S, the amino acid substitution in E59 is one or more of E59T, E59V, E59I, E59Y, E59F, E59W, E59R, the amino acid substitution in D68 is D68N or D68T, the amino acid substitution in A73 is A73F or A73V, the amino acid substitution in D74 is D74V, the amino acid substitution in I75 is I75V or I75L, the amino acid substitution in E77 is E77V, the amino acid substitution in R84 is R84L.

In some examples, the modified protein comprises deletion of amino acids E50, F52 and R54 and amino acid substitutions E2N, E23A, Y65R, L70I, and an amino acid substitution in S76, I75 and E77, as compared to MNEI (SEQ ID NO:1), the amino acid substitution in S76 is one or more of S76Y, S76F, S76T, S76W, S76R, S76V, S76I, S76H or S76A, the amino acid substitution in I75 is I75V or I75L, the amino acid substitution in E77 is E77V.

In some examples, the modified protein comprises deletion of amino acids E50, F52 and R54 and amino acid substitutions E2N, E23A, Y65R, L70I, and an amino acid substitution in S76, R84 and in one or more amino acids G1, E2, A19, V20, K25, I26, Q28, R31, T33, N35, C41, E59, D68, A73, D74, I75, E77 as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in K25 is K25R, the amino acid substitution in I26 is one or more of I26W, I26V, I26T, the amino acid substitution in Q28 is one or more of Q28R, Q28K, Q28S, Q28E, the amino acid substitution in R31 is R31T, the amino acid substitution in T33 is T33R, the amino acid substitution in N35 is N35T, the amino acid substitution in C41 is one or more of C41A, C41V, C41T, C41S, the amino acid substitution in E59 is one or more of E59T, E59V, E59I, E59Y, E59F, E59W, E59R, the amino acid substitution in D68 is D68N or D68T, the amino acid substitution in A73 is A73F or A73V, the amino acid substitution in D74 is D74V, the amino acid substitution in I75 is I75V or I75L, the amino acid substitution in E77 is E77V, the amino acid substitution in R84 is R84L.

In some examples, the modified protein comprises deletion of amino acids E50, F52 and R54 and amino acid substitutions E2N, E23A, Y65R, L70I, and an amino acid substitution in 576, R84 and in one or more amino acids G1, E2, A19, V20, K25, I26, Q28, R31, T33, N35, C41, E59, D68, A73, D74, I75, E77 as compared to MNEI (SEQ ID NO:1), the amino acid substitution in S76 is one or more of S76Y, S76F, S76T, S76W, S76R, S76V, S76I, S76H or S76A, the amino acid substitution in G1 is G1M, the amino acid substitution in A19 is A19V, the amino acid substitution in V20 is V20I, the amino acid substitution in D68 is D68N or D68T, the amino acid substitution in R84 is R84L.

In some examples, the modified protein comprises deletion of amino acids E50, F52 and R54 and amino acid substitutions E2N, E23A, Y65R, L70I, and amino acid substitution in G1 and S76 as compared to MNEI (SEQ ID NO:1).

In some examples, the modified protein comprises deletion of amino acids E50, F52 and R54 and amino acid substitutions E2N, E23A, Y65R, L70I, G1M and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, G1M and S76Y as compared to MNEI (SEQ ID NO:1). In some embodiments, the modified protein is represented by an amino acid denoted herein as DM413.

In some examples, the modified protein comprises deletion of amino acids E50, F52 and R54 and amino acid substitutions E2N, E23A, Y65R, L70I, and amino acid substitution in A19 and S76 as compared to MNEI (SEQ ID NO:1). In some examples, the modified protein comprises A19V and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, A19V and S76Y as compared to MNEI (SEQ ID NO:1). In some embodiments, the modified protein is represented by an amino acid denoted herein as DM202.

In some examples, the modified protein comprises deletion of amino acids E50, F52 and R54 and amino acid substitutions E2N, E23A, Y65R, L70I, and amino acid substitution in V20 and S76 as compared to MNEI (SEQ ID NO:1). In some examples, the modified protein comprises V20I and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, V20I and S76Y as compared to MNEI (SEQ ID NO:1). In some embodiments, the modified protein is represented by an amino acid denoted herein as DM206.

In some examples, the modified protein comprises deletion of amino acids E50, F52 and R54 and amino acid substitutions E2N, E23A, Y65R, L70I, K25 and S76 as compared to MNEI (SEQ ID NO:1).

In some examples, the modified protein comprises deletion of amino acids E50, F52 and R54 and amino acid substitutions E2N, E23A, Y65R, L70I, K25R and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, K25R and S76W as compared to MNEI (SEQ ID NO:1). In some embodiments, the modified protein is represented by an amino acid denoted herein as DM162.

In some examples, the modified protein comprises deletion of amino acids E50, F52 and R54 and amino acid substitutions E2N, E23A, Y65R, L70I, K25R and S76F as compared to MNEI (SEQ ID NO:1). In some embodiments, the modified protein is represented by an amino acid denoted herein as DM160.

In some examples, the modified protein comprises deletion of amino acids E50, F52 and R54 and amino acid substitutions E2N, E23A, Y65R, L70I, K25R and S76Y as compared to MNEI (SEQ ID NO:1). In some embodiments, the modified protein is represented by an amino acid denoted herein as DM101.

In some examples, the modified protein comprises deletion of amino acids E50, F52 and R54 and amino acid substitutions E2N, E23A, Y65R, L70I, and amino acid substitution in I26 and S76 as compared to MNEI (SEQ ID NO:1).

In some examples, the modified protein comprises deletion of amino acids E50, F52 and R54 and amino acid substitutions E2N, E23A, Y65R, L70I, I26T and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, I26V and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, I26W and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, I26T and S76F as compared to MNEI (SEQ ID NO:1). In some embodiments, the modified protein is represented by an amino acid denoted herein as DM159.

In some examples, the modified protein comprises deletion of amino acids E50, F52 and R54 and amino acid substitutions E2N, E23A, Y65R, L70I, I26T and S76W as compared to MNEI (SEQ ID NO:1). In some embodiments, the modified protein is represented by an amino acid denoted herein as DM161.

In some examples, the modified protein comprises deletion of amino acids E50, F52 and R54 and amino acid substitutions E2N, E23A, Y65R, L70I, I26T and S76Y as compared to MNEI (SEQ ID NO:1). In some embodiments, the modified protein is represented by an amino acid denoted herein as DM100.

In some examples, the modified protein comprises deletion of amino acids E50, F52 and R54 and amino acid substitutions E2N, E23A, Y65R, L70I, and amino acid substitution in Q28 and S76 as compared to MNEI (SEQ ID NO: 1).

In some examples, the modified protein comprises deletion of amino acids E50, F52 and R54 and amino acid substitutions E2N, E23A, Y65R, L70I, Q28S and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, Q28S and S76Y as compared to MNEI (SEQ ID NO:1). In some embodiments, the modified protein is represented by an amino acid denoted herein as DM520.

In some examples, the modified protein comprises deletion of amino acids E50, F52 and R54 and amino acid substitutions E2N, E23A, Y65R, L70I, Q28K and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, Q28K and S76Y as compared to MNEI (SEQ ID NO:1). In some embodiments, the modified protein is represented by an amino acid denoted herein as DM363.

In some examples, the modified protein comprises deletion of amino acids E50, F52 and R54 and amino acid substitutions E2N, E23A, Y65R, L70I, Q28R and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, Q28R and S76Y as compared to MNEI (SEQ ID NO:1). In some embodiments, the modified protein is represented by an amino acid denoted herein as DM517.

In some examples, the modified protein comprises deletion of amino acids E50, F52 and R54 and amino acid substitutions E2N, E23A, Y65R, L70I, and amino acid substitution in R31 and S76 as compared to MNEI (SEQ ID NO:1).

In some examples, the modified protein comprises deletion of amino acids E50, F52 and R54 and amino acid substitutions E2N, E23A, Y65R, L70I, R31T and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, R31T and S76Y as compared to MNEI (SEQ ID NO:1). In some embodiments, the modified protein is represented by an amino acid denoted herein as DM286.

In some examples, the modified protein comprises deletion of amino acids E50, F52 and R54 and amino acid substitutions E2N, E23A, Y65R, L70I, and amino acid substitution in T33 and S76 as compared to MNEI (SEQ ID NO:1).

In some examples, the modified protein comprises deletion of amino acids E50, F52 and R54 and amino acid substitutions E2N, E23A, Y65R, L70I, T33R and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, T33R and S76W as compared to MNEI (SEQ ID NO:1). In some embodiments, the modified protein is represented by an amino acid denoted herein as DM234.

In some examples, the modified protein comprises deletion of amino acids E50, F52 and R54 and amino acid substitutions E2N, E23A, Y65R, L70I, T33R and S76Y as compared to MNEI (SEQ ID NO:1). In some embodiments, the modified protein is represented by an amino acid denoted herein as DM222.

In some examples, the modified protein comprises deletion of amino acids E50, F52 and R54 and amino acid substitutions E2N, E23A, Y65R, L70I, T33R and S76F as compared to MNEI (SEQ ID NO:1). In some embodiments, the modified protein is represented by an amino acid denoted herein as DM228.

In some examples, the modified protein comprises deletion of amino acids E50, F52 and R54 and amino acid substitutions E2N, E23A, Y65R, L70I, and amino acid substitution in N35 and S76 as compared to MNEI (SEQ ID NO:1).

In some examples, the modified protein comprises deletion of amino acids E50, F52 and R54 and amino acid substitutions E2N, E23A, Y65R, L70I, N35T and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, N35T and S76Y as compared to MNEI (SEQ ID NO:1). In some embodiments, the modified protein is represented by an amino acid denoted herein as DM289.

In some examples, the modified protein comprises deletion of amino acids E50, F52 and R54 and amino acid substitutions E2N, E23A, Y65R, L70I, and amino acid substitution in C41 and S76 as compared to MNEI (SEQ ID NO:1).

In some examples, the modified protein comprises deletion of amino acids E50, F52 and R54 and amino acid substitutions E2N, E23A, Y65R, L70I, C41V and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, C41V and S76F as compared to MNEI (SEQ ID NO:1). In some embodiments, the modified protein is represented by an amino acid denoted herein as DM249.

In some examples, the modified protein comprises deletion of amino acids E50, F52 and R54 and amino acid substitutions E2N, E23A, Y65R, L70I, C41V and S76Y as compared to MNEI (SEQ ID NO:1). In some embodiments, the modified protein is represented by an amino acid denoted herein as DM146.

In some examples, the modified protein comprises deletion of amino acids E50, F52 and R54 and amino acid substitutions E2N, E23A, Y65R, L70I, C41V and S76W as compared to MNEI (SEQ ID NO:1). In some embodiments, the modified protein is represented by an amino acid denoted herein as DM269.

In some examples, the modified protein comprises deletion of amino acids E50, F52 and R54 and amino acid substitutions E2N, E23A, Y65R, L70I, C41T and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, C41T and S76W as compared to MNEI (SEQ ID NO:1). In some embodiments, the modified protein is represented by an amino acid denoted herein as DM291.

In some examples, the modified protein comprises deletion of amino acids E50, F52 and R54 and amino acid substitutions E2N, E23A, Y65R, L70I, C41T and S76F as compared to MNEI (SEQ ID NO:1). In some embodiments, the modified protein is represented by an amino acid denoted herein as DM294.

In some examples, the modified protein comprises deletion of amino acids E50, F52 and R54 and amino acid substitutions E2N, E23A, Y65R, L70I, C41T and S76Y as compared to MNEI (SEQ ID NO:1). In some embodiments, the modified protein is represented by an amino acid denoted herein as DM287.

In some examples, the modified protein comprises deletion of amino acids E50, F52 and R54 and amino acid substitutions E2N, E23A, Y65R, L70I, C41S and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, C41S and S76Y as compared to MNEI (SEQ ID NO:1). In some embodiments, the modified protein is represented by an amino acid denoted herein as DM346. [DS instead of DM211]

In some examples, the modified protein comprises deletion of amino acids E50, F52 and R54 and amino acid substitutions E2N, E23A, Y65R, L70I, C41A and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, C41A and S76Y as compared to MNEI (SEQ ID NO:1). In some embodiments, the modified protein is represented by an amino acid denoted herein as DM210.

In some examples, the modified protein comprises deletion of amino acids E50, F52 and R54 and amino acid substitutions E2N, E23A, Y65R, L70I, and amino acid substitution in E59 and S76 as compared to MNEI (SEQ ID NO:1).

In some examples, the modified protein comprises deletion of amino acids E50, F52 and R54 and amino acid substitutions E2N, E23A, Y65R, L70I, E59T and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, E59T and S76I as compared to MNEI (SEQ ID NO:1) and is represented by an amino acid denoted herein as DM657.

In some examples, the modified protein comprises deletion of amino acids E50, F52 and R54 and amino acid substitutions E2N, E23A, Y65R, L70I, E59T and S76V as compared to MNEI (SEQ ID NO:1). In some embodiments, the modified protein is represented by an amino acid denoted herein as DM654.

In some examples, the modified protein comprises deletion of amino acids E50, F52 and R54 and amino acid substitutions E2N, E23A, Y65R, L70I, E59T and S76T as compared to MNEI (SEQ ID NO:1). In some embodiments, the modified protein is represented by an amino acid denoted herein as DM651.

In some examples, the modified protein comprises deletion of amino acids E50, F52 and R54 and amino acid substitutions E2N, E23A, Y65R, L70I, E59V and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, E59V and S76I as compared to MNEI (SEQ ID NO:1). In some embodiments, the modified protein is represented by an amino acid denoted herein as DM655.

In some examples, the modified protein comprises deletion of amino acids E50, F52 and R54 and amino acid substitutions E2N, E23A, Y65R, L70I, E59V and S76V as compared to MNEI (SEQ ID NO:1). In some embodiments, the modified protein is represented by an amino acid denoted herein as DM652.

In some examples, the modified protein comprises deletion of amino acids E50, F52 and R54 and amino acid substitutions E2N, E23A, Y65R, L70I, E59V and S76T as compared to MNEI (SEQ ID NO:1). In some embodiments, the modified protein is represented by an amino acid denoted herein as DM605.

In some examples, the modified protein comprises deletion of amino acids E50, F52 and R54 and amino acid substitutions E2N, E23A, Y65R, L70L, E59I and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, E59I and S76I as compared to MNEI (SEQ ID NO:1). In some embodiments, the modified protein is represented by an amino acid denoted herein as DM656.

In some examples, the modified protein comprises deletion of amino acids E50, F52 and R54 and amino acid substitutions E2N, E23A, Y65R, L70I, E59I and S76V as compared to MNEI (SEQ ID NO:1). In some embodiments, the modified protein is represented by an amino acid denoted herein as DM653.

In some examples, the modified protein comprises deletion of amino acids E50, F52 and R54 and amino acid substitutions E2N, E23A, Y65R, L70I, E59I and S76T as compared to MNEI (SEQ ID NO:1). In some embodiments, the modified protein is represented by an amino acid denoted herein as DM650.

In some examples, the modified protein comprises deletion of amino acids E50, F52 and R54 and amino acid substitutions E2N, E23A, Y65R, L70I, E59Y and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, E59Y and S76V as compared to MNEI (SEQ ID NO:1). In some embodiments, the modified protein is represented by an amino acid denoted herein as DM662.

In some examples, the modified protein comprises deletion of amino acids E50, F52 and R54 and amino acid substitutions E2N, E23A, Y65R, L70I, E59F and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, E59F and S76M as compared to MNEI (SEQ ID NO:1). In some embodiments, the modified protein is represented by an amino acid denoted herein as DM660.

In some examples, the modified protein comprises deletion of amino acids E50, F52 and R54 and amino acid substitutions E2N, E23A, Y65R, L70I, E59W and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, E59W and S76Y as compared to MNEI (SEQ ID NO:1). In some embodiments, the modified protein is represented by an amino acid denoted herein as DM661.

In some examples, the modified protein comprises deletion of amino acids E50, F52 and R54 and amino acid substitutions E2N, E23A, Y65R, L70I, E59R and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, E59R and S76T as compared to MNEI (SEQ ID NO:1). In some embodiments, the modified protein is represented by an amino acid denoted herein as DM604.

In some examples, the modified protein comprises deletion of amino acids E50, F52 and R54 and amino acid substitutions E2N, E23A, Y65R, L70I, D68 and S76 as compared to MNEI (SEQ ID NO:1).

In some examples, the modified protein comprises deletion of amino acids E50, F52 and R54 and amino acid substitutions E2N, E23A, Y65R, L70I, D68N and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, D68N and S76W as compared to MNEI (SEQ ID NO:1). In some embodiments, the modified protein is represented by an amino acid denoted herein as DM236.

In some examples, the modified protein comprises deletion of amino acids E50, F52 and R54 and amino acid substitutions E2N, E23A, Y65R, L70I, D68N and S76F as compared to MNEI (SEQ ID NO:1). In some embodiments, the modified protein is represented by an amino acid denoted herein as DM230.

In some examples, the modified protein comprises deletion of amino acids E50, F52 and R54 and amino acid substitutions E2N, E23A, Y65R, L70I, D68N and S76Y as compared to MNEI (SEQ ID NO:1). In some embodiments, the modified protein is represented by an amino acid denoted herein as DM224.

In some examples, the modified protein comprises deletion of amino acids E50, F52 and R54 and amino acid substitutions E2N, E23A, Y65R, L70I, D68T and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, D68T and S76Y as compared to MNEI (SEQ ID NO:1). In some embodiments, the modified protein is represented by an amino acid denoted herein as DM649.

In some examples, the modified protein comprises deletion of amino acids E50, F52 and R54 and amino acid substitutions E2N, E23A, Y65R, L70I, A73 and S76 as compared to MNEI (SEQ ID NO:1).

In some examples, the modified protein comprises deletion of amino acids E50, F52 and R54 and amino acid substitutions E2N, E23A, Y65R, L70I, A73V and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, A73V and S76F as compared to MNEI (SEQ ID NO:1). In some embodiments, the modified protein is represented by an amino acid denoted herein as DM248.

In some examples, the modified protein comprises deletion of amino acids E50, F52 and R54 and amino acid substitutions E2N, E23A, Y65R, L70I, A73V and S76Y as compared to MNEI (SEQ ID NO:1). In some embodiments, the modified protein is represented by an amino acid denoted herein as DM204.

In some examples, the modified protein comprises deletion of amino acids E50, F52 and R54 and amino acid substitutions E2N, E23A, Y65R, L70I, A73F and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70, I75 and S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70, I75V and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70, I75V and S76Y as compared to MNEI (SEQ ID NO:1). In some embodiments, the modified protein is represented by an amino acid denoted herein as DM600.

In some examples, the modified protein comprises deletion of amino acids E50, F52 and R54 and amino acid substitutions E2N, E23A, Y65R, L70, I75L and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, E77 and S76 as compared to MNEI (SEQ ID NO:1).

In some examples, the modified protein comprises deletion of amino acids E50, F52 and R54 and amino acid substitutions E2N, E23A, Y65R, L70I, E77V and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, E77V and S76Y as compared to MNEI (SEQ ID NO:1). In some embodiments, the modified protein is represented by an amino acid denoted herein as DM594.

In some examples, the modified protein comprises deletion of amino acids E50, F52 and R54 and amino acid substitutions E2N, E23A, Y65R, L70I and amino acid substitution in R84 and S76 as compared to MNEI (SEQ ID NO:1).

In some examples, the modified protein comprises deletion of amino acids E50, F52 and R54 and amino acid substitutions E2N, E23A, Y65R, L70I, R84L and an amino acid substitution in S76 being one or more of S76Y, S76F, S76T, S76W, S76R, S76V, S76I, S76H or S76A as compared to MNEI (SEQ ID NO:1).

In some examples, the modified protein comprises deletion of amino acids E50, F52 and R54 and amino acid substitutions E2N, E23A, Y65R, L70I, R84L and S76Y as compared to MNEI (SEQ ID NO:1). In some embodiments, the modified protein is represented by an amino acid denoted herein as DM90.

In some examples, the modified protein comprises deletion of amino acids E50, F52 and R54 and amino acid substitutions E2N, E23A, Y65R, L70I and amino acid substitution in A19, Q28 and S76 as compared to MNEI (SEQ ID NO:1).

In some examples, the modified protein comprises deletion of amino acids E50, F52 and R54 and amino acid substitutions E2N, E23A, Y65R, L70I, A19V, Q28K and S76Y as compared to MNEI (SEQ ID NO:1). In some embodiments, the modified protein is represented by an amino acid denoted herein as DM610.

In some examples, the modified protein comprises deletion of amino acids E50, F52 and R54 and amino acid substitutions E2N, E23A, Y65R, L70I, A19V, Q28R and S76Y as compared to MNEI (SEQ ID NO:1). In some embodiments, the modified protein is represented by an amino acid denoted herein as DM621.

In some examples, the modified protein comprises deletion of amino acids E50, F52 and R54 and amino acid substitutions E2N, E23A, Y65R, L70I and amino acid substitution in A19, T33 and S76 as compared to MNEI (SEQ ID NO:1).

In some examples, the modified protein comprises deletion of amino acids E50, F52 and R54 and amino acid substitutions E2N, E23A, Y65R, L70I, A19V, T33R and S76Y as compared to MNEI (SEQ ID NO:1). In some embodiments, the modified protein is represented by an amino acid denoted herein as DM617.

In some examples, the modified protein comprises deletion of amino acids E50, F52 and R54 and amino acid substitutions E2N, E23A, Y65R, L70I and amino acid substitution in A19, N35 and S76 as compared to MNEI (SEQ ID NO:1).

In some examples, the modified protein comprises deletion of amino acids E50, F52 and R54 and amino acid substitutions E2N, E23A, Y65R, L70L, A19V, N35T and S76Y as compared to MNEI (SEQ ID NO:1). In some embodiments, the modified protein is represented by an amino acid denoted herein as DM625.

In some examples, the modified protein comprises deletion of amino acids E50, F52 and R54 and amino acid substitutions E2N, E23A, Y65R, L70I and amino acid substitution in A19, R84 and S76 as compared to MNEI (SEQ ID NO:1).

In some examples, the modified protein comprises deletion of amino acids E50, F52 and R54 and amino acid substitutions E2N, E23A, Y65R, L70I, A19V, R84L and S76Y as compared to MNEI (SEQ ID NO:1). In some embodiments, the modified protein is represented by an amino acid denoted herein as DM626.

In some examples, the modified protein comprises deletion of amino acids E50, F52 and R54 and amino acid substitutions E2N, E23A, Y65R, L70I and amino acid substitution in V20, Q28 and S76 as compared to MNEI (SEQ ID NO:1).

In some examples, the modified protein comprises deletion of amino acids E50, F52 and R54 and amino acid substitutions E2N, E23A, Y65R, L70I, V20I, Q28R and S76F as compared to MNEI (SEQ ID NO:1). In some embodiments, the modified protein is represented by an amino acid denoted herein as DM681.

In some examples, the modified protein comprises deletion of amino acids E50, F52 and R54 and amino acid substitutions E2N, E23A, Y65R, L70I, V20I, Q28R and S76Y as compared to MNEI (SEQ ID NO:1). In some embodiments, the modified protein is represented by an amino acid denoted herein as DM620.

In some examples, the modified protein comprises deletion of amino acids E50, F52 and R54 and amino acid substitutions E2N, E23A, Y65R, L70I, V20I, Q28K and S76Y as compared to MNEI (SEQ ID NO:1). In some embodiments, the modified protein is represented by an amino acid denoted herein as DM613.

In some examples, the modified protein comprises deletion of amino acids E50, F52 and R54 and amino acid substitutions E2N, E23A, Y65R, L70I and amino acid substitution in V20, R31 and S76 as compared to MNEI (SEQ ID NO:1).

In some examples, the modified protein comprises deletion of amino acids E50, F52 and R54 and amino acid substitutions E2N, E23A, Y65R, L70I, V20I, R31T and S76Y as compared to MNEI (SEQ ID NO:1). In some embodiments, the modified protein is represented by an amino acid denoted herein as DM633.

In some examples, the modified protein comprises deletion of amino acids E50, F52 and R54 and amino acid substitutions E2N, E23A, Y65R, L70I and amino acid substitution in V20, T33 and S76 as compared to MNEI (SEQ ID NO:1).

In some examples, the modified protein comprises deletion of amino acids E50, F52 and R54 and amino acid substitutions E2N, E23A, Y65R, L70I, V20I, T33R and S76Y as compared to MNEI (SEQ ID NO:1). In some embodiments, the modified protein is represented by an amino acid denoted herein as DM616.

In some examples, the modified protein comprises deletion of amino acids E50, F52 and R54 and amino acid substitutions E2N, E23A, Y65R, L70I and amino acid substitution in V20, N35 and S76 as compared to MNEI (SEQ ID NO:1).

In some examples, the modified protein comprises deletion of amino acids E50, F52 and R54 and amino acid substitutions E2N, E23A, Y65R, L70I, V20I, N35T and S76Y as compared to MNEI (SEQ ID NO:1). In some embodiments, the modified protein is represented by an amino acid denoted herein as DM634.

In some examples, the modified protein comprises deletion of amino acids E50, F52 and R54 and amino acid substitutions E2N, E23A, Y65R, L70I and amino acid substitution in V20, D68 and S76 as compared to MNEI (SEQ ID NO:1).

In some examples, the modified protein comprises deletion of amino acids E50, F52 and R54 and amino acid substitutions E2N, E23A, Y65R, L70I, V20I, D68N and S76Y as compared to MNEI (SEQ ID NO:1). In some embodiments, the modified protein is represented by an amino acid denoted herein as DM611.

In some examples, the modified protein comprises deletion of amino acids E50, F52 and R54 and amino acid substitutions E2N, E23A, Y65R, L70I, V20, R84 and S76 as compared to MNEI (SEQ ID NO:1).

In some examples, the modified protein comprises deletion of amino acids E50, F52 and R54 and amino acid substitutions E2N, E23A, Y65R, L70I, V20I, R84L and S76Y as compared to MNEI (SEQ ID NO:1). In some embodiments, the modified protein is represented by an amino acid denoted herein as DM635.

In some examples, the modified protein comprises deletion of amino acids E50, F52 and R54 and amino acid substitutions E2N, E23A, Y65R, L70I and amino acid substitution in K25, Q28 and S76 as compared to MNEI (SEQ ID NO:1).

In some examples, the modified protein comprises deletion of amino acids E50, F52 and R54 and amino acid substitutions E2N, E23A, Y65R, L70, K25R, Q28K and S76Y as compared to MNEI (SEQ ID NO:1). In some embodiments, the modified protein is represented by an amino acid denoted herein as DM166.

In some examples, the modified protein comprises deletion of amino acids E50, F52 and R54 and amino acid substitutions E2N, E23A, Y65R, L70, K25R, Q28K and S76F as compared to MNEI (SEQ ID NO:1). In some embodiments, the modified protein is represented by an amino acid denoted herein as DM168.

In some examples, the modified protein comprises deletion of amino acids E50, F52 and R54 and amino acid substitutions E2N, E23A, Y65R, L70I, K25R, Q28R and S76Y as compared to MNEI (SEQ ID NO:1). In some embodiments, the modified protein is represented by an amino acid denoted herein as DM165.

In some examples, the modified protein comprises deletion of amino acids E50, F52 and R54 and amino acid substitutions E2N, E23A, Y65R, L70, K25R, Q28R and S76F as compared to MNEI (SEQ ID NO:1). In some embodiments, the modified protein is represented by an amino acid denoted herein as DM167.

In some examples, the modified protein comprises deletion of amino acids E50, F52 and R54 and amino acid substitutions E2N, E23A, Y65R, L70I and amino acid substitution in K25, I26, Q28 and S76 as compared to MNEI (SEQ ID NO:1). In some examples, the modified protein comprises deletion of amino acids E50, F52 and R54 and amino acid substitutions E2N, E23A, Y65R, L70I, K25R, I26T, Q28K and S76Y as compared to MNEI (SEQ ID NO:1). In some embodiments, the modified protein is represented by an amino acid denoted herein as DM288.

In some examples, the modified protein comprises deletion of amino acids E50, F52 and R54 and amino acid substitutions E2N, E23A, Y65R, L70I and amino acid substitution in K25, T33 and S76 as compared to MNEI (SEQ ID NO:1). In some examples, the modified protein comprises deletion of amino acids E50, F52 and R54 and amino acid substitutions E2N, E23A, Y65R, L70I, K25R, T33R and S76Y as compared to MNEI (SEQ ID NO:1). In some embodiments, the modified protein is represented by an amino acid denoted herein as DM618.

In some examples, the modified protein comprises deletion of amino acids E50, F52 and R54 and amino acid substitutions E2N, E23A, Y65R, L70I and amino acid substitution in K25, C41 and S76 as compared to MNEI (SEQ ID NO:1). In some examples, the modified protein comprises deletion of amino acids E50, F52 and R54 and amino acid substitutions E2N, E23A, Y65R, L70I, K25R, C41T and S76Y as compared to MNEI (SEQ ID NO:1). In some embodiments, the modified protein is represented by an amino acid denoted herein as DM481.

In some examples, the modified protein comprises deletion of amino acids E50, F52 and R54 and amino acid substitutions E2N, E23A, Y65R, L70I and amino acid substitution in K25, D68 and S76 as compared to MNEI (SEQ ID NO:1). In some examples, the modified protein comprises deletion of amino acids E50, F52 and R54 and amino acid substitutions E2N, E23A, Y65R, L70I, K25R, D68N and S76Y as compared to MNEI (SEQ ID NO:1). In some embodiments, the modified protein is represented by an amino acid denoted herein as DM479.

In some examples, the modified protein comprises deletion of amino acids E50, F52 and R54 and amino acid substitutions E2N, E23A, Y65R, L70I and amino acid substitution in I26, Q28, and S76 as compared to MNEI (SEQ ID NO:1).

In some examples, the modified protein comprises deletion of amino acids E50, F52 and R54 and amino acid substitutions E2N, E23A, Y65R, L70I, I26W, Q28K and S76Y as compared to MNEI (SEQ ID NO:1). In some embodiments, the modified protein is represented by an amino acid denoted herein as DM128.

In some examples, the modified protein comprises deletion of amino acids E50, F52 and R54 and amino acid substitutions E2N, E23A, Y65R, L70I, I26W, Q28E and S76Y as compared to MNEI (SEQ ID NO:1). In some embodiments, the modified protein is represented by an amino acid denoted herein as DM127.

In some examples, the modified protein comprises deletion of amino acids E50, F52 and R54 and amino acid substitutions E2N, E23A, Y65R, L70I, I26V, Q28K and S76Y as compared to MNEI (SEQ ID NO:1). In some embodiments, the modified protein is represented by an amino acid denoted herein as DM455.

In some examples, the modified protein comprises deletion of amino acids E50, F52 and R54 and amino acid substitutions E2N, E23A, Y65R, L70I, I26T, Q28K and S76W as compared to MNEI (SEQ ID NO:1). In some embodiments, the modified protein is represented by an amino acid denoted herein as DM164.

In some examples, the modified protein comprises deletion of amino acids E50, F52 and R54 and amino acid substitutions E2N, E23A, Y65R, L70I, I26T, Q28R and S76Y as compared to MNEI (SEQ ID NO:1). In some embodiments, the modified protein is represented by an amino acid denoted herein as DM526.

In some examples, the modified protein comprises deletion of amino acids E50, F52 and R54 and amino acid substitutions E2N, E23A, Y65R, L70I, I26T, Q28K and S76F as compared to MNEI (SEQ ID NO:1). In some embodiments, the modified protein is represented by an amino acid denoted herein as DM163.

In some examples, the modified protein comprises deletion of amino acids E50, F52 and R54 and amino acid substitutions E2N, E23A, Y65R, L70I, I26T, Q28K and S76Y as compared to MNEI (SEQ ID NO:1). In some embodiments, the modified protein is represented by an amino acid denoted herein as DM158.

In some examples, the modified protein comprises deletion of amino acids E50, F52 and R54 and amino acid substitutions E2N, E23A, Y65R, L70I, I26T, Q28S and S76Y as compared to MNEI (SEQ ID NO:1). In some embodiments, the modified protein is represented by an amino acid denoted herein as DM456.

In some examples, the modified protein comprises deletion of amino acids E50, F52 and R54 and amino acid substitutions E2N, E23A, Y65R, L70I and amino acid substitution in I26, Q28, C41 and S76 as compared to MNEI (SEQ ID NO:1).

In some examples, the modified protein comprises deletion of amino acids E50, F52 and R54 and amino acid substitutions E2N, E23A, Y65R, L70I, I26T, Q28K, C41T and S76Y as compared to MNEI (SEQ ID NO:1). In some embodiments, the modified protein is represented by an amino acid denoted herein as DM483.

In some examples, the modified protein comprises deletion of amino acids E50, F52 and R54 and amino acid substitutions E2N, E23A, Y65R, L70I and amino acid substitution in I26, Q28, D68 and S76 as compared to MNEI (SEQ ID NO:1).

In some examples, the modified protein comprises deletion of amino acids E50, F52 and R54 and amino acid substitutions E2N, E23A, Y65R, L70I, I26T, Q28K, D68N and S76Y as compared to MNEI (SEQ ID NO:1). In some embodiments, the modified protein is represented by an amino acid denoted herein as DM484.

In some examples, the modified protein comprises deletion of amino acids E50, F52 and R54 and amino acid substitutions E2N, E23A, Y65R, L70I and amino acid substitution in Q28, R31 and S76 as compared to MNEI (SEQ ID NO:1).

In some examples, the modified protein comprises deletion of amino acids E50, F52 and R54 and amino acid substitutions E2N, E23A, Y65R, L70I, Q28R, R31T and S76Y as compared to MNEI (SEQ ID NO:1). In some embodiments, the modified protein is represented by an amino acid denoted herein as DM171.

In some examples, the modified protein comprises deletion of amino acids E50, F52 and R54 and amino acid substitutions E2N, E23A, Y65R, L70I, Q28K, R31T and S76Y as compared to MNEI (SEQ ID NO:1). In some embodiments, the modified protein is represented by an amino acid denoted herein as DM630.

In some examples, the modified protein comprises deletion of amino acids E50, F52 and R54 and amino acid substitutions E2N, E23A, Y65R, L70I and amino acid substitution in Q28, T33 and S76 as compared to MNEI (SEQ ID NO:1).

In some examples, the modified protein comprises deletion of amino acids E50, F52 and R54 and amino acid substitutions E2N, E23A, Y65R, L70I, Q28K, T33R and S76Y as compared to MNEI (SEQ ID NO:1). In some embodiments, the modified protein is represented by an amino acid denoted herein as DM619.

In some examples, the modified protein comprises deletion of amino acids E50, F52 and R54 and amino acid substitutions E2N, E23A, Y65R, L70I, Q28R, T33R and S76Y as compared to MNEI (SEQ ID NO:1). In some embodiments, the modified protein is represented by an amino acid denoted herein as DM622.

In some examples, the modified protein comprises deletion of amino acids E50, F52 and R54 and amino acid substitutions E2N, E23A, Y65R, L70I and amino acid substitution in Q28, N35 and S76 as compared to MNEI (SEQ ID NO:1).

In some examples, the modified protein comprises deletion of amino acids E50, F52 and R54 and amino acid substitutions E2N, E23A, Y65R, L70I, Q28K, N35T and S76Y as compared to MNEI (SEQ ID NO:1). In some embodiments, the modified protein is represented by an amino acid denoted herein as DM631.

In some examples, the modified protein comprises deletion of amino acids E50, F52 and R54 and amino acid substitutions E2N, E23A, Y65R, L70I, Q28R, N35T and S76Y as compared to MNEI (SEQ ID NO:1). In some embodiments, the modified protein is represented by an amino acid denoted herein as DM640.

In some examples, the modified protein comprises deletion of amino acids E50, F52 and R54 and amino acid substitutions E2N, E23A, Y65R, L70I and amino acid substitution in Q28, C41 and S76 as compared to MNEI (SEQ ID NO:1).

In some examples, the modified protein comprises deletion of amino acids E50, F52 and R54 and amino acid substitutions E2N, E23A, Y65R, L70I, Q28K, C41A and S76W as compared to MNEI (SEQ ID NO:1). In some embodiments, the modified protein is represented by an amino acid denoted herein as DM682.

In some examples, the modified protein comprises deletion of amino acids E50, F52 and R54 and amino acid substitutions E2N, E23A, Y65R, L70I, Q28K, C41A and S76F as compared to MNEI (SEQ ID NO:1). In some embodiments, the modified protein is represented by an amino acid denoted herein as DM683.

In some examples, the modified protein comprises deletion of amino acids E50, F52 and R54 and amino acid substitutions E2N, E23A, Y65R, L70I, Q28K, C41S and S76Y as compared to MNEI (SEQ ID NO:1). In some embodiments, the modified protein is represented by an amino acid denoted herein as DM534.

In some examples, the modified protein comprises deletion of amino acids E50, F52 and R54 and amino acid substitutions E2N, E23A, Y65R, L70I, Q28R, C41A and S76F as compared to MNEI (SEQ ID NO:1). In some embodiments, the modified protein is represented by an amino acid denoted herein as DM685.

In some examples, the modified protein comprises deletion of amino acids E50, F52 and R54 and amino acid substitutions E2N, E23A, Y65R, L70I, Q28R, C41A and S76Y as compared to MNEI (SEQ ID NO:1). In some embodiments, the modified protein is represented by an amino acid denoted herein as DM532.

In some examples, the modified protein comprises deletion of amino acids E50, F52 and R54 and amino acid substitutions E2N, E23A, Y65R, L70L, Q28R, C41T and S76Y as compared to MNEI (SEQ ID NO:1). In some embodiments, the modified protein is represented by an amino acid denoted herein as DM528.

In some examples, the modified protein comprises deletion of amino acids E50, F52 and R54 and amino acid substitutions E2N, E23A, Y65R, L70I, Q28R, C41S and S76Y as compared to MNEI (SEQ ID NO:1). In some embodiments, the modified protein is represented by an amino acid denoted herein as DM530.

In some examples, the modified protein comprises deletion of amino acids E50, F52 and R54 and amino acid substitutions E2N, E23A, Y65R, L70I, Q28K, C41A and S76Y as compared to MNEI (SEQ ID NO:1). In some embodiments, the modified protein is represented by an amino acid denoted herein as DM536.

In some examples, the modified protein comprises deletion of amino acids E50, F52 and R54 and amino acid substitutions E2N, E23A, Y65R, L70I, Q28K, C41T and S76Y as compared to MNEI (SEQ ID NO:1). In some embodiments, the modified protein is represented by an amino acid denoted herein as DM478.

In some examples, the modified protein comprises deletion of amino acids E50, F52 and R54 and amino acid substitutions E2N, E23A, Y65R, L70I and amino acid substitution in Q28, D68 and S76 as compared to MNEI (SEQ ID NO:1).

In some examples, the modified protein comprises deletion of amino acids E50, F52 and R54 and amino acid substitutions E2N, E23A, Y65R, L70I, Q28K, D68T and S76Y as compared to MNEI (SEQ ID NO:1). In some embodiments, the modified protein is represented by an amino acid denoted herein as DM607.

In some examples, the modified protein comprises deletion of amino acids E50, F52 and R54 and amino acid substitutions E2N, E23A, Y65R, L70I, Q28K, D68N and S76Y as compared to MNEI (SEQ ID NO:1). In some embodiments, the modified protein is represented by an amino acid denoted herein as DM472.

In some examples, the modified protein comprises deletion of amino acids E50, F52 and R54 and amino acid substitutions E2N, E23A, Y65R, L70I, Q28R, D68T and S76Y as compared to MNEI (SEQ ID NO:1). In some embodiments, the modified protein is represented by an amino acid denoted herein as DM608.

In some examples, the modified protein comprises deletion of amino acids E50, F52 and R54 and amino acid substitutions E2N, E23A, Y65R, L70L, Q28R, D68N and S76Y as compared to MNEI (SEQ ID NO:1). In some embodiments, the modified protein is represented by an amino acid denoted herein as DM542.

In some examples, the modified protein comprises deletion of amino acids E50, F52 and R54 and amino acid substitutions E2N, E23A, Y65R, L70I and amino acid substitution in Q28, R84 and S76 as compared to MNEI (SEQ ID NO:1).

In some examples, the modified protein comprises deletion of amino acids E50, F52 and R54 and amino acid substitutions E2N, E23A, Y65R, L70I, Q28K, R84L and S76Y as compared to MNEI (SEQ ID NO:1). In some embodiments, the modified protein is represented by an amino acid denoted herein as DM632.

In some examples, the modified protein comprises deletion of amino acids E50, F52 and R54 and amino acid substitutions E2N, E23A, Y65R, L70I, Q28R, R84L and S76Y as compared to MNEI (SEQ ID NO:1). In some embodiments, the modified protein is represented by an amino acid denoted herein as DM641.

In some examples, the modified protein comprises deletion of amino acids E50, F52 and R54 and amino acid substitutions E2N, E23A, Y65R, L70I, and amino acid substitution in R31, T33 and S76 as compared to MNEI (SEQ ID NO:1).

In some examples, the modified protein comprises deletion of amino acids E50, F52 and R54 and amino acid substitutions E2N, E23A, Y65R, L70I, R31T, T33R and S76Y as compared to MNEI (SEQ ID NO:1). In some embodiments, the modified protein is represented by an amino acid denoted herein as DM636.

In some examples, the modified protein comprises deletion of amino acids E50, F52 and R54 and amino acid substitutions E2N, E23A, Y65R, L70I, and amino acid substitution in T33, N35 and S76 as compared to MNEI (SEQ ID NO:1).

In some examples, the modified protein comprises deletion of amino acids E50, F52 and R54 and amino acid substitutions E2N, E23A, Y65R, L70I, T33R, N35T and S76Y as compared to MNEI (SEQ ID NO:1). In some embodiments, the modified protein is represented by an amino acid denoted herein as DM637.

In some examples, the modified protein comprises deletion of amino acids E50, F52 and R54 and amino acid substitutions E2N, E23A, Y65R, L70I, and amino acid substitution in T33, D68 and S76 as compared to MNEI (SEQ ID NO:1).

In some examples, the modified protein comprises deletion of amino acids E50, F52 and R54 and amino acid substitutions E2N, E23A, Y65R, L70I, T33R, D68N and S76Y as compared to MNEI (SEQ ID NO:1). In some embodiments, the modified protein is represented by an amino acid denoted herein as DM614.

In some examples, the modified protein comprises deletion of amino acids E50, F52 and R54 and amino acid substitutions E2N, E23A, Y65R, L70I, and amino acid substitution in T33, R84 and S76 as compared to MNEI (SEQ ID NO:1).

In some examples, the modified protein comprises deletion of amino acids E50, F52 and R54 and amino acid substitutions E2N, E23A, Y65R, L70I, T33R, R84L and S76Y as compared to MNEI (SEQ ID NO:1). In some embodiments, the modified protein is represented by an amino acid denoted herein as DM638.

In some examples, the modified protein comprises deletion of amino acids E50, F52 and R54 and amino acid substitutions E2N, E23A, Y65R, L70I, and amino acid substitution in N35, D68 and S76 as compared to MNEI (SEQ ID NO:1).

In some examples, the modified protein comprises deletion of amino acids E50, F52 and R54 and amino acid substitutions E2N, E23A, Y65R, L70I, N35T, D68T and S76Y as compared to MNEI (SEQ ID NO:1). In some embodiments, the modified protein is represented by an amino acid denoted herein as DM643.

In some examples, the modified protein comprises deletion of amino acids E50, F52 and R54 and amino acid substitutions E2N, E23A, Y65R, L70I, N35T, D68N and S76Y as compared to MNEI (SEQ ID NO:1). In some embodiments, the modified protein is represented by an amino acid denoted herein as DM628.

In some examples, the modified protein comprises deletion of amino acids E50, F52 and R54 and amino acid substitutions E2N, E23A, Y65R, L70I, and amino acid substitution in E59, D74 and S76 as compared to MNEI (SEQ ID NO:1).

In some examples, the modified protein comprises deletion of amino acids E50, F52 and R54 and amino acid substitutions E2N, E23A, Y65R, L70I, E59V, D74V and S76V as compared to MNEI (SEQ ID NO:1). In some embodiments, the modified protein is represented by an amino acid denoted herein as DM602.

In some examples, the modified protein comprises deletion of amino acids E50, F52 and R54 and amino acid substitutions E2N, E23A, Y65R, L70I, and amino acid substitution in D68, R31 and S76 as compared to MNEI (SEQ ID NO:1).

In some examples, the modified protein comprises deletion of amino acids E50, F52 and R54 and amino acid substitutions E2N, E23A, Y65R, L70I, D68T, R31T and S76Y as compared to MNEI (SEQ ID NO:1). In some embodiments, the modified protein is represented by an amino acid denoted herein as DM642.

In some examples, the modified protein comprises deletion of amino acids E50, F52 and R54 and amino acid substitutions E2N, E23A, Y65R, L70I, and amino acid substitution in D68, R31 and S76 as compared to MNEI (SEQ ID NO:1).

In some examples, the modified protein comprises deletion of amino acids E50, F52 and R54 and amino acid substitutions E2N, E23A, Y65R, L70I, D68N, R31T and S76Y as compared to MNEI (SEQ ID NO:1). In some embodiments, the modified protein is represented by an amino acid denoted herein as DM627.

In some examples, the modified protein comprises deletion of amino acids E50, F52 and R54 and amino acid substitutions E2N, E23A, Y65R, L70I, and amino acid substitution in D68, R84 and S76 as compared to MNEI (SEQ ID NO:1).

In some examples, the modified protein comprises deletion of amino acids E50, F52 and R54 and amino acid substitutions E2N, E23A, Y65R, L70I, D68N, R84L and S76F as compared to MNEI (SEQ ID NO:1). In some embodiments, the modified protein is represented by an amino acid denoted herein as DM242.

In some examples, the modified protein comprises deletion of amino acids E50, F52 and R54 and amino acid substitutions E2N, E23A, Y65R, L70I, D68N, R84L and S76Y as compared to MNEI (SEQ ID NO:1). In some embodiments, the modified protein is represented by an amino acid denoted herein as DM240.

In some examples, the modified protein comprises deletion of amino acids E50, F52 and R54 and amino acid substitutions E2N, E23A, Y65R, L70I, D68T, R84L and S76Y as compared to MNEI (SEQ ID NO:1). In some embodiments, the modified protein is represented by an amino acid denoted herein as DM644.

In some examples, the modified protein comprises deletion of amino acids E50, F52 and R54 and amino acid substitutions E2N, E23A, Y65R, L70I, and amino acid substitution in 175, E77 and S76 as compared to MNEI (SEQ ID NO:1).

In some examples, the modified protein comprises deletion of amino acids E50, F52 and R54 and amino acid substitutions E2N, E23A, Y65R, L70, I75V, E77V and S76Y as compared to MNEI (SEQ ID NO:1). In some embodiments, the modified protein is represented by an amino acid denoted herein as DM595.

In some examples, the modified protein is one or more of DM89, DM114 (Tm=101.5° C.), DM137 (Tm=97° C.), or any combination thereof.

In some examples, the modified protein is one or more of DM456 (Tm>104° C.), DM517 (Tm=100° C.), DM100 (Tm=100° C.), DM165 (Tm=99° C.), DM361 (Tm=97° C.), DM224 (Tm=95° C.) DM346 (Tm=97° C.), DM101 (Tm=96° C.), DM206 (Tm=96° C.), DM209 (Tm=96° C.), DM202 (Tm=96° C.), DM479 (Tm=97° C.) or any combinations thereof. As described herein, the Tm can be measured by any method known in the art, for example, using DSF as described in the examples below.

As noted herein and shown in the examples, below, the predicted Tm values highly correlated with the experimental measured Tm value. In some examples, the modified protein is one or more of DM635 (predicated Tm 105.7° C.), DM644 (predicated Tm 105.43° C.), DM242 (predicated Tm 105.06° C.), DM632 (predicted Tm 104° C.), DM90 (predicted Tm 104° C.), DM240 (predicted Tm 104° C.), DM641 (predicted Tm 103.8° C.), DM162 (predicted Tm 102° C.), DM630 (predicted Tm 101.9° C.), DM657 (predicted Tm 101.8° C.), DM655 (predicted Tm 101.8° C.), DM642 (predicted Tm 101.7° C.), DM633 (predicted Tm101.6° C.), DM595 (predicted Tm 101.5° C.), DM656 (predicted Tm 101.3° C.), DM638 (predicted Tm 101.2° C.), DM335 (predicted Tm 101.1° C.), DM286 (predicted Tm 101.1° C.).

Interestingly and as shown in the examples below, the substitutions were shown to be synergistic substitutions. As used herein the term synergistic substitutions refers to simultaneous modification of multiple amino acid within a protein sequence that collectively enhance or modify its function. In other words, the combined effect of these substitutions is greater than the sum of their individual effects.

In some examples, the modified protein is one or more of DM479, DM472, DM346, DM165, DM361, DM456 or any combinations thereof.

In some examples, the modified protein is one or more of DM240, DM641, DM633, DM627, DM171, DM480, DM362, DM236, DM396, DM479, DM167, DM165, DM397, DM679, DM230, DM681, DM361, DM224, DM611, DM620, DM473, DM517, DM472, DM685, DM608, DM628, DM521, DM542, DM477, DM640, DM532, DM528, DM621, DM530, DM360, DM73, DM614, DM526, DM622, DM94, DM486, DM484, DM457, DM209, DM540, DM333, DM511, DM539, DM524, DM148 or any combinations thereof.

In some examples, the modified protein is one or more of DM202, DM207, DM289, DM210, DM89, DM287, DM224, DM346, DM209, DM203, DM274, DM273, DM222, DM206, DM160, DM292, DM253, DM241, DM204, DM128, DM158, DM250, DM240, DM247, DM127, DM178, DM174, DM248, DM254, DM208, DM179, DM242 or any combinations thereof.

Table 1 shows proteins related to the present disclosure including the modified proteins encompassed by the present disclosure and their corresponding SEQ ID NO:

TABLE 1
Sequences of the modified proteins and MNEI

| DM# | SEQ ID NO: | Sequence |
|---|---|---|
| MNEI | SEQ ID NO: 1 | GEWEIIDIGPFTQNLGKFAVDEENKIGQYGRLTFNKVIRPCMKKTIYENEGFREIKGYEYQLY |
| | | VYASDKLFRADISEDYKTRGRKLLRFNGPVPPP |
| DM129 | SEQ ID NO: 2 | GEWEIIDIGPFTQNLGKFAVDEENKIGQYGRLTFNKVIRPCMKKTIYENEGFREIKGYEYQLY |
| | | VYASDKLFRADIYEDYKTRGRKLLRFNGPVPPP |
| DM147 | SEQ ID NO: 3 | GEWEIIDIGPFTQNLGKFAVDEENKIGQYGRLTFNKVIRPCMKKTIYENEGFREIKGYEYQLY |
| | | VYASDKLFRADIFEDYKTRGRKLLRFNGPVPPP |
| DM149 | SEQ ID NO: 4 | GNWEIIDIGPFTQNLGKFAVDEANKIGQYGRLTFNKVIRPCMKKTIYENEGFREIKGYEYQLY |
| | | VRASDKIFRADIYEDYKTRGRKLLRFNGPVPPP |
| DM89 | SEQ ID NO: 5 | GNWEIIDIGPFTQNLGKFAVDEANKIGQYGRLTFNKVIRPCMKKTIYENGEIKGYEYQLYVRA |
| | | SDKIFRADIYEDYKTRGRKLLRFNGPVPPP |
| DM114 | SEQ ID NO: 6 | GNWEIIDIGPFTQNLGKFAVDEANKIGQYGRLTFNKVIRPCMKKTIYENGEIKGYEYQLYVRA |
| | | SDKIFRADIFEDYKTRGRKLLRFNGPVPPP |
| DM137 | SEQ ID NO: 7 | GNWEIIDIGPFTQNLGKFAVDEANKIGQYGRLTFNKVIRPCMKKTIYENGEIKGYEYQLYVRA |
| | | SDKIFRADIWEDYKTRGRKLLRFNGPVPPP |
| DM90 | SEQ ID NO: 8 | GNWEIIDIGPFTQNLGKFAVDEANKIGQYGRLTFNKVIRPCMKKTIYENGEIKGYEYQLYVRA |
| | | SDKIFRADIYEDYKTRGLKLLRFNGPVPPP |
| DM100 | SEQ ID NO: 9 | GNWEIIDIGPFTQNLGKFAVDEANKTGQYGRLTFNKVIRPCMKKTIYENGEIKGYEYQLYVR |
| | | ASDKIFRADIYEDYKTRGRKLLRFNGPVPPP |
| DM101 | SEQ ID NO: 10 | GNWEIIDIGPFTQNLGKFAVDEANRIGQYGRLTFNKVIRPCMKKTIYENGEIKGYEYQLYVRA |
| | | SDKIFRADIYEDYKTRGRKLLRFNGPVPPP |
| DM121 | SEQ ID NO: 11 | GNWEIIDIGPFTQNLGKFAVDEENKIGQYGRLTFNKVIRPCMKKTIYENGEIKGYEYQLYVRA |
| | | SDKIFRADIYEDYKTRGRKLLRFNGPVPPP |
| DM122 | SEQ ID NO: 12 | GEWEIIDIGPFTQNLGKFAVDEANKIGQYGRLTFNKVIRPCMKKTIYENGEIKGYEYQLYVRA |
| | | SDKIFRADIYEDYKTRGRKLLRFNGPVPPP |
| DM123 | SEQ ID NO: 13 | GNWEIIDIGPFTQNLGKFAVDEANKIGQYGRLTFNKVIRPCMKKTIYENGEIKGYEYQLYVYA |
| | | SDKIFRADIYEDYKTRGRKLLRFNGPVPPP |
| DM124 | SEQ ID NO: 14 | GNWEIIDIGPFTQNLGKFAVDEANKIGQYGRLTFNKVIRPCMKKTIYENGEIKGYEYQLYVRA |
| | | SDKLFRADIYEDYKTRGRKLLRFNGPVPPP |
| DM125 | SEQ ID NO: 15 | GEWEIIDIGPFTQNLGKFAVDEENKIGQYGRLTFNKVIRPCMKKTIYENGEIKGYEYQLYVYA |
| | | SDKIFRADIYEDYKTRGRKLLRFNGPVPPP |
| DM148 | SEQ ID NO: 16 | GEWEIIDIGPFTQNLGKFAVDEENKIGQYGRLTFNKVIRPCMKKTIYENGEIKGYEYQLYVYA |
| | | SDKLFRADIYEDYKTRGRKLLRFNGPVPPP |
| DM126 | SEQ ID NO: 17 | GEWEIIDIGPFTQNLGKFAVDEANKIGQYGRLTFNKVIRPAMKKTIYENGEIKGYEYQLYVRA |
| | | SDKLFRADIYEDYKTRGRKLLRFNGPVPPP |
| DM127 | SEQ ID NO: 18 | GNWEIIDIGPFTQNLGKFAVDEANKWGEYGRLTFNKVIRPCMKKTIYENGEIKGYEYQLYVR |
| | | ASDKIFRADIYEDYKTRGRKLLRFNGPVPPP |
| DM128 | SEQ ID NO: 19 | GNWEIIDIGPFTQNLGKFAVDEANKWGKYGRLTFNKVIRPCMKKTIYENGEIKGYEYQLYVR |
| | | ASDKIFRADIYEDYKTRGRKLLRFNGPVPPP |
| DM164 | SEQ ID NO: 20 | GNWEIIDIGPFTQNLGKFAVDEANKTGKYGRLTFNKVIRPCMKKTIYENGEIKGYEYQLYVR |
| | | ASDKIFRADIWEDYKTRGRKLLRFNGPVPPP |
| DM160 | SEQ ID NO: 21 | GNWEIIDIGPFTQNLGKFAVDEANRIGQYGRLTFNKVIRPCMKKTIYENGEIKGYEYQLYVRA |
| | | SDKIFRADIFEDYKTRGRKLLRFNGPVPPP |
| DM162 | SEQ ID NO: 22 | GNWEIIDIGPFTQNLGKFAVDEANRIGQYGRLTFNKVIRPCMKKTIYENGEIKGYEYQLYVRA |
| | | SDKIFRADIWEDYKTRGRKLLRFNGPVPPP |
| DM159 | SEQ ID NO: 23 | GNWEIIDIGPFTQNLGKFAVDEANKTGQYGRLTFNKVIRPCMKKTIYENGEIKGYEYQLYVR |
| | | ASDKIFRADIFEDYKTRGRKLLRFNGPVPPP |
| DM163 | SEQ ID NO: 24 | GNWEIIDIGPFTQNLGKFAVDEANKTGKYGRLTFNKVIRPCMKKTIYENGEIKGYEYQLYVR |
| | | ASDKIFRADIFEDYKTRGRKLLRFNGPVPPP |
| DM161 | SEQ ID NO: 25 | GNWEIIDIGPFTQNLGKFAVDEANKTGQYGRLTFNKVIRPCMKKTIYENGEIKGYEYQLYVR |
| | | ASDKIFRADIWEDYKTRGRKLLRFNGPVPPP |
| DM227 | SEQ ID NO: 26 | GEWEIIDIGPFTQNLGKFAVDEENKIGQYGRLTFNKVIRPCMKKTIYENEGFREIKGYEYQLY |
| | | VYASNKLFRADIYEDYKTRGRKLLRFNGPVPPP |
| DM250 | SEQ ID NO: 27 | GNWEIIDIGPFTQNLGKFAIDEANKIGQYGRLTFNKVIRPCMKKTIYENGEIKGYEYQLYVRA |
| | | SDKIFRADIFEDYKTRGRKLLRFNGPVPPP |
| DM627 | SEQ ID NO: 28 | GNWEIIDIGPFTQNLGKFAVDEANKIGQYGTLTFNKVIRPCMKKTIYENGEIKGYEYQLYVRA |
| | | SNKIFRADIYEDYKTRGRKLLRFNGPVPPP |
| DM187 | SEQ ID NO: 29 | GEWEIIDIGPFTQNLGKFAVDEENRIGRYGRLTFNKVIRPCMKKTIYENEGFREIKGYEYQLYV |
| | | YASDKLFRADIYEDYKTRGRKLLRFNGPVPPP |
| DM09 | SEQ ID NO: 30 | GNWEIIDIGPFTQNLGKFAVDEANKIGQYGRLTFNKVIRPCMKKTIYENEGFREIKGYEYQLY |
| | | VRASDKLFRADISEDYKTRGRKLLRFNGPVPPP |
| DM14 | SEQ ID NO: 31 | GNWEIIDIGPFTQNLGKFAVDEANKIGQYGRLTFNKVIRPCMKKTIYENEGFREIKGYEYQLY |
| | | VRASDKIFRADISEDYKTRGRKLLRFNGPVPPP |
| DM636 | SEQ ID NO: 32 | GNWEIIDIGPFTQNLGKFAVDEANKIGQYGTLRFNKVIRPCMKKTIYENGEIKGYEYQLYVRA |
| | | SDKIFRADIYEDYKTRGRKLLRFNGPVPPP |
| DM29 | SEQ ID NO: 33 | GEWEIIDIGPFTQNLGKFAVDEENKIGQYGRLTFNKVIRPCMKKTIYENGEIKGYEYQLYVYA |
| | | SDKLFRADISEDYKTRGRKLLRFNGPVPPP |
| DM31 | SEQ ID NO: 34 | GNWEIIDIGPFTQNLGKFAVDEANKIGQYGRLTFNKVIRPCMKKTIYENGEIKGYEYQLYVRA |
| | | SDKIFRADISEDYKTRGRKLLRFNGPVPPP |
| DM70 | SEQ ID NO: 35 | GNWEIIDIGPFTQNLGKFAVDEANKIGQYGRLTFNKVIRPCMKKTIYENGEIKGYEYQLYVRA |
| | | SDKIFRADISEDYKTRGLKLLRFNGPVPPP |
| DM42 | SEQ ID NO: 36 | GNWEIIDIGPFTQNLGKFAVDEANKTGQYGRLTFNKVIRPCMKKTIYENGEIKGYEYQLYVR |
| | | ASDKIFRADISEDYKTRGRKLLRFNGPVPPP |
| DM42b | SEQ ID NO: 37 | GEWEIIDIGPFTQNLGKFAVDEENKTGQYGRLTFNKVIRPCMKKTIYENEGFREIKGYEYQLY |
| | | VYASDKLFRADISEDYKTRGRKLLRFNGPVPPP |
| DM43 | SEQ ID NO: 38 | GNWEIIDIGPFTQNLGKFAVDEANRIGQYGRLTFNKVIRPCMKKTIYENGEIKGYEYQLYVRA |
| | | SDKIFRADISEDYKTRGRKLLRFNGPVPPP |
| DM115 | SEQ ID NO: 39 | GNWEIIDIGPFTQNLGKFAVDEANKWGEYGRLTFNKVIRPCMKKTIYENGEIKGYEYQLYVR |
| | | ASDKIFRADISEDYKTRGRKLLRFNGPVPPP |
| DM116 | SEQ ID NO: 40 | GNWEIIDIGPFTQNLGKFAVDEANKWGKYGRLTFNKVIRPCMKKTIYENGEIKGYEYQLYVR |
| | | ASDKIFRADISEDYKTRGRKLLRFNGPVPPP |
| DM130 | SEQ ID NO: 41 | GEWEIIDIGPFTQNLGKFAVDEANKIGQYGRLTFNKVIRPAMKKTIYENEGFREIKGYEYQLY |
| | | VRASDKLFRADIYEDYKTRGRKLLRFNGPVPPP |
| DM146 | SEQ ID NO: 42 | GNWEIIDIGPFTQNLGKFAVDEANKIGQYGRLTFNKVIRPVMKKTIYENGEIKGYEYQLYVRA |
| | | SDKIFRADIYEDYKTRGRKLLRFNGPVPPP |
| DM280 | SEQ ID NO: 43 | GEWEIIDIGPFTQNLGKFAIDEENKIGQYGRLTFNKVIRPCMKKTIYENEGFREIKGYEYQLYV |
| | | YASDKLFRADIWEDYKTRGRKLLRFNGPVPPP |
| DM274 | SEQ ID NO: 44 | GNWEIIDIGPFTQNLGKFAVDEANKIGQYGRLTFNKVIRPAMKKTIYENGEIKGYEYQLYVRA |
| | | SDKIFRADIWEDYKTRGRKLLRFNGPVPPP |
| DM363 | SEQ ID NO: 45 | GNWEIIDIGPFTQNLGKFAVDEANKIGKYGRLTFNKVIRPCMKKTIYENGEIKGYEYQLYVRA |
| | | SDKIFRADIYEDYKTRGRKLLRFNGPVPPP |
| DM607 | SEQ ID NO: 46 | GNWEIIDIGPFTQNLGKFAVDEANKIGKYGRLTFNKVIRPCMKKTIYENGEIKGYEYQLYVRA |
| | | STKIFRADIYEDYKTRGRKLLRFNGPVPPP |
| DM530 | SEQ ID NO: 47 | GNWEIIDIGPFTQNLGKFAVDEANKIGRYGRLTFNKVIRPSMKKTIYENGEIKGYEYQLYVRA |
| | | SDKIFRADIYEDYKTRGRKLLRFNGPVPPP |
| DM614 | SEQ ID NO: 48 | GNWEIIDIGPFTQNLGKFAVDEANKIGQYGRLRENKVIRPCMKKTIYENGEIKGYEYQLYVRA |
| | | SNKIFRADIYEDYKTRGRKLLRFNGPVPPP |
| DM594 | SEQ ID NO: 49 | GNWEIIDIGPFTQNLGKFAVDEANKIGQYGRLTFNKVIRPCMKKTIYENGEIKGYEYQLYVRA |
| | | SDKIFRADIYVDYKTRGRKLLRFNGPVPPP |
| DM651 | SEQ ID NO: 50 | GNWEIIDIGPFTQNLGKFAVDEANKIGQYGRLTFNKVIRPCMKKTIYENGEIKGYTYQLYVRA |
| | | SDKIFRADITEDYKTRGRKLLRFNGPVPPP |
| DM478 | SEQ ID NO: 51 | GNWEIIDIGPFTQNLGKFAVDEANKIGKYGRLTFNKVIRPTMKKTIYENGEIKGYEYQLYVRA |
| | | SDKIFRADIYEDYKTRGRKLLRFNGPVPPP |
| DM224 | SEQ ID NO: 52 | GNWEIIDIGPFTQNLGKFAVDEANKIGQYGRLTFNKVIRPCMKKTIYENGEIKGYEYQLYVRA |
| | | SNKIFRADIYEDYKTRGRKLLRFNGPVPPP |
| DM619 | SEQ ID NO: 53 | GNWEIIDIGPFTQNLGKFAVDEANKIGKYGRLRENKVIRPCMKKTIYENGEIKGYEYQLYVRA |
| | | SDKIFRADIYEDYKTRGRKLLRFNGPVPPP |
| DM46 | SEQ ID NO: 54 | GNWEIIDIGPFTQNLGKFAVDEANKIGQYGRLTFNKVIRPTMKKTIYENGEIKGYEYQLYVRA |
| | | SDKIFRADISEDYKTRGRKLLRFNGPVPPP |
| DM254 | SEQ ID NO: 55 | GNWEIIDIGPFTQNLGKFAVDEANKIGQYGRLTFNKVIRPAMKKTIYENGEIKGYEYQLYVRA |
| | | SDKIFRADIFEDYKTRGRKLLRFNGPVPPP |
| DM282 | SEQ ID NO: 56 | GEWEIIDIGPFTQNLGKFAVDEENKIGQYGRLTFNKVIRPCMKKTIYENEGFREIKGYEYQLY |
| | | VYASDKLFRADIWEDYKTRGRKLLRMNGPVPPP |
| DM635 | SEQ ID NO: 57 | GNWEIIDIGPFTQNLGKFAIDEANKIGQYGRLTFNKVIRPCMKKTIYENGEIKGYEYQLYVRA |
| | | SDKIFRADIYEDYKTRGLKLLRFNGPVPPP |
| DM289 | SEQ ID NO: 58 | GNWEIIDIGPFTQNLGKFAVDEANKIGQYGRLTFTKVIRPCMKKTIYENGEIKGYEYQLYVRA |
| | | SDKIFRADIYEDYKTRGRKLLRFNGPVPPP |
| DM561 | SEQ ID NO: 59 | GNWEIIDIGPFTQNLGKFAVDEANKIGQYGTLRFNKVIRPCMKKTIYENGEIKGYEYQLYVRA |
| | | SDKIFRADISEDYKTRGRKLLRFNGPVPPP |
| DM362 | SEQ ID NO: 60 | GEWEIIDIGPFTQNLGKFAVDEANKIGQYGRLTFNKVIRPCMKKTIYENGEIKGYEYQLYVYA |
| | | SNKLFRADIYEDYKTRGRKLLRFNGPVPPP |
| DM660 | SEQ ID NO: 61 | GNWEIIDIGPFTQNLGKFAVDEANKIGQYGRLTFNKVIRPCMKKTIYENGEIKGYFYQLYVRA |
| | | SDKIFRADIMEDYKTRGRKLLRFNGPVPPP |
| DM57 | SEQ ID NO: 62 | GNWEIIDIGPFTQNLGKFAVDEANKIGQYGRLRENKVIRPCMKKTIYENGEIKGYEYQLYVRA |
| | | SDKIFRADISEDYKTRGRKLLRFNGPVPPP |
| DM364 | SEQ ID NO: 63 | GNWEIIDIGPFTQNLGKFAVDEANKIGQYGRLTFNKVIRPCMKKTIYENGEIKGYEYQLYVYA |
| | | SDKLFRADIYEDYKTRGRKLLRFNGPVPPP |
| DM281 | SEQ ID NO: 64 | GEWEIIDIGPFTQNLGKFAVDEENKIGQYGRLTFNKVIRPCMKKTIYENEGFREIKGYEYQLY |
| | | VYASDKLFRADLWEDYKTRGRKLLRFNGPVPPP |
| DM601 | SEQ ID NO: 65 | GNWEIIDIGPFTQNLGKFAVDEANKIGQYGRLTFNKVIRPCMKKTIYENGEIKGYEYQLYVRA |
| | | SDKIFRADVSEDYKTRGRKLLRFNGPVPPP |
| DM87 | SEQ ID NO: 66 | GNWEIIDIGPFTQNLGKFAVDEANKIGQYGRLTFNKVIRPCMKKTIYENGEIKGYEYQLYVRA |
| | | SNKIFRADISEDYKTRGRKLLRFNGPVPPP |
| DM204 | SEQ ID NO: 67 | GNWEIIDIGPFTQNLGKFAVDEANKIGQYGRLTFNKVIRPCMKKTIYENGEIKGYEYQLYVRA |
| | | SDKIFRVDIYEDYKTRGRKLLRFNGPVPPP |
| DM242 | SEQ ID NO: 68 | GNWEIIDIGPFTQNLGKFAVDEANKIGQYGRLTFNKVIRPCMKKTIYENGEIKGYEYQLYVRA |
| | | SNKIFRADIFEDYKTRGLKLLRFNGPVPPP |
| DM472 | SEQ ID NO: 69 | GNWEIIDIGPFTQNLGKFAVDEANKIGKYGRLTFNKVIRPCMKKTIYENGEIKGYEYQLYVRA |
| | | SNKIFRADIYEDYKTRGRKLLRFNGPVPPP |
| DM455 | SEQ ID NO: 70 | GNWEIIDIGPFTQNLGKFAVDEANKVGKYGRLTFNKVIRPCMKKTIYENGEIKGYEYQLYVR |
| | | ASDKIFRADIYEDYKTRGRKLLRFNGPVPPP |
| DM664 | SEQ ID NO: 71 | GNWEIIDIGPFTQNLGKFAVDEANKIGQYGRLTFNKVIRPCMKKTIYENGEIKGYEYQLYVRA |
| | | SDKIFRADIIEDYKTRGRKLLRFNGPVPPP |
| DM270 | SEQ ID NO: 72 | GNWEIIDIGPFTQNLGKFAIDEANKIGQYGRLTFNKVIRPCMKKTIYENGEIKGYEYQLYVRA |
| | | SDKIFRADIWEDYKTRGRKLLRFNGPVPPP |
| DM690 | SEQ ID NO: 73 | GNWEIIDIGPFTQNLGKFAVDEANKIGQYGRLTFNKVIRPCMKKTIYENGEIKGYEYQLYVRA |
| | | SDKIFRADIAEDYKTRGRKLLRFNGPVPPP |
| DM334 | SEQ ID NO: 74 | GEWEIIDIGPFTQNLGKFAVDEQNKIGKYGRLTFNKVIRPCMKKTIYENGEIKGYEYQLYVYA |
| | | SDKLFRADIYEDYKTRGRKLLRFNGPVPPP |
| DM457 | SEQ ID NO: 75 | GNWEIIDIGPFTQNLGKFAVDEANKIGKYGRLTFNKVIRPCMKKTIYENGEIKGYEYQLYVRA |
| | | SNKIFRADISEDYKTRGRKLLRFNGPVPPP |
| DM641 | SEQ ID NO: 76 | GNWEIIDIGPFTQNLGKFAVDEANKIGRYGRLTFNKVIRPCMKKTIYENGEIKGYEYQLYVRA |
| | | SDKIFRADIYEDYKTRGLKLLRFNGPVPPP |
| DM200 | SEQ ID NO: 77 | GEWEIIDIGPFTQNLGKFAVDEENKWGEYGRLTFNKVIRPCMKKTIYENEGFREIKGYEYQLY |
| | | VYASDKLFRADIYEDYKTRGRKLLRFNGPVPPP |
| DM166 | SEQ ID NO: 78 | GNWEIIDIGPFTQNLGKFAVDEANRIGKYGRLTFNKVIRPCMKKTIYENGEIKGYEYQLYVRA |
| | | SDKIFRADIYEDYKTRGRKLLRFNGPVPPP |
| DM240 | SEQ ID NO: 79 | GNWEIIDIGPFTQNLGKFAVDEANKIGQYGRLTFNKVIRPCMKKTIYENGEIKGYEYQLYVRA |
| | | SNKIFRADIYEDYKTRGLKLLRFNGPVPPP |
| DM246 | SEQ ID NO: 80 | GNWEIIDIGPFTQNLGKFVVDEANKIGQYGRLTFNKVIRPCMKKTIYENGEIKGYEYQLYVRA |
| | | SDKIFRADIFEDYKTRGRKLLRFNGPVPPP |
| DM267 | SEQ ID NO: 81 | GNWEIIDIGPFTQNLGKFAVDEANKIGQYGRLTFNKVIRPCMKKTIYENGEIKGYEYQLYIRA |
| | | SDKIFRADIWEDYKTRGRKLLRFNGPVPPP |
| DM260 | SEQ ID NO: 82 | GEWEIIDIGPFTQNLGKFAIDEENKIGQYGRLTFNKVIRPCMKKTIYENEGFREIKGYEYQLYV |
| | | YASDKLFRADIFEDYKTRGRKLLRFNGPVPPP |
| DM168 | SEQ ID NO: 83 | GNWEIIDIGPFTQNLGKFAVDEANRIGKYGRLTFNKVIRPCMKKTIYENGEIKGYEYQLYVRA |
| | | SDKIFRADIFEDYKTRGRKLLRFNGPVPPP |
| DM655 | SEQ ID NO: 84 | GNWEIIDIGPFTQNLGKFAVDEANKIGQYGRLTFNKVIRPCMKKTIYENGEIKGYVYQLYVRA |
| | | SDKIFRADIIEDYKTRGRKLLRFNGPVPPP |
| DM288 | SEQ ID NO: 85 | GNWEIIDIGPFTQNLGKFAVDEANRTGKYGRLTFNKVIRPCMKKTIYENGEIKGYEYQLYVR |
| | | ASDKIFRADIYEDYKTRGRKLLRFNGPVPPP |
| DM464 | SEQ ID NO: 86 | GNWEIIDIGPFTQNLGKFAVDEANRIGQYGRLTFNKVIRPCMKKTIYENGEIKGYEYQLYVRA |
| | | SNKIFRADISEDYKTRGRKLLRFNGPVPPP |
| DM484 | SEQ ID NO: 87 | GNWEIIDIGPFTQNLGKFAVDEANKTGKYGRLTFNKVIRPCMKKTIYENGEIKGYEYQLYVR |
| | | ASNKIFRADIYEDYKTRGRKLLRFNGPVPPP |
| DM395 | SEQ ID NO: 88 | GMWEIIDIGPFTQNLGKFAVDEANKIGQYGRLTFNKVIRPCMKKTIYENGEIKGYEYQLYVR |
| | | ASDKIFRADISEDYKTRGRKLLRFNGPVPPP |
| DM177 | SEQ ID NO: 89 | GNWEIIDIGPFTQNLGKFAVDEANKWGKYGRLTFNKVIRPCMKKTIYENGEIKGYEYQLYVR |
| | | ASDKIFRADIFEDYKTRGRKLLRFNGPVPPP |
| DM536 | SEQ ID NO: 90 | GNWEIIDIGPFTQNLGKFAVDEANKIGKYGRLTFNKVIRPAMKKTIYENGEIKGYEYQLYVRA |
| | | SDKIFRADIYEDYKTRGRKLLRFNGPVPPP |
| DM682 | SEQ ID NO: 91 | GNWEIIDIGPFTQNLGKFAVDEANKIGKYGRLTFNKVIRPAMKKTIYENGEIKGYEYQLYVRA |
| | | SDKIFRADIWEDYKTRGRKLLRFNGPVPPP |
| DM213 | SEQ ID NO: 92 | GEWEIIDIGPFTQNLGKFAVDEENKIGQYGRLTFNKVIRPCMKKTIYENEGFREIKGYEYQLYI |
| | | YASDKLFRADIYEDYKTRGRKLLRFNGPVPPP |
| DM178 | SEQ ID NO: 93 | GNWEIIDIGPFTQNLGKFAVDEANKWGKYGRLTFNKVIRPCMKKTIYENGEIKGYEYQLYVR |
| | | ASDKIFRADIWEDYKTRGRKLLRFNGPVPPP |
| DM539 | SEQ ID NO: 94 | GNWEIIDIGPFTQNLGKFAVDEANKIGRYGRLRENKVIRPCMKKTIYENGEIKGYEYQLYVRA |
| | | SDKIFRADISEDYKTRGRKLLRFNGPVPPP |
| DM208 | SEQ ID NO: 95 | GNWEIIDIGPFTQNLGKFAVDEANKIGQYGRLTFNKVIRPCMKKTIYENGEIKGYEYQLYVRA |
| | | SDKIFRADIYEDYKTRGRKLLRMNGPVPPP |
| DM397 | SEQ ID NO: 96 | GNWEIIDIGPFTQNLGKFAVDEANKIGQYGRLTFNKVIRPCMKKTIYENGEIKGYEYQLYVYA |
| | | SNKLFRADIYEDYKTRGRKLLRFNGPVPPP |
| DM683 | SEQ ID NO: 97 | GNWEIIDIGPFTQNLGKFAVDEANKIGKYGRLTFNKVIRPAMKKTIYENGEIKGYEYQLYVRA |
| | | SDKIFRADIFEDYKTRGRKLLRFNGPVPPP |
| DM526 | SEQ ID NO: 98 | GNWEIIDIGPFTQNLGKFAVDEANKTGRYGRLTFNKVIRPCMKKTIYENGEIKGYEYQLYVR |
| | | ASDKIFRADIYEDYKTRGRKLLRFNGPVPPP |
| DM236 | SEQ ID NO: 99 | GNWEIIDIGPFTQNLGKFAVDEANKIGQYGRLTFNKVIRPCMKKTIYENGEIKGYEYQLYVRA |
| | | SNKIFRADIWEDYKTRGRKLLRFNGPVPPP |
| DM264 | SEQ ID NO: 100 | GEWEIIDIGPFTQNLGKFAVDEENKIGQYGRLTFNKVIRPAMKKTIYENEGFREIKGYEYQLY |
| | | VYASDKLFRADIFEDYKTRGRKLLRFNGPVPPP |
| DM239 | SEQ ID NO: 101 | GEWEIIDIGPFTQNLGKFAVDEENKIGQYGRLTFNKVIRPCMKKTIYENEGFREIKGYEYQLY |
| | | VYASNKLFRADIWEDYKTRGRKLLRFNGPVPPP |
| DM165 | SEQ ID NO: 102 | GNWEIIDIGPFTQNLGKFAVDEANRIGRYGRLTFNKVIRPCMKKTIYENGEIKGYEYQLYVRA |
| | | SDKIFRADIYEDYKTRGRKLLRFNGPVPPP |
| DM602 | SEQ ID NO: 103 | GNWEIIDIGPFTQNLGKFAVDEANKIGQYGRLTFNKVIRPCMKKTIYENGEIKGYVYQLYVRA |
| | | SDKIFRAVIVEDYKTRGRKLLRFNGPVPPP |
| DM662 | SEQ ID NO: 104 | GNWEIIDIGPFTQNLGKFAVDEANKIGQYGRLTFNKVIRPCMKKTIYENGEIKGYYYQLYVRA |
| | | SDKIFRADIVEDYKTRGRKLLRFNGPVPPP |
| DM361 | SEQ ID NO: 105 | GNWEIIDIGPFTQNLGKFAVDEANKIGQYGRLTFNKVIRPCMKKTIYENGEIKGYEYQLYVYA |
| | | SNKIFRADIYEDYKTRGRKLLRFNGPVPPP |
| DM632 | SEQ ID NO: 106 | GNWEIIDIGPFTQNLGKFAVDEANKIGKYGRLTFNKVIRPCMKKTIYENGEIKGYEYQLYVRA |
| | | SDKIFRADIYEDYKTRGLKLLRFNGPVPPP |
| DM654 | SEQ ID NO: 107 | GNWEIIDIGPFTQNLGKFAVDEANKIGQYGRLTFNKVIRPCMKKTIYENGEIKGYTYQLYVRA |
| | | SDKIFRADIVEDYKTRGRKLLRFNGPVPPP |
| DM517 | SEQ ID NO: 108 | GNWEIIDIGPFTQNLGKFAVDEANKIGRYGRLTFNKVIRPCMKKTIYENGEIKGYEYQLYVRA |
| | | SDKIFRADIYEDYKTRGRKLLRFNGPVPPP |
| DM174 | SEQ ID NO: 109 | GNWEIIDIGPFTQNLGKFAVDEANKIGQYGRLTFNKVIRPCMKKTIYENGEIKGYEYQLYVRA |
| | | SDKIFRADIWEDYKTRGLKLLRFNGPVPPP |
| DM631 | SEQ ID NO: 110 | GNWEIIDIGPFTQNLGKFAVDEANKIGKYGRLTFTKVIRPCMKKTIYENGEIKGYEYQLYVRA |
| | | SDKIFRADIYEDYKTRGRKLLRFNGPVPPP |
| DM278 | SEQ ID NO: 111 | GEWEIIDIGPFTQNLGKFAVDEENKIGQYGRLTFNKVIRPCMKKTIYENEGFREIKGYEYQLY |
| | | VYASDKLFRVDIWEDYKTRGRKLLRFNGPVPPP |
| DM197 | SEQ ID NO: 112 | GEWEIIDIGPFTQNLGKFAVDEENKWGKYGRLTFNKVIRPCMKKTIYENEGFREIKGYEYQLY |
| | | VYASDKLFRADIFEDYKTRGRKLLRFNGPVPPP |
| DM257 | SEQ ID NO: 113 | GEWEIIDIGPFTQNLGKFAVDEENKIGQYGRLTFNKVIRPCMKKTIYENEGFREIKGYEYQLYI |
| | | YASDKLFRADIFEDYKTRGRKLLRFNGPVPPP |
| DM210 | SEQ ID NO: 114 | GNWEIIDIGPFTQNLGKFAVDEANKIGQYGRLTFNKVIRPAMKKTIYENGEIKGYEYQLYVRA |
| | | SDKIFRADIYEDYKTRGRKLLRFNGPVPPP |
| DM283 | SEQ ID NO: 115 | GEWEIIDIGPFTQNLGKFAVDEENKIGQYGRLTFNKVIRPCMKKTIYENEGFREIKGYEYQLY |
| | | VYASDKLFRFDIWEDYKTRGRKLLRMNGPVPPP |
| DM47 | SEQ ID NO: 116 | GNWEIIDIGPFTQNLGKFAVDEANKIGQYGTLTFNKVIRPCMKKTIYENGEIKGYEYQLYVRA |
| | | SDKIFRADISEDYKTRGRKLLRFNGPVPPP |
| DM262 | SEQ ID NO: 117 | GEWEIIDIGPFTQNLGKFAVDEENKIGQYGRLTFNKVIRPCMKKTIYENEGFREIKGYEYQLY |
| | | VYASDKLFRADIFEDYKTRGRKLLRMNGPVPPP |
| DM271 | SEQ ID NO: 118 | GNWEIIDIGPFTQNLGKFAVDEANKIGQYGRLTFNKVIRPCMKKTIYENGEIKGYEYQLYVRA |
| | | SDKIFRADLWEDYKTRGRKLLRFNGPVPPP |
| DM237 | SEQ ID NO: 119 | GEWEIIDIGPFTQNLGKFAVDEENKIGQYGRLRENKVIRPCMKKTIYENEGFREIKGYEYQLY |
| | | VYASDKLFRADIWEDYKTRGRKLLRFNGPVPPP |
| DM214 | SEQ ID NO: 120 | GEWEIIDIGPFTQNLGKFAVDEENKIGQYGRLTFNKVIRPCMKKTIYENEGFREIKGYEYQLY |
| | | VYASDKLFRVDIYEDYKTRGRKLLRFNGPVPPP |
| DM41 | SEQ ID NO: 121 | GNWEIIDIGPFTQNLGKFAVDEANKSGQYGRLTFNKVIRPCMKKTIYENGEIKGYEYQLYVR |
| | | ASDKIFRADISEDYKTRGRKLLRFNGPVPPP |
| DM249 | SEQ ID NO: 122 | GNWEIIDIGPFTQNLGKFAVDEANKIGQYGRLTFNKVIRPVMKKTIYENGEIKGYEYQLYVRA |
| | | SDKIFRADIFEDYKTRGRKLLRFNGPVPPP |
| DM552 | SEQ ID NO: 123 | GNWEIIDIGPFTQNLGKFAVDEANKIGKYGTLTFNKVIRPCMKKTIYENGEIKGYEYQLYVRA |
| | | SDKIFRADISEDYKTRGRKLLRFNGPVPPP |
| DM606 | SEQ ID NO: 124 | GNWEIIDIGPFTQNLGKFAVDEANKIGQYGRLTFNKVIRPCMKKTIYENGEIKGYEYQLYVRA |
| | | SDKIFRADIREDYKTRGRKLLRFNGPVPPP |
| DM65 | SEQ ID NO: 125 | GNWEIIDIGPFTQNLGKFAVDEANKIGKYGRLTFNKVIRPCMKKTIYENGEIKGYEYQLYVRA |
| | | SDKIFRADISEDYKTRGRKLLRFNGPVPPP |
| DM218 | SEQ ID NO: 126 | GEWEIIDIGPFTQNLGKFAVDEENKIGQYGRLTFNKVIRPCMKKTIYENEGFREIKGYEYQLY |
| | | VYASDKLFRADIYEDYKTRGRKLLRMNGPVPPP |
| DM295 | SEQ ID NO: 127 | GNWEIIDIGPFTQNLGKFAVDEANKIGQYGRLTFTKVIRPCMKKTIYENGEIKGYEYQLYVRA |
| | | SDKIFRADIFEDYKTRGRKLLRFNGPVPPP |
| DM653 | SEQ ID NO: 128 | GNWEIIDIGPFTQNLGKFAVDEANKIGQYGRLTFNKVIRPCMKKTIYENGEIKGYIYQLYVRA |
| | | SDKIFRADIVEDYKTRGRKLLRFNGPVPPP |
| DM207 | SEQ ID NO: 129 | GNWEIIDIGPFTQNLGKFAVDEANKIGQYGRLTFNKVIRPCMKKTIYENGEIKGYEYQLYVRA |
| | | SDKIFRADLYEDYKTRGRKLLRFNGPVPPP |
| DM275 | SEQ ID NO: 130 | GNWEIIDIGPFTQNLGKFAVDEANKIGQYGRLTFNKVIRPSMKKTIYENGEIKGYEYQLYVRA |
| | | SDKIFRADIWEDYKTRGRKLLRFNGPVPPP |
| DM272 | SEQ ID NO: 131 | GNWEIIDIGPFTQNLGKFAVDEANKIGQYGRLTFNKVIRPCMKKTIYENGEIKGYEYQLYVRA |
| | | SDKIFRADIWEDYKTRGRKLLRMNGPVPPP |
| DM179 | SEQ ID NO: 132 | GNWEIIDIGPFTQNLGKFAVDEANKWGEYGRLTFNKVIRPCMKKTIYENGEIKGYEYQLYVR |
| | | ASDKIFRADIWEDYKTRGRKLLRFNGPVPPP |
| DM269 | SEQ ID NO: 133 | GNWEIIDIGPFTQNLGKFAVDEANKIGQYGRLTFNKVIRPVMKKTIYENGEIKGYEYQLYVRA |
| | | SDKIFRADIWEDYKTRGRKLLRFNGPVPPP |
| DM625 | SEQ ID NO: 134 | GNWEIIDIGPFTQNLGKFVVDEANKIGQYGRLTFTKVIRPCMKKTIYENGEIKGYEYQLYVRA |
| | | SDKIFRADIYEDYKTRGRKLLRFNGPVPPP |
| DM633 | SEQ ID NO: 135 | GNWEIIDIGPFTQNLGKFAIDEANKIGQYGTLTFNKVIRPCMKKTIYENGEIKGYEYQLYVRAS |
| | | DKIFRADIYEDYKTRGRKLLRFNGPVPPP |
| DM685 | SEQ ID NO: 136 | GNWEIIDIGPFTQNLGKFAVDEANKIGRYGRLTFNKVIRPAMKKTIYENGEIKGYEYQLYVRA |
| | | SDKIFRADIFEDYKTRGRKLLRFNGPVPPP |
| DM640 | SEQ ID NO: 137 | GNWEIIDIGPFTQNLGKFAVDEANKIGRYGRLTFTKVIRPCMKKTIYENGEIKGYEYQLYVRA |
| | | SDKIFRADIYEDYKTRGRKLLRFNGPVPPP |
| DM650 | SEQ ID NO: 138 | GNWEIIDIGPFTQNLGKFAVDEANKIGQYGRLTFNKVIRPCMKKTIYENGEIKGYIYQLYVRA |
| | | SDKIFRADITEDYKTRGRKLLRFNGPVPPP |
| DM222 | SEQ ID NO: 139 | GNWEIIDIGPFTQNLGKFAVDEANKIGQYGRLRENKVIRPCMKKTIYENGEIKGYEYQLYVRA |
| | | SDKIFRADIYEDYKTRGRKLLRFNGPVPPP |
| DM360 | SEQ ID NO: 140 | MMWEIIDIGPFTQNLGKFAVDEANKIGQYGRLTFNKVIRPCMKKTIYENGEIKGYEYQLYVR |
| | | ASDKIFRADIYEDYKTRGRKLLRFNGPVPPP |
| DM85 | SEQ ID NO: 141 | GNWEIIDIGPFTQNLGKFAVDEANKIGQYGRLTFNKVIRPCMKKTIYENGEIKGYEYQLYVRA |
| | | SDKIFRVDISEDYKTRGRKLLRFNGPVPPP |
| DM151 | SEQ ID NO: 142 | GNWEIIDIGPFTQNLGKFAVDEANKIGQYGRLTFNKVIRPSMKKTIYENGEIKGYEYQLYVRA |
| | | SDKIFRADISEDYKTRGRKLLRFNGPVPPP |
| DM513 | SEQ ID NO: 143 | GNWEIIDIGPFTQNLGKFAIDEANKIGQYGRLRENKVIRPCMKKTIYENGEIKGYEYQLYVRA |
| | | SDKIFRADISEDYKTRGRKLLRFNGPVPPP |
| DM212 | SEQ ID NO: 144 | GEWEIIDIGPFTQNLGKFVVDEENKIGQYGRLTFNKVIRPCMKKTIYENEGFREIKGYEYQLY |
| | | VYASDKLFRADIYEDYKTRGRKLLRFNGPVPPP |
| DM198 | SEQ ID NO: 145 | GEWEIIDIGPFTQNLGKFAVDEENKWGKYGRLTFNKVIRPCMKKTIYENEGFREIKGYEYQLY |
| | | VYASDKLFRADIWEDYKTRGRKLLRFNGPVPPP |
| DM243 | SEQ ID NO: 146 | GEWEIIDIGPFTQNLGKFAVDEENKIGQYGRLTFNKVIRPCMKKTIYENEGFREIKGYEYQLY |
| | | VYASNKLFRADIYEDYKTRGLKLLRFNGPVPPP |
| DM225 | SEQ ID NO: 147 | GEWEIIDIGPFTQNLGKFAVDEENKIGQYGRLRFNKVIRPCMKKTIYENEGFREIKGYEYQLY |
| | | VYASDKLFRADIYEDYKTRGRKLLRFNGPVPPP |
| DM91 | SEQ ID NO: 148 | GNWEIIDIGPFTQNLGKFAVDEANKIGQYGRLTFNKVIRPVMKKTIYENGEIKGYEYQLYVRA |
| | | SDKIFRADISEDYKTRGRKLLRFNGPVPPP |
| DM661 | SEQ ID NO: 149 | GNWEIIDIGPFTQNLGKFAVDEANKIGQYGRLTFNKVIRPCMKKTIYENGEIKGYWYQLYVR |
| | | ASDKIFRADIYEDYKTRGRKLLRFNGPVPPP |
| DM221 | SEQ ID NO: 150 | GEWEIIDIGPFTQNLGKFAVDEENKIGQYGRLTFNKVIRPSMKKTIYENEGFREIKGYEYQLYV |
| | | YASDKLFRADIYEDYKTRGRKLLRFNGPVPPP |
| DM201 | SEQ ID NO: 151 | GEWEIIDIGPFTQNLGKFAVDEENKWGKYGRLTFNKVIRPCMKKTIYENEGFREIKGYEYQLY |
| | | VYASDKLFRADIYEDYKTRGRKLLRFNGPVPPP |
| DM681 | SEQ ID NO: 152 | GNWEIIDIGPFTQNLGKFAIDEANKIGRYGRLTFNKVIRPCMKKTIYENGEIKGYEYQLYVRAS |
| | | DKIFRADIFEDYKTRGRKLLRFNGPVPPP |
| DM252 | SEQ ID NO: 153 | GNWEIIDIGPFTQNLGKFAVDEANKIGQYGRLTFNKVIRPCMKKTIYENGEIKGYEYQLYVRA |
| | | SDKIFRADIFEDYKTRGRKLLRMNGPVPPP |
| DM292 | SEQ ID NO: 154 | GNWEIIDIGPFTQNLGKFAVDEANKIGQYGRLTFTKVIRPCMKKTIYENGEIKGYEYQLYVRA |
| | | SDKIFRADIWEDYKTRGRKLLRFNGPVPPP |
| DM330 | SEQ ID NO: 155 | GNWEIIDIGPFTQNLGKFAVDEANKIGSYGRLTFNKVIRPCMKKTIYENGEIKGYEYQLYVRA |
| | | SDKIFRADISEDYKTRGRKLLRFNGPVPPP |
| DM276 | SEQ ID NO: 156 | GEWEIIDIGPFTQNLGKFVVDEENKIGQYGRLTFNKVIRPCMKKTIYENEGFREIKGYEYQLY |
| | | VYASDKLFRADIWEDYKTRGRKLLRFNGPVPPP |
| DM206 | SEQ ID NO: 157 | GNWEIIDIGPFTQNLGKFAIDEANKIGQYGRLTFNKVIRPCMKKTIYENGEIKGYEYQLYVRA |
| | | SDKIFRADIYEDYKTRGRKLLRFNGPVPPP |
| DM593 | SEQ ID NO: 158 | GNWEIIDIGPFTQNLGKFAVDEANKIGQYGRLTFNKVIRPCMKKTIYENGEIKGYEYQLYVRA |
| | | SDKIFRADISVDYKTRGRKLLRFNGPVPPP |
| DM396 | SEQ ID NO: 159 | GMWEIIDIGPFTQNLGKFAVDEANKIGQYGRLTFNKVIRPCMKKTIYENGEIKGYEYQLYVR |
| | | ASDKIFRADIYEDYKTRGRKLLRFNGPVPPP |
| DM261 | SEQ ID NO: 160 | GEWEIIDIGPFTQNLGKFAVDEENKIGQYGRLTFNKVIRPCMKKTIYENEGFREIKGYEYQLY |
| | | VYASDKLFRADLFEDYKTRGRKLLRFNGPVPPP |
| DM337 | SEQ ID NO: 161 | GEWQIIDIGPFTQNLGKFAVDEENKIGQYGRLTFNKVIRPCMKKTIYENGEIKGYEYQLYVYA |
| | | SDKLFRADIYEDYKTRGRKLLRFNGPVPPP |
| DM202 | SEQ ID NO: 162 | GNWEIIDIGPFTQNLGKFVVDEANKIGQYGRLTFNKVIRPCMKKTIYENGEIKGYEYQLYVRA |
| | | SDKIFRADIYEDYKTRGRKLLRFNGPVPPP |
| DM77 | SEQ ID NO: 163 | GNWEIIDIGPFTQNLGKFVVDEANKIGQYGRLTFNKVIRPCMKKTIYENGEIKGYEYQLYVRA |
| | | SDKIFRADISEDYKTRGRKLLRFNGPVPPP |
| DM245 | SEQ ID NO: 164 | GEWEIIDIGPFTQNLGKFAVDEENKIGQYGRLTFNKVIRPCMKKTIYENEGFREIKGYEYQLY |
| | | VYASNKLFRADIFEDYKTRGLKLLRFNGPVPPP |
| DM413 | SEQ ID NO: 165 | MNWEIIDIGPFTQNLGKFAVDEANKIGQYGRLTFNKVIRPCMKKTIYENGEIKGYEYQLYVR |
| | | ASDKIFRADIYEDYKTRGRKLLRFNGPVPPP |
| DM203 | SEQ ID NO: 166 | GNWEIIDIGPFTQNLGKFAVDEANKIGQYGRLTFNKVIRPCMKKTIYENGEIKGYEYQLYIRA |
| | | SDKIFRADIYEDYKTRGRKLLRFNGPVPPP |
| DM303 | SEQ ID NO: 167 | GEWEIIDIGPFTQNLGKFAVDEENKIGQYGRLTFTKVIRPCMKKTIYENEGFREIKGYEYQLYV |
| | | YASDKLFRADIWEDYKTRGRKLLRFNGPVPPP |
| DM477 | SEQ ID NO: 168 | GNWEIIDIGPFTQNLGKFAVDEANKIGQYGRLTFNKVIRPTMKKTIYENGEIKGYEYQLYVYA |
| | | SNKIFRADIYEDYKTRGRKLLRFNGPVPPP |
| DM663 | SEQ ID NO: 169 | GNWEIIDIGPFTQNLGKFAVDEANKIGQYGRLTFNKVIRPCMKKTIYENGEIKGYEYQLYVRA |
| | | SDKIFRADIVEDYKTRGRKLLRFNGPVPPP |
| DM338 | SEQ ID NO: 170 | GNWEIIDIGPFTQNLGKFAVDEENKIGQYGRLTFNKVIRPCMKKTIYENGEIKGYEYQLYVYA |
| | | SDKLFRADIYEDYKTRGRKLLRFNGPVPPP |
| DM301 | SEQ ID NO: 171 | GEWEIIDIGPFTQNLGKFAVDEENKIGQYGRLTFNKVIRPTMKKTIYENEGFREIKGYEYQLY |
| | | VYASDKLFRADIWEDYKTRGRKLLRFNGPVPPP |
| DM286 | SEQ ID NO: 172 | GNWEIIDIGPFTQNLGKFAVDEANKIGQYGTLTFNKVIRPCMKKTIYENGEIKGYEYQLYVRA |
| | | SDKIFRADIYEDYKTRGRKLLRFNGPVPPP |
| DM516 | SEQ ID NO: 173 | GNWEIIDIGPFTQNLGKFAVDEANKIGKYGRLRENKVIRPCMKKTIYENGEIKGYEYQLYVRA |
| | | SDKIFRADISEDYKTRGRKLLRFNGPVPPP |
| DM209 | SEQ ID NO: 174 | GNWEIIDIGPFTQNLGKFAVDEANKIGQYGRLTFNKVIRPCMKKTIYENGEIKGYEYQLYVRA |
| | | SDKIFRFDIYEDYKTRGRKLLRMNGPVPPP |
| DM263 | SEQ ID NO: 175 | GEWEIIDIGPFTQNLGKFAVDEENKIGQYGRLTFNKVIRPCMKKTIYENEGFREIKGYEYQLY |
| | | VYASDKLFRFDIFEDYKTRGRKLLRMNGPVPPP |
| DM620 | SEQ ID NO: 176 | GNWEIIDIGPFTQNLGKFAIDEANKIGRYGRLTFNKVIRPCMKKTIYENGEIKGYEYQLYVRAS |
| | | DKIFRADIYEDYKTRGRKLLRFNGPVPPP |
| DM658 | SEQ ID NO: 177 | GNWEIIDIGPFTQNLGKFAVDEANKIGQYGRLTFNKVIRPCMKKTIYENGEIKGYEYQLYVRA |
| | | SDKIFRADITEDYKTRGRKLLRFNGPVPPP |
| DM473 | SEQ ID NO: 178 | GNWEIIDIGPFTQNLGKFAVDEANKIGKYGRLTFNKVIRPCMKKTIYENGEIKGYEYQLYVYA |
| | | SNKIFRADIYEDYKTRGRKLLRFNGPVPPP |
| DM335 | SEQ ID NO: 179 | GEWEIIDIGPFTQNLGKFAVDEANKIGKYGRLTFNKVIRPCMKKTIYENGEIKGYEYQLYVYA |
| | | SDKLFRADIYEDYKTRGRKLLRFNGPVPPP |
| DM247 | SEQ ID NO: 180 | GNWEIIDIGPFTQNLGKFAVDEANKIGQYGRLTFNKVIRPCMKKTIYENGEIKGYEYQLYIRA |
| | | SDKIFRADIFEDYKTRGRKLLRFNGPVPPP |
| DM532 | SEQ ID NO: 181 | GNWEIIDIGPFTQNLGKFAVDEANKIGRYGRLTFNKVIRPAMKKTIYENGEIKGYEYQLYVRA |
| | | SDKIFRADIYEDYKTRGRKLLRFNGPVPPP |
| DM346 | SEQ ID NO: 182 | GNWEIIDIGPFTQNLGKFAVDEANKIGQYGRLTFNKVIRPSMKKTIYENGEIKGYEYQLYVRA |
| | | SDKIFRADIYEDYKTRGRKLLRFNGPVPPP |
| DM176 | SEQ ID NO: 183 | GNWEIIDIGPFTQNLGKFAVDEANKWGEYGRLTFNKVIRPCMKKTIYENGEIKGYEYQLYVR |
| | | ASDKIFRADIFEDYKTRGRKLLRFNGPVPPP |
| DM605 | SEQ ID NO: 184 | GNWEIIDIGPFTQNLGKFAVDEANKIGQYGRLTFNKVIRPCMKKTIYENGEIKGYVYQLYVRA |
| | | SDKIFRADITEDYKTRGRKLLRFNGPVPPP |
| DM277 | SEQ ID NO: 185 | GEWEIIDIGPFTQNLGKFAVDEENKIGQYGRLTFNKVIRPCMKKTIYENEGFREIKGYEYQL YI |
| | | YASDKLFRADIWEDYKTRGRKLLRFNGPVPPP |
| DM567 | SEQ ID NO: 186 | GNWEIIDIGPFTQNLGKFAVDEANKIGQYGTLTFNKVIRPCMKKTIYENGEIKGYEYQLYVRA |
| | | STKIFRADISEDYKTRGRKLLRFNGPVPPP |
| DM528 | SEQ ID NO: 187 | GNWEIIDIGPFTQNLGKFAVDEANKIGRYGRLTFNKVIRPTMKKTIYENGEIKGYEYQLYVRA |
| | | SDKIFRADIYEDYKTRGRKLLRFNGPVPPP |
| DM268 | SEQ ID NO: 188 | GNWEIIDIGPFTQNLGKFAVDEANKIGQYGRLTFNKVIRPCMKKTIYENGEIKGYEYQLYVRA |
| | | SDKIFRVDIWEDYKTRGRKLLRFNGPVPPP |
| DM652 | SEQ ID NO: 189 | GNWEIIDIGPFTQNLGKFAVDEANKIGQYGRLTFNKVIRPCMKKTIYENGEIKGYVYQLYVRA |
| | | SDKIFRADIVEDYKTRGRKLLRFNGPVPPP |
| DM613 | SEQ ID NO: 190 | GNWEIIDIGPFTQNLGKFAIDEANKIGKYGRLTFNKVIRPCMKKTIYENGEIKGYEYQLYVRA |
| | | SDKIFRADIYEDYKTRGRKLLRFNGPVPPP |
| DM244 | SEQ ID NO: 191 | GEWEIIDIGPFTQNLGKFAVDEENKIGQYGRLTFNKVIRPCMKKTIYENEGFREIKGYEYQLY |
| | | VYASNKLFRADIWEDYKTRGLKLLRFNGPVPPP |
| DM644 | SEQ ID NO: 192 | GNWEIIDIGPFTQNLGKFAVDEANKIGQYGRLTFNKVIRPCMKKTIYENGEIKGYEYQLYVRA |
| | | STKIFRADIYEDYKTRGLKLLRFNGPVPPP |
| DM273 | SEQ ID NO: 193 | GNWEIIDIGPFTQNLGKFAVDEANKIGQYGRLTFNKVIRPCMKKTIYENGEIKGYEYQLYVRA |
| | | SDKIFRFDIWEDYKTRGRKLLRMNGPVPPP |
| DM630 | SEQ ID NO: 194 | GNWEIIDIGPFTQNLGKFAVDEANKIGKYGTLTFNKVIRPCMKKTIYENGEIKGYEYQLYVRA |
| | | SDKIFRADIYEDYKTRGRKLLRFNGPVPPP |
| DM628 | SEQ ID NO: 195 | GNWEIIDIGPFTQNLGKFAVDEANKIGQYGRLTFTKVIRPCMKKTIYENGEIKGYEYQLYVRA |
| | | SNKIFRADIYEDYKTRGRKLLRFNGPVPPP |
| DM234 | SEQ ID NO: 196 | GNWEIIDIGPFTQNLGKFAVDEANKIGQYGRLRENKVIRPCMKKTIYENGEIKGYEYQLYVRA |
| | | SDKIFRADIWEDYKTRGRKLLRFNGPVPPP |
| DM611 | SEQ ID NO: 197 | GNWEIIDIGPFTQNLGKFAIDEANKIGQYGRLTFNKVIRPCMKKTIYENGEIKGYEYQLYVRA |
| | | SNKIFRADIYEDYKTRGRKLLRFNGPVPPP |
| DM638 | SEQ ID NO: 198 | GNWEIIDIGPFTQNLGKFAVDEANKIGQYGRLRFNKVIRPCMKKTIYENGEIKGYEYQLYVRA |
| | | SDKIFRADIYEDYKTRGLKLLRFNGPVPPP |
| DM626 | SEQ ID NO: 199 | GNWEIIDIGPFTQNLGKFVVDEANKIGQYGRLTFNKVIRPCMKKTIYENGEIKGYEYQLYVRA |
| | | SDKIFRADIYEDYKTRGLKLLRFNGPVPPP |
| DM171 | SEQ ID NO: 200 | GNWEIIDIGPFTQNLGKFAVDEANKIGRYGTLTFNKVIRPCMKKTIYENGEIKGYEYQLYVRA |
| | | SDKIFRADIYEDYKTRGRKLLRFNGPVPPP |
| DM94 | SEQ ID NO: 201 | GNWEIIDIGPFTQNLGKFAVDEANKIGQYGTLTFNKVIRPCMKKTIYENGEIKGYEYQLYVRA |
| | | SNKIFRADISEDYKTRGRKLLRFNGPVPPP |
| DM543 | SEQ ID NO: 202 | GNWEIIDIGPFTQNLGKFVVDEANKIGQYGTLTFNKVIRPCMKKTIYENGEIKGYEYQLYVRA |
| | | SDKIFRADISEDYKTRGRKLLRFNGPVPPP |
| DM217 | SEQ ID NO: 203 | GEWEIIDIGPFTQNLGKFAVDEENKIGQYGRLTFNKVIRPCMKKTIYENEGFREIKGYEYQLY |
| | | VYASDKLFRADLYEDYKTRGRKLLRFNGPVPPP |
| DM183 | SEQ ID NO: 204 | GEWEIIDIGPFTQNLGKFAVDEENKTGQYGRLTFNKVIRPCMKKTIYENEGFREIKGYEYQLY |
| | | VYASDKLFRADIWEDYKTRGRKLLRFNGPVPPP |
| DM302 | SEQ ID NO: 205 | GEWEIIDIGPFTQNLGKFAVDEENKIGQYGRLTFNKVIRPCMKKTIYENEGFREIKGYEYQLY |
| | | VYASDKLFRADIWEDYKTRGLKLLRFNGPVPPP |
| DM167 | SEQ ID NO: 206 | GNWEIIDIGPFTQNLGKFAVDEANRIGRYGRLTFNKVIRPCMKKTIYENGEIKGYEYQLYVRA |
| | | SDKIFRADIFEDYKTRGRKLLRFNGPVPPP |
| DM534 | SEQ ID NO: 207 | GNWEIIDIGPFTQNLGKFAVDEANKIGKYGRLTFNKVIRPSMKKTIYENGEIKGYEYQLYVRA |
| | | SDKIFRADIYEDYKTRGRKLLRFNGPVPPP |
| DM256 | SEQ ID NO: 208 | GEWEIIDIGPFTQNLGKFVVDEENKIGQYGRLTFNKVIRPCMKKTIYENEGFREIKGYEYQLY |
| | | VYASDKLFRADIFEDYKTRGRKLLRFNGPVPPP |
| DM220 | SEQ ID NO: 209 | GEWEIIDIGPFTQNLGKFAVDEENKIGQYGRLTFNKVIRPAMKKTIYENEGFREIKGYEYQLY |
| | | VYASDKLFRADIYEDYKTRGRKLLRFNGPVPPP |
| DM294 | SEQ ID NO: 210 | GNWEIIDIGPFTQNLGKFAVDEANKIGQYGRLTFNKVIRPTMKKTIYENGEIKGYEYQLYVRA |
| | | SDKIFRADIFEDYKTRGRKLLRFNGPVPPP |
| DM595 | SEQ ID NO: 211 | GNWEIIDIGPFTQNLGKFAVDEANKIGQYGRLTFNKVIRPCMKKTIYENGEIKGYEYQLYVRA |
| | | SDKIFRADVYVDYKTRGRKLLRFNGPVPPP |
| DM634 | SEQ ID NO: 212 | GNWEIIDIGPFTQNLGKFAIDEANKIGQYGRLTFTKVIRPCMKKTIYENGEIKGYEYQLYVRAS |
| | | DKIFRADIYEDYKTRGRKLLRFNGPVPPP |
| DM333 | SEQ ID NO: 213 | GEWEIIDIGPFTQNLGKFAVDEENKIGQYGRLTFNKVIRPCMKKTIYENGEIKGYEYQLYVYA |
| | | SNKLFRADIYEDYKTRGRKLLRFNGPVPPP |
| DM181 | SEQ ID NO: 214 | GEWEIIDIGPFTQNLGKFAVDEENKTGQYGRLTFNKVIRPCMKKTIYENEGFREIKGYEYQLY |
| | | VYASDKLFRADIFEDYKTRGRKLLRFNGPVPPP |
| DM258 | SEQ ID NO: 215 | GEWEIIDIGPFTQNLGKFAVDEENKIGQYGRLTFNKVIRPCMKKTIYENEGFREIKGYEYQLY |
| | | VYASDKLFRVDIFEDYKTRGRKLLRFNGPVPPP |
| DM649 | SEQ ID NO: 216 | GNWEIIDIGPFTQNLGKFAVDEANKIGQYGRLTFNKVIRPCMKKTIYENGEIKGYEYQLYVRA |
| | | STKIFRADIYEDYKTRGRKLLRFNGPVPPP |
| DM542 | SEQ ID NO: 217 | GNWEIIDIGPFTQNLGKFAVDEANKIGRYGRLTFNKVIRPCMKKTIYENGEIKGYEYQLYVRA |
| | | SNKIFRADIYEDYKTRGRKLLRFNGPVPPP |
| DM637 | SEQ ID NO: 218 | GNWEIIDIGPFTQNLGKFAVDEANKIGQYGRLRFTKVIRPCMKKTIYENGEIKGYEYQLYVRA |
| | | SDKIFRADIYEDYKTRGRKLLRFNGPVPPP |
| DM284 | SEQ ID NO: 219 | GEWEIIDIGPFTQNLGKFAVDEENKIGQYGRLTFNKVIRPAMKKTIYENEGFREIKGYEYQLY |
| | | VYASDKLFRADIWEDYKTRGRKLLRFNGPVPPP |
| DM248 | SEQ ID NO: 220 | GNWEIIDIGPFTQNLGKFAVDEANKIGQYGRLTFNKVIRPCMKKTIYENGEIKGYEYQLYVRA |
| | | SDKIFRVDIFEDYKTRGRKLLRFNGPVPPP |
| DM456 | SEQ ID NO: 221 | GNWEIIDIGPFTQNLGKFAVDEANKTGSYGRLTFNKVIRPCMKKTIYENGEIKGYEYQLYVRA |
| | | SDKIFRADIYEDYKTRGRKLLRFNGPVPPP |
| DM219 | SEQ ID NO: 222 | GEWEIIDIGPFTQNLGKFAVDEENKIGQYGRLTFNKVIRPCMKKTIYENEGFREIKGYEYQLY |
| | | VYASDKLFRFDIYEDYKTRGRKLLRMNGPVPPP |
| DM481 | SEQ ID NO: 223 | GNWEIIDIGPFTQNLGKFAVDEANRIGQYGRLTFNKVIRPTMKKTIYENGEIKGYEYQLYVRA |
| | | SDKIFRADIYEDYKTRGRKLLRFNGPVPPP |
| DM616 | SEQ ID NO: 224 | GNWEIIDIGPFTQNLGKFAIDEANKIGQYGRLRENKVIRPCMKKTIYENGEIKGYEYQLYVRA |
| | | SDKIFRADIYEDYKTRGRKLLRFNGPVPPP |
| DM305 | SEQ ID NO: 225 | GEWEIIDIGPFTQNLGKFAVDEENKIGQYGRLTFNKVIRPTMKKTIYENEGFREIKGYEYQLY |
| | | VYASDKLFRADIFEDYKTRGRKLLRFNGPVPPP |
| DM297 | SEQ ID NO: 226 | GEWEIIDIGPFTQNLGKFAVDEENKIGQYGRLTFNKVIRPTMKKTIYENEGFREIKGYEYQLY |
| | | VYASDKLFRADIYEDYKTRGRKLLRFNGPVPPP |
| DM285 | SEQ ID NO: 227 | GEWEIIDIGPFTQNLGKFAVDEENKIGQYGRLTFNKVIRPSMKKTIYENEGFREIKGYEYQLYV |
| | | YASDKLFRADIWEDYKTRGRKLLRFNGPVPPP |
| DM621 | SEQ ID NO: 228 | GNWEIIDIGPFTQNLGKFVVDEANKIGRYGRLTFNKVIRPCMKKTIYENGEIKGYEYQLYVRA |
| | | SDKIFRADIYEDYKTRGRKLLRFNGPVPPP |
| DM233 | SEQ ID NO: 229 | GEWEIIDIGPFTQNLGKFAVDEENKIGQYGRLTFNKVIRPCMKKTIYENEGFREIKGYEYQLY |
| | | VYASNKLFRADIFEDYKTRGRKLLRFNGPVPPP |
| DM251 | SEQ ID NO: 230 | GNWEIIDIGPFTQNLGKFAVDEANKIGQYGRLTFNKVIRPCMKKTIYENGEIKGYEYQLYVRA |
| | | SDKIFRADLFEDYKTRGRKLLRFNGPVPPP |
| DM479 | SEQ ID NO: 231 | GNWEIIDIGPFTQNLGKFAVDEANRIGQYGRLTFNKVIRPCMKKTIYENGEIKGYEYQLYVRA |
| | | SNKIFRADIYEDYKTRGRKLLRFNGPVPPP |
| DM66 | SEQ ID NO: 232 | GNWEIIDIGPFTQNLGKFAVDEANKIGRYGRLTFNKVIRPCMKKTIYENGEIKGYEYQLYVRA |
| | | SDKIFRADISEDYKTRGRKLLRFNGPVPPP |
| DM230 | SEQ ID NO: 233 | GNWEIIDIGPFTQNLGKFAVDEANKIGQYGRLTFNKVIRPCMKKTIYENGEIKGYEYQLYVRA |
| | | SNKIFRADIFEDYKTRGRKLLRFNGPVPPP |
| DM241 | SEQ ID NO: 234 | GNWEIIDIGPFTQNLGKFAVDEANKIGQYGRLTFNKVIRPCMKKTIYENGEIKGYEYQLYVRA |
| | | SNKIFRADIWEDYKTRGLKLLRFNGPVPPP |
| DM365 | SEQ ID NO: 235 | GEWQIIDIGPFTQNLGKFAVDEANKIGQYGRLTFNKVIRPCMKKTIYENGEIKGYEYQLYVYA |
| | | SDKLFRADIYEDYKTRGRKLLRFNGPVPPP |
| DM182 | SEQ ID NO: 236 | GEWEIIDIGPFTQNLGKFAVDEENRIGQYGRLTFNKVIRPCMKKTIYENEGFREIKGYEYQLY |
| | | VYASDKLFRADIFEDYKTRGRKLLRFNGPVPPP |
| DM656 | SEQ ID NO: 237 | GNWEIIDIGPFTQNLGKFAVDEANKIGQYGRLTFNKVIRPCMKKTIYENGEIKGYIYQLYVRA |
| | | SDKIFRADIIEDYKTRGRKLLRFNGPVPPP |
| DM486 | SEQ ID NO: 238 | GNWEIIDIGPFTQNLGKFAVDEANKTGKYGRLTFNKVIRPCMKKTIYENGEIKGYEYQLYVY |
| | | ASNKIFRADIYEDYKTRGRKLLRFNGPVPPP |
| DM642 | SEQ ID NO: 239 | GNWEIIDIGPFTQNLGKFAVDEANKIGQYGTLTFNKVIRPCMKKTIYENGEIKGYEYQLYVRA |
| | | STKIFRADIYEDYKTRGRKLLRFNGPVPPP |
| DM287 | SEQ ID NO: 240 | GNWEIIDIGPFTQNLGKFAVDEANKIGQYGRLTFNKVIRPTMKKTIYENGEIKGYEYQLYVRA |
| | | SDKIFRADIYEDYKTRGRKLLRFNGPVPPP |
| DM96 | SEQ ID NO: 241 | GNWEIIDIGPFTQNLGKFAIDEANKIGQYGRLTFNKVIRPCMKKTIYENGEIKGYEYQLYVRA |
| | | SDKIFRADISEDYKTRGRKLLRFNGPVPPP |
| DM600 | SEQ ID NO: 242 | GNWEIIDIGPFTQNLGKFAVDEANKIGQYGRLTFNKVIRPCMKKTIYENGEIKGYEYQLYVRA |
| | | SDKIFRADVYEDYKTRGRKLLRFNGPVPPP |
| DM659 | SEQ ID NO: 243 | GNWEIIDIGPFTQNLGKFAVDEANKIGQYGRLTFNKVIRPCMKKTIYENGEIKGYEYQLYVRA |
| | | SDKIFRADIHEDYKTRGRKLLRFNGPVPPP |
| DM332 | SEQ ID NO: 244 | MMWEIIDIGPFTQNLGKFAVDEENKIGQYGRLTFNKVIRPCMKKTIYENGEIKGYEYQLYVY |
| | | ASDKLFRADIYEDYKTRGRKLLRFNGPVPPP |
| DM199 | SEQ ID NO: 245 | GEWEIIDIGPFTQNLGKFAVDEENKWGEYGRLTFNKVIRPCMKKTIYENEGFREIKGYEYQLY |
| | | VYASDKLFRADIWEDYKTRGRKLLRFNGPVPPP |
| DM520 | SEQ ID NO: 246 | GNWEIIDIGPFTQNLGKFAVDEANKIGSYGRLTFNKVIRPCMKKTIYENGEIKGYEYQLYVRA |
| | | SDKIFRADIYEDYKTRGRKLLRFNGPVPPP |
| DM228 | SEQ ID NO: 247 | GNWEIIDIGPFTQNLGKFAVDEANKIGQYGRLRENKVIRPCMKKTIYENGEIKGYEYQLYVRA |
| | | SDKIFRADIFEDYKTRGRKLLRFNGPVPPP |
| DM265 | SEQ ID NO: 248 | GEWEIIDIGPFTQNLGKFAVDEENKIGQYGRLTFNKVIRPSMKKTIYENEGFREIKGYEYQLYV |
| | | YASDKLFRADIFEDYKTRGRKLLRFNGPVPPP |
| DM196 | SEQ ID NO: 249 | GEWEIIDIGPFTQNLGKFAVDEENKWGEYGRLTFNKVIRPCMKKTIYENEGFREIKGYEYQLY |
| | | VYASDKLFRADIFEDYKTRGRKLLRFNGPVPPP |
| DM266 | SEQ ID NO: 250 | GNWEIIDIGPFTQNLGKFVVDEANKIGQYGRLTFNKVIRPCMKKTIYENGEIKGYEYQLYVRA |
| | | SDKIFRADIWEDYKTRGRKLLRFNGPVPPP |
| DM610 | SEQ ID NO: 251 | GNWEIIDIGPFTQNLGKFVVDEANKIGKYGRLTFNKVIRPCMKKTIYENGEIKGYEYQLYVRA |
| | | SDKIFRADIYEDYKTRGRKLLRFNGPVPPP |
| DM298 | SEQ ID NO: 252 | GEWEIIDIGPFTQNLGKFAVDEENKIGQYGRLTFNKVIRPCMKKTIYENEGFREIKGYEYQLY |
| | | VYASDKLFRADIYEDYKTRGLKLLRFNGPVPPP |
| DM185 | SEQ ID NO: 253 | GEWEIIDIGPFTQNLGKFAVDEENKTGKYGRLTFNKVIRPCMKKTIYENEGFREIKGYEYQLY |
| | | VYASDKLFRADIFEDYKTRGRKLLRFNGPVPPP |
| DM307 | SEQ ID NO: 254 | GEWEIIDIGPFTQNLGKFAVDEENKIGQYGRLTFTKVIRPCMKKTIYENEGFREIKGYEYQLYV |
| | | YASDKLFRADIFEDYKTRGRKLLRFNGPVPPP |
| DM480 | SEQ ID NO: 255 | GNWEIIDIGPFTQNLGKFAVDEANRIGQYGRLTFNKVIRPCMKKTIYENGEIKGYEYQLYVYA |
| | | SNKIFRADIYEDYKTRGRKLLRFNGPVPPP |
| DM186 | SEQ ID NO: 256 | GEWEIIDIGPFTQNLGKFAVDEENKTGKYGRLTFNKVIRPCMKKTIYENEGFREIKGYEYQLY |
| | | VYASDKLFRADIWEDYKTRGRKLLRFNGPVPPP |
| DM604 | SEQ ID NO: 257 | GNWEIIDIGPFTQNLGKFAVDEANKIGQYGRLTFNKVIRPCMKKTIYENGEIKGYRYQLYVRA |
| | | SDKIFRADITEDYKTRGRKLLRFNGPVPPP |
| DM622 | SEQ ID NO: 258 | GNWEIIDIGPFTQNLGKFAVDEANKIGRYGRLRENKVIRPCMKKTIYENGEIKGYEYQLYVRA |
| | | SDKIFRADIYEDYKTRGRKLLRFNGPVPPP |
| DM255 | SEQ ID NO: 259 | GNWEIIDIGPFTQNLGKFAVDEANKIGQYGRLTFNKVIRPSMKKTIYENGEIKGYEYQLYVRA |
| | | SDKIFRADIFEDYKTRGRKLLRFNGPVPPP |
| DM231 | SEQ ID NO: 260 | GEWEIIDIGPFTQNLGKFAVDEENKIGQYGRLRFNKVIRPCMKKTIYENEGFREIKGYEYQLY |
| | | VYASDKLFRADIFEDYKTRGRKLLRFNGPVPPP |
| DM299 | SEQ ID NO: 261 | GEWEIIDIGPFTQNLGKFAVDEENKIGQYGRLTFTKVIRPCMKKTIYENEGFREIKGYEYQLYV |
| | | YASDKLFRADIYEDYKTRGRKLLRFNGPVPPP |
| DM657 | SEQ ID NO: 262 | GNWEIIDIGPFTQNLGKFAVDEANKIGQYGRLTFNKVIRPCMKKTIYENGEIKGYTYQLYVRA |
| | | SDKIFRADIIEDYKTRGRKLLRFNGPVPPP |
| DM180 | SEQ ID NO: 263 | GEWEIIDIGPFTQNLGKFAVDEENKTGKYGRLTFNKVIRPCMKKTIYENEGFREIKGYEYQLY |
| | | VYASDKLFRADIYEDYKTRGRKLLRFNGPVPPP |
| DM253 | SEQ ID NO: 264 | GNWEIIDIGPFTQNLGKFAVDEANKIGQYGRLTFNKVIRPCMKKTIYENGEIKGYEYQLYVRA |
| | | SDKIFRFDIFEDYKTRGRKLLRMNGPVPPP |
| DM291 | SEQ ID NO: 265 | GNWEIIDIGPFTQNLGKFAVDEANKIGQYGRLTFNKVIRPTMKKTIYENGEIKGYEYQLYVRA |
| | | SDKIFRADIWEDYKTRGRKLLRFNGPVPPP |
| DM643 | SEQ ID NO: 266 | GNWEIIDIGPFTQNLGKFAVDEANKIGQYGRLTFTKVIRPCMKKTIYENGEIKGYEYQLYVRA |
| | | STKIFRADIYEDYKTRGRKLLRFNGPVPPP |
| DM540 | SEQ ID NO: 267 | GNWEIIDIGPFTQNLGKFAVDEANKIGRYGRLTFNKVIRPCMKKTIYENGEIKGYEYQLYVRA |
| | | SNKIFRADISEDYKTRGRKLLRFNGPVPPP |
| DM216 | SEQ ID NO: 268 | GEWEIIDIGPFTQNLGKFAIDEENKIGQYGRLTFNKVIRPCMKKTIYENEGFREIKGYEYQLYV |
| | | YASDKLFRADIYEDYKTRGRKLLRFNGPVPPP |
| DM618 | SEQ ID NO: 269 | GNWEIIDIGPFTQNLGKFAVDEANRIGQYGRLRENKVIRPCMKKTIYENGEIKGYEYQLYVRA |
| | | SDKIFRADIYEDYKTRGRKLLRFNGPVPPP |
| DM69 | SEQ ID NO: 270 | GNWEIIDIGPFTQNLGKFAVDEANRIGKYGRLTFNKVIRPCMKKTIYENGEIKGYEYQLYVRA |
| | | SDKIFRADISEDYKTRGRKLLRFNGPVPPP |
| DM150 | SEQ ID NO: 271 | GNWEIIDIGPFTQNLGKFAVDEANKIGQYGRLTFNKVIRPAMKKTIYENGEIKGYEYQLYVRA |
| | | SDKIFRADISEDYKTRGRKLLRFNGPVPPP |
| DM158 | SEQ ID NO: 272 | GNWEIIDIGPFTQNLGKFAVDEANKTGKYGRLTFNKVIRPCMKKTIYENGEIKGYEYQLYVR |
| | | ASDKIFRADIYEDYKTRGRKLLRFNGPVPPP |
| DM521 | SEQ ID NO: 273 | GNWEIIDIGPFTQNLGKFAVDEANKIGRYGRLTFNKVIRPCMKKTIYENGEIKGYEYQLYVYA |
| | | SNKIFRADIYEDYKTRGRKLLRFNGPVPPP |
| DM608 | SEQ ID NO: 274 | GNWEIIDIGPFTQNLGKFAVDEANKIGRYGRLTFNKVIRPCMKKTIYENGEIKGYEYQLYVRA |
| | | STKIFRADIYEDYKTRGRKLLRFNGPVPPP |
| DM679 | SEQ ID NO: 275 | GNWEIIDIGPFTQNLGKFAIDEANKIGQYGRLTFNKVIRPCMKKTIYENGEIKGYEYQLYVRA |
| | | SNKIFRADIFEDYKTRGRKLLRFNGPVPPP |
| DM688 | SEQ ID NO: 276 | GNWEIIDIGPFTQNLGKFAVDEANKIGRYGRLTFNKVIRPTMKKTIYENGEIKGYEYQLYVRA |
| | | SDKIFRADIWEDYKTRGRKLLRFNGPVPPP |

In some embodiments, the modified protein comprising an amino acid sequence set forth in one or more of SEQ ID NO:5, SEQ ID NO:6, SEQ ID NO:7, SEQ ID NO:221, SEQ ID NO:108, SEQ ID NO:9, SEQ ID NO:102, SEQ ID NO:105, SEQ ID NO:52, SEQ ID NO:182, SEQ ID NO:10, SEQ ID NO:69, SEQ ID NO:157, SEQ ID NO:114, SEQ ID NO:174, SEQ ID NO:162, SEQ ID NO:231, SEQ ID NO:57, SEQ ID NO:192, SEQ ID NO:68, SEQ ID NO:106, SEQ ID NO:8, SEQ ID NO:79, SEQ ID NO:76, SEQ ID NO:22, SEQ ID NO:194, SEQ ID NO:262, SEQ ID NO:84, SEQ ID NO:239, SEQ ID NO:135, SEQ ID NO:211, SEQ ID NO:237, SEQ ID NO:198, SEQ ID NO:179, SEQ ID NO:172 or any combination thereof.

As described herein, the modified proteins have at least improved stability as compared to the reference protein.

In accordance with the present disclosure, the modified protein has at least one improved food-related property feature as compared to the reference protein.

The term food-related property as used herein encompasses a property that enable the fitness of the modified protein in food and beverage applications such as flavor, texture, taste, sweetness threshold, sweetness level, sweetness profile, sensory profile, sweetness kinetics, stability (structural and functional), heat resistance, fitness to food matrix, shelf-life, masking and/or enhancement of other flavor, off-taste, taste onset, lingering taste, roundness of taste or sugar-like taste.

In some embodiments, the at least one food-related property is sensory-affecting property. The term “sensory-affecting property” as used herein refers to a change in the sensory impression as determined, for example, by a sense of taste. The sensory-affecting property include for example sweetness profile such as sweetness potency (sugar-like flavor), sweetness kinetics (onset time, lingering time, taste duration), lack of off-taste, and masking or enhancing of other tastes, off-taste (e.g. metallic taste). For example, an improved property relates with increases sweetness, reduced onset time or reduced lingering taste.

In accordance with some embodiments wherein the at least one property is the sensory-affecting property, the modified protein may be considered as a sugar substitute. In some embodiments, the at least one food-related property is at least one of sweetness potency, reduced onset time or reduced lingering taste.

In some examples, the modified protein has an improved lingering. In some examples, the modified protein is DM114. In some examples, the modified protein is DM137. In some examples, the modified protein is DM157. In some examples, the modified protein is DM224. In some examples, the modified protein is DM157. In some examples, the modified protein is DM02.

In some examples, the modified protein is DM165.

As detailed above, the modified protein may be used in combination with at least one additional food ingredient. In some embodiments, the at least one food-related property may refer to a synergistic effect between the modified protein and at least one food ingredient. Non-limiting examples of a food ingredient include artificial or natural flavor, food additive, food coloring, preservative or an additional sugar additive. The food ingredient may have a masking taste effect or enhancing taste effect.

As described herein, the modified protein described herein has an improved food-related property. The protein's sweetness profile such as sweetness potency (sugar-like flavor), lack of off-taste, reduced onset time and reduced lingering taste of the modified protein may be determined by any known taste test that is known in the art.

For example, comparison to the sweetness of sucrose or other sweeteners can be made by a taste panel and the sweetness potency may be graded as detailed in the examples below.

The comparison may be by determine the threshold of the modified protein as compared to a known sweetener, such as sucrose, for example by determining the minimal concentration required to evoke the sensation of sweetness or the assessment of the sweetness profile including characteristics such as sweetness profile, sweetness onset time, lingering taste, mouthfeel, aftertaste, off-taste, and masking of unwanted tastes.

As used herein the term sweetening-affecting properties encompass a sweet sensation determined by at least one of a sweetness threshold of about 0.28 mg/L or higher, sweetness duration of about between 1 to 20 seconds, at times between 2 to 18 seconds, at times between 2-4 seconds.

The modified protein similar to the reference protein binds to the sweet receptor.

In some embodiments, the modified protein has perceived sweetness threshold that is 300-16,000 higher than sugar on a weight basis.

The sensory profile includes taste kinetics which is usually a gaussian showing taste intensity over time i.e. onset duration (time till feeling taste), taste duration and time of lingering taste (corresponding to the tail of the gaussian). Additional features include off-taste (e.g. due to binding to other receptors), roundness of the taste, metallic and other side-tastes, synergy with other ingredients (e.g. masking and enhancing other flavors or their unwanted tastes, such as stevia) and alike.

As described herein, the computational analysis was conducted in order to identify regions and/or amino acids residues on the basis of MNEI or MNEI based protein.

The modified proteins described herein can be designed by various methods.

In some embodiments, protein design is done using computational tools or by expert protein design and structural biology methods, e.g., site-directed mutagenesis, protein engineering, or directed evolution, as further described below. The inventors have developed computational methodologies based on sequence data, structural data, and/or evolutionary data of the reference flavor proteins and other proteins that have local or global similarities to the reference flavor protein in sequence and/or structural features. The computational methods developed and applied herein enabled the inventors to design proteins with specific amino acid substitutions that are energetically favorable and thus are predicted to have improved traits such as thermostability, halostability, pH-stability, shelf-life, folding, and solubility features. Specifically, Computational Protein Design (CPD) was applied to specific sites or regions within the reference protein structure and/or sequence that are not necessary for functional binding to the receptor. In addition, CPD allowed the inventors to limit the substitutions to a predefined set of amino acids that fit the required improved features. The predefined set of amino acids is both in the input data, i.e., the regions of the protein subjected to CPD, and in the output data, i.e., the location and types of amino acids present in the resulting modified protein.

For example, by using CPD it is possible to replace “non-ideal” amino acids (such as hydrophilic amino acids within a hydrophobic core or hydrophobic amino acids on the external surface region) with “ideal” amino acids (such as hydrophilic amino acids in the external surface region and hydrophobic amino acids within a hydrophobic core).

Without being bound by theory, the inventors suggest that substituting hydrophobic amino acids with hydrophilic amino acids on the external surface region will reduce non-specific binding to the oral cavity and reduce the lingering aftertaste.

The methodologies developed herein comprise searching for “stabilizing substitutions,” e.g., amino acid substitutions that will decrease the protein structure's overall energy. The overall energy may be calculated by applying known algorithms in the art. Non-limiting examples of such algorithms include Rosetta, OSPREY (M. Hallen, J. Martin, et al., Journal of Computational Chemistry 2018; 39(30): 2494-2507), or EnCoM (Frappier V, Chartier M, Najmanovich R J. Nucleic Acids Res. 2015; 43(W1): W395-400). These CPD methods undergo focusing and filtering by an array of orthogonal methods such as evolutionary sequence and structural consensus, regular and high-temperature molecular dynamics (MD) and other dynamic simulations, correlated mutational analysis (CMA), surface electrostatics analysis, visual inspection, as well as analysis of cavities, hydrophobic patches, unsatisfied hydrogen bonds and alike.

The amino acid substitutions are based on the following considerations: (a) surface electrostatic potential and (lack of) hydrophobic patches on the surface, (b) retention of the protein's isoelectric point (pI) in a specific range, (c) analysis of the intra-protein cavities, (d) dynamic stability including correlated mutational analysis, normal mode analysis, and root mean square fluctuations (RMSF) in high-temperature or room temperature dynamics, (e) entropic and/or enthalpic components of the substitution energetics, (f) visualization of the specific substitution, (g) types of amino-acids permitted in the family of related proteins; as reflected by an evolutionary conservation analysis of a curated multiple sequence alignment (MSA), and (h) frequency of the substitution as reflected in low-pseudo-energy CPD calculations.

The computational methodologies include one or more of the following steps:
(1) Multiple Sequence Alignment (MSA) or Multiple Structural Alignment. In this step, DNA sequences and/or protein sequences with similarity to the target reference protein or fragments thereof are queried in public databases. Based on the obtained results, a multiple-sequence alignment (MSA) or multiple structural alignment is constructed and the conservation rate is calculated. According to MSA results, a decision regarding the level of CPD to be conducted is made. In non-conserved positions, all amino acids (with or without Cysteine) are allowed in CPD, whereas for more conserved positions, the CPD is limited to residues with similar properties (charge, size, internal dynamics, etc.). This step involves limiting the substitutions in each position based on biophysical knowledge and conservation data. The MSA may yield a Position Specific Substitution Matrix (PSSM) in which each location along the sequence is described in a way correlated with the relative abundance of each amino acid possibly taking into account a potential probability of substitution or of deletion or insertion of amino acids.
(2) Protein function analysis and analysis of structure-function-dynamics relationships. In this step, a database of substitutions with known impact (such as on activity, structure, binding, etc.) is constructed using prior knowledge. Substitutions and substitution-adjacent positions (e.g., a distance of 0.5-1 nm), known, based on prior knowledge, to disturb protein stability and/or function are limited during CPD and are not substituted.
(3) CPD. This step is partially done by designated software such as ROSETTA, OSPREY, SCWRL, PyMol, AlphaFold and alike. Before deterministic CPD is conducted, the reference protein 3D structure/model is energy minimized. The CPD may include site-directed amino-acid replacement where one amino-acid is replaced by another or replacement of protein regions by other amino-acid sequences such resulting in a protein with the different length. The latter can be done by rebuilding regions such as loop by ab initio methods or by taking regions from other proteins, a method that may be referred to as ‘grafting’. For each reference protein, multiple models are considered.

Another consideration in CPD is retaining the functional plasticity required for binding to the receptor while increasing the thermal stability, which intrinsically is often associated with protein rigidification. The protein must undergo some conformational changes (also known as ‘functional plasticity’) in order to activate the receptor. The inventors thus focused on regions which can be rigidified while conserving regions where functional plasticity must be retained.

The term “amino acid sequence” and/or “polypeptide chain” are used to described a protein having an amino acid sequence or poly peptide chain. As such, the term “reference protein” is equivalent to the term “reference amino acid sequence” and the term “modified protein” is equivalent to the term “modified amino acid sequence”. It should be noted that the terms “amino acid sequence” and/or “polypeptide chain” encompass sequences having a 3D structure as well as sequences with no 3D structure.

The Amino acids may be referred to herein by either their commonly known three letter symbols or by the one-letter symbols recommended by the IUPAC-IUB Biochemical Nomenclature Commission. Amino acid substitution (replacement) as used herein refers to a change from one amino acid to a different amino acid. This typically being due to point mutation in DNA sequence caused by nonsynonymous missense mutation which alters the codon sequence to code other amino acid instead of the references. An amino acid replacement may have an effect on function or structure of protein and this generally depends on how similar or dissimilar the replaced amino acids are, as well as on their position in the sequence or the structure. For example, the amino acid substitutions may be made on the basis of similarity in polarity, charge, solubility, hydrophobicity, hydrophilicity, bulkiness (or flexibility), beta-branching, aromaticity, ability to confer specific bonding interactions (hydrogen bonds, salt bridges, polar and non-polar interactions), pK, ability to bind sugars and other post-translational modifications and/or the amphipathic nature of the residues involved.

In some embodiments, the amino acid substitutions may be conservative replacement. Such a replacement encompasses a change in an amino acid into another amino acid exhibiting similar properties. Conservative amino acid replacements (also denoted as conservative amino acid “substitutions” or conservative amino acid mutations) is an amino acid replacement in a protein that changes a given amino acid to a different amino acid with similar biochemical, structural and/or chemical properties.

For example, amino acids may be sorted into six main classes on the basis of their structure and the general chemical characteristics of their side chains (R groups).
Aliphatic: Isoleucine (I), Leucine (L), Glycine (G), Alanine (A), Valine (V);
Hydroxyl or sulfur/selenium-containing: Serine (S), Cysteine (C), Threonine (T), Methionine (M);
Cyclic: Proline (P)
Aromatic: Phenylalanine (F), Tyrosine (Y), Tryptophan (W)
Basic: Histidine (H), Lysine (K), Arginine (R)
Acidic and their amides: Aspartate (D), Glutamate (E), Asparagine (N), Glutamine (Q).

In addition, each of the following groups contains other exemplary amino acids that are conservative substitutions for one another:
1) Very small: Alanine (A), Glycine (G);
2) Negative charge: Aspartic acid (D), Glutamic acid (E);
3) Polar (amidated carboxyl side chain): Asparagine (N), Glutamine (Q);
4) Positively charged: Arginine (R), Lysine (K);
6) Aromatic: Phenylalanine (F), Tyrosine (Y), Tryptophan (W), and occasionally also Histidine (H);
7) Small polar: Serine (S), Threonine (T);
8) Sulfur-containing: Cysteine (C), Methionine (M)
9) Small: Ala (A), Glycine (G), Serine (S).
10) Beta-branched: Valine (V), Isoleucine (I) and occasionally also Threonine (T);
11) Polar: Asparagine (N), Glutamine (Q), Serine (S), Threonine (T);

Nevertheless, there are numerous clustering of amino-acids yielding numerous amino acids indexes with each highlighting a different aspect of the amino acid characteristics—e.g. see hundreds of such indexes in the aa index database https://www.genome.jp/aaindex/ Consequently, some of the conservative replacements may actually represent other features which are important for the fitness of the protein to industrial use in the food and beverage industry, e.g. non-specific binding to the tongue or other sensory profile aspects.

In addition, an additional conservation analysis is based on the following,
nonpolar “hydrophobic” amino acids are selected from the group consisting of Valine (V), Isoleucine (I), Leucine (L), Methionine (M), Phenylalanine (F), Tryptophan (W), Cysteine (C), Alanine (A), Tyrosine (Y), Histidine (H), Threonine (T), Serine (S), Proline (P), Glycine (G), Arginine (R) and Lysine (K);
“polar” amino acids are selected from the group consisting of Arginine (R), Lysine (K), Aspartic acid (D), Glutamic acid (E), Asparagine (N), Glutamine (Q);
“positively charged” amino acids are selected form the group consisting of Arginine (R), Lysine (K) and Histidine (H) and
“acidic” amino acids are selected from the group consisting of Aspartic acid (D), Asparagine (N), Glutamic acid (E) and Glutamine (Q).

In some embodiments, the replacement is a radical replacement. A radical replacement (substitution) is an exchange of an amino acid into another amino acid with different properties.

The degree of sequence similarity and/or sequence identity between the reference protein and the modified protein may generally affect the properties of the modified proteins. For example, a large number of substitutions may affect the binding kinetics, folding kinetics, solubility, thermostability, halostability, pH stability, shelf-life, binding to non-aqueous particles (e.g. protein or fat in food matrix or hydrophobic regions in the oral cavity), 3D structure as well as its activity and related properties. The computational methods developed and applied herein, provide a thorough understanding on putative amino acids residues for substitution that will result in improved modified proteins.

The modified protein can be used as a flavor modifying agent or a flavor enhancing agent.

The protein described herein is for use as an oral product. In some embodiments, the product is a food product, a food supplementary product or a medicament. For the preparation of a product, the proteins described herein may be combined with any food grade additive. The food product may be provided and in used in any solid dry form, including, without being limited thereto, fine powder, lyophilizate, granulate, tablets, etc. In some embodiments, the composition is provided in liquid form, for example, as a solute in water (aqueous solution).

The product comprising the proteins may have various applications. This include, without being limited thereto (each of the following constituting a separate embodiment of the present disclosure), utilization as a sweetener, flavor, enhancer or masker in the food and beverages industry (soft drinks, ready-to-drink beverages, syrups, functional drinks, sports drinks etc.), in the dairy industry, i.e., dairy products, yoghurts and puddings, in the pharmaceutical industry, in the naturopathic industry, nutraceutical industry and other healthcare products (e.g. toothpaste, mouthwash); candy and gum industry, or any other application that requires the use of a flavor modifying composition as an excipient or additive.

The product may comprises additional food ingredients. In some embodiments, the food ingredient is a sweetener, for example stevia. As shown in the Examples below, combination of the modified protein described herein and stevia produced a synergetic effect. Thus, in some embodiments, the product comprises at least one modified protein as described herein and stevia.

It should be noted that the modified proteins according to the invention can be produced by any method known in the art, for example the protein can be produced synthetically, by recombinant DNA technology or by protein production in microorganisms via fermenters or in plants or in plant callus or other bioreactors. In some embodiments, the modified proteins may be produced in bacteria, such as E. coli. In some other embodiments, the modified proteins may be produced yeast, such as Saccharomyces cerevisiae or Pichia pastoris. In some embodiments, the DNA sequence of the chosen amino acid sequence is optimized in the RNA and DNA levels. In the RNA level this includes minimization of RNA secondary structures to ensure quick insertion into the ribosome. In the DNA level this includes codon optimization to the host organism (taking into account the RNA-level optimization). The codon-usage optimization provides preference for using the most abundant tRNA in the host organism for each amino acid expressed.

The term “about” as used herein indicates values that may deviate up to 1%, more specifically 5%, more specifically 10%, more specifically 15%, and in some cases up to 20% higher or lower than the value referred to, the deviation range including integer values, and, if applicable, non-integer values as well, constituting a continuous range. In some embodiments, the term “about” refers to ±10%.

As noted herein, the modified protein has at least improved stability as compared to a reference protein. The term “improved” as used herein in connection with stability or any other feature of the modified protein refers to an increase or elevation of the stability of between about 1% to 100%, specifically, 5% to 100% of the indicated parameter, more specifically, about 1% to about 5%, about 5% to 10%, about 10% to 15%, about 15% to 20%, about 20% to 25%, about 25% to 30%, about 30% to 35%, about 35% to 40%, about 40% to 45%, about 45% to 50%, about 50% to 55%, about 55% to 60%, about 60% to 65%, about 65% to 70%, about 75% to 80%, about 80% to 85% about 85% to 90%, about 90% to 95%, about 95% to 99%, or about 99% to 99.9%, 100% or more as compared to the stability of the reference protein.

All scientific and technical terms used herein have meanings commonly used in the art unless otherwise specified. The definitions provided herein are to facilitate understanding of certain terms used frequently herein and are not meant to limit the scope of the present disclosure.

The term “about” as used herein indicates values that may deviate up to 1%, more specifically 5%, more specifically 10%, more specifically 15%, and in some cases up to 20% higher or lower than the value referred to, the deviation range including integer values, and, if applicable, non-integer values as well, constituting a continuous range. Thus, as used herein the term “about” refers to ±10%.

It should be noted that various embodiments of this invention may be presented in a range format. The description of a range should be considered to have specifically disclosed all the possible sub ranges as well as individual numerical values within that range. For example, description of a range such as from 1 to 6 or between 1 and 6 should be considered to have specifically disclosed sub ranges such as from 1 to 3, from 1 to 4, from 1 to 5, from 2 to 4, from 2 to 6, from 3 to 6 etc., as well as individual numbers within that range, for example, 1, 2, 3, 4, 5, and 6.

As used herein, the forms “a”, “an” and “the” include singular as well as plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments unless the embodiment is inoperative without those elements.

It should be noted that the various embodiments and examples detailed herein in connection with various aspects of the invention may be applicable to one or more aspects disclosed herein. It should be further noted that any embodiment described herein, for example, related to method, may be applied separately or in various combinations. Various embodiments and aspects of the present invention as delineated hereinabove and as claimed in the claims section below find experimental support in the following examples. The phrases “in another embodiment” or any reference made to embodiment as used herein do not necessarily refer to different embodiment, although it may. Thus, various embodiments of the invention can be combined (from the same or from different aspects) without departing from the scope of the invention.

Various embodiments and aspects of the present invention as delineated herein above and as claimed in the claims section below find experimental support in the following examples.

Disclosed and described, it is to be understood that this invention is not limited to the particular examples, methods steps, and reactors disclosed herein as such methods steps and reactors may vary somewhat. It is also to be understood that the terminology used herein is used for the purpose of describing particular embodiments only and not intended to be limiting since the scope of the present invention will be limited only by the appended claims and equivalents thereof.

The following examples are representative of techniques employed by the inventors in carrying out aspects of the present invention. It should be appreciated that while these techniques are exemplary of preferred embodiments for the practice of the invention, those of skill in the art, in light of the present disclosure, will recognize that numerous modifications can be made without departing from the spirit and intended scope of the invention.

### NON-LIMITING EXAMPLES

### Example 1: Design of MNEI Based Proteins

Design of MNEI-based proteins was conducted as follows: Single-chain monellin, MNEI (SEQ ID NO:1), is a polypeptide composed of 96 amino acids, with a molecular weight of ˜11 kD and pI˜8.7.

### Methods:

### ANM (Anisotropic Network Model)

ANM is a computational method used to study the dynamics and motions of proteins. It assumes that proteins can be approximated as a network of interacting atoms or residues.

The ANM considers the interactions between neighboring atoms in a protein and calculates the force constants between them. By representing the protein as a network of nodes (representing atoms) connected by edges (representing interactions), ANM analyzes the vibrational modes and collective motions of the protein structure.

This analysis represents the structure as a network of nodes and springs. ANM dynamics is exclusively based on inter-residue contact topology represented by an N×N harmonic potentials of uniform force constant γ, for all interacting residues matrix, the 3N×3N Hessian H of second derivatives of the potential, for N nodes/residues. Mode spectra of N−1 (or 3N−6) non-zero modes are obtained upon eigenvalue decomposition of H. Modes are rank-ordered by increasing frequency such that mode 1 is the slowest and softest (most easily accessible) mode. Soft modes are highly cooperative. Pseudoinverse of H scales with the cross-correlations between residue fluctuations, organized in N×N (or 3N×3N) covariance matrix (Hongchun Li et al., 2017, Nucleic Acids Research 45(W1), W374-W380).

### Molecular Dynamics

Molecular dynamics (MD) systems setup and simulation. For all simulated proteins residue protonation states were set as appropriate at pH 7.0 using PROPKA (Olsson et al., 2011, Journal of Chemical Theory and Computation, 7(22), 525-537) version 3.4. All systems were placed in a dodecahedron box with TIP4P water (Jorgensen et al., 1983, Chem. Phys., 79, 926-935), of which the minimal distance from the protein to the box wall was 1.5 nm. Each system was neutralized by randomly placed sodium or chloride counter-ions with a concentration of 150 mM NaCl. MD simulations were performed using the GROMACS software (Abraham et al., 2015, SoftwareX, 1-2, 19-25) version 2022.1. Systems were parameterized using the Amber99SB all-atom force field (Hornak et al., 2006, Proteins, 65, 712-725).

Systems were relaxed with 50000 steps of steepest descent energy minimization, followed by equilibration using the NVT ensemble. In equilibration, atoms' initial velocities were randomly distributed according to a Maxwell-Boltzmann distribution at 300 K. Harmonic positional restraints of 1000 kJ mol⁻¹ nm⁻² were applied to protein atoms and temperature was steadily increased to 300 K over the course of 1000 ps, and then increased to 433K for 1000 more ps, using V-rescale (modified Berendsen thermostat). Pressure was then equilibrated to 1 atm with Parrinello-Rahman method (Parrinello and Rahman, 1981, J. Appl. Phys., 52, 7182-7190) and restraints were removed steadily over 5 steps of 1000 ps each. Production simulations were performed in the NPT ensemble without positional restraints, using an integration time-step of 2 fs, and saving snapshots every 10 ps for analysis. Independent replicates of each system were conducted for 50 ns each. MD simulations were performed with periodic boundary conditions, with long-range interactions computed using PME (T. Darden, D. York, L. Pedersen, Particle mesh Ewald: An N·log(N) method for Ewald sums in large systems. J. Chem. Phys. 98, 10089-10092 (1993)), using a 1.5 nm radius cutoff.

### MD Analyses Included the Following Components:

Average Native Contacts were calculated using Best-Hummer fraction of native contacts function (Best et al., 2013, PNAS, 110(44), 17874-17879) as implemented in MDTraj version 1.9.6 (McGibbon et al., 2015, Biophys J., 109(8), 1528-32). A native contact is a contact between two amino acids that are not neighboring in the amino acid sequence but are spatially close in the protein's native state tertiary structure. These contacts are used in molecular dynamics to measure deviation. A Beta constant of 50 1/nm, a Lambda constant of 1.8, and a native contact cutoff of 0.45 nm were used. The fraction of native contacts was averaged over the simulation time course. More contacts between heavy atoms of the protein means higher stability during simulations.
1. Average Helix H-bonds during simulation were calculated using GROMACS hbond utility using intra-main-chain hydrogen bonds, in order to detect secondary structure unfolding. The helix residues are defined as residues 10-26.
2. Average Beta-Sheet H-bonds during simulation were calculated using GROMACS hbond utility using intra-main-chain hydrogen bonds. Beta-sheet residues are defined as residues 2-6, 35-37, 42-48, 54-66, 69-78, 82-90 numbered according to the sequence and structure of MNEI (2O9U).
3. Water-beta-sheet backbone Hbonds—measures the average number of water molecules around the beta sheet of the protein, that are stable enough to be able to connect the protein's backbone in segments with beta-strand secondary structure.
4. Fraction of canonical helix—this is the fraction of H-bonds in the helix that are of type i:i+4. There are three types of helical H-bonds: i:i+3, i:i+4 and i:i+5, indicating a 3-10 helix, alpha-helix and pi-helix, respectively. The alpha-helix with i:i+4 bonds is the most canonical. This value indicates that alpha-helix is maintained during simulation. The higher the fraction of canonical H-bonds the more stable the helix is expected to be.
5. Sum RMSD (root mean square deviations)—averages of RMSD of proteins' C-alpha atoms in the helix region (residues 10-26), loops (residues 38-42, 49-53, 67-68, 79-81, 7-9, 27-34), C-terminus of the protein (residues 90-96) and beta-sheet (residues 2-6, 35-37, 42-48, 54-66, 69-78, 82-90) were calculated using GROMACS rms utility. Averages were then summed to produce a single measure. The residues are numbered according to the sequence and structure of MNEI (SEQ ID NO:8, PDB ID: 2O9U).
6. RMSF (root mean square fluctuations) of proteins' backbone atoms throughout the MD simulations. These were calculated using GROMACS rmsf utility and averaged for each residue.'
7. RMSF AUC (Area Under Curve) differences (AAUC) were calculated using the average RMSF of three MD simulation repeats for each DM, as AAUC=(AUC(variant)−AUC(reference), where the reference is DM31 or MNEI).

Molecular Graphics: Structural analyses, measurements, figures and movie clips were performed with either VMD (Humphrey, W., Dalke, A. and Schulten, K, VMD—Visual Molecular Dynamics, J. Molec. Graphics 1996, 14.1, 33-38.) version 1.9.4. Figures and movies were rendered using VMD or PyMol (The PyMOL Molecular Graphics System, Version 2.5.2, Schrödinger, LLC.).

### Structure Prediction and Energy Calculations

New variants of MNEI were modeled by using the template of DM31 and/or MNEI crystal structures (DM31 as determined by the Weizmann institute crystallization unit, MNEI based on a structure from the Protein Data Bank (PDB), ID 2O9U). The resulting structures were submitted to the Rosetta software, for further energy minimization and calculation of energy scores, using Rosetta 3.8 (Schueler-Furman et al., 2005, Science, 310, 638-642; Baker, 2006, Philos Trans R Soc Lond B Biol Sci., 361, 459-63; Kaufmann et al., 2010, Biochemistry, 49, 2987-2998). The minimization and scoring were performed using Rosetta's FastRelax protocol and the REF2015 energy function (Park et al., 2016, J Chem Theory Comput, 12, 6201-6212). For each input sequence, the protocol was repeated for at least 30K times, thus obtaining multiple structures along with their Rosetta Energy Function (REU) scores. For each variant, the 30K scores were sorted, and the 500 lowest scoring structures were used for further examination and analyses. For MNEI and DM31, the input structures were the corresponding crystal structures (2O9U for MNEI), and the protocol was repeated 100K times. Table 2 presents new variants selected for expression in the lab, along with their corresponding Rosetta Energy Units (REU) scores. For some analyses, the lowest energy structure for each new variant was used.

### Additional Protein Features

Visualization and analysis of hydrogen bonds was done with PyMol. In addition, we examined hydrogen bonds using the Baker-Hubbard method (Baker and Hubbard, 1984, Progress in Biophysics and Molecular Biology, 44.2, 97-179), as implemented in the MDTraj Python package (McGibbon et al., 2015, Biophys J., 109(8), 1528-1532) version 1.9.6. An additional measure of hydrophobicity was used—SAP (Spatial Aggregation Propensity) score (Lauer et al., 2012, J Pharm Sci, 101(1), 102-115), calculated using Rosetta. This score measures local hydrophobicity of surface patches. Such surface regions can potentially form hydrophobic interactions with other patches on other proteins—thus increasing the risk of aggregation.

An additional measure was used for estimating protein structure packing—VoroMQA (Olechnovič & Venclovas, 2017, Proteins, 85, 1131-1145. This method combines statistical potentials with the use of interatomic contact areas instead of distances. Contact areas, derived using Voronoi tessellation of protein structure, are used to describe and integrate both explicit interactions between protein atoms and implicit interactions of protein atoms with solvent. VoroMQA produces scores at atomic, residue, and global levels, all in the fixed range from 0 to 1.

### Results

Table 1 presented above presents examples of proteins that were designed using the methods described herein. Table 1 also includes sequence of MNEI (know protein).

Table 2 presents the calculated Rosetta Energy Unit (REU) scores for MNEI, variants y. For both the minimization and calculation, Rosetta's REF2015 energy function was used. The table also presents the SAP score, referring to hydrophobicity and indicating aggregation propensity.

Average RMSD was calculated using protein's backbone atoms. Average H-bonds in the helix and beta-sheet mainchain were calculated in GROMACS (see Molecular dynamics, under Methods), colored by green-yellow-red gradient (green marks higher number of H-bonds). Average RMSD of specific secondary structure elements (helix, La2 and L23) were calculated using protein's C-alpha atoms, and colored by green-yellow-red gradient (green indicates lower RMSD).

TABLE 2
Molecular Dynamics (MD) simulations' results.

| | | | | | | Fraction | water- | | | |
|---|---|---|---|---|---|---|---|---|---|---|
| | Amino acid modifications | average | average | average | sum | of | beta sheet | | Rosetta | |
| | as compared to MNEI | native | Hbonds | Hbonds | RMSD | Canonical | backbone | | score | Tm_model |
| DM# | (SEQ ID NO: 1) | contacts | helix | beta | (new) | Helix | Hbonds | RMSF_AUC | (REU) | predictions |
| DM635 | ΔE50, ΔF52, ΔR53, E2N, | 923.29 | 9.19 | 28.53 | 0.47 | 0.79 | 25.17 | 2.51 | −328.23 | 105.70 |
| | E23A, Y65R, L70I, V20I, | | | | | | | | | |
| | R84L, S76Y | | | | | | | | | |
| DM644 | ΔE50, ΔF52, ΔR53, | 1003.731 | 9.331293 | 28.14 | 0.47 | 0.79 | 25.28 | | −320.92 | 105.43 |
| | E2N, E23A, Y65R, L70I, | | | | | | | | | |
| | D68T, R84L, S76Y | | | | | | | | | |
| DM242 | ΔE50, ΔF52, ΔR53, | 993.39 | 9.27 | 28.21 | 0.57 | 0.81 | 25.23 | 3.18 | −328.24 | 105.06 |
| | E2N, E23A, Y65R, L70I, | | | | | | | | | |
| | D68N, R84L, S76F | | | | | | | | | |
| DM632 | ΔE50, ΔF52, ΔR53, | 976.2554 | 9.224036 | 28.46 | 0.47 | 0.79 | 25.06 | | −326.22 | 104.55 |
| | E2N, E23A, Y65R, L70I, | | | | | | | | | |
| | Q28K, R84L, S76Y | | | | | | | | | |
| DM90 | ΔE50, ΔE52, ΔP53, | 1066.45 | 9.09 | 28.38 | 0.49 | 0.79 | 25.02 | −1.15 | −329.00 | 104.40 |
| | E2N, E23A, Y65R, L70I, | | | | | | | | | |
| | S76Y, R84L | | | | | | | | | |
| DM240 | ΔE50, ΔF52, ΔR53, | 1042.05 | 9.17 | 28.13 | 0.48 | 0.78 | 25.37 | −0.03 | −328.51 | 104.03 |
| | E2N, E23A, Y65R, L70I, | | | | | | | | | |
| | D68N, R84L, S76Y | | | | | | | | | |
| DM641 | ΔE50, ΔF52, ΔR53, | 935.7874 | 9.239135 | 28.41 | 0.53 | 0.79 | 25.07 | −1.22 | −326.2 | 103.84 |
| | E2N, E23A, Y65R, L70I, | | | | | | | | | |
| | Q28R, R84L, S76Y | | | | | | | | | |
| DM162 | ΔE50, ΔF52, ΔR53, | 1019.64 | 9.48 | 28.20 | 0.47 | 0.78 | 24.79 | 0.29 | −320.86 | 102.08 |
| | E2N, E23A, Y65R, L70I, | | | | | | | | | |
| | S76W, K25R | | | | | | | | | |
| DM630 | ΔE50, ΔF52, ΔR53, | 1036.32 | 9.33 | 28.57 | 0.42 | 0.82 | 24.73 | 1.41 | −326.46 | 101.90 |
| | E2N, E23A, Y65R, L70I, | | | | | | | | | |
| | Q28K, R31T, S76Y | | | | | | | | | |
| DM70 | ΔE50, ΔE52, ΔP53, | 966.97 | 9.26 | 28.22 | 0.46 | 0.80 | 26.11 | −0.91 | −325.41 | 101.85 |
| | E2N, E23A, Y65R, L70I, | | | | | | | | | |
| | R84L | | | | | | | | | |
| DM657 | ΔE50, ΔE52, ΔP53, | 967.90 | 9.39 | 28.29 | 0.41 | 0.81 | 25.18 | −1.33 | −321.69 | 101.84 |
| | E2N, E23A, Y65R, L70I, | | | | | | | | | |
| | E59T, S76I | | | | | | | | | |
| DM655 | ΔE50, ΔF52, ΔR53, | 946.76 | 9.36 | 28.53 | 0.49 | 0.82 | 24.80 | 2.54 | −323.78 | 101.81 |
| | E2N, E23A, Y65R, L70I, | | | | | | | | | |
| | E59V, S76I | | | | | | | | | |
| DM642 | ΔE50, ΔF52, ΔR53, | 1047.06 | 9.22 | 28.27 | 0.48 | 0.81 | 24.73 | −0.74 | −319.54 | 101.71 |
| | E2N, E23A, Y65R, L70I, | | | | | | | | | |
| | D68T, R31T, S76Y | | | | | | | | | |
| DM633 | ΔE50, ΔF52, ΔR53, | 1006.41 | 9.03 | 28.33 | 0.52 | 0.80 | 24.80 | 1.51 | −327.68 | 101.68 |
| | E2N, E23A, Y65R, L70I, | | | | | | | | | |
| | V20I, R31T, S76Y | | | | | | | | | |
| DM595 | ΔE50, ΔE52, ΔP53, | 976.73 | 9.44 | 28.49 | 0.44 | 0.81 | 24.64 | 1.32 | −324.53 | 101.52 |
| | E2N, E23A, Y65R, L70I, | | | | | | | | | |
| | I75V, S76Y, E77V | | | | | | | | | |
| DM656 | ΔE50, ΔE52, ΔP53, | 1016.04 | 9.33 | 28.44 | 0.45 | 0.81 | 25.03 | −1.44 | −324.03 | 101.28 |
| | E2N, E23A, Y65R, L70I, | | | | | | | | | |
| | E59I, S76I | | | | | | | | | |
| DM638 | ΔE50, ΔF52, ΔR53, | 909.9091 | 9.145481 | 28.15 | 0.54 | 0.79 | 25.47 | −0.16 | −327.2 | 101.21 |
| | E2N, E23A, Y65R, L70I, | | | | | | | | | |
| | T33R, R84L, S76Y | | | | | | | | | |
| DM335 | ΔE50, ΔE52, ΔP53, | 1070.05 | 9.40 | 28.63 | 0.41 | 0.81 | 25.27 | 3.42 | −326.67 | 101.12 |
| | E23A, Q28K, S76Y, | | | | | | | | | |
| DM286 | ΔE50, ΔF52, ΔR53, | 971.40 | 9.14 | 28.43 | 0.50 | 0.80 | 24.65 | −0.85 | −328.38 | 101.10 |
| | E2N, E23A, Y65R, L70I, | | | | | | | | | |
| | R31T, S76Y | | | | | | | | | |
| DM654 | ΔE50, ΔF52, ΔR53, | 960.60 | 9.36 | 27.93 | 0.54 | 0.81 | 25.67 | 0.40 | −321.54 | 100.98 |
| | E2N, E23A, Y65R, L70I, | | | | | | | | | |
| | E59T, S76V | | | | | | | | | |
| DM626 | ΔE50, ΔF52, ΔR53, E2N, | 907.95 | 8.35 | 27.68 | 0.58 | 0.73 | 26.22 | 2.69 | −325.27 | 100.83 |
| | E23A, Y65R, L70I, | | | | | | | | | |
| | A19V, R84L, S76Y | | | | | | | | | |
| DM137 | ΔE50, ΔF52, ΔR53, E2N, | 1058.72 | 9.20 | 28.23 | 0.47 | 0.80 | 24.61 | −1.10 | −323.95 | 100.77 |
| | E23A, Y65R, L70I, S76W | | | | | | | | | |
| DM652 | ΔE50, ΔF52, ΔR53, E2N, | 1045.62 | 9.24 | 27.96 | 0.45 | 0.81 | 25.48 | 0.41 | −323.10 | 100.71 |
| | E23A, Y65R, L70I, | | | | | | | | | |
| | E59V, S76V | | | | | | | | | |
| DM627 | ΔE50, ΔF52, ΔR53, E2N, | 922.59 | 9.30 | 27.80 | 0.48 | 0.80 | 25.21 | 2.76 | −326.10 | 100.65 |
| | E23A, Y65R, L70I, | | | | | | | | | |
| | D68N, R31T, S76Y | | | | | | | | | |
| DM171 | ΔE50, ΔF52, ΔR53, | 1054.63 | 9.23 | 27.83 | 0.46 | 0.80 | 25.20 | −0.45 | −326.71 | 100.46 |
| | E2N, E23A, Y65R, | | | | | | | | | |
| | L70I, Q28R, R31T, S76Y | | | | | | | | | |
| DM594 | ΔE50, ΔE52, ΔR53, | 1076.38 | 9.22 | 28.26 | 0.53 | 0.80 | 25.05 | 1.30 | −325.75 | 100.39 |
| | E2N, E23A, Y65R, L70I, | | | | | | | | | |
| | S76Y, E77V | | | | | | | | | |
| DM653 | ΔE50, ΔF52, ΔR53, | 1015.73 | 9.24 | 28.25 | 0.46 | 0.81 | 25.06 | −1.78 | −323.76 | 100.36 |
| | E2N, E23A, Y65R, L70I, | | | | | | | | | |
| | E59I, S76V | | | | | | | | | |
| DM160 | ΔE50, ΔF52, ΔP53, | 958.09 | 9.42 | 28.42 | 0.44 | 0.78 | 24.78 | −1.09 | −324.54 | 100.34 |
| | E2N, E23A, Y65R, L70I, | | | | | | | | | |
| | S76F, K25R | | | | | | | | | |
| DM480 | ΔE50, ΔF52, ΔR53, | 988.03 | 9.45 | 28.39 | 0.43 | 0.79 | 25.00 | −1.08 | −323.35 | 100.33 |
| | E2N, E23A, L70I, | | | | | | | | | |
| | K25R + D68N, S76Y | | | | | | | | | |
| DM362 | ΔE50, ΔF52, ΔP53, | 992.54 | 9.15 | 28.66 | 0.51 | 0.81 | 25.30 | 0.07 | −324.81 | 100.32 |
| | E23A, S76Y, D68N | | | | | | | | | |
| DM101 | ΔE50, ΔF52, ΔR53, | 1011.85 | 9.50 | 28.54 | 0.52 | 0.78 | 24.60 | −1.49 | −324.54 | 100.30 |
| | E2N, E23A, Y65R, L70I, | | | | | | | | | |
| | S76Y, K25R | | | | | | | | | |
| DM122 | ΔE50, ΔF52, ΔR53, | 1024.47 | 9.221956 | 28.51 | 0.47 | 0.8 | 25.07 | −0.68 | −326.44 | 100.23 |
| | E23A, Y65R, L70I, S76Y | | | | | | | | | |
| DM206 | ΔE50, ΔF52, ΔR53, | 950.99 | 9.17 | 28.63 | 0.45 | 0.80 | 24.66 | 32.77 | −327.96 | 99.77 |
| | E2N, E23A, Y65R, L70I, | | | | | | | | | |
| | V20I, S76Y | | | | | | | | | |
| DM236 | ΔE50, ΔF52, ΔR53, | 958.69 | 9.10 | 28.28 | 0.64 | 0.79 | 24.69 | 0.82 | −324.07 | 99.75 |
| | E2N, E23A, Y65R, L70I, | | | | | | | | | |
| | D68N, S76W | | | | | | | | | |
| DM662 | ΔE50, ΔF52, ΔR53, | 1053.62 | 9.25 | 27.92 | 0.42 | 0.82 | 25.57 | 10.45 | −323.88 | 99.71 |
| | E2N, E23A, Y65R, L70I, | | | | | | | | | |
| | E59Y, S76V | | | | | | | | | |
| DM396 | ΔE50, ΔF52, ΔR53, | 955.37 | 9.37 | 28.59 | 0.62 | 0.82 | 24.77 | −0.86 | −325.65 | 99.65 |
| | E2M, E23A, Y65R, L70I, , | | | | | | | | | |
| | S76Y | | | | | | | | | |
| DM600 | ΔE50, ΔE52, ΔR53, | 1083.08 | 9.44 | 28.41 | 0.43 | 0.82 | 24.70 | −0.34 | −325.61 | 99.65 |
| | E2N, E23A, Y65R, L70I, | | | | | | | | | |
| | I75V, S76Y | | | | | | | | | |
| DM166 | ΔE50, ΔF52, ΔR53, | 918.66 | 9.48 | 28.29 | 0.64 | 0.77 | 24.87 | 0.85 | −323.41 | 99.63 |
| | E2N, E23A, Y65R, L70I, | | | | | | | | | |
| | 25R, Q28K, S76Y | | | | | | | | | |
| DM364 | ΔE50, ΔF52, ΔR53, | 1069.35 | 9.24 | 28.61 | 0.44 | 0.80 | 25.01 | 2.62 | −325.86 | 99.61 |
| | E2N, E23A, S76Y | | | | | | | | | |
| DM479 | ΔE50, ΔF52, ΔR53, | 940.51 | 9.49 | 28.40 | 0.48 | 0.77 | 24.79 | −0.94 | −324.65 | 99.57 |
| | E2N, E23A, Y65R, L70I, | | | | | | | | | |
| | 25R, D68N, S76Y | | | | | | | | | |
| DM664 | ΔE50, ΔF52, ΔP53, | 1050.11 | 9.35 | 28.42 | 0.44 | 0.81 | 25.28 | 5.65 | −322.63 | 99.49 |
| | E2N, E23A, Y65R, L70I, | | | | | | | | | |
| | S76I | | | | | | | | | |
| DM126 | ΔE50, ΔF52, ΔP53, | 1021.62 | 9.42 | 28.21 | 0.48 | 0.82 | 26.21 | −1.08 | −327.03 | 99.43 |
| | E23A, Y65R, S76Y C41A | | | | | | | | | |
| DM114 | ΔE50, ΔF52, ΔR53, | 975.87 | 9.23 | 28.32 | 0.47 | 0.81 | 24.80 | 0.29 | −324.10 | 99.39 |
| | E2N, E23A, Y65R, L70I, | | | | | | | | | |
| | S76F | | | | | | | | | |
| DM167 | ΔE50, ΔF52, ΔR53, | 1039.682 | 9.456097 | 28.51 | 0.43 | 0.78 | 24.64 | 0.18 | −320.09 | 99.37 |
| | E2N, E23A, Y65R, L70I, | | | | | | | | | |
| | K25R, Q28R, S76F | | | | | | | | | |
| DM124 | ΔE50, ΔF52, ΔP53, | 935.0259 | 9.337399 | 28.32 | 0.43 | 0.81 | 24.65 | 2.22 | −328 | 99.36 |
| | E2N, E23A, Y65R, S76Y, | | | | | | | | | |
| DM365 | ΔE50, ΔF52, ΔR53, | 996.65 | 9.17 | 28.43 | 0.45 | 0.79 | 25.24 | −0.17 | −326.11 | 99.27 |
| | E23A, S76Y, E4Q | | | | | | | | | |
| DM520 | ΔE50, ΔF52, ΔR53, | 915.64 | 9.29 | 28.51 | 0.46 | 0.80 | 24.47 | −1.87 | −326.55 | 99.21 |
| | E2N, E23A, Y65R, L70I, | | | | | | | | | |
| | Q28S, S76Y | | | | | | | | | |
| DM165 | ΔE50, ΔF52, ΔP53, | 1072.90 | 9.54 | 28.65 | 0.43 | 0.78 | 24.37 | 1.18 | −322.97 | 99.19 |
| | E2N, E23A, Y65R, L70I, | | | | | | | | | |
| | 25R, Q28R, S76Y | | | | | | | | | |
| DM397 | ΔE50, ΔF52, ΔR53, | 1028.66 | 9.29 | 28.76 | 0.44 | 0.81 | 24.76 | | −325.61 | 99.06 |
| | E2N, E23A, S76Y, D68N | | | | | | | | | |
| DM269 | ΔE50, ΔF52, ΔP53, | 1020.27 | 8.98 | 27.70 | 0.58 | 0.79 | 25.46 | 1.99 | −324.68 | 99.06 |
| | E2N, E23A, Y65R, L70I, | | | | | | | | | |
| | C41V, S76W | | | | | | | | | |
| DM168 | ΔE50, ΔF52, ΔR53, | 1000.499 | 9.30572 | 27.78 | 0.57 | 0.76 | 25.66 | 1.5 | −320.52 | 99.04 |
| | E2N, E23A, Y65R, L70I, | | | | | | | | | |
| | K25R, Q28K, S76F | | | | | | | | | |
| DM660 | ΔE50, ΔF52, ΔR53, | 1016.17 | 9.33 | 28.24 | 0.45 | 0.80 | 24.90 | −0.57 | −321.51 | 99.01 |
| | E2N, E23A, Y65R, L70I, | | | | | | | | | |
| | E59F, S76M | | | | | | | | | |
| DM682 | ΔE50, ΔF52, ΔP53, | 1001.54 | 9.18 | 28.11 | 0.46 | 0.80 | 25.44 | 0.30 | −324.02 | 99.00 |
| | E2N, E23A, Y65R, L70I, | | | | | | | | | |
| | 41A, Q28K, S76W | | | | | | | | | |
| DM123 | ΔE50, ΔE52, ΔP53, E2N, | 1005.40 | 9.29 | 28.51 | 0.51 | 0.81 | 25.00 | 4.10 | −326.13 | 98.98 |
| | E23A, L70I, S76Y | | | | | | | | | |
| DM679 | ΔE50, ΔF52, ΔP53, | 933.7867 | 9.090186 | 27.62 | 0.54 | 0.79 | 24.96 | −0.38 | −324.32 | 98.98 |
| | E2N, E23A, Y65R, L70I, | | | | | | | | | |
| | V20I, D68N, S76F | | | | | | | | | |
| DM230 | ΔE50, ΔE52, ΔP53, | 1067.91 | 9.30 | 28.47 | 0.53 | 0.81 | 24.59 | 1.80 | −324.01 | 98.95 |
| | E2N, E23A, Y65R, L70I, | | | | | | | | | |
| | D68N, S76F | | | | | | | | | |
| DM661 | ΔE50, ΔF52, ΔP53, | 1037.35 | 9.32 | 28.30 | 0.44 | 0.81 | 24.24 | 1.27 | −324.41 | 98.92 |
| | E2N, E23A, Y65R, L70I, | | | | | | | | | |
| | E59W, S76Y | | | | | | | | | |
| DM249 | ΔE50, ΔF52, ΔR53, | 1011.97 | 9.33 | 28.29 | 0.50 | 0.81 | 25.11 | 0.14 | −325.73 | 98.89 |
| | E2N, E23A, Y65R, L70I, | | | | | | | | | |
| | C41V, S76F | | | | | | | | | |
| DM681 | ΔE50, ΔF52, ΔR53, | 1025.86 | 9.07 | 28.47 | 0.45 | 0.79 | 24.50 | −1.33 | −324.58 | 98.64 |
| | E2N, E23A, Y65R, L70I, | | | | | | | | | |
| | V20I, Q28R, S76F | | | | | | | | | |
| DM481 | ΔE50, ΔF52, ΔR53, | 1091.72 | 9.43 | 28.35 | 0.50 | 0.78 | 24.70 | −1.19 | −322.63 | 98.60 |
| | E2N, E23A, Y65R, L70I, | | | | | | | | | |
| | K25R, C41T, S76Y | | | | | | | | | |
| DM289 | ΔE50, ΔF52, ΔR53, | 991.24 | 9.23 | 28.28 | 0.46 | 0.79 | 25.07 | −0.51 | −327.70 | 98.60 |
| | E2N, E23A, Y65R, L70I, | | | | | | | | | |
| | N35T, S76Y | | | | | | | | | |
| DM291 | ΔE50, ΔF52, ΔR53, | 1060.20 | 9.24 | 28.36 | 0.46 | 0.80 | 24.52 | −1.10 | −322.19 | 98.60 |
| | E2N, E23A, Y65R, L70I, | | | | | | | | | |
| | C41T, S76W | | | | | | | | | |
| DM607 | ΔE50, ΔF52, ΔP53, | 995.21 | 9.31 | 28.53 | 0.51 | 0.80 | 24.56 | 0.24 | −319.75 | 98.57 |
| | E2N, E23A, Y65R, | | | | | | | | | |
| | L70I, Q28K, D68T, S76Y | | | | | | | | | |
| DM361 | ΔE50, ΔF52, ΔP53, | 1040.18 | 9.26 | 28.72 | 0.48 | 0.81 | 24.66 | −1.47 | −326.86 | 98.52 |
| | E2N, E23A, L70I, | | | | | | | | | |
| | D68N, S76Y | | | | | | | | | |
| DM636 | ΔE50, ΔF52, ΔP53, | 1034.34 | 9.21 | 28.29 | 0.57 | 0.80 | 24.94 | −0.46 | −325.45 | 98.51 |
| | E2N, E23A, Y65R, L70I, | | | | | | | | | |
| | T33R, R31T, S76Y | | | | | | | | | |
| DM690 | ΔE50, ΔF52, ΔR53, | 972.54 | 9.42 | 28.07 | 0.53 | 0.82 | 26.15 | −1.03 | −321.87 | 98.49 |
| | E2N, E23A, Y65R, | | | | | | | | | |
| | L70I, S76A | | | | | | | | | |
| DM593 | ΔE50, ΔF52, ΔR53, | 965.59 | 9.34 | 28.26 | 0.54 | 0.81 | 25.80 | 36.66 | −320.29 | 98.48 |
| | E2N, E23A, Y65R, | | | | | | | | | |
| | L70I, E77V | | | | | | | | | |
| DM643 | ΔE50, ΔF52, ΔR53, | 967.5659 | 9.095423 | 28.18 | 0.52 | 0.79 | 24.8 | 1.35 | −318.6 | 98.47 |
| | E2N, E23A, Y65R, L70I, | | | | | | | | | |
| | D68T, N35T, S76Y | | | | | | | | | |
| DM649 | ΔE50, ΔF52, ΔR53, | 948.98 | 9.22 | 27.78 | 0.53 | 0.79 | 25.16 | | −320.65 | 98.40 |
| | E2N, E23A, Y65R, L70I, | | | | | | | | | |
| | D68T, S76Y | | | | | | | | | |
| DM294 | ΔE50, ΔF52, ΔR53, | 1019.87 | 9.23 | 28.50 | 0.45 | 0.81 | 24.39 | 0.04 | −322.79 | 98.22 |
| | E2N, E23A, Y65R, L70I, | | | | | | | | | |
| | C41T, S76F | | | | | | | | | |
| DM651 | ΔE50, ΔF52, ΔR53, | 1088.05 | 9.33 | 28.20 | 0.45 | 0.80 | 25.39 | 0.47 | −320.35 | 98.22 |
| | E2N, E23A, Y65R, | | | | | | | | | |
| | L70I, E59T, S76T | | | | | | | | | |
| DM128 | ΔE50, ΔF52, ΔR53, | 937.54 | 9.38 | 28.26 | 0.52 | 0.81 | 24.79 | 1.83 | −329.99 | 98.21 |
| | E2N, E23A, Y65R, L70I, | | | | | | | | | |
| | I26W, Q28K, S76Y | | | | | | | | | |
| DM663 | ΔE50, ΔF52, ΔR53, | 993.61 | 9.23 | 28.35 | 0.54 | 0.79 | 25.49 | −1.17 | −322.37 | 98.20 |
| | E2N, E23A, Y65R, L70I, | | | | | | | | | |
| | S76V | | | | | | | | | |
| DM127 | ΔE50, ΔF52, ΔR53, | 966.01 | 9.29 | 28.36 | 0.49 | 0.78 | 24.46 | 0.40 | −329.42 | 98.19 |
| | E2N, E23A, Y65R, L70I, | | | | | | | | | |
| | I26W, Q28E, S76Y | | | | | | | | | |
| DM89 | ΔE50, ΔF52, ΔR53, | 1026.75 | 9.12 | 28.45 | 0.47 | 0.79 | 24.97 | −1.10 | −327.41 | 98.19 |
| | E2N, E23A, Y65R, L70I, | | | | | | | | | |
| | S76Y | | | | | | | | | |
| DM224 | ΔE50, ΔF52, ΔR53, | 1034.67 | 9.25 | 28.26 | 0.60 | 0.80 | 24.91 | | −327.55 | 98.14 |
| | E2N, E23A, Y65R, L70I, | | | | | | | | | |
| | D68N, S76Y | | | | | | | | | |
| DM611 | ΔE50, ΔF52, ΔR53, | 989.14 | 9.11 | 28.50 | 0.55 | 0.78 | 24.52 | −0.45 | −327.99 | 98.10 |
| | E2N, E23A, Y65R, L70I, | | | | | | | | | |
| | V20I, D68N, S76Y | | | | | | | | | |
| DM620 | ΔE50, ΔF52, ΔR53, | 1007.55 | 9.16 | 28.51 | 0.51 | 0.79 | 24.75 | 0.47 | −326.88 | 97.90 |
| | E2N, E23A, Y65R, L70I, | | | | | | | | | |
| | V20I, Q28R, S76Y | | | | | | | | | |
| DM602 | ΔE50, ΔF52, ΔP53, | 951.52 | 8.97 | 28.07 | 0.55 | 0.77 | 24.83 | 2.37 | −326.39 | 97.88 |
| | E2N, E23A, Y65R, L70I, | | | | | | | | | |
| | 59V, D74V, S76V | | | | | | | | | |
| DM363 | ΔE50, ΔF52, ΔR53, | 1042.42 | 9.11 | 28.35 | 0.46 | 0.79 | 25.02 | 52.75 | −326.89 | 97.83 |
| | E2N, E23A, Y65R, L70I, | | | | | | | | | |
| | Q28K, S76Y | | | | | | | | | |
| DM234 | ΔE50, ΔF52, ΔR53, | 1000.48 | 9.37 | 28.35 | 0.53 | 0.80 | 24.56 | −1.37 | −322.79 | 97.76 |
| | E2N, E23A, Y65R, L70I, | | | | | | | | | |
| | T33R, S76W | | | | | | | | | |
| DM473 | ΔE50, ΔF52, ΔP53, | 950.35 | 9.30 | 28.46 | 0.48 | 0.81 | 25.22 | 0.33 | −326.45 | 97.75 |
| | E2N, E23A, L70I, | | | | | | | | | |
| | D68N, Q28K, S76Y | | | | | | | | | |
| DM683 | ΔE50, ΔF52, Δ53, | 1020.12 | 9.27 | 28.31 | 0.49 | 0.79 | 25.16 | 26.43 | −324.81 | 97.65 |
| | E2N, E23A, Y65R, L70I, | | | | | | | | | |
| | C41A, Q28K, S76F | | | | | | | | | |
| DM536 | ΔE50, ΔF52, ΔR53, | 1056.94 | 9.29 | 28.29 | 0.46 | 0.80 | 25.28 | −1.19 | −327.61 | 97.61 |
| | E2N, E23A, Y65R, | | | | | | | | | |
| | L70I, C41A, Q28K, S76Y | | | | | | | | | |
| DM517 | ΔE50, ΔF52, ΔR53, | 980.97 | 9.23 | 28.58 | 0.47 | 0.79 | 24.66 | 3.00 | −325.64 | 97.48 |
| | E2N, E23A, Y65R, | | | | | | | | | |
| | L70I, Q28R, S76Y | | | | | | | | | |
| DM472 | ΔE50, ΔF52, ΔR53, | 1064.12 | 9.24 | 28.56 | 0.47 | 0.80 | 24.53 | 6.17 | −326.71 | 97.47 |
| | E2N, E23A, Y65R, L70I, | | | | | | | | | |
| | D68N, Q28K, S76Y | | | | | | | | | |
| DM613 | ΔE50, ΔF52, ΔR53, | 998.56 | 8.84 | 28.16 | 0.56 | 0.77 | 25.04 | 25.35 | −328.02 | 97.46 |
| | E2N, E23A, Y65R, | | | | | | | | | |
| | L70I, V20I, Q28K, S76Y | | | | | | | | | |
| DM605 | ΔE50, ΔF52, | 900.4837 | 9.240495 | 28.19 | 0.53 | 0.81 | 25.42 | −0.93 | −321.6 | 97.38 |
| | ΔR53, E2N, E23A, Y65R, | | | | | | | | | |
| | L70I, E59V, S76T | | | | | | | | | |
| DM685 | ΔE50, ΔF52, ΔR53, | 935.31 | 9.23 | 28.41 | 0.51 | 0.80 | 25.18 | −1.41 | −325.15 | 97.31 |
| | E2N, E23A, Y65R, | | | | | | | | | |
| | L70I, C41A, Q28R, S76F | | | | | | | | | |
| DM146 | ΔE50, ΔF52, ΔR53, | 1005.44 | 9.12 | 27.87 | 0.53 | 0.80 | 25.42 | 2.39 | −328.67 | 97.21 |
| | E2N, E23A, Y65R, | | | | | | | | | |
| | L70I, C41V, S76Y | | | | | | | | | |
| DM631 | ΔE50, ΔE52, ΔP53, E2N, | 982.0241 | 9.010202 | 28.42 | 0.56 | 0.78 | 25.05 | 0.55 | −325.34 | 97.19 |
| | E23A, Y65R, | | | | | | | | | |
| | L70I, Q28K, N35T, S76Y | | | | | | | | | |
| DM618 | ΔE50, ΔF52, ΔR53, | 1011.77 | 9.46 | 28.39 | 0.46 | 0.79 | 24.60 | 0.12 | −323.71 | 97.09 |
| | E2N, E23A, Y65R, L70I, | | | | | | | | | |
| | T33R, K25R, S76Y | | | | | | | | | |
| DM608 | ΔE50, ΔE52, ΔP53, | 1028.33 | 9.05 | 28.33 | 0.46 | 0.80 | 24.76 | 1.70 | −319.09 | 97.06 |
| | E2N, E23A, Y65R, L70I, | | | | | | | | | |
| | Q28R, D68T, S76Y | | | | | | | | | |
| DM628 | ΔE50, ΔF52, ΔR53, | 969.2729 | 9.118411 | 27.79 | 0.48 | 0.79 | 25.54 | 0.1 | −326.98 | 96.88 |
| | E2N, E23A, Y65R, L70I, | | | | | | | | | |
| | D68N, N35T, S76Y | | | | | | | | | |
| DM521 | ΔE50, ΔE52, | 1035.97 | 9.21 | 28.47 | 0.46 | 0.80 | 24.98 | 0.48 | −324.72 | 96.73 |
| | ΔR53, E2N, E23A | | | | | | | | | |
| | L70I, D68N, Q28R, S76Y | | | | | | | | | |
| DM542 | ΔE50, ΔF52, ΔR53, | 911.50 | 9.32 | 28.56 | 0.49 | 0.81 | 24.80 | 1.86 | −325.79 | 96.70 |
| | E2N, E23A, Y65R, L70I, | | | | | | | | | |
| | D68N, Q28R, S76Y | | | | | | | | | |
| DM650 | ΔE50, ΔF52, ΔR53, | 1028.47 | 9.31 | 28.27 | 0.50 | 0.80 | 25.22 | −1.63 | −322.26 | 96.69 |
| | E2N, E23A, Y65R, | | | | | | | | | |
| | L70I, E59I, S76T | | | | | | | | | |
| DM477 | ΔE50, ΔE52, ΔP53, | 973.46 | 9.16 | 28.14 | 0.60 | 0.79 | 25.18 | 2.17 | −325.70 | 96.62 |
| | E2N, E23A, L70I, | | | | | | | | | |
| | C41T, D68N, S76Y | | | | | | | | | |
| DM640 | ΔE50, ΔF52, ΔR53, | 944.1608 | 9.108073 | 27.23 | 0.62 | 0.78 | 25.88 | 2.27 | −325.05 | 96.57 |
| | E2N, E23A, Y65R, L70I, | | | | | | | | | |
| | Q28R, N35T, S76Y | | | | | | | | | |
| DM532 | ΔE50, ΔF52, ΔR53, | 873.08 | 9.12 | 28.55 | 0.47 | 0.79 | 25.10 | 3.98 | −326.49 | 96.43 |
| | E2N, E23A, Y65R, L70I, | | | | | | | | | |
| | C41A, Q28R, S76Y | | | | | | | | | |
| DM287 | ΔE50, ΔF52, ΔP53, | 965.01 | 9.11 | 28.10 | 0.50 | 0.79 | 25.30 | 4.39 | −325.85 | 96.37 |
| | E2N, E23A, Y65R, | | | | | | | | | |
| | L70I, C41T, S76Y | | | | | | | | | |
| DM528 | ΔE50, ΔF52, ΔR53, | 1003.94 | 9.18 | 28.53 | 0.51 | 0.81 | 24.42 | −1.55 | −325.30 | 96.31 |
| | E2N, E23A, Y65R, | | | | | | | | | |
| | L70I, C41T, Q28R, S76Y | | | | | | | | | |
| DM478 | ΔE50, ΔF52, ΔR53, | 1009.63 | 9.09 | 28.44 | 0.50 | 0.79 | 24.70 | −1.01 | −328.00 | 96.27 |
| | E2N, E23A, Y65R, | | | | | | | | | |
| | L70I, C41T, Q28K, S76Y | | | | | | | | | |
| DM346 | ΔE50, ΔF52, ΔR53, | 1005.953 | 9.2677 | 28.54 | 0.42 | 0.81 | 24.66 | −1.46 | −325.96 | 96.21 |
| | E2N, E23A, Y65R, | | | | | | | | | |
| | L70I, C41S, S76Y | | | | | | | | | |
| DM455 | ΔE50, ΔF52, Δ53, | 995.74 | 8.89 | 28.25 | 0.58 | 0.76 | 25.22 | 1.66 | −326.18 | 96.13 |
| | E2N, E23A, Y65R, | | | | | | | | | |
| | L70I, Q28K, I26V, S76Y | | | | | | | | | |
| DM288 | ΔE50, ΔF52, ΔP53, | 1028.59 | 9.39 | 28.52 | 0.50 | 0.78 | 24.70 | −1.15 | −322.75 | 96.04 |
| | E2N, E23A, Y65R, | | | | | | | | | |
| | L70I, K25R, Q28K, I26T, | | | | | | | | | |
| | S76Y | | | | | | | | | |
| DM534 | ΔE50, ΔF52, ΔP53, | 979.53 | 9.25 | 28.70 | 0.54 | 0.81 | 24.43 | 13.85 | −324.36 | 96.03 |
| | E2N, E23A, Y65R, L70I, | | | | | | | | | |
| | C41S, Q28K, S76Y | | | | | | | | | |
| DM159 | ΔE50, ΔF52, Δ53, | 1002.65 | 9.47 | 28.50 | 0.46 | 0.82 | 24.64 | −1.75 | −323.01 | 96.00 |
| | E2N, E23A, Y65R, L70I, | | | | | | | | | |
| | S76F, I26T | | | | | | | | | |
| DM164 | ΔE50, ΔE52, ΔP53, | 1068.28 | 9.26 | 28.29 | 0.47 | 0.80 | 24.90 | 0.59 | −323.19 | 95.93 |
| | E2N, E23A, Y65R, L70I, | | | | | | | | | |
| | Q28K, I26T, S76W | | | | | | | | | |
| DM210 | ΔE50, ΔF52, ΔP53, | 853.54 | 8.67 | 28.19 | 0.63 | 0.76 | 25.40 | 12.30 | −328.19 | 95.65 |
| | E2N, E23A, Y65R, L70I, | | | | | | | | | |
| | C41A, S76Y | | | | | | | | | |
| DM616 | ΔE50, ΔF52, ΔP53, | 1030.55 | 9.13 | 28.35 | 0.59 | 0.78 | 24.80 | 63.31 | −327.01 | 95.65 |
| | E2N, E23A, Y65R, L70I, | | | | | | | | | |
| | T33R, V20I, S76Y | | | | | | | | | |
| DM100 | ΔE50, ΔF52, ΔP53, | 1014.57 | 9.43 | 28.52 | 0.44 | 0.82 | 24.77 | −1.70 | −327.29 | 95.57 |
| | E2N, E23A, Y65R, L70I, | | | | | | | | | |
| | S76Y, I26T | | | | | | | | | |
| DM202 | ΔE50, ΔF52, ΔR53, | 953.05 | 8.62 | 28.27 | 0.53 | 0.75 | 25.17 | −0.62 | −326.10 | 95.52 |
| | E2N, E23A, Y65R, L70I, | | | | | | | | | |
| | A19V, S76Y | | | | | | | | | |
| DM604 | ΔE50, ΔF52, ΔP53, | 947.21 | 9.22 | 28.16 | 0.51 | 0.81 | 25.10 | −0.66 | −321.51 | 95.46 |
| | E2N, E23A, Y65R, L70I, | | | | | | | | | |
| | E59R, S76T | | | | | | | | | |
| DM658 | ΔE50, ΔF52, ΔP53, | 1018.99 | 9.26 | 28.34 | 0.43 | 0.81 | 25.71 | −1.39 | −321.91 | 95.45 |
| | E2N, E23A, Y65R, L70I, | | | | | | | | | |
| | S76T | | | | | | | | | |
| DM610 | ΔE50, ΔF52, ΔR53, | 966.24 | 8.71 | 28.29 | 0.47 | 0.77 | 25.17 | 1.97 | −325.10 | 95.43 |
| | E2N, E23A, Y65R, L70I, | | | | | | | | | |
| | A19V, Q28K, S76Y | | | | | | | | | |
| DM621 | ΔE50, ΔF52, ΔR53, | 890.35 | 8.87 | 28.39 | 0.45 | 0.78 | 24.91 | −1.00 | −326.16 | 95.25 |
| | E2N, E23A, Y65R, L70I, | | | | | | | | | |
| | A19V, Q28R, S76Y | | | | | | | | | |
| DM222 | ΔE50, ΔF52, ΔR53, | 907.60 | 9.28 | 28.45 | 0.50 | 0.80 | 24.86 | −0.79 | −326.42 | 95.17 |
| | E2N, E23A, Y65R, L70I, | | | | | | | | | |
| | T33R, S76Y | | | | | | | | | |
| DM163 | ΔE50, ΔF52, ΔR53, | 902.54 | 9.40 | 28.42 | 0.52 | 0.81 | 24.82 | 23.06 | −322.47 | 95.13 |
| | E2N, E23A, Y65R, L70I, | | | | | | | | | |
| | Q28K, I26T, S76F | | | | | | | | | |
| DM47 | ΔE50, ΔF52, ΔR53, | 943.74 | 9.18 | 28.22 | 0.55 | 0.80 | 25.98 | 9.80 | −322.63 | 95.04 |
| | E2N, E23A, Y65R, L70I, | | | | | | | | | |
| | R31T | | | | | | | | | |
| DM248 | ΔE50, ΔF52, ΔR53, | 998.07 | 8.62 | 28.03 | 0.56 | 0.77 | 25.28 | | −327.38 | 94.90 |
| | E2N, E23A, Y65R, L70I, | | | | | | | | | |
| | A73V, S76F | | | | | | | | | |
| DM637 | ΔE50, ΔF52, ΔP53, | 967.4253 | 9.074611 | 27.93 | 0.55 | 0.78 | 25.69 | 0.57 | −326.43 | 94.83 |
| | E2N, E23A, Y65R, L70I, | | | | | | | | | |
| | T33R, N35T, S76Y | | | | | | | | | |
| DM530 | ΔE50, ΔF52, ΔR53, | 986.52 | 9.24 | 28.58 | 0.43 | 0.79 | 24.44 | −1.54 | −324.34 | 94.79 |
| | E2N, E23A, Y65R, L70I, | | | | | | | | | |
| | C41S, Q28R, S76Y | | | | | | | | | |
| DM567 | ΔE50, ΔF52, ΔP53, | 972.09 | 9.26 | 27.96 | 0.45 | 0.82 | 26.23 | 2.35 | −315.77 | 94.67 |
| | E2N, E23A, Y65R, L70I, | | | | | | | | | |
| | D68T, R31T | | | | | | | | | |
| DM552 | ΔE50, ΔF52, ΔR53, | 952.85 | 9.22 | 26.81 | 0.60 | 0.80 | 26.81 | −0.46 | −321.55 | 94.65 |
| | E2N, E23A, Y65R, L70I, | | | | | | | | | |
| | Q28K, R31T | | | | | | | | | |
| DM360 | ΔE50, ΔF52, ΔR53, E23A, | 973.78 | 9.33 | 28.46 | 0.43 | 0.81 | 24.37 | 0.68 | −326.27 | 94.48 |
| | Y65R, L70I, | | | | | | | | | |
| | G1M, E2M, S76Y | | | | | | | | | |
| DM413 | ΔE50, ΔF52, ΔR53, | 1088.40 | 9.29 | 28.30 | 0.50 | 0.80 | 24.76 | −0.34 | −325.17 | 94.40 |
| | E2N, E23A, Y65R, L70I, | | | | | | | | | |
| | G1M, S76Y | | | | | | | | | |
| DM619 | ΔE50, ΔF52, ΔR53, | 1022.99 | 9.26 | 28.31 | 0.47 | 0.80 | 25.00 | 5.08 | −325.40 | 94.40 |
| | E2N, E23A, Y65R, L70I, | | | | | | | | | |
| | T33R, Q28K, S76Y | | | | | | | | | |
| DM228 | ΔE50, ΔF52, ΔP53, | 1043.75 | 8.81 | 28.43 | 0.47 | 0.80 | 24.83 | −0.32 | −323.10 | 94.29 |
| | E2N, E23A, Y65R, L70I, | | | | | | | | | |
| | T33R, S76F | | | | | | | | | |
| DM43 | ΔE50, ΔE52, ΔP53, | 1013.25 | 9.55 | 28.14 | 0.44 | 0.79 | 25.89 | 0.59 | −324.54 | 94.13 |
| | E2N, E23A, Y65R, L70I, | | | | | | | | | |
| | K25R | | | | | | | | | |
| DM158 | ΔE50, ΔF52, ΔR53, | 1018.79 | 9.26 | 28.49 | 0.47 | 0.80 | 24.79 | −0.63 | −326.10 | 93.98 |
| | E2N, E23A, Y65R, L70I, | | | | | | | | | |
| | Q28K, I26T, S76Y | | | | | | | | | |
| DM625 | ΔE50, ΔF52, ΔR53, E2N, | 981.08 | 8.04 | 27.33 | 0.59 | 0.70 | 25.68 | 19.23 | −325.14 | 93.95 |
| | E23A, Y65R, L70I, | | | | | | | | | |
| | A19V, N35T, S76Y | | | | | | | | | |
| DM614 | ΔE50, ΔF52, ΔR53, | 1054.90 | 9.18 | 28.31 | 0.55 | 0.80 | 24.80 | −0.78 | −326.42 | 93.92 |
| | E2N, E23A, Y65R, L70I, | | | | | | | | | |
| | T33R, D68N, S76Y | | | | | | | | | |
| DM634 | ΔE50, ΔF52, ΔR53, | 883.27 | 7.18 | 27.93 | 0.91 | 0.68 | 25.59 | 9.26 | −325.91 | 93.91 |
| | E2N, E23A, Y65R, L70I, | | | | | | | | | |
| | V20I, N35T, S76Y | | | | | | | | | |
| DM526 | ΔE50, ΔF52, ΔR53, | 949.64 | 9.42 | 28.02 | 0.50 | 0.81 | 25.33 | 20.32 | −324.56 | 93.89 |
| | E2N, E23A, Y65R, L70I, | | | | | | | | | |
| | Q28R, I26T, S76Y | | | | | | | | | |
| DM606 | ΔE50, ΔF52, ΔR53, | 984.24 | 9.2 B6 | 28.08 | 0.49 | 0.82 | 25.58 | −0.79 | −324.66 | 93.80 |
| | E2N, E23A, Y65R, L70I, | | | | | | | | | |
| | S76R | | | | | | | | | |
| DM622 | ΔE50, ΔE52, ΔP53, | 997.36 | 9.30 | 28.38 | 0.44 | 0.80 | 24.86 | 19.95 | −324.72 | 93.72 |
| | E2N, E23A, Y65R, L70I, | | | | | | | | | |
| | T33R, Q28R, S76Y | | | | | | | | | |
| DM94 | ΔE50, ΔF52, ΔP53, | 1034.045 | 9.336462 | 28.09 | 0.47 | 0.8 | 25.94 | −0.63 | −322.53 | 93.65 |
| | E2N, E23A, Y65R, L70I, | | | | | | | | | |
| | D68N, R31T | | | | | | | | | |
| DM659 | ΔE50, ΔF52, ΔR53, | 958.99 | 9.09 | 28.38 | 0.51 | 0.78 | 25.12 | 28.18 | −322.67 | 93.58 |
| | E2N, E23A, Y65R, L70I, | | | | | | | | | |
| | S76H | | | | | | | | | |
| DM486 | ΔE50, ΔF52, ΔR53, | 1005.60 | 9.38 | 28.51 | 0.49 | 0.80 | 24.81 | 1.29 | −325.64 | 93.48 |
| | E2N, E23A, L70I, | | | | | | | | | |
| | I26T, Q28K, D68N | | | | | | | | | |
| | S76Y | | | | | | | | | |
| DM484 | ΔE50, ΔF52, ΔR53, | 983.29 | 9.16 | 28.50 | 0.54 | 0.79 | 24.73 | 3.21 | −325.26 | 92.96 |
| | E2N, E23A, Y65R, L70I, | | | | | | | | | |
| | I26T, Q28K, D68N, S76Y | | | | | | | | | |
| DM543 | ΔE50, ΔF52, ΔR53, | 1042.12 | 8.78 | 28.24 | 0.45 | 0.77 | 26.00 | −0.55 | −321.25 | 92.94 |
| | E2N, E23A, Y65R, L70I, | | | | | | | | | |
| | A19V, R31T | | | | | | | | | |
| DM204 | ΔE50, ΔF52, ΔR53, | 971.73 | 7.89 | 28.18 | 0.68 | 0.73 | 25.07 | 9.93 | −327.02 | 92.86 |
| | E2N, E23A, Y65R, L70I, | | | | | | | | | |
| | A73V, S76Y | | | | | | | | | |
| DM96 | ΔE50, ΔF52, ΔR53, | 972.29 | 9.25 | 27.94 | 0.49 | 0.79 | 26.29 | 0.19 | −321.55 | 92.76 |
| | E2N, E23A, Y65R, L70I, | | | | | | | | | |
| | V20I | | | | | | | | | |
| DM456 | ΔE50, ΔF52, ΔP53, | 1049.08 | 9.21 | 28.27 | 0.55 | 0.81 | 25.08 | −0.37 | −326.20 | 92.73 |
| | E2N, E23A, Y65R, L70I, | | | | | | | | | |
| | Q28S, I26T, S76Y | | | | | | | | | |
| DM464 | ΔE50, ΔF52, ΔR53, | 1069.73 | 9.40 | 28.09 | 0.52 | 0.79 | 25.87 | 0.55 | −318.94 | 91.84 |
| | E2N, E23A, Y65R, L70I, | | | | | | | | | |
| | K25R, D68N | | | | | | | | | |
| DM65 | ΔE50, ΔF52, ΔR53, | 1035.57 | 9.14 | 28.29 | 0.58 | 0.79 | 25.97 | −0.88 | −320.54 | 91.74 |
| | E2N, E23A, Y65R, L70I, | | | | | | | | | |
| | Q28K | | | | | | | | | |
| DM115 | ΔE50, ΔF52, ΔR53, | 1028.86 | 9.34 | 28.24 | 0.48 | 0.80 | 25.47 | −1.57 | −323.89 | 91.71 |
| | E2N, E23A, Y65R, L70I, | | | | | | | | | |
| | I26W, Q28E | | | | | | | | | |
| DM561 | ΔE50, ΔE52, ΔP53, | 991.25 | 9.06 | 27.94 | 0.57 | 0.78 | 26.37 | 17.57 | −321.46 | 91.40 |
| | E2N, E23A, Y65R, L70I, | | | | | | | | | |
| | T33R, R31T | | | | | | | | | |
| DM31 | ΔE50, ΔF52, ΔR53, | 975.97 | 9.14 | 28.11 | 0.47 | 0.80 | 25.96 | | −321.66 | 91.32 |
| | E2N, E23A, Y65R, L70I, | | | | | | | | | |
| DM46 | ΔE50, ΔF52, ΔR53, | 984.91 | 9.19 | 28.16 | 0.45 | 0.81 | 25.53 | −1.14 | −320.28 | 91.32 |
| | E2N, E23A, Y65R, L70I, | | | | | | | | | |
| | C41T | | | | | | | | | |
| DM85 | ΔE50, ΔF52, ΔR53, | 1033.74 | 9.17 | 27.92 | 0.48 | 0.78 | 26.19 | 3.07 | −322.19 | 91.25 |
| | E2N, E23A, Y65R, L70I, | | | | | | | | | |
| | A73V | | | | | | | | | |
| DM601 | ΔE50, ΔE52, ΔP53, | 924.99 | 9.39 | 28.11 | 0.42 | 0.81 | 26.08 | −1.35 | −319.84 | 91.09 |
| | E2N, E23A, Y65R, L70I, | | | | | | | | | |
| | I75V | | | | | | | | | |
| DM116 | ΔE50, ΔF52, ΔR53, | 1066.72 | 9.34 | 28.25 | 0.48 | 0.81 | 25.74 | −0.68 | −324.13 | 91.05 |
| | E2N, E23A, Y65R, L70I, | | | | | | | | | |
| | I26W, Q28K | | | | | | | | | |
| DM395 | ΔE50, ΔF52, ΔP53, | 974.07 | 9.12 | 28.21 | 0.62 | 0.78 | 26.12 | −0.17 | −320.19 | 90.63 |
| | E2M, E23A, Y65R, L70I, | | | | | | | | | |
| DM457 | ΔE50, ΔF52, ΔP53, | 1019.40 | 9.26 | 28.20 | 0.44 | 0.80 | 25.69 | | −320.89 | 90.28 |
| | E2N, E23A, Y65R, L70I, | | | | | | | | | |
| | D68N, Q28K | | | | | | | | | |
| DM91 | ΔE50, ΔF52, ΔR53, | 1016.01 | 9.10 | 28.08 | 0.68 | 0.80 | 25.96 | 1.06 | −322.60 | 90.28 |
| | E2N, E23A, Y65R, L70I, | | | | | | | | | |
| | C41V | | | | | | | | | |
| DM77 | ΔE50, ΔF52, ΔR53, | 933.12 | 8.69 | 28.09 | 0.50 | 0.77 | 26.17 | 0.11 | −320.38 | 89.80 |
| | E2N, E23A, Y65R, L70I, | | | | | | | | | |
| | A19V | | | | | | | | | |
| DM209 | ΔE50, ΔF52, ΔR53, | 989.42 | 9.37 | 28.28 | 0.48 | 0.83 | 24.87 | 1.12 | −328.41 | 89.56 |
| | E2N, E23A, Y65R, L70I, | | | | | | | | | |
| | A73F, F89M, S76Y | | | | | | | | | |
| DM130 | S76Y, E23A, Y65R, C41A | 1068.20 | 9.30 | 27.48 | 0.47 | 0.81 | 25.74 | −23.64 | −314.41 | 89.51 |
| DM540 | ΔE50, ΔF52, ΔR53, | 877.59 | 9.29 | 28.31 | 0.46 | 0.82 | 25.66 | −1.48 | −319.44 | 89.48 |
| | E2N, E23A, Y65R, L70I, | | | | | | | | | |
| | D68N, Q28R | | | | | | | | | |
| DM334 | ΔE50, ΔF52, ΔP53, | 983.92 | 7.91 | 28.17 | 0.68 | 0.71 | 25.81 | 17.05 | −324.35 | 89.02 |
| | E23Q , Q28K, S76Y | | | | | | | | | |
| DM151 | ΔE50, ΔF52, ΔR53, | 1040.08 | 9.27 | 28.13 | 0.55 | 0.82 | 25.89 | −0.33 | −319.93 | 88.93 |
| | E2N, E23A, Y65R, L70I, | | | | | | | | | |
| | C41S | | | | | | | | | |
| DM333 | ΔE50, ΔF52, ΔR53, | 941.68 | 7.65 | 28.64 | 0.61 | 0.70 | 25.24 | 0.98 | −326.71 | 88.92 |
| | S76Y, D68N | | | | | | | | | |
| DM513 | ΔE50, ΔF52, ΔR53, | 963.94 | 9.05 | 28.15 | 0.57 | 0.78 | 26.16 | −0.13 | −319.50 | 88.84 |
| | E2N, E23A, Y65R, L70I, | | | | | | | | | |
| | T33R, V20I | | | | | | | | | |
| DM516 | ΔE50, ΔF52, ΔR53, | 953.00 | 9.39 | 28.23 | 0.43 | 0.81 | 25.78 | −1.42 | −319.22 | 88.16 |
| | E2N, E23A, Y65R, L70I, | | | | | | | | | |
| | T33R, Q28K | | | | | | | | | |
| DM57 | ΔE50, ΔF52, ΔR53, | 1083.52 | 9.13 | 28.22 | 0.45 | 0.79 | 25.86 | −0.85 | −320.33 | 87.92 |
| | E2N, E23A, Y65R, L70I, | | | | | | | | | |
| | T33R | | | | | | | | | |
| DM87 | ΔE50, ΔF52, ΔP53, | 1011.40 | 8.22 | 27.90 | 0.62 | 0.74 | 26.25 | 2.92 | −321.47 | 87.09 |
| | E2N, E23A, Y65R, L70I, | | | | | | | | | |
| | D68N | | | | | | | | | |
| DM338 | ΔE50, ΔF52, ΔR53, | 907.29 | 7.50 | 28.46 | 0.68 | 0.67 | 25.00 | 2.58 | −325.78 | 86.69 |
| | E2N, S76Y | | | | | | | | | |
| DM539 | ΔE50, ΔF52, ΔR53, | 1010.35 | 9.10 | 28.23 | 0.43 | 0.79 | 25.80 | −0.42 | −319.34 | 86.19 |
| | E2N, E23A, Y65R, L70I, | | | | | | | | | |
| | T33R, Q28R | | | | | | | | | |
| DM125 | ΔE50, ΔE52, ΔP53, | 856.40 | 6.85 | 27.48 | 0.78 | 0.63 | 26.58 | 14.07 | −325.71 | 85.77 |
| | L70I, S76Y | | | | | | | | | |
| DM148 | ΔE50, ΔF52, ΔR53, | 944.46 | 6.07 | 28.33 | 0.78 | 0.59 | 25.45 | 15.11 | −325.85 | 85.54 |
| | S76Y | | | | | | | | | |
| DM121 | ΔE50, ΔF52, ΔR53, | 921.1628 | 6.866627 | 27.96 | 0.78 | 0.65 | 25.3 | 9.29 | −327.1 | 85.04 |
| | E2N, Y65R, L70I, S76Y | | | | | | | | | |
| DM337 | ΔE50, ΔF52, ΔR53, | 915.87 | 6.49 | 28.31 | 0.75 | 0.64 | 25.27 | 3.07 | −326.57 | 84.99 |
| | S76Y, E4Q | | | | | | | | | |
| DM298 | R84L, S76Y | 930.17 | 5.68 | 26.62 | 0.97 | 0.54 | 26.50 | −18.14 | −318.21 | 81.78 |
| DM332 | ΔE50, ΔF52, ΔR53, | 1016.00 | 7.32 | 28.23 | 0.67 | 0.65 | 25.44 | 5.32 | −324.44 | 79.37 |
| | E2M, S76Y, G1M | | | | | | | | | |
| DM147 | S76F | 918.09 | 7.10 | 27.51 | 0.69 | 0.70 | 25.23 | −16.95 | −314.47 | 79.36 |
| DM129 | S76Y | 993.04 | 7.40 | 27.46 | 0.70 | 0.69 | 25.42 | −19.13 | −313.15 | 79.21 |
| DM66 | ΔE50, ΔF52, ΔR53, | 1002.83 | 9.28 | 28.22 | 0.44 | 0.80 | 25.92 | −1.64 | −314.04 | 77.20 |
| | E2N, E23A, Y65R, L70I, | | | | | | | | | |
| | Q28R | | | | | | | | | |
| DM219 | A73F, F89M, S76Y | 946.74 | 6.94 | 26.69 | 0.85 | 0.68 | 26.26 | −21.13 | −315.41 | 69.23 |
| DM263 | A73F, F89M, S76F | 873.87 | 6.57 | 26.68 | 0.98 | 0.60 | 26.39 | −7.21 | −315.02 | 68.80 |
| DM29 | ΔE50, ΔF52, ΔR53, | 896.0229 | 5.555737 | 27.69 | 0.88 | 0.59 | 26.7 | 8.47 | −319.65 | 77.67 |
| DM161 | ΔE50, ΔF52, ΔR53, | 1014.83 | 9.31 | 28.31 | 0.47 | 0.83 | 24.66 | −0.94 | −323.59 | 97.07 |
| | E2N, E23A, Y65R, L70I, | | | | | | | | | |
| | S76W, 126T | | | | | | | | | |

With regards to Rosetta energy scores for MNEI based variants: DM212 (A19V, S76Y) has a score of −304.306 REU. DM217(I75L, S76Y) has a score of −308.118 REU. DM299(N35T, S76Y) has a score of −312.195 REU. DM276(A19V, S76W) has a score of −307.017 REU. DM256(A19V, S76F) has a score of −307.977 REU. DM220(C41A, S76Y) has a score of −313.722 REU. DM281(I75L, S76W) has a score of −308.084 REU. DM129(S76Y) has a score of −313.148 REU. DM297(C41T, S76Y) has a score of −312.022 REU. DM221(C41S, S76Y) has a score of −312.548 REU. DM227(D68N, S76Y) has a score of −314.09 REU. DM219(A73F, F89M, S76Y) has a score of −315.41 REU. DM213(V64I, S76Y) has a score of −313.15 REU. DM183(S76W, I26T) has a score of −310.896 REU. DM284 (C41A, S76W) has a score of −312.41 REU. DM283(A73F, F89M, S76W) has a score of −312.802 REU. DM225(T33R, S76Y) has a score of −314.501 REU. DM307(N35T, S76F) has a score of −312.43 REU. DM216(V20I, S76Y) has a score of −316.389 REU. DM182(S76F, K25R) has a score of −313.12 REU. DM303(N35T, S76W) has a score of −312.963 REU. DM237(T33R, S76W) has a score of −311.444 REU. DM263(A73F, F89M, S76F) has a score of −315.016 REU. DM244(D68N, R84L, S76W) has a score of −316.843 REU. DM214(A73V, S76Y) has a score of −316.179 REU. DM201(I26W, Q28K, S76Y) has a score of −319.166 REU. DM261(I75L, S76F) has a score of −311.468 REU. DM180(Q28K, I26T, S76Y) has a score of −315.492 REU. DM260(V20I, S76F) has a score of −314.026 REU. DM243(D68N, R84L, S76Y) has a score of −317.997 REU. DM285(C41S, S76W) has a score of −311.278 REU. DM257(V64I, S76F) has a score of −313.764 REU. DM280(V20I, S76W) has a score of −313.281 REU. DM239(D68N, S76W) has a score of −313.781 REU. DM200(I26W, Q28E, S76Y) has a score of −319.278 REU. DM198(I26W, Q28K, S76W) has a score of −316.895 REU. DM181(S76F, I26T) has a score of −312.985 REU. DM265(C41S, S76F) has a score of −312.498 REU. DM187(K25R, Q28R, S76Y) has a score of −313.041 REU. DM302(R84L, S76W) has a score of −317.531 REU. DM258(A73V, S76F) has a score of −317.64 REU. DM233(D68N, S76F) has a score of −314.319 REU. DM264(C41A, S76F) has a score of −315.808 REU. DM147(S76F) has a score of −314.468 REU. DM282(F89M, S76W) has a score of −312.956 REU. DM231(T33R, S76F) has a score of −313.647 REU. DM218(F89M, S76Y) has a score of −317.154 REU.

With regards to Rosetta energy scores for DM31-based variants: DM202(ΔE50, ΔF52, ΔR53, E2N, E23A, Y65R, L70I, A19V, S76Y) has a score of −326.104 REU. DM207(ΔE50, ΔF52, ΔR53, E2N, E23A, Y65R, L70I, I75L, S76Y) has a score of −325.596 REU. DM289(ΔE50, ΔF52, ΔR53, E2N, E23A, Y65R, L70I, N35T, S76Y) has a score of −327.695 REU. DM266(ΔE50, ΔF52, ΔR53, E2N, E23A, Y65R, L70I, A19V, S76W) has a score of −322.122 REU. DM246(ΔE50, ΔF52, ΔR53, E2N, E23A, Y65R, L70I, A19V, S76F) has a score of −322.969 REU. DM210(ΔE50, ΔF52, ΔR53, E2N, E23A, Y65R, L70I, C41A, S76Y) has a score of −328.185 REU. DM271(ΔE50, ΔF52, ΔR53, E2N, E23A, Y65R, L70I, I75L, S76W) has a score of −322.428 REU. DM287(ΔE50, ΔF52, ΔR53, E2N, E23A, Y65R, L70I, C41T, S76Y) has a score of −325.849 REU. DM211(ΔE50, ΔF52, ΔR53, E2N, E23A, Y65R, L70I, C41S, S76Y) has a score of −326.053 REU. DM224(ΔE50, ΔF52, ΔR53, E2N, E23A, Y65R, L70I, D68N, S76Y) has a score of −327.546 REU. DM203(ΔE50, ΔF52, ΔR53, E2N, E23A, Y65R, L70I, V64I, S76Y) has a score of −326.036 REU. DM161(ΔE50, ΔF52, ΔR53, E2N, E23A, Y65R, L70I, S76W, I26T) has a score of −323.585 REU. DM274(ΔE50, ΔF52, ΔR53, E2N, E23A, Y65R, L70I, C41A, S76W) has a score of −324.868 REU. DM273(ΔE50, ΔF52, ΔR53, E2N, E23A, Y65R, L70I, A73F, F89M, S76W) has a score of −324.977 REU. DM222(ΔE50, ΔF52, ΔR53, E2N, E23A, Y65R, L70I, T33R, S76Y) has a score of −326.421 REU. DM295(ΔE50, ΔF52, ΔR53, E2N, E23A, Y65R, L70I, N35T, S76F) has a score of −324.151 REU. DM206(ΔE50, ΔF52, ΔR53, E2N, E23A, Y65R, L70I, V20I, S76Y) has a score of −327.962 REU. DM160(ΔE50, ΔF52, ΔR53, E2N, E23A, Y65R, L70I, S76F, K25R) has a score of −324.536 REU. DM292(ΔE50, ΔF52, ΔR53, E2N, E23A, Y65R, L70I, N35T, S76W) has a score of −324.361 REU. DM234(ΔE50, ΔF52, ΔR53, E2N, E23A, Y65R, L70I, T33R, S76W) has a score of −322.785 REU. DM241(ΔE50, ΔF52, ΔR53, E2N, E23A, Y65R, L70I, D68N, R84L, S76W) has a score of −327.95 REU. DM204(ΔE50, ΔF52, ΔR53, E2N, E23A, Y65R, L70I, A73V, S76Y) has a score of −327.016 REU. DM128(ΔE50, ΔF52, ΔR53, E2N, E23A, Y65R, L70I, I26W, Q28K, S76Y) has a score of −329.989 REU. DM251(ΔE50, ΔF52, ΔR53, E2N, E23A, Y65R, L70I, I75L, S76F) has a score of −322.262 REU. DM158(ΔE50, ΔF52, ΔR53, E2N, E23A, Y65R, L70I, Q28K, I26T, S76Y) has a score of −326.098 REU. DM250(ΔE50, ΔF52, ΔR53, E2N, E23A, Y65R, L70I, V20I, S76F) has a score of −324.555 REU. DM240(ΔE50, ΔF52, ΔR53, E2N, E23A, Y65R, L70I, D68N, R84L, S76Y) has a score of −328.51 REU. DM275(ΔE50, ΔF52, ΔR53, E2N, E23A, Y65R, L70I, C41S, S76W) has a score of −321.76 REU. DM247(ΔE50, ΔF52, ΔR53, E2N, E23A, Y65R, L70I, V64I, S76F) has a score of −324.213 REU. DM270(ΔE50, ΔF52, ΔR53, E2N, E23A, Y65R, L70I, V20I, S76W) has a score of −323.622 REU. DM236(ΔE50, ΔF52, ΔR53, E2N, E23A, Y65R, L70I, D68N, S76W) has a score of −324.065 REU. DM127(ΔE50, ΔF52, ΔR53, E2N, E23A, Y65R, L70I, I26W, Q28E, S76Y) has a score of −329.421 REU. DM178(ΔE50, ΔF52, ΔR53, E2N, E23A, Y65R, L70I, I26W, Q28K, S76W) has a score of −326.997 REU. DM159(ΔE50, ΔF52, ΔR53, E2N, E23A, Y65R, L70I, S76F, I26T) has a score of −323.01 REU. DM255(ΔE50, ΔF52, ΔR53, E2N, E23A, Y65R, L70I, C41S, S76F) has a score of −322.513 REU. DM165(ΔE50, ΔF52, ΔR53, E2N, E23A, Y65R, L70I, K25R, Q28R, S76Y) has a score of −322.968 REU. DM174(ΔE50, ΔF52, ΔR53, E2N, E23A, Y65R, L70I, R84L, S76W) has a score of −327.282 REU. DM248(ΔE50, ΔF52, ΔR53, E2N, E23A, Y65R, L70I, A73V, S76F) has a score of −327.375 REU. DM230(ΔE50, ΔF52, ΔR53, E2N, E23A, Y65R, L70I, D68N, S76F) has a score of −324.008 REU. DM254(ΔE50, ΔF52, ΔR53, E2N, E23A, Y65R, L70I, C41A, S76F) has a score of −325.464 REU. DM272(ΔE50, ΔF52, ΔR53, E2N, E23A, Y65R, L70I, F89M, S76W) has a score of −322.55 REU. DM228(ΔE50, ΔF52, ΔR53, E2N, E23A, Y65R, L70I, T33R, S76F) has a score of −323.104 REU. DM208(ΔE50, ΔF52, ΔR53, E2N, E23A, Y65R, L70I, F89M, S76Y) has a score of −326.518 REU. DM679 (ΔE50, ΔF52, ΔR53, E2N, E23A, Y65R, L70I, V20I, D68N, S76F) has score of −324.319 REU. DM687 (ΔE50, ΔF52, ΔR53, E2N, E23A, Y65R, L70I, C41T, Q28K, S76F) has score of −323.70 REU. DM688 (ΔE50, ΔF52, ΔR53, E2N, E23A, Y65R, L70I, C41T, Q28R, S76W) has score of −320.87 REU. DM689 (ΔE50, ΔF52, ΔR53, E2N, E23A, Y65R, L70I, C41T, Q28R, S76F) has score of −322.01 REU.

### Example 2: Cloning, Expression, and Characterization of MNEI Designer Proteins

Recombinant MNEI proteins are produced in E. coli BL21(DE3+) under a T7 promoter induced with Isopropyl ß-D-1-thiogalactopyranoside (IPTG). Using this system, MNEI proteins are expressed as cytosolic protein (soluble fraction) in a high-density fermentation process. Designer MNEI (DM) are designed proteins with up to 11% amino acid substitutions.

All DMs are produced in E. coli fermentation and purified to a level of >90%.

### Cloning

Site-directed mutagenesis (SDM) was used for creating the DMs.

### Fermentation

All DM clones were produced by bacterial fermentation in flasks incubated at 37 C with horizontal steering. Protein variant production was induced by IPTG.

### Purification

All DM samples are purified using the following steps:
1. Lysis by pressure homogenizer.
2. Capture of the protein on a multimode resin, elution with increasing NaCl concentration in the same buffer.

At least one polishing step using resins from the following groups:
1. Ion exchange.
2. Hydrophobic interaction.
3. Size exclusion.
4. Final microbial filtration (0.2 um) and storage at 2-8° C.

### Characterization

### Purification Level

Purification level is evaluated by SDS-page followed by Coomassie blue staining and RP-HPLC.

### Sweetness Evaluation

Amai Proteins uses a routine, bi-weekly, expert panel for sensory evaluation. The sensory panel includes panelists who are calibrated with sugar solutions on a scale of 0-100 (magnitude estimation), with 0=not sweet at all and 100=very sweet. Linear scale for sucrose is obtained in concentrations of 2° Bx, 4° Bx, 6° Bx, and 8° Bx.

Brix (Bx)=gr/100 ml. After calibration, tasters graded the tested samples on the same scale according to the validated tasting protocol.

The new selected DMs were tested at 6° Bx equivalent at a potency of ×3500 in water solution.

All the tested products were served using code numbers.

Before and between samples, the tasters were requested to rinse their mouth with mineral water, eat an unsalted cracker and a cucumber, and drink water again.

Sweetness after Heat Treatment

Measuring the sweetness intensity of the new DMs after heat treatment at 95° C. for 30 min.

The new DMs were tested at 5° Bx equivalent at a potency of ×5000 in buffer citrate (pH˜3.1).

The buffer citrate was heated in the thermomix to 95° C., then the DM was added to the thermomix and the temperature was kept at 95° C. for 30 minutes. Then the heated buffer solution with the DM was poured into a bottle and cooled down immediately. The sweetness intensity was measured at room temperature.

All the tested products were served using code numbers.

Before and between samples, the tasters were requested to rinse their mouth with mineral water, eat an unsalted cracker and a cucumber, and drink water again.

### Time Intensity

### Time Intensity=Measuring Sweetness Intensity Over Time.

1. The new selected DMs were tested at 6° Bx equivalent at a potency of ×3500 in water solution.
2. Panelists were calibrated first with sugar solutions (in water) on a scale of 0-100, while 0=not sweet at all. Calibration solutions used were 4° Bx sucrose (defined as 50 sweetness) and 8° Bx (defined as 100 sweetness grade).
3. After calibration, the tasters preformed time-intensity evaluation for each sample according to the following stages:
   a. After giving a signal, all tasters put the sample in their mouth, rolled it in their oral cavity for 2 seconds, and then swallowed.
   b. After swallowing, the guide measured times, and at each time point, the taster was asked to grade the currently sensed sweetness intensity on the same scale (0-100) until the taste has disappeared.
   c. The time periods examined were: 1, 2, 5, 7, 10, 15, 20, 30, 40, 50, 60, 70, 80, 90, 100, 110, 120, 135, 150, 180, 210, 240, 270, and 300 seconds.
4. All the tested products were served using code numbers.
5. Before and between samples, the tasters were requested to rinse their mouth with mineral water, eat an unsalted cracker and a cucumber, and drink water again.

### DSF and DSC Analysis—Heat Sensitivity

Relative Tm is determined by Differential Scanning Fluorimetry (DSF) using Nanotemper Prometheus. DSF is a method for easy, rapid, and accurate analysis of protein stability and aggregation. DSF detects changes in the fluorescence of tryptophan and tyrosine residues in the protein. The fluorescence of tryptophan and tyrosine residues is strongly dependent on their close surroundings. A change in protein conformation will be reflected as a fluorescence change. The 1^{st} derivate of the fluorescence ratio (330/350) is used to determine the inflection point. Since no secondary reporter fluorophores are required, protein solutions can be analyzed independently of buffer compositions and over a concentration range of 250 mg/ml down to 10 μg/ml. DMs are analyzed at a concentration of 0.5 mg/ml in a 10 mM phosphate buffer pH 7.

TABLE 3
experimental results

| | | Tm | | Sweetness | Delta_time/ |
|---|---|---|---|---|---|
| | Amino acid modifications as | measured | | after heat | max |
| | compared to MNEI (SEQ ID | by DSF | Sweetness | treatment | intensity |
| | NO: 1) | (° C.) | vs DM31 ^{#} | vs DM31 ^{#} | vs DM31 ^{#} |
| MNEI | | 73 | | | |
| DM31 | ΔE50, ΔF52, | 94 | 1 | 1.00 | 1 |
| | ΔR53, E2N, E23A, Y65R, L70I | | | | |
| DM114 | ΔE50, ΔF52, ΔR53, E2N, E23A, | 101.5 | 0.86 | 0.97 | 0.74 |
| | Y65R, L70I, S76F | | | | |
| DM137 | ΔE50, ΔF52, ΔR53, E2N, E23A, | 97 | 0.93 | 0.97 | 0.9 |
| | Y65R, L70I, S76W | | | | |
| DM89 | ΔE50, ΔF52, ΔR53, E2N, E23A, | 101 | 1.02 | 0.84 | 0.89 |
| | Y65R, L70I, S76Y | | | | |
| DM129 | S76Y | 80 | 0.35 | | |
| DM130 | E23A, Y65R, S76Y, C41A | 91 | 0.73 | 0.81 | |
| DM41 | ΔE50, ΔF52, ΔR53, E2N, E23A, | 94 | 0.84 | | |
| | Y65R, L70I, I26S | | | | |
| DM42 | ΔE50, ΔF52, ΔR53, E2N, E23A, | 99 | 1 | 0.58 | |
| | Y65R, L70I, I26T | | | | |
| DM100 | ΔE50, ΔF52, ΔR53, E2N, E23A, | >100 | 0.61 | | |
| | Y65R, L70I, S76Y, I26T | | | | |
| DM43 | ΔE50, ΔF52, ΔR53, E2N, E23A, | 94 | 1.06 | 1.27 | 1.11 |
| | Y65R, L70I, K25R | | | | |
| DM101 | ΔE50, ΔF52, ΔR53, E2N, E23A, | 96 | 0.83 | | |
| | Y65R, L70I, S76Y, K25R | | | | |
| DM108 | ΔE50, ΔF52, ΔR53, E2N, E23A, | 81 | 1.13 | | |
| | Y65R, L70I, D68T | | | | |
| DM87 | ΔE50, ΔF52, ΔR53, E2N, E23A, | 90 | 1.05 | 1.23 | 1.17 |
| | Y65R, L70I, D68N | | | | |
| DM224 | ΔE50, ΔF52, ΔR53, E2N, E23A, | 95 | 0.96 | 0.94 | |
| | Y65R, L70I, D68N, S76Y | | | | |
| DM69 | ΔE50, ΔF52, ΔR53, E2N, E23A, | 97.5 | 1.2 | 1.75 | 1.34 |
| | Y65R, L70I, K25R, Q28K | | | | |
| DM165 | ΔE50, ΔF52, ΔR53, E2N, E23A, | 99 | 1.09 | | 1.23 |
| | Y65R, L70I, K25R, Q28R, S76Y | | | | |
| DM464 | ΔE50, ΔF52, ΔR53, E2N, E23A, | 88 | 1.11 | | 1.12 |
| | Y65R, L70I, K25R, D68N | | | | |
| DM479 | ΔE50, ΔF52, ΔR53, E2N, E23A, | 97 | | | |
| | Y65R, L70I, K25R, D68N, S76Y | | | | |
| DM66 | ΔE50, ΔF52, ΔR53, E2N, E23A, | 95 | 1.14 | 1.17 | 1.27 |
| | Y65R, L70I, Q28R | | | | |
| DM517 | ΔE50, ΔF52, ΔR53, E2N, E23A, | 100 | 1.07 | 1.1 | 0.92 |
| | Y65R, L70I, Q28R, S76Y | | | | |
| DM65 | ΔE50, ΔF52, ΔR53, E2N, E23A, | 88 | 1.2 | 1.26 | 0.91 |
| | Y65R, L70I, Q28K | | | | |
| DM46 | ΔE50, ΔF52, ΔR53, E2N, E23A, | 88.8 | 0.95 | 1.08 | 0.97 |
| | Y65R, L70I, C41T | | | | |
| DM472 | ΔE50, ΔF52, ΔR53, E2N, E23A, | 100 | 1.05 | | 1.32 |
| | Y65R, L70I, D68N, Q28K, S76Y | | | | |
| DM151 | ΔE50, ΔF52, ΔR53, E2N, E23A, | 88 | 0.96 | 1.29 | |
| | Y65R, L70I, C41S | | | | |
| DM346 | ΔE50, ΔF52, ΔR53, E2N, E23A, | 97 | 0.92 | | 1.03 |
| | Y65R, L70I, C41S, S76Y | | | | |
| DM150 | ΔE50, ΔF52, ΔR53, E2N, E23A, | | 0.98 | 1.17 | |
| | Y65R, L70I, C41A | | | | |
| DM210 | ΔE50, ΔF52, ΔR53, E2N, E23A, | | 0.99 | | |
| | Y65R, L70I, C41A, S76Y | | | | |
| DM209 | ΔE50, ΔF52, ΔR53, E2N, E23A, | 96 | 0.41 | | |
| | Y65R, L70I, A73F, F89M, S76Y | | | | |
| DM77 | ΔE50, ΔF52, ΔR53, E2N, E23A, | 88 | 1.03 | 1.13 | 1.02 |
| | Y65R, L70I, A19V | | | | |
| DM202 | ΔE50, ΔF52, ΔR53, E2N, E23A, | 96 | 0.87 | | 0.74 |
| | Y65R, L70I, A19V, S76Y | | | | |
| DM96 | ΔE50, ΔF52, ΔR53, E2N, E23A, | 92.5 | 1.06 | 1.18 | 1.15 |
| | Y65R, L70I, V20I | | | | |
| DM206 | ΔE50, ΔF52, ΔR53, E2N, E23A, | 100 | 0.94 | | 1.00 |
| | Y65R, L70I, V20I, S76Y | | | | |
| DM330 | ΔE50, ΔF52, ΔR53, E2N, E23A, | 94.1 | 0.94 | | |
| | Y65R, L70I, Q28S | | | | |
| DM42 | ΔE50, ΔF52, ΔR53, E2N, E23A, | 99 | 1 | 0.58 | |
| | Y65R, L70I, I26T | | | | |
| DM456 | ΔE50, ΔF52, ΔR53, E2N, E23A, | 104 | 0.88 | | |
| | Y65R, L70I, Q28S, I26T, S76Y | | | | |
| DM29 | ΔE50, ΔF52, ΔR53 | 80.1 | | | |
| DM472 | ΔE50, ΔF52, ΔR53, E2N, E23A, | 100 | 1.05 | | 1.32 |
| | Y65R, L70I, D68N, Q28K, S76Y | | | | |
| DM361 | ΔE50, ΔF52, ΔR53, E2N, E23A, | 97 | 0.85 | | |
| | L70I, D68N, S76Y | | | | |

^{#} Determined by sensory panel.

Delta time/max intensity vs DM31 is the ratio between the delta time and max sweetness intensity of a DM. Delta time is the difference between the time point of sweetness equals to zero and the beginning of the experiment. Maximal sweetness intensity is the maximum value of sweetness of the DM. For each new variant, the ratio Delta time/max intensity of the variant is divided by the same ratio as calculated for DM31, from the same sensory panel.

Table 4 shows predicted Tm values and experimental Tm value of modified proteins with substitutions in amino acid S76.

TABLE 4
comparison of predicted Tm values and experimental
Tm value for exemplary proteins.

| | Amino acid modifications as compared to | Tm measured | Tm predictions |
|---|---|---|---|
| DM | MNEI (SEQ ID NO: 1) | by DSF (° C.) | (° C.) |
| MNEI | | 73 | 66.8 |
| DM31 | ΔE50, ΔF52, ΔR53, E2N, E23A, Y65R, L70I, | 94 | 91.32 |
| DM114 | ΔE50, ΔF52, ΔR53, E2N, E23A, Y65R, | 101.5 | 99.39 |
| | L70I, S76F | | |
| DM137 | ΔE50, ΔF52, ΔR53, E2N, E23A, Y65R, | 97 | 100.77 |
| | L70I, S76W | | |
| DM89 | ΔE50, ΔF52, ΔR53, | 101 | 98.19 |
| | E2N, E23A, Y65R, L70I, S76Y | | |
| DM129 | S76Y | 80 | 79.21 |
| DM130 | S76Y, E23A, Y65R, C41A | 91 | 89.51 |
| DM100 | ΔE50, ΔF52, ΔR53, E2N, E23A, Y65R, | >100 | 95.57 |
| | L70I, S76Y, I26T | | |
| DM101 | ΔE50, ΔF52, ΔR53, E2N, E23A, Y65R, | 96 | 100.30 |
| | L70I, S76, K25R | | |
| DM224 | ΔE50, ΔF52, ΔR53, E2N, E23A, Y65R, L70I, | 95 | 98.14 |
| | D68N, S76Y | | |
| DM165 | ΔE50, ΔF52, ΔR53, E2N, E23A, Y65R, | 15 Jun. 2023 | 99.19 |
| | L70I, K25R, Q28R, S76Y | | |
| DM479 | ΔE50, ΔF52, ΔR53, E2N, E23A, Y65R, | 97 | 99.57 |
| | L70I, K25R, D68N, S76Y | | |
| DM517 | ΔE50, ΔF52, ΔR53, E2N, E23A, Y65R, | 15 Jun. 2023 | 97.48 |
| | L70I, Q28R, S76Y | | |
| DM472 | ΔE50, ΔF52, ΔR53, E2N, E23A, Y65R, | 100 | 97.47 |
| | L70I, D68N, Q28K, S76Y | | |
| DM346 | ΔE50, ΔF52, ΔR53, E2N, E23A, Y65R, | 97 | 96.21 |
| | L70I, C41S, S76Y | | |
| DM209 | ΔE50, ΔF52, ΔR53, E2N, E23A, Y65R, | 96 | 89.56 |
| | L70I, A73F, F89M, S76Y | | |
| DM202 | ΔE50, ΔF52, ΔR53, E2N, E23A, Y65R, L70I, | 96 | 95.52 |
| | A19V, S76Y | | |
| DM206 | ΔE50, ΔF52, ΔR53, E2N, E23A, Y65R, | 100 | 99.77 |
| | L70I, V20I, S76Y | | |
| DM330 | ΔE50, ΔF52, ΔR53, E2N, E23A, Y65R, | 94.1 | 91.78 |
| | L70I, Q28S | | |
| DM456 | ΔE50, ΔF52, ΔR53, E2N, E23A, Y65R, | 104 | 92.73 |
| | L70I, Q28S, I26T, S76Y | | |

As can be seen, the prediction follows the experimental data. This suggested that the predicted Tm values can be used to predict the experimental Tm. As can be seen from this Table, modifications in amino acid S76 either on MNEI or as comparted to DM31 increased the Tm value. Based on these results, it was suggested that different modifications in this amino acid are highly effective as they significantly increase the stability of the protein.

Combining Substitutions in S76 with Loop Remodeling:

It was suggested that the L23 loop of MNEI is close to amino acid S76 and hence it was suggested that substitutions at amino acid S76 may improve stability.

Several modified proteins were prepared with substitutions in S76. Table 3 shows a list of modified proteins in which amino acid S76 was substituted and the experimental results for these proteins. Some variants were based on S76 in the context of DM31.

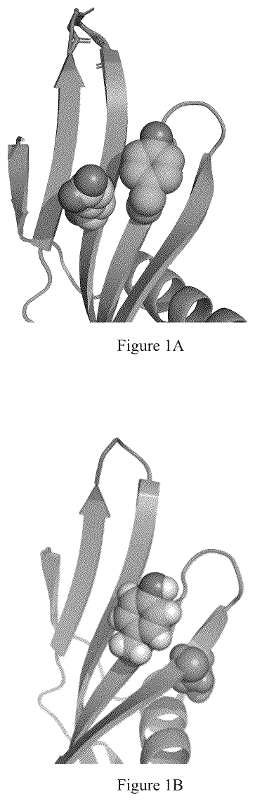

FIG. 1A shows DM89 (ΔE50, ΔF52, ΔR53, E2N, E23A, Y65R, L70I, S76Y) with the L23 loop in magenta and S76Y in cyan. The proximity of the loop and S76 is clearly visible. This indicates to the possibility of an interaction and possible synergism. The results show that indeed adding the substitution in residue S76 to DM31 increased stability, as can be seen by DSF results (Table 3). DM89 (ΔE50, ΔF52, ΔR53, E2N, E23A, Y65R, L70I, S76Y) is as sweet as or slightly sweeter than DM31, with a Tm of 101° C. In addition, it has decreased lingering effect compared to DM31, shown in the fact that DM89 has −10% reduction in Delta time/Maximum sweetness intensity (Table 3). DM89 (ΔE50, ΔF52, ΔR53, E2N, E23A, Y65R, L70I, S76Y, Tm 101° C.), DM114 (ΔE50, ΔF52, ΔR53, E2N, E23A, Y65R, L70I, S76F, Tm 101.5° C.), DM137 (ΔE50, ΔF52, ΔR53, E2N, E23A, Y65R, L70I, S76W, Tm 97° C.) are more stable than DM31. Their sweetness is similar to that of DM31, however, all three proteins exhibit reduced lingering (reduction of more than 25% for DM114, and −10% for DM89 & DM137, see Table 3, Delta time/Maximum sweetness intensity).

### Amino Acid R84:

The minimized model of DM89 (FIG. 1B) reveals that R84 is relatively close to S76. Hence, modified proteins including substitutions in R84 were analyzed.

DM90 (ΔE50, ΔF52, ΔR53, E2N, E23A, Y65R, L70I, R84L, S76Y) has more native contacts, better REU score and lower RMSF AUC than DM70 (ΔE50, ΔF52, ΔR53, E2N, E23A, Y65R, L70I, R8RL), DM89 (ΔE50, ΔF52, ΔR53, E2N, E23A, Y65R, L70I, S76Y) and DM31. In addition, DM90 (ΔE50, ΔF52, ΔR53, E2N, E23A, Y65R, L70I, R84L, S76Y) has Tm prediction of 104° C., higher than DM70 (ΔE50, ΔF52, ΔR53, E2N, E23A, Y65R, L70I, R84L) with experimental Tm of 94° C.

As can be seen from the Tables above, the combination of one or more substitutions provides an increased stability that is higher than each one alone.

Table 5 shows exemplary calculations of representative modified proteins showing the advantages in combining one or more modifications.

| | | | Delta as |
|---|---|---|---|
| | Amino acid modifications as compared | DSF | compared |
| | to MNEI (SEQ ID NO: 1) | (Tm) | with DM31 |
| DM330 | ΔE50, ΔF52, ΔR53, E2N, E23A, Y65R, | 94.1 | 0.1 |
| | L70I, Q28S | | |
| DM42 | ΔE50, ΔF52, ΔR53, | 99 | 5 |
| | E2N, E23A, Y65R, L70I, I26T | | |
| DM89 | ΔE50, ΔF52, ΔR53, | 101 | 7 |
| | E2N, E23A, Y65R, L70I, S76Y | | |
| DM100 | ΔE50, ΔF52, ΔR53, | 100 | 6 |
| | E2N, E23A, Y65R, L70I, I26T, S76Y | | |
| DM456 | ΔE50, ΔF52, ΔR53, | 104 | 10 |
| | E2N, E23A, Y65R, L70I, Q28S, I26T, | | |
| | S76Y | | |
| DM87 | ΔE50, ΔF52, ΔR53, | 90 | −4 |
| | E2N, E23A, Y65R, L70I, D68N | | |
| DM89 | ΔE50, ΔF52, ΔR53, | 101 | 7 |
| | E2N, E23A, Y65R, L70I, S76Y | | |
| DM591 | ΔE50, ΔF52, ΔR53, | 91 | −3 |
| | E2N, E23A, L70I | | |
| DM95 | ΔE50, ΔF52, ΔR53, | 89.5 | −4.5 |
| | E2N, E23A, L70I, D68N | | |
| DM224 | ΔE50, ΔF52, ΔR53, | 95 | 1 |
| | E2N, E23A, Y65R, L70I, D68N, S76Y | | |
| DM361 | ΔE50, ΔF52, ΔR53, | 97 | 3 |
| | E2N, E23A, L70I, D68N, S76Y | | |
| DM43 | ΔE50, ΔF52, ΔR53, | 94 | 0 |
| | E2N, E23A, Y65R, L70I, K25R | | |
| DM89 | ΔE50, ΔF52, ΔR53, | 101 | 7 |
| | E2N, E23A, Y65R, L70I, S76Y | | |
| DM66 | ΔE50, ΔF52, ΔR53, | 95 | 1 |
| | E2N, E23A, Y65R, L70I, Q28R | | |
| DM101 | ΔE50, ΔF52, ΔR53, | 96 | 2 |
| | E2N, E23A, Y65R, L70I, K25R, S76Y | | |
| DM517 | ΔE50, ΔF52, ΔR53, | 100 | 6 |
| | E2N, E23A, Y65R, L70I, Q28R, S76Y | | |
| DM165 | ΔE50, ΔF52, ΔR53, | 99 | 5 |
| | E2N, E23A, Y65R, L70I, K25R, Q28R, | | |
| | S76Y | | |
| DM89 | ΔE50, ΔF52, ΔR53, | 101 | 7 |
| | E2N, E23A, Y65R, L70I, S76Y | | |
| DM151 | ΔE50, ΔF52, ΔR53, | 88 | −6 |
| | E2N, E23A, Y65R, L70I, C41S | | |
| DM346 | ΔE50, ΔF52, ΔR53, | 97 | 3 |
| | E2N, E23A, Y65R, L70I, C41S, S76Y | | |
| DM89 | E50, ΔF52, ΔR53, | 101 | 7 |
| | E2N, E23A, Y65R, L70I, S76Y | | |
| DM87 | E50, ΔF52, ΔR53, | 90 | −4 |
| | E2N, E23A, Y65R, L70I, D68N | | |
| DM65 | E50, ΔF52, ΔR53, | 88 | −6 |
| | E2N, E23A, Y65R, L70I, Q28K | | |
| DM224 | E50, ΔF52, ΔR53, | 95 | 1 |
| | E2N, E23A, Y65R, L70I, D68N, S76Y | | |
| DM472 | E50, ΔF52, ΔR53, | 100 | 6 |
| | E2N, E23A, Y65R, L70I, D6N, Q28K, | | |
| | S76Y | | |
| DM89 | E50, ΔF52, ΔR53, | 101 | 7 |
| | E2N, E23A, Y65R, L70I, S76Y | | |
| DM87 | E50, ΔF52, ΔR53, | 90 | −4 |
| | E2N, E23A, Y65R, L70I, D68N | | |
| DM43 | E50, ΔF52, ΔR53, | 94 | 0 |
| | E2N, E23A, Y65R, L70I, K25R | | |
| DM101 | E50, ΔF52, ΔR53, | 96 | 2 |
| | E2N, E23A, Y65R, L70I, K25R, S76Y | | |
| DM224 | E50, ΔF52, ΔR53, E2N, E23A, Y65R, | 95 | 1 |
| | L70I, D68N, S76Y | | |
| DM479 | E50, ΔF52, ΔR53, | 97 | 3 |
| | E2N, E23A, Y65R, L70I, K25R, D68N, | | |
| | S76Y | | |

The following modified proteins were predicted to have an advantage in combination of modifications DM240, DM641, DM633, DM627, DM171, DM480, DM362, DM236, DM396, DM479, DM167, DM165, DM397, DM679, DM230, DM681, DM361, DM224, DM611, DM620, DM473, DM517, DM472, DM685, DM608, DM628, DM521, DM542, DM477, DM640, DM532, DM528, DM621, DM530, DM360, DM73, DM614, DM526, DM622, DM94, DM486, DM484, DM457, DM209, DM540, DM333, DM511, DM539, DM524, DM148.

The Tm predictions are calculated in comparison to DM31.

All DMs below are based on MNEI (SEQ ID NO: 1) with substitutions of E2N, Y65R, L70I, and E23A and deletions in amino acid E50, F52 and R53, unless declared otherwise.

DM635 ΔE50, ΔF52, ΔR53, E2N, E23A, Y65R, L70I, V20I, R84L, S76Y) The predicted Tm for this DM is 106° C., higher than DM31. The global VoroMQA packing score for this DM (0.51) is higher than DM31 (0.49) and DM89 (0.49), and the residue specific packing score at position 76 (0.60) is much higher than the score for DM31 (0.52) and DM89 (0.53).

DM286 ΔE50, ΔF52, ΔR53, E2N, E23A, Y65R, L70I, R31T, S76Y) Tm prediction of 101° C. which is surprisingly high comparing to Tm predictions of 95° C. (DM47) and 98° C. (DM89).

DMs which Combine a Substitution in S76 with Substitutions of D68, T33, G1M, G2M:

Taking into account the computational analysis and the predictions obtained with S76, the inventors have designed additional proteins with additional substitutions that are suggested to have improved properties, such as improved stability.

The inventors have initially verified the effect of substitutions in D68. D68N was previously shown to increase sweetness (Kohmura 1992) but it's effect on stability was not described.

The following modified proteins were designed to predict the effect of substitution in D68:

Modification of DM31 with substitution D68T (DM108) was shown to increase sweetness (Table 3).

As can be seen from Table 2, the Rosetta energy score for substitutions, D68N+S76Y on MNEI (DM227) is lower by 1.3 REU, whereas the same substitutions on DM31 (DM224) improve the energy score by −5.9 REU. DM224 REU score suggested its high stability. This indicates that there is a synergistic effect when combining D68N+S76Y with the substitutions made in DM31.

These computational conclusions were verified experimentally and as can be seen in Table 3, DM224 (ΔE50, ΔF52, ΔR53, E2N, E23A, Y65R, L70I, D68N, S76Y) has an higher sweetness and a high stability as compared to DM87 (ΔE50, ΔF52, ΔR53, E2N, E23A, Y65R, L70I, D68N) (Table 3).

DM361 (ΔE50, ΔF52, ΔR53, E2N, E23A, L70I, D68N, S76Y) has higher Tm (97° C.) than DM224 (D68N, S76Y)(95° C.) (Table 3) and its stability predictions are better (Table 2). DM361 experimental Tm is 97° C., which is 3 degrees more than DM31. Also, the Tm of the comprising substitutions in DM87 (ΔE50, ΔF52, ΔR53, E2N, E23A, L70I, D68N, Tm 90° C.), DM89 ΔE50, ΔF52, ΔR53, E2N, E23A, Y65R, L70T, S76Y, Tm 101°) and DM591 ΔE50, ΔF52, ΔR53, E2N, E23A, L70I), Tm of 91° C.). Thus, the combination of D68N, S76Y and R65Y(reverse) is synergistic.

DM397 (ΔE50, ΔF52, ΔR53, E2N, E23A, Y65R, L70I, S76Y, D68N) with Tm prediction of 99.06° C. and ΔTm of 7.74° C., exhibits synergism since it possesses a ΔTm that is better than the sum of the ΔTms (3.4° C.) of the following DMs comprising it: DM87 (ΔE50, ΔF52, ΔR53, E2N, E23A, Y65R, L70I, D68N) with Tm prediction of 87.09° C., DM89 (ΔE50, ΔF52, ΔR53, E2N, E23A, Y65R, L70I, S76Y) with Tm prediction of 98.19° C., DM142 (ΔE50, ΔF52, ΔR53, E2N, E23A, Y65R) with Tm prediction of 91.52° C., DM591 (ΔE50, ΔF52, ΔR53, E2N, E23A, L70I) with Tm prediction of 91.89° C.

DM362 (ΔE50, ΔF52, ΔR53, E23A, S76Y, D68N) has Tm prediction of 100° C., which is higher than DM224 (ΔE50, ΔF52, ΔR53, E2N, E23A, Y65R, L70I, D68N, S76Y). It has a Tm prediction of 100.32° C. and ΔTm of 9.0° C., and exhibits synergism since it possesses a ΔTm that is better than the sum of the ΔTms (5.44° C.) of the following DMs comprising it: DM87 (ΔE50, ΔF52, ΔR53, E2N, E23A, L70I, D68N, Tm prediction of 87.09° C.), DM122 (ΔE50, ΔF52, ΔR53, E23A, Y65R, L70I, S76Y), Tm prediction of 100.23° C.), DM142 (ΔE50, ΔF52, ΔR53, E2N, E23A, Y65R), Tm prediction of 91.52° C.), DM591 (ΔE50, ΔF52, ΔR53, E2N, E23A, L70I), Tm prediction of 91.89° C.).

substitution

DM627 (ΔE50, ΔF52, ΔR53, E2N, E23A, Y65R, L70I, D68N, R31T, S76Y) with Tm prediction of 100.65° C. and ΔTm of 9.33° C., it exhibits synergism since it possesses a ΔTm that is better than the sum of the ΔTms (5.55° C.) of the following DMs comprising it: DM87 (ΔE50, ΔF52, ΔR53, E2N, E23A, Y65R, L70I, D68N) with Tm prediction of 87.09° C., DM286 (ΔE50, ΔF52, ΔR53, E2N, E23A, Y65R, L70I, R31T, S76Y) with Tm prediction of 101.1° C.

DM642 (ΔE50, ΔF52, ΔR53, E2N, E23A, Y65R, L70I, D68T, R31T, S76Y) has Tm prediction of 101° C., whereas DM567 (D68T, R31T) has Tm prediction of 94° C.

DM614 (ΔE50, ΔF52, ΔR53, E2N, E23A, Y65R, L70I, D68N, T33R, S76Y) has Tm prediction of 94° C., higher than DM31, DM511 (ΔE50, ΔF52, ΔR53, E2N, E23A, Y65R, L70I, D68N, T33R), DM87 (ΔE50, ΔF52, ΔR53, E2N, E23A, Y65R, L70I, D68N) and DM57 (ΔE50, ΔF52, ΔR53, E2N, E23A, Y65R, L70I, T33R). Molecular dynamics analysis showed that it has better REU and more native contacts than DM31. This DM has a ΔTm of 2.6° C., it exhibits synergism since it possesses a ΔTm that is better than the sum of the ΔTms (−0.77° C.) of the following DMs comprising it: DM57 (ΔE50, ΔF52, ΔR53, E2N, E23A, Y65R, L70I, T33R) with Tm prediction of 87.92° C., DM87 (ΔE50, ΔF52, ΔR53, E2N, E23A, Y65R, L70I, D68N) with Tm prediction of 87.09° C., DM89 (ΔE50, ΔF52, ΔR53, E2N, E23A, Y65R, L70I, S76Y) with Tm prediction of 98.19° C.

DM542 (ΔE50, ΔF52, ΔR53, E2N, E23A, Y65R, L70I, D68N, Q28R, S76Y) is based on DM66 (ΔE50, ΔF52, ΔR53, E2N, E23A, Y65R, L70I, Q28R) which has higher sweetness. DM542 has a higher predicted Tm than DM540 (ΔE50, ΔF52, ΔR53, E2N, E23A, Y65R, L70I, D68N, Q28R). With a Tm prediction of 96.7° C. and ΔTm of 5.38° C., this DM exhibits synergism since it possesses a ΔTm that is better than the sum of the ΔTms (−11.49° C.) of the following DMs comprising it: DM66 (ΔE50, ΔF52, ΔR53, E2N, E23A, Y65R, L70I, Q28R) with Tm prediction of 77.2° C., DM87 (D68N) with Tm prediction of 87.09° C., DM89 (ΔE50, ΔF52, ΔR53, E2N, E23A, Y65R, L70I, S76Y) with Tm prediction of 98.19° C.

DM240 (ΔE50, ΔF52, ΔR53, E2N, E23A, Y65R, L70I, D68N, R84L, S76Y) with Tm prediction of 104.03° C. and ΔTm of 12.71° C., it exhibits synergism since it possesses a ΔTm that is better than the sum of the ΔTms (8.85° C.) of the following DMs comprising it: DM87 (ΔE50, ΔF52, ΔR53, E2N, E23A, Y65R, L70I, D68N) with Tm prediction of 87.09° C., DM90 (ΔE50, ΔF52, ΔR53, E2N, E23A, Y65R, L70I, S76Y, R84L) with Tm prediction of 104.4° C. Additionally, there is synergism in the Rosetta energy scores. These combinations lead to an improvement of 6.85 REU on DM31 and lead to a smaller improvement of only 2.65 REU on MNEI, indicating that there is synergism of these substitutions with the modifications of DM31.

DM472 (ΔE50, ΔF52, ΔR53, E2N, E23A, Y65R, L70I, D68N, Q28K, S76Y) has higher Tm than DM31 (100° C.). It exhibits synergism since it possesses a delta in Tm of 6° C., which is better than sum of delta Tm of DM89 (ΔE50, ΔF52, ΔR53, E2N, E23A, Y65R, L70I, S76Y), DM87 (ΔE50, ΔF52, ΔR53, E2N, E23A, Y65R, L70I, D68N) and DM65 (ΔE50, ΔF52, ΔR53, E2N, E23A, Y65R, L70I, Q28K), or DM224 (ΔE50, ΔF52, ΔR53, E2N, E23A, Y65R, L70I, D68N, S76Y) with DM65 (ΔE50, ΔF52, ΔR53, E2N, E23A, Y65R, L70I, Q28K). DM479 (ΔE50, ΔF52, ΔR53, E2N, E23A, Y65R, L70I, K25R, D68N, S76Y) has low RMSF which also indicates high stability. DM479 has Tm of 97 which is better than DM31 in 3 degrees. It exhibits synergism since it possesses a delta in Tm of 3 degrees, which is better than sum of delta Tm of DM101 (ΔE50, ΔF52, ΔR53, E2N, E23A, Y65R, L70I, K25R, S76Y), DM87 (ΔE50, ΔF52, ΔR53, E2N, E23A, Y65R, L70I, D68N), or DM224 (ΔE50, ΔF52, ΔR53, E2N, E23A, Y65R, L70I, D68N, S76Y) with DM43 (ΔE50, ΔF52, ΔR53, E2N, E23A, Y65R, L70I, K25R). DM240 (ΔE50, ΔF52, ΔR53, E2N, E23A, Y65R, L70I, D68N, R84L, S76Y) has a high predicted Tm, REU −329, which has improvement of 6.9 REU—better from than the improvement of DM243(ΔE50, ΔF52, ΔR53, E2N, E23A, Y65R, L70I, D68N, R84L, S76Y) from MNEI (2.6 REU)—indicating synergic effect of that combination with DM31, and better RMSF AUC.

DM241 (ΔE50, ΔF52, ΔR53, E2N, E23A, Y65R, L70I, D68N, R84L, S76W) has lower REU than DM137 (ΔE50, ΔF52, ΔR53, E2N, E23A, Y65R, L70I, S76W), DM70 (ΔE50, ΔF52, ΔR53, E2N, E23A, Y65R, L70I, R84L), DM87 (ΔE50, ΔF52, ΔR53, E2N, E23A, Y65R, L70I, D68N), DM31. The Rosetta score of DM241 is −327.9 REU, an improvement of 6 REU from DM31, higher when compared to DM244 (ΔE50, ΔF52, ΔR53, E2N, E23A, Y65R, L70I, D68N, R84L, S76W on MNEI) with an improvement of −1.50 on MNEI—these data indicated that the combination with DM31 work in synergism.

DM236 (ΔE50, ΔF52, ΔR53, E2N, E23A, Y65R, L70I, D68N, S76W) The Rosetta energy score for these substitutions on MNEI (ΔE50, ΔF52, ΔR53, E2N, E23A, Y65R, L70I, DM239) is reduced by 1.6 REU as compared to MNEI, whereas the same substitutions (ΔE50, ΔF52, ΔR53, E2N, E23A, Y65R, L70I, D68N, S76W) on DM31 improved the energy score by −2.4 REU as compared to DM31. This indicates that there is a synergistic effect when combining the substitutions D68N, S76W (of DM236) and the modifications of DM31. This DM has a Tm of 99.75 and ΔTm of 8.43, exhibits synergism since it possesses a ΔTm that is better than the sum of the ΔTms (5.21) of the following DMs comprising it: DM87 (ΔE50, ΔF52, ΔR53, E2N, E23A, Y65R, L70I, D68N) with Tm of 87.09, DM137 (ΔE50, ΔF52, ΔR53, E2N, E23A, Y65R, L70I, S76W) with Tm of 97.

DM230 (ΔE50, ΔF52, ΔR53, E2N, E23A, Y65R, L70I, D68N, S76F) The Rosetta energy score for these substitutions on MNEI (DM233) is reduced by 1.0 REU as comparted to MNEI, whereas the same substitutions (D68N, S76F) on DM31 improved the energy score by −2.3 REU. This indicates that there is a synergistic effect when combining the substitutions (D68N, S76F) of DM230 and the modifications of DM31. This DM has a Tm of 98.95 and ΔTm of 7.63, exhibits synergism since it possesses a ΔTm that is better than the sum of the ΔTms (3.83) of the following DMs comprising it: DM87 (ΔE50, ΔF52, ΔR53, E2N, E23A, Y65R, L70I, D68N) with Tm of 87.09, DM114 (ΔE50, ΔF52, ΔR53, E2N, E23A, Y65R, L70I, S76F) with Tm of 99.39.

DM608 (ΔE50, ΔF52, ΔR53, E2N, E23A, Y65R, L70I, D68T, Q28R, S76Y) has higher Tm prediction than DM108 (ΔE50, ΔF52, ΔR53, E2N, E23A, Y65R, L70I, D68T) and DM66 (ΔE50, ΔF52, ΔR53, E2N, E23A, Y65R, L70I, Q28R). With a ΔTm of 5.74° C., it exhibits synergism since it possesses a ΔTm that is better than the sum of the ΔTms (−7.05° C.) of the following DMs comprising it: DM66 (ΔE50, ΔF52, ΔR53, E2N, E23A, Y65R, L70I, Q28R) with Tm prediction of 77.2° C., DM649 (ΔE50, ΔF52, ΔR53, E2N, E23A, Y65R, L70I, D68T, S76Y) with Tm prediction of 98.4° C.

DM644 (ΔE50, ΔF52, ΔR53, E2N, E23A, Y65R, L70I, D68T, R84L, S76Y) has Tm prediction of 105. RMSF AUC −0.56 which is similar to DM31, and packing (using VoroMQA) is very good at position 76.

G1M, E2M is a combination known to increase sweetness (Somoza et al 1995). When combining these substitutions with S76Y, DM360 (ΔE50, ΔF52, ΔR53, E2N, E23A, Y65R, L70I, G1M, E2M, S76Y) had lower beta sheet RMSD and lower REU than DM413 (ΔE50, ΔF52, ΔR53, E2N, E23A, Y65R, L70I, G1M, S76Y). DM360 also has a Tm prediction of 94.48° C. and ΔTm of 3.16° C., it exhibits synergism since it possesses a ΔTm that is better than the sum of the ΔTms (1.09° C.) of the following DMs comprising it: DM89 (ΔE50, ΔF52, ΔR53, E2N, E23A, Y65R, L70I, S76Y) with Tm prediction of 98.19° C., DM395 (ΔE50, ΔF52, ΔR53, E2N, E23A, Y65R, L70I, E2M) with Tm prediction of 90.63° C., DM412 (ΔE50, ΔF52, ΔR53, E2N, E23A, Y65R, L70I, G1M) with Tm prediction of 86.23° C.

DM396 (ΔE50, ΔF52, ΔR53, E2N, E23A, Y65R, L70I, E2M, S76Y) contains E2M which was mentioned by Zhao et al. 2018 as increasing sweetness. Its sweetness is 3-fold higher than that of MNEI, however, its Tm is 4° degrees lower than MNEI (see Zhao et al.), indicating a significant reduction in stability. Based on the prediction model, we predicted an increment of 9° C. for the combination of E2M & S76Y on the template of DM31. DM396's (ΔE50, ΔF52, ΔR53, E2N, E23A, Y65R, L70I, E2M, S76Y) predicted Tm is 99.6° C. It exhibits synergism since it possesses a ΔTm that is better than the sum of the ΔTms (6.18° C.) of the following DMs comprising it: DM89 (ΔE50, ΔF52, ΔR53, E2N, E23A, Y65R, L70I, S76Y) with Tm prediction of 98.19° C., DM395 (ΔE50, ΔF52, ΔR53, E2N, E23A, Y65R, L70I, E2M) with Tm prediction of 90.63° C.

DM222 (ΔE50, ΔF52, ΔR53, E2N, E23A, Y65R, L70I, T33R, S76Y) has a higher Tm prediction (98.19° C.) than DM57 (ΔE50, ΔF52, ΔR53, E2N, E23A, Y65R, L70I, T33R) (87.92° C.). RMSF is similar to DM57 (ΔE50, ΔF52, ΔR53, E2N, E23A, Y65R, L70I, T33R) and DM89 (ΔE50, ΔF52, ΔR53, E2N, E23A, Y65R, L70I, S76Y). The Rosetta energy score for these substitutions on MNEI (DM225) is lower by 0.8 REU, whereas the same substitutions on DM31 improve the energy score by −4.8 REU. This indicates that there is a synergistic effect with the substitutions of DM222 and the modifications of DM31.

DM638 (ΔE50, ΔF52, ΔR53, E2N, E23A, Y65R, L70I, T33R, R84L, S76Y) has a Tm prediction of 101.2

DM622 (ΔE50, ΔF52, ΔR53, E2N, E23A, Y65R, L70I, T33R, Q28R, S76Y) Tm prediction is higher than DM539 (ΔE50, ΔF52, ΔR53, E2N, E23A, Y65R, L70I, T33R, Q28R), DM57 (ΔE50, ΔF52, ΔR53, E2N, E23A, Y65R, L70I, T33R) and DM65 (ΔE50, ΔF52, ΔR53, E2N, E23A, Y65R, L70T, Q28K). Both Q28R and T33R have been shown to increase sweetness (Table 3). With a Tm prediction of 93.72° C. and ΔTm of 2.4° C., this DM exhibits synergism since it possesses a ΔTm that is better than the sum of the ΔTms (−10.65° C.) of the following DMs comprising it: DM57 (ΔE50, ΔF52, ΔR53, E2N, E23A, Y65R, L70I, T33R) with Tm prediction of 87.92° C., DM66 (ΔE50, ΔF52, ΔR53, E2N, E23A, Y65R, L70I, Q28R) with Tm prediction of 77.2° C., DM89 (ΔE50, ΔF52, ΔR53, E2N, E23A, Y65R, L70I, S76Y) with Tm prediction of 98.19° C.

DM242 (ΔE50, ΔF52, ΔR53, E2N, E23A, Y65R, L70I, D68N, R84L, S76F) The Tm for this DM is predicted to be 105° C. which is higher than DM70 (ΔE50, ΔF52, ΔR53, E2N, E23A, Y65R, L70I, R84L), DM87 (ΔE50, ΔF52, ΔR53, E2N, E23A, Y65R, L70I, D68N) and DM114 (ΔE50, ΔF52, ΔR53, E2N, E23A, Y65R, L70I, S76F), it has REU of −328, its difference from DM31 is 6.6 units, which is higher improvement than DM245 (ΔE50, ΔF52, ΔR53, E2N, E23A, Y65R, L70I, D68N, R84L, S76F on MNEI, which improve in 3.8 REU), meaning that this combination has synergetic effect on DM31.

DM628 (ΔE50, ΔF52, ΔR53, E2N, E23A, Y65R, L70I, D68N, N35T, S76Y) with Tm prediction of 96.88° C. and ΔTm of 5.56° C., it exhibits synergism since it possesses a ΔTm that is better than the sum of the ΔTms (3.04° C.) of the following DMs comprising it: DM87 (ΔE50, ΔF52, ΔR53, E2N, E23A, Y65R, L70I, D68N) with Tm of 87.09° C., DM289 (ΔE50, ΔF52, ΔR53, E2N, E23A, Y65R, L70I, N35T, S76Y) with Tm of 98.6° C.

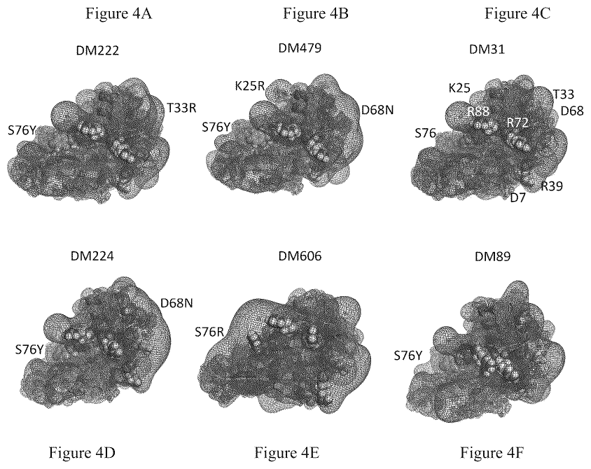

FIG. 4 shows the electrostatics potential of DM31 (FIG. 4C), DM89 (FIG. 4F) (ΔE50, ΔF52, ΔR53, E2N, E23A, Y65R, L70I, S76Y), DM222 (FIG. 4A) (ΔE50, ΔF52, ΔR53, E2N, E23A, Y65R, L70I, T33R, S76Y), DM224 (FIG. 4D) (D68N, S76Y), DM479 (FIG. 4B) (ΔE50, ΔF52, ΔR53, E2N, E23A, Y65R, L70I, K25R, D68N, S76Y), DM606 (FIG. 4E) (ΔE50, ΔF52, ΔR53, E2N, E23A, Y65R, L70I, S76R). Residues which are known for their importance for sweetness are labeled and presented as spheres. R88 and R72, R39, K36 and D7 which are known to be important to receptor's binding and sweetness (Somoza et al 1995, Yang et al 2020, Liu et al 2012). Substitutions of the specific DMs are labeled and presented as spheres. S76Y does not interfere with the positive electrostatic surface of R88, R72, R39. T33R and D68N increase the positive surface imbalance and therefore have a positive effect on sweetness.

Core Substitutions in Conjunction with S76Y

Additional modified proteins were designed in which MNEI core region was substituted.

DM247 (ΔE50, ΔF52, ΔR53, E2N, E23A, Y65R, L70I, V64I, S76F) The Rosetta energy score for these substitutions on MNEI (DM257) is worse by 1.6 REU, whereas the same substitutions on DM31 improve the energy score by −2.6 REU. This indicates that there is a synergistic effect with the substitutions of DM247 and the modifications of DM31.

DM202 (ΔE50, ΔF52, ΔR53, E2N, E23A, Y65R, L70I, A19V, S76Y) has experimental Tm of 96° C., which is higher than DM31. The RMSF AUC for this variant also indicates stability. Additionally, the global VoroMQA packing score(0.52) for this variant is better than those of DM31 (0.49) and DM89(0.49). Notably, DM202 has better REU than DM31, decreasing 4 points (−326.1 for DM202 vs. −321.66 for DM31), however the substitutions A19V, S76Y on MNEI (DM212) increase REU by 11 points (−304.31 for DM212 vs. −315 for MNEI). This implies that A19V, S76Y has a synergistic effect with DM31's substitutions and deletions. DM276 (ΔE50, ΔF52, ΔR53, E2N, E23A, Y65R, L70I, A19V, S76W) and DM256 (ΔE50, ΔF52, ΔR53, E2N, E23A, Y65R, L70I, A19V, S76F) decrease REU by 8 points compared to MNEI. However, the same substitutions on DM31, i.e., DM266 (ΔE50, ΔF52, ΔR53, E2N, E23A, Y65R, L70I, A19V, S76W) and DM246 (ΔE50, ΔF52, ΔR53, E2N, E23A, Y65R, L70I, A19V, S76F) increase REU by 1 point. In conclusion, the interaction of residues 19 and 76 is synergistic with other substitutions of DM31.

DM204 (ΔE50, ΔF52, ΔR53, E2N, E23A, Y65R, L70I, A73V, S76Y) This DM has a predicted Tm of 93° C., indicating increased stability. The global VoroMQA packing score(0.51) is higher than that of its predecessors DM31(0.49), DM89(0.49) and DM85(0.5) (A73V on DM31). The Rosetta energy score (REU) for this variant is similar to that of DM89, and higher than DM31 and DM85. Its Rosetta score is −327 REU, an improvement of 5 REU from DM31, which is bigger when compared to DM214(A73V, S76Y on MNEI), that had no improvement at all from MNEI—that indicated that the combination with DM31 works in synergism.

DM206 (ΔE50, ΔF52, ΔR53, E2N, E23A, Y65R, L70I, V20I, S76Y) exhibits experimental Tm is 96° C., higher than DM31. The Rosetta energy score (REU) for this variant is better than that of DM31 by −6 REUs, and also better than DM89 and DM96 (V20I on DM31). The same substitutions on MNEI (DM216) improved REU by −1, this indicates a synergistic effect between the substitutions of DM206 and the modifications of DM31.

DM250 ΔE50, ΔF52, ΔR53, E2N, E23A, Y65R, L70I, V20I, S76F) decreased REU by 3 points vs. DM31. However, DM260 (V20I, S76F on MNEI) increased REU by 1 point vs. MNEI. This indicates a synergistic effect between the substitutions of DM250 and the modifications of DM31.

DM209 (ΔE50, ΔF52, ΔR53, E2N, E23A, Y65R, L70I, A73F, F89M, S76Y) Its experimental Tm is 96° C., which is higher than DM31. This combination of substitutions improves REU by 8 points (−328.41 of DM209 vs. −321.66 of D31). However, the same combination on MNEI (DM219) does not improve the REU (−315 in both MNEI and DM219). Which means A73F, F89M, S76Y is synergistic with DM31 substitutions and deletions.

DM253 ΔE50, ΔF52, ΔR53, E2N, E23A, Y65R, L70I, A73F, F89M, S76F) improves REU by 6 points (−326.13 for DM253 vs −321.66 for DM31). However, the same combination on MNEI (DM263) does not improve the REU (−315 in both MNEI and DM263). Which means A73F, F89M, S76F is synergistic with DM31 substitutions. This DM has a ΔREU of −4.47, therefore it exhibits synergism since it possesses a ΔREU that is better than the sum of the ΔREUs (−0.86) of the following DMs comprising it: DM131 (ΔE50, ΔF52, ΔR53, E2N, E23A, L70I, A73F) with REU of −320.83, DM252 (ΔE50, ΔF52, ΔR53, E2N, E23A, L70I, F89M, S76F) with REU of −323.36. Additionally, it exhibits synergism since it possesses a ΔREU that is better than the sum of the ΔREUs (0.06) of the following DMs comprising it: DM104 (ΔE50, ΔF52, ΔR53, E2N, E23A, L70I, F89M) with REU of −319.99, DM114 (ΔE50, ΔF52, ΔR53, E2N, E23A, L70I, S76F) with REU of −324.1, DM131 (ΔE50, ΔF52, ΔR53, E2N, E23A, L70I, A73F) with REU of −320.83.

DM273 (ΔE50, ΔF52, ΔR53, E2N, E23A, Y65R, L70I, A73F, F89M, S76W) improves REU by 3.3 points, however, the same combination on MNEI (DM283) increase REU by 2.5 points. Which means A73F, F89M, S76W is synergistic with DM31 substitutions. This DM has a ΔREU of −3.32, exhibits synergism since it possesses a ΔREU that is better than the sum of the ΔREUs (−0.06) of the following DMs comprising it: DM131 (ΔE50, ΔF52, ΔR53, E2N, E23A, L70I, A73F) with REU of −320.83, DM272 (ΔE50, ΔF52, ΔR53, E2N, E23A, L70I, F89M, S76W) with REU of −322.55. Additionally, it exhibits synergism since it possesses a ΔREU that is better than the sum of the ΔREUs (0.21) of the following DMs comprising it: DM104 (ΔE50, ΔF52, ΔR53, E2N, E23A, L70I, F89M) with REU of −319.99, DM131 (ΔE50, ΔF52, ΔR53, E2N, E23A, L70I, A73F) with REU of −320.83, DM137 (ΔE50, ΔF52, ΔR53, E2N, E23A, L70I, S76W) with REU of −323.95.

DM248 (ΔE50, ΔF52, ΔR53, E2N, E23A, Y65R, L70I, A73V, S76F) The predicted Tm for this DM is 95° C., indicating good stability. The Rosetta energy score (REU) for this DM is almost identical to that of DM89, and is greater than the sum of the effects of substitutions to A73V (DM85) and S76F (DM114) alone. Its Rosetta score is −327 REU, an improvement of 5.7 REU from DM31, which is bigger when compared to DM258(A73V, S76F on MNEI), that had only 2.3 REU improvement from MNEI—that indicated that the combination with DM31 works in synergism. The average native contacts for this DM is higher than that of DM31. The A73V substitution (DM85) has a higher global VoroMQA packing score(0.5) than DM31 and DM89(0.49), this effect is carried over into DM248 and is not seen in DM114 (ΔE50, ΔF52, ΔR53, E2N, E23A, Y65R, L70I, S76F) where a reduction in residue specific packing is observed at positions 73 and 76. The substitution to phenylalanine at position 76 is found in structural homologs with similar folding to this stem and loop structure.

DM210 (ΔE50, ΔF52, ΔR53, E2N, E23A, Y65R, L70I, C41A, S76Y) The Tm of this DM is predicted to be 96° C., higher than DM31. The Rosetta energy score for this DM is much better than DM31 Rosetta score of −328 REU—an improvement of 6.5 compared to DM31. The same combination on MNEI (DM220) led to a poorer Rosetta score by 1.6 REUs from MNEI, indicating a synergetic effect of the combination with DM31.

DM208 (ΔE50, ΔF52, ΔR53, E2N, E23A, Y65R, L70I, C41A, S76F) decreases REU by 4 points comparing to DM31, whereas DM264 (C41A, S76F on MNEI) has the same REU as MNEI. This implies synergism of C41A, S76F with DM31 substitutions and deletions.

DM274 (ΔE50, ΔF52, ΔR53, E2N, E23A, Y65R, L70I, C41A, S76W) lowers REU by 3 points comparing to DM31. However DM284 (C41A, S76W on MNEI) increase REU of MNEI by 2.9 points. This implies synergism of C41A+S76W with DM31 substitutions and deletions.

DM346 (ΔE5, ΔF52, ΔR53, E2N, E23A, Y65R, L70I, C41S, S76Y) The Tm measured by DSF for this DM is 97° C., higher than DM31 and DM151 (ΔE50, ΔF52, ΔR53, E2N, E23A, L70I, C41S). The RMSF AUC for this DM is better than DM31, DM89 and DM151. The average native contacts is also better than DM31. The Rosetta score is better than DM31 and DM151. The residue specific VoroMQA packing score is better at position 76 (0.54) in comparison to DM31(0.52) and DM89(0.53). DM221 (C41S, S76Y on MNEI) increased REU of MNEI by 2.8 points. However, DM346 decreased REU by 4.3 points. This implies the synergism between C41S, S76Y and DM31 substitutions and deletions.

DM287(ΔE50, ΔF52, ΔR53, E2N, E23A, Y65R, L70I, C41T, S76Y) The predicted Tm for this DM is 96° C., higher than DM31. The VoroMQA global packing score (0.5) for this DM is better than DM31(0.49), DM89(0.49) and DM46 (C41T on DM31) whose score is identical. Surprisingly, the RMSF AUC for this DM is significantly worse than DM31, DM89 and DM46, where the values for DM89 and DM46 are similar and better than DM31. Despite this predicted instability, the Tm is higher than DM31. DM287 lowers REU of DM31 by 4 points. However, the same substitutions on MNEI (DM297) increase REU by 3 points. This implies synergistic effect between C41T, S76Y and DM31 substitutions and deletions.

DM477 (ΔE50, ΔF52, ΔR53, E2N, E23A, L70I, C41T, D68N, S76Y) The predicted Tm for this DM is 97° C., higher than DM31 and ΔTm of 5.3° C., it exhibits synergism since it possesses a ΔTm that is better than the sum of the ΔTms (1.38° C.) of the following DMs comprising it: DM87 (ΔE50, ΔF52, ΔR53, E2N, E23A, L70T, D68N) with Tm prediction of 87.09° C., DM287 (ΔE50, ΔF52, ΔR53, E2N, E23A, L70I, C41T, S76Y) with Tm prediction of 96.37° C., DM591 (ΔE50, ΔF52, ΔR53, E2N, E23A, L70I) with Tm prediction of 91.89° C.

DM203 (ΔE50, ΔF52, ΔR53, E2N, E23A, Y65R, L70I, V64I, S76Y) The Rosetta energy score for these substitutions on MNEI (DM213) is worse by 2.2 REU, whereas the same substitutions on DM31 improve the energy score by −4.4 REU. This indicates that there is a synergistic effect with the substitutions of DM203 and DM31.

DM207 (ΔE50, ΔF52, ΔR53, E2N, E23A, L70I, I75L, S76Y) has REU of −325.6 with improves DM31 by 3 points. However, DM217 (ΔE50, ΔF52, ΔR53, E2N, E23A, L70I, I75L, S76Y on MNEI) has REU of −308.12 which increase MNEI REU (−315) by 11 points. This implies an synergism between I75L, S76Y and DM31 substitutions and deletions.

DM595 (ΔE50, ΔF52, ΔR53, E2N, E23A, Y65R, L70I, I75V, S76Y, E77V) The predicted Tm for this DM is 102° C., higher than all the DMs that comprise it: DM31, DM89, DM593, DM594, DM600, DM601. The average β-sheet RMSD is also lower compared to the DMs that comprise it, indicating that the β-sheet is stabilized by these substitutions.

DM611 (ΔE50, ΔF52, ΔR53, E2N, E23A, Y65R, L70I, V20I, D68N, S76Y) The predicted Tm for this DM is 98° C., higher than DM31. With a ΔTm of 6.78° C., it exhibits synergism since it possesses a ΔTm that is better than the sum of the ΔTms (4.08° C.) of the following DMs comprising it: DM87 (D68N) with Tm prediction of 87.09° C., DM89 (S76Y) with Tm prediction of 98.19° C., DM96 (V20I) with Tm prediction of 92.76° C.

DM679 (ΔE50, ΔF52, ΔR53, E2N, E23A, Y65R, L70I, V20I, D68N, S76F) with Tm prediction of 98.98° C. and ΔTm of 7.66° C., it exhibits synergism since it possesses a ΔTm that is better than the sum of the ΔTms (5.28° C.) of the following DMs comprising it: DM87 (D68N) with Tm prediction of 87.09° C., DM96 (V20I) with Tm prediction of 92.76° C., DM114 (S76F) with Tm prediction of 99.39° C.

DM620 (ΔE50, ΔF52, ΔR53, E2N, E23A, Y65R, L70I, V20I, Q28R, S76Y) The predicted Tm for this DM is 98° C., higher than DM31. Both V20I and Q28R were shown to increase sweetness (Table 3). This DM has a ΔTm of 6.58° C., it exhibits synergism since it possesses a ΔTm that is better than the sum of the ΔTms (−5.81° C.) of the following DMs comprising it: DM66 (Q28R) with Tm prediction of 77.2° C., DM89 (S76Y) with Tm prediction of 98.19° C., DM96 (V20I) with Tm prediction of 92.76° C.

DM681 (ΔE50, ΔF52, ΔR53, E2N, E23A, Y65R, L70I, V20I, Q28R, S76F) with Tm prediction of 98.64° C. and ΔTm of 7.32° C., it exhibits synergism since it possesses a ΔTm that is better than the sum of the ΔTms (−4.61° C.) of the following DMs comprising it: DM66 (Q28R) with Tm prediction of 77.2° C., DM96 (V20I) with Tm prediction of 92.76° C., DM114 (S76F) with Tm prediction of 99.39° C.

DM621 (ΔE50, ΔF52, ΔR53, E2N, E23A, Y65R, L70I, A19V, Q28R, S76Y) The predicted Tm for this DM is 95° C., higher than DM31. Both A19V and Q28R were shown to increase sweetness (Table 3). With a ΔTm of 3.93° C., it exhibits synergism since it possesses a ΔTm that is better than the sum of the ΔTms (−9.92° C.) of the following DMs comprising it: DM66 (Q28R) with Tm prediction of 77.2° C., DM202 (A19V, S76Y) with Tm prediction of 95.52° C.

DM289 (ΔE50, ΔF52, ΔR53, E2N, E23A, Y65R, L70I, N35T, S76Y) has Tm prediction of 98° C. RMSF_AUC is better than DM31. It also improves REU by 6 points. However, DM299 (N35T, S76Y on MNEI) increase REU by 3 points, which implies a synergistic effect between N35T, S76Y and DM31 substitutions and deletions.

DM292 ΔE50, ΔF52, ΔR53, E2N, E23A, Y65R, L70I, N35T, S76W) This combination of substitutions on DM31 improves the Rosetta energy score by 2.7 REU, whereas these substitutions on MNEI lead to a Rosetta score that is worse by 2.38 REU. These results indicate that there is a synergistic effect between these substitutions and the modifications of DM31 relative to MNEI.

DM626 ΔE50, ΔF52, (ΔE50, ΔF52, ΔR53, E2N, E23A, Y65R, L70I, A19V, R84L, S76Y) The predicted Tm for this DM is 101° C., higher than DM31 and equal to DM89. The Rosetta energy score for this DM is better than that of DM31 (˜−4 ΔREU).

DM633 (ΔE50, ΔF52, ΔR53, E2N, E23A, Y65R, L70I, ((ΔE50, ΔF52, ΔR53, E2N, E23A, Y65R, L70I, V20I, R31T, S76Y) The predicted Tm for this DM is 102° C., higher than DM31 and DM89 and all its precursors (DM96, DM47, DM286, DM206). With a ΔTm of 10.36° C., it exhibits synergism since it possesses a ΔTm that is better than the sum of the ΔTms (8.13° C.) of the following DMs comprising it: DM89 (S76Y) with Tm prediction of 98.19° C., DM555 (ΔE50, ΔF52,

((ΔE50, ΔF52, ΔR53, E2N, E23A, Y65R, L70I, V20I, R31T) with Tm prediction of 92.58° C. The Rosetta energy score for this DM was higher than DM31 and DM89. The average native contacts for this DM are better than all its predecessors except for DM89.

DM600 ΔE50, ΔF52, ((ΔE50, ΔF52, ΔR53, E2N, E23A, Y65R, L70I, I75V, S76Y) possesses a predicted Tm (99.6° C.) that is surprisingly and synergistically greater than the sum of the substitutions (DM601 and DM89) that comprise it. The RMSF AUC for this DM is better than DM31. The I75V substitution is correlated with S76Y in comparison to spatially similar stem and loop structures found in other proteins. It also possesses a global VoroMQA packing score(0.5) that is better than its predecessors: DM31(0.49), DM89(0.49) and DM601.

DM208 ΔE50, ΔF52, ((ΔE50, ΔF52, ΔR53, E2N, E23A, Y65R, L70I, F89M, S76Y) has a Rosetta score: −326 REU, an improvement of 4.8 REU from DM31, which is bigger when compared to DM218 (F89M, S76Y on MNEI), that had only 1.8 REU improvement from MNEI—that indicates that the combination with DM31 works in synergism.

### Helix Related

S76Y was also combined with two substitutions of the helix capping, DM100 and DM101. DM100 is very stable—its experimental Tm is 100° C., which is 6 degrees more than DM31. DM101 is very stable—its experimental Tm is 96° C., which is 2 degrees more than DM31. In these DMs which have DM31 changes, including loop remodeling, S76Y and an helix capping substitution, it was suggested that they have following synergic effects:
Beta is stabilized by the rigidification of the loop
Beta is protected from water with S76Y
Helix is stabilized with the helix capping substitution
Native contacts of DM100 and DM101 are higher than DM31, DM89 (but not DM130).

DM100 show higher number than MNEI, DM31 and DM130, of backbone H-bonds which are the intra-beta-sheet and intra-helical. These H-bonds keep the secondary structure of these segments during simulations. The fraction of canonical helix in DM100 is also higher in DM100, comparing to these references.

Combining Beta-Sheet Stability with Alpha Helix for Synergic Stability Increase:

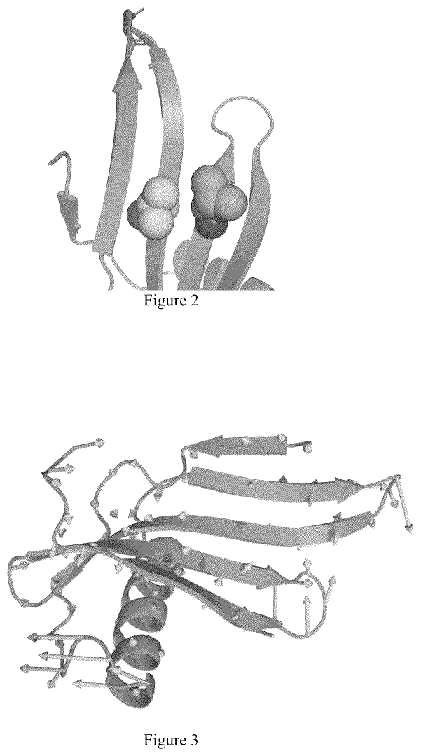

ANM analysis (FIG. 3) shows that the global movement of MNEI is mainly driven by two flexible areas in the protein: 1—The β-hairpins comprised of β-strands 2 and 3, and β-strands 4 and 5 which drive the motion of the β-sheet; 2—The helix, and its C-terminal loop. Joint rigidification of those two key areas is predicted to result in a synergistic increase in stability. This is done by joining the S76Y modification to modifications in the helix C-terminus: Q28K, Q28R, Q28S, K25R.

### Q28K:

This substitution was originally found by Leone et al. (Leone 2016) to increase sweetness. It was found that Q28K strengthens the helix end via improved packing of this region (ref PCT march). We have combined these two substitutions in DM363 ΔE50, ΔF52, ΔR53, E2N, E23A, Y65R, L70I, Q28K, S76Y), its MD simulations show that it is better at maintaining the native contacts and that it has RMSD that to some extent is better than that of DM89 (S76Y) (Table 2, RMSD some and). This confirms the hypothesis that the beta sheet and the helix are related.

DM632 ΔE50, ΔF52, ΔR53, E2N, E23A, Y65R, L70I, Q28K, R84L, S76Y) has Tm prediction of 104.5 which is higher than DM31.

DM335 (ΔE50, ΔF52, ΔR53, E23A, Q28K, S76Y) which is Q28K, S76Y on MNEI, was also better at average native contacts and greatly improved RMSD (Table 2).

DM630 ΔE50, ΔF52, ΔR53, E2N, E23A, Y65R, L70I, Q28K, R31T, S76Y) vs DM552 ΔE50, ΔF52, ΔR53, E2N, E23A, Y65R, L70I, Q28K, R31T) will be added later DM158 (ΔE50, ΔF52, ΔR53, E2N, E23A, Y65R, L70I, Q28K, I26T, S76Y) has Tm prediction of 93.98. Its Rosetta score is −326 REU, an improvement of 4.4 REU from DM31, which is bigger when compared to DM180 (Q28K, I26T, S76YonS76Y on MNEI), that had no improvement at all from MNEI—that indicated that the combination with DM31 works in synergism.

DM486 (ΔE50, ΔF52, ΔR53, E2N, E23A, L70I, I26T, Q28K, D68N, S76Y) possesses a similar Tm prediction to DM31 with Tm prediction of 93.48° C. and ΔTm of 2.16° C., it exhibits synergism since it possesses a ΔTm that is better than the sum of the ΔTms (−1.0° C.) of the following DMs comprising it: DM87 (ΔE50, ΔF52, ΔR53, E2N, E23A, Y65R, L70I, D68N) with Tm prediction of 87.09° C., DM158 (ΔE50, ΔF52, ΔR53, E2N, E23A, Y65R, L70I, Q28K, I26T, S76Y) with Tm prediction of 93.98° C., DM591 (ΔE50, ΔF52, ΔR53, E2N, E23A, L70I) with Tm prediction of 91.89° C.

DM456 (ΔE50, ΔF52, ΔR53, E2N, E23A, Y65R, L70I, Q28S, I26T, S76Y). It has better native contacts (Table 2). Its experimental Tm is 104° C., which is 10 degrees more than DM31. It exhibits synergism since it possesses better delta in Tm than sum of delta of DM100 (ΔE50, ΔF52, ΔR53, E2N, E23A, Y65R, L70I, I26T, S76Y) with Tm of 100, and DM330 (ΔE50, ΔF52, ΔR53, E2N, E23A, Y65R, L70I, Q28S) with Tm 94.1. DM455 (ΔE50, ΔF52, ΔR53, E2N, E23A, Y65R, L70I, Q28K, I26V, S76Y) possesses a better Tm prediction to DM31 and. It has better fraction of canonical helix than DM89, DM31 and DM65.

DM473 (ΔE50, ΔF52, ΔR53, E2N, E23A, L70I, D68N, Q28K, S76Y) Has Tm prediction of 97.75 and ΔTm of 6.43° C., it exhibits synergism since it possesses a ΔTm that is better than the sum of the ΔTms (2.85° C.) of the following DMs comprising it: DM87 (ΔE50, ΔF52,

ΔR53, E2N, E23A, Y65R, L70I, D68N) with Tm prediction of 87.09° C., DM363 (ΔE50, ΔF52, ΔR53, E2N, E23A, Y65R, L70I, Q28K, S76Y) with Tm prediction of 97.83° C., DM591 (ΔE50, ΔF52, ΔR53, E2N, E23A, L70I,) with Tm prediction of 91.89° C.

### Helix and Core Combinations to S76Y:

Since the region connecting the beta sheet and the alpha helix is the core of the protein, we have added core modifications to the above combinations, to improve the interaction between these regions and thereby combine the effect of the two-stabilizing modifications.

Residue C41 is in the core of the protein, the C41S substitution was previously shown to increase sweetness (Liu 2015, Zhao 2019). C41A was predicted to have no effect on stability and increase sweetness (Tang 2020).

### Q28R

We have proposed Q28R in March 2023, following the mode of activation of Q28K exhibiting a stronger positive effect on packing.

DM517 (ΔE50, ΔF52, ΔR53, E2N, E23A, Y65R, L70I, Q28R, S76Y). Its experimental Tm is 100° C., which is 6 degrees more than DM31. It's sweetness intensity is similar to DM31. It's sweetness intensity after heat treatment is similar to DM31.MD simulation indicates better H-bonds of the betasheet and better protection of the H-bonds from water (Table 2).

DM641 (ΔE50, ΔF52, ΔR53, E2N, E23A, Y65R, L70I, Q28R, R84L, S76Y) has Tm prediction of 103.8, which is better than Tm of DM31. With a ΔTm of 12.52° C., it exhibits synergism since it possesses a ΔTm that is better than the sum of the ΔTms (−1.04° C.) of the following DMs comprising it: DM66 (ΔE50, ΔF52, ΔR53, E2N, E23A, Y65R, L70I, Q28R) with Tm prediction of 77.2° C., DM90 (ΔE50, ΔF52, ΔR53, E2N, E23A, Y65R, L70I, S76Y, R84L) with Tm prediction of 104.4° C.

DM640 (ΔE50, ΔF52, ΔR53, E2N, E23A, Y65R, L70I, Q28R, N35T, S76Y) with Tm prediction of 96.57° C. and ΔTm of 5.25° C., it exhibits synergism since it possesses a ΔTm that is better than the sum of the ΔTms (−6.84° C.) of the following DMs comprising it: DM66 ((ΔE50, ΔF52, ΔR53, E2N, E23A, Y65R, L70I, Q28R) with Tm of 77.2° C., DM289 (ΔE50, ΔF52, ΔR53, E2N, E23A, Y65R, L70I, N35T, S76Y) with Tm of 98.6° C.

To further improve the stability of the protein and improve the RMSF parameter via modification of the core we have tested the combinations of DM517 with C41A, C41S and C41T. All of these DMs had a Tm prediction better than DM31 and similar to DM89. While DM532 ((ΔE50, ΔF52,

ΔR53, E2N, E23A, Y65R, L70I, C41A, Q28R, S76Y) has a Tm prediction of 96.43° C. and ΔTm of 5.11° C., it exhibits synergism since it possesses a ΔTm that is better than the sum of the ΔTms (−9.79° C.) of the following DMs comprising it: DM66 (ΔE50, ΔF52, ΔR53, E2N, E23A, Y65R, L70I, (Q28R) with Tm prediction of 77.2° C., DM210 (C41A, S76Y) with Tm prediction of 95.65° C. DM528 ((ΔE50, ΔF52, ΔR53, E2N, E23A, Y65R, L70I, (C41T, Q28R, S76Y) and DM530 ((ΔE50, ΔF52, ΔR53, E2N, E23A, Y65R, L70I, C41S, Q28R, S76Y) had better RMSF AUC compared to DM66, DM31 and DM DM89 (Table 2). DM530 also had better RMSD than DM66, DM31 and DM89. Both criteria indicated increases in stability (Table 2). DM530 has a Tm prediction of 94.79° C. and ΔTm of 3.47° C., it exhibits synergism since it possesses a ΔTm that Is better than the sum of the ΔTms (−9.65° C.) of the following DMs comprising it: DM66 ((ΔE50, ΔF52, ΔR53, E2N, E23A, Y65R, L70I, Q28R) with Tm prediction of 77.2° C., DM89 (S76Y) with Tm prediction of 98.19° C., DM702 (C41S) with Tm prediction of 88.93° C.

DM685 (ΔE50, ΔF52, ΔR53, E2N, E23A, Y65R, L70I, C41A, Q28R, S76F) with Tm prediction of 97.31° C. and ΔTm of 5.99° C., it exhibits synergism since it possesses a ΔTm that is better than the sum of the ΔTms (−6.47° C.) of the following DMs comprising it: DM66 ((ΔE50, ΔF52, ΔR53, E2N, E23A, Y65R, L70I, Q28R) with Tm prediction of 77.2° C., DM114 (ΔE50, ΔF52, ΔR53, E2N, E23A, Y65R, L70I, S76F) with Tm prediction of 99.39° C., DM150 (ΔE50, ΔF52, ΔR53, E2N, E23A, Y65R, L70I, C41A) with Tm prediction of 90.9° C.

DM528 (ΔE50, ΔF52, ΔR53, E2N, E23A, Y65R, L70I, C41T, Q28R, S76Y) with Tm prediction of 96.31° C. and ΔTm of 4.99° C., it exhibits synergism since it possesses a ΔTm that is better than the sum of the ΔTms (−9.07° C.) of the following DMs comprising it: DM66 (ΔE50, ΔF52, ΔR53, E2N, E23A, Y65R, L70I, Q28R) with Tm prediction of 77.2° C., DM287 (ΔE50, ΔF52, ΔR53, E2N, E23A, Y65R, L70I, C41T, S76Y) with Tm prediction of 96.37° C.

DM165 (ΔE50, ΔF52, ΔR53, E2N, E23A, Y65R, L70I, K25R, Q28R, S76Y) possesses a better Tm prediction to DM31 and DM89. Its Tm was experimentally assessed (99C). This Tm is synergistic comparing to combination of DM101 (ΔE50, ΔF52, ΔR53, E2N, E23A, Y65R, L70I, K25R, S76Y) with DM66 (ΔE50, ΔF52, ΔR53, E2N, E23A, Y65R, L70I, Q28R) since DM165 has delta of 5 degrees over DM31 whereas DM66 and DM101 have sum of only 3 degrees. DM165 also exhibits synergism in sweetness intensity since increases sweetness more than the combination of DM101 ((ΔE50, ΔF52, ΔR53, E2N, E23A, Y65R, L70I, K25R, S76Y) with DM66 ((ΔE50, ΔF52, ΔR53, E2N, E23A, Y65R, L70I, Q28R). It has better RMSD than DM66, DM31 and DM89 and it better maintains the native contacts of the starting structure (Table 2, average native contacts). DM165 has a lower Rosetta energy score than DM31 by 1 REU (−322.97 vs −321.66), however the same substitutions on MNEI (DM187) increased REU (−313.04 for DM187 vs −315 for MNEI). This might imply synergism for K25R, Q28K and S76Y with DM31 substitutions.

DM167 (ΔE50, ΔF52, ((ΔE50, ΔF52, ΔR53, E2N, E23A, Y65R, L70I, K25R, Q28R, S76F) with Tm prediction of 99.37° C. and ΔTm of 8.05° C., it exhibits synergism since it possesses a ΔTm that is better than the sum of the ΔTms (−5.1° C.) of the following DMs comprising it: DM66 (Q28R) with Tm prediction of 77.2° C., DM160 ((ΔE50, ΔF52, ΔR53, E2N, E23A, Y65R, L70I, S76F, K25R) with Tm prediction of 100.34° C.

DM171 (ΔE50, ΔF52, ΔR53, E2N, E23A, Y65R, L70I, Q28R, R31T, S76Y) possesses a better Tm prediction than DM31 and DM89. It has a Tm prediction of 100.46° C. and ΔTm of 9.14° C., exhibits synergism since it possesses a ΔTm that is better than the sum of the ΔTms (−4.34° C.) of the following DMs comprising it: DM66 ΔE50, ΔF52, ΔR53, E2N, E23A, Y65R, L70I. Q28R) with Tm prediction of 77.2° C., DM286 (ΔE50, ΔF52, ΔR53, E2N, E23A, Y65R, L70I, R31T, S76Y) with Tm prediction of 101.1° C. It has better RMSF AUC compared to DM31.

DM521 ΔE50, ΔF52, ΔR53, E2N, E23A, L70I, D68N, Q28R, S76Y) possesses a Tm prediction that is better than DM31 and similar to DM89 and ΔTm of 5.41° C., it exhibits synergism since it possesses a ΔTm that is better than the sum of the ΔTms (−10.7° C.) of the following DMs comprising it: DM66 ΔE50, ΔF52, ΔR53, E2N, E23A, Y65R, L70I, Q28R) with Tm prediction of 77.2° C., DM87 ΔE50, ΔF52, ΔR53, E2N, E23A, Y65R, L70I, D68N) with Tm prediction of 87.09° C., DM123 (S76Y, R65Y(reverse)) with Tm prediction of 98.98° C.

DM526 ΔE50, ΔF52, ΔR53, E2N, E23A, Y65R, L70I Q28R, I26T, S76Y) possesses a similar Tm prediction to DM31 with Tm prediction of 93.89° C. and ΔTm of 2.57° C., it exhibits synergism since it possesses a ΔTm that is better than the sum of the ΔTms (−9.87° C.) of the following DMs comprising it: DM66 ΔE50, ΔF52,

ΔR53, E2N, E23A, Y65R, L70I, Q28R) with Tm prediction of 77.2° C., DM100 ΔE50, ΔF52, ΔR53, E2N, E23A, Y65R, L70I, S76Y, I26T) with Tm prediction of 95.57° C.

K25R

We have submitted the K25R substitution as part of the March 2023 PCT. This substitution had the effect of stronger H-bonding and protection of the backbone between position 21 and 25 leading to an increase in stability. The composite of K25R and S76Y (DM101: (ΔE50, ΔF52,

ΔR53, E2N, E23A, Y65R, L70I, K25R, S76Y), resulted in better RMSF than of either DM31, DM43 (K25R) and DM89.

DM160 (ΔE50, ΔF52, ΔR53, E2N, E23A, Y65R, L70I, K25R, S76F) has Tm prediction of 100° C. Its REU is better than DM31 (−324.54 vs −321.66). However, K25R, S76F on MNEI (DM182) has worse REU than MNEI (−313.12 for DM182 vs −315 for MNEI). This shows the synergism between K25R, S76F and DM31 substitutions.

DM480 (ΔE50, ΔF52, ΔR53, E2N, E23A, L70I, K25R, D68N, S76Y) possesses a better Tm prediction to DM31 and DM89 (ΔE50, ΔF52, ΔR53, E2N, E23A, Y65R, L70I, S76Y) and ΔTm of 9.01° C., it exhibits synergism since it possesses a ΔTm that is better than the sum of the ΔTms (5.32° C.) of the following DMs comprising it: DM87 (ΔE50, ΔF52, ΔR53, E2N, E23A, Y65R, L70I, D68N) with Tm prediction of 87.09° C., DM101 (ΔE50, ΔF52, ΔR53, E2N, E23A, Y65R, L70I, S76Y, K25R) with Tm prediction of 100.3° C., DM591 (ΔE50, ΔF52, ΔR53, E2N, E23A, L70I) with Tm prediction of 91.89° C. It has better RMSF AUC compared to DM31 (Table 2), and has better RMSD than DM31, DM43(K25R) and DM89 indicating a stronger increase in stability.

DM687 (ΔE50, ΔF52, ΔR53, E2N, E23A, Y65R, L70I, C41T, Q28K, S76F) with REU of −323.7 and ΔREU of −2.04, exhibits synergism since it possesses a ΔREU that is better than the sum of the ΔREUs (−0.01) of the following DMs comprising it: DM65 (ΔE50, ΔF52, ΔR53, E2N, E23A, Y65R, L70I, Q28K) with REU of −320.54, DM294 (ΔE50, ΔF52, ΔR53, E2N, E23A, Y65R, L70I, C41T, S76F) with REU of −322.79. Additionally, it exhibits synergism since it possesses a ΔREU that is better than the sum of the ΔREUs (0.07) of the following DMs comprising it: DM46 (ΔE50, ΔF52, ΔR53, E2N, E23A, Y65R, L70I, C41T) with REU of −320.28, DM65 (ΔE50, ΔF52, ΔR53, E2N, E23A, Y65R, L70I, Q28K) with REU of −320.54, DM114 (ΔE50, ΔF52,

ΔR53, E2N, E23A, Y65R, L70I, S76F) with REU of −324.1.

DM127 (ΔE50, ΔF52, ΔR53, E2N, E23A, Y65R, L70I, I26W, Q28E, S76Y) and DM128 (ΔE50, ΔF52, ΔR53, E2N, E23A, Y65R, L70I, I26W, Q28K, S76Y) has Tm predictions that are as good as DM89, with better protected H-bond (water-beta sheet backbone Hbonds, table 2) with favorable minimal REU −329.421 (ΔREU −7.76) and −329.989 (ΔREU −8.33), the improvement of the combination on REU from DM31 were greater than DM200 ((ΔE50, ΔF52, ΔR53, E2N, E23A, Y65R, L70I, I26W, Q28E, S76Y) with ΔREU of −3.93 and DM201 ((ΔE50, ΔF52, ΔR53, E2N, E23A, Y65R, L70I, I26W, Q28K, S76Y) with ΔREU −3.82—which are the same combinations on MNEI—indicating a synergic effect of these combinations with DM31. DM127 and DM128 were better than DM31, DM89, DM115 (ΔE50, ΔF52, ΔR53, E2N, E23A, Y65R, L70I, I26W, Q28E) and DM116 (ΔE50, ΔF52, ΔR53, E2N, E23A, Y65R, L70I, I26W, Q28K).

DM162 (ΔE50, ΔF52,

ΔR53, E2N, E23A, Y65R, L70I, S76W, K25R) possesses a better Tm prediction to DM31 and DM89. Its average native contacts are better than DM31, similar to DM89 (ΔE50, ΔF52, ΔR53, E2N, E23A, Y65R, L70I, S76Y). Its helix more canonical. Its RMSF AUC is better than DM43 (ΔE50, ΔF52, ΔR53, E2N, E23A, Y65R, L70I, K25R).

DM159 (ΔE50, ΔF52, ΔR53, E2N, E23A, Y65R, L70I, S76F, I26T) has Tm prediction of 96, It has better RMSF AUC compared to DM31 and DM89. (Table 2)

DM178 (ΔE50, ΔF52, ΔR53, E2N, E23A, Y65R, L70I, I26W, Q28K, S76W) Rosetta score is −327 REU, an improvement of 5 REU from DM31, which is bigger when compared to DM198(I26W, Q28K, S76W on MNEI), that had only 1.5 REU improvement from MNEI—that indicated that the combination with DM31 works in synergism. Additionally, this DM has a ΔREU of −5.34, and exhibits synergism since it possesses a ΔREU that is better than the sum of the ΔREUs (−2.98) of the following DMs comprising it: DM65 ((ΔE50, ΔF52, ΔR53, E2N, E23A, Y65R, L70I, Q28K) with REU of 320.54, DM137 ((ΔE50, ΔF52, ΔR53, E2N, E23A, Y65R, L70I, S76W) with REU of −323.95, DM144 (I26W) with REU of −323.48.

DM179 (ΔE50, ΔF52, ΔR53, E2N, E23A, Y65R, L70I, I26W, Q28E, S76W) Rosetta score is −326 REU, an improvement of 4.4 REU from DM31, which is bigger when compared to DM199 (I26W, Q28E, S76W on MNEI), that had only 1.5 REU improvement from MNEI—that indicated that the combination with DM31 works in synergism.

DM100 (ΔE50, ΔF52, ΔR53, E2N, E23A, Y65R, L70I, S76Y, I26T) Its experimental Tm is 100° C., which is 10 degrees more than DM31. Shows a higher number than MNEI, DM31 and DM130, of backbone H-bonds which are the intra-beta-sheet and intra-helical H-bonds. These H-bonds maintain the secondary structure of these segments during simulations. The fraction of canonical helix in DM100 is also higher, when comparing to the above reference designs.

DM174 (ΔE50, ΔF52, ΔR53, E2N, E23A, Y65R, L70I, R84L, S76W) Rosetta score is −327 REU, an improvement of 5.6 REU from DM31, which is bigger when compared to DM302 (R84L, S76W on MNEI), that had only 2.2 REU improvement from MNEI—that indicated that the combination with DM31 works in synergism.

### Alternatives to S76Y-Suggesting New Title: Beta Sheet Stabilization Via Protecting the Backbone Hbonds (59Aa-76Aa)

To stabilize the beta sheet of the protein, we added modifications that protect the H-bond of the backbone between β-strands 3 and 4. This is achieved mainly by substitution of the residues in positions 59 and 76 to β-branched or bulky residues. Due to the proximity of position 59 to position 76, substitutions at this position can protect the hydrogen bonds within the β-sheet (FIG. 1A). For example, DM652 (ΔE50, ΔF52, ΔR53, E2N, E23A, Y65R, L70I, E59V, S76Y) has β-branched substitutions and from structural analysis it can be seen that the backbone is not exposed to the solvent (FIG. 2)

DM652 (ΔE50, ΔF52, ΔR53, E2N, E23A, Y65R, L70I, E59V, S76V) The predicted Tm for this DM is 101° C., similar to DM89 and much higher than DM31. The Rosetta energy score is better than DM31 (˜−1.5 ΔREU). The average native contacts for this DM and much higher than that of DM31 and DM89. The replacement of E59V correlates with S76V in homologous structures of this stem loop, together this pair is predominant among these homologous protein substructures.

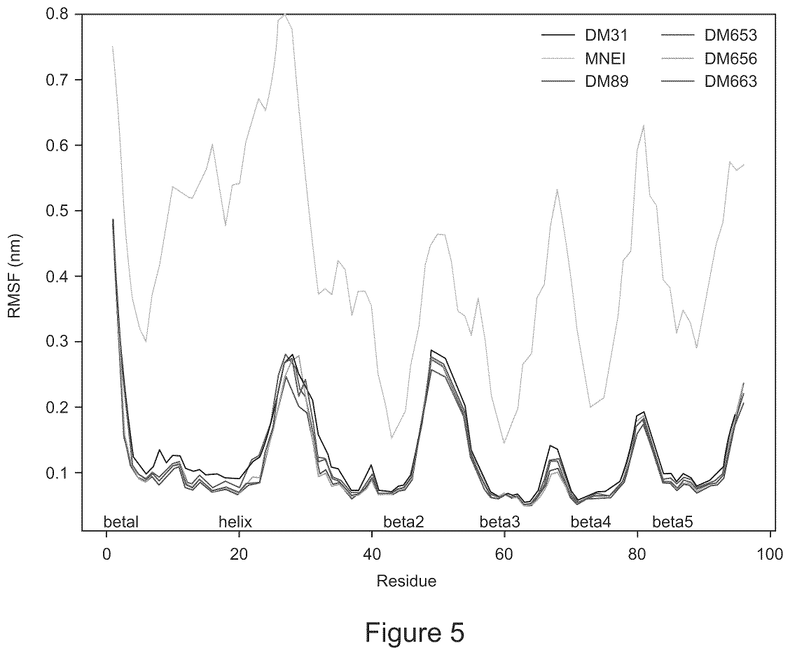

DM653 (ΔE50, ΔF52, ΔR53, E2N, E23A, Y65R, L70I, E59I, S76V) The predicted Tm for this DM is 100° C., similar to DM89 and much higher than DM31. The Rosetta energy score is better than DM31 (˜−2 ΔREU) The RMSF AUC for this DM is better than DM31 (FIG. 5) and DM89(ΔE50, ΔF52, ΔR53, E2N, E23A, Y65R, L70I, S76Y) The average native contacts for this DM is higher than DM31 and slightly lower than DM89. The replacement of E59I correlates with S76V in homologous structures of this stem loop.

DM654 (ΔE50, ΔF52, ΔR53, E2N, E23A, Y65R, L70I, E59T, S76V) The predicted Tm for this DM is 101° C., similar to DM89(ΔE50, ΔF52, ΔR53, E2N, E23A, Y65R, L70I, S76Y) and much higher than DM31. The replacement of E59T correlates with S76V in homologous structures of this stem loop.

DM655 (ΔE50, ΔF52, ΔR53, E2N, E23A, Y65R, L70I, E59V, S76I) The predicted Tm for this DM is 102° C., higher than DM89 and DM31. The Rosetta energy score for this DM is better than DM31 (˜−2 ΔREU), but worse than DM89. The global VoroMQA packing score(0.55) is better than DM31(0.49) and DM89(0.49), with the residue packing score of position 76 (0.66) being higher than DM31(0.52) and DM89(0.53). The RMSF AUC is lower than its precursor DM664 (ΔE50, ΔF52, ΔR53, E2N, E23A, Y65R, L70I, S76I). The Tm value obtained here is surprising since the RMSF AUC value is much worse than DM31 and DM89, the same can be said with regards to average native contacts.

DM656 (ΔE50, ΔF52, ΔR53, E2N, E23A, Y65R, L70I, E59I, S76I) The predicted Tm for this DM is 101° C., similar to DM89 and much higher than DM31. The Rosetta energy score is better than DM31 (˜−3 ΔREU). The RMSF AUC is better than DM31 and DM89 (FIG. 5). The average RMSD of the β-sheet is lower than that of DM31 and DM89 indicating a stabilized sheet. The residue VoroMQA score for positions 59(−0.58), and 76(−0.55) is better than that of DM31(0.57 and 0.52), where the value at position 76 is better than DM89(0.53) as well. The replacement of E59I correlates with S76I in homologous structures of this stem loop.

DM657 (ΔE50, ΔF52, ΔR53, E2N, E23A, Y65R, L70I, E59T, S76I) The predicted Tm for this DM is 102° C., higher than DM89 and DM31. The RMSF AUC is better than DM31 and DM89. The average RMSD of the β-sheet is lower than that of DM31 and DM89 indicating a stabilized sheet. The average native contacts is lower than DM31 and DM89. The Rosetta energy score is similar to DM31. Surprisingly, despite the lower average native contacts and lack of improvement in Rosetta energy score, as compared to DM31, the predicted Tm is very high.

DM662 (ΔE50, ΔF52, ΔR53, E2N, E23A, Y65R, L70I, E59Y, S76V) The predicted Tm for this DM is −100° C., higher than DM31. The Rosetta energy score for this DM is better than DM31 by ˜−2 REU. The average native contacts for this DM are better than that of DM31, DM89 and DM663 (S76V). The global VoroMQA packing score(0.51) for this DM is also better than DM31(0.49) and DM89(0.49) and similar to DM661.

DM663 (ΔE50, ΔF52, ΔR53, E2N, E23A, Y65R, L70I, S76V) The predicted Tm for this DM is 98° C., higher than DM31. The Rosetta energy score for this DM is better than DM31. The RMSF AUC for this DM is better than DM31 and DM89 (FIG. 5). Homologous structures to the stem loop structure in this region often contained valine at position 76.

DM664 (ΔE50, ΔF52, ΔR53, E2N, E23A, Y65R, L70I, S76I) The predicted Tm for this DM is 100° C., much higher than DM31 and similar to DM89. The average native contacts for this DM is higher than DM31 and DM89. The Rosetta energy score for this DM is better then DM31 but worse than DM89. Homologous structures to the stem loop structure in this region often contained isoleucine at position 76.

### Example 3: Energy Bar Formulations with Designer-MNEI (DM) Proteins

Formulations of energy bar with DM proteins are presented in Table 6.

TABLE 6
DM based energy bar formulation (40% added sugar
reduction compared to energy bar without DM)

| Ingredients | Energy bar | |
|---|---|---|
| Whole oatmeal | 21-26 | g |
| Whole crisped rice | 17-22 | g |
| Pecans | 8-12 | g |
| Almonds | 8-12 | g |
| Glucose syrup | 17-22 | g |
| Palm oil | 6-9 | g |
| Glycerol | 1-3 | g |
| Soy lecithin | 0.2-1 | g |
| Salt | 0.1-0.5 | g |
| Maltodextrin | 2-5 | g |
| DM protein | 7-10 | mg |

### Example 4: Marzipan Formulation with Designer-MNEI (DM) Proteins

Marzipan is a confection made primary of grounded almonds and sugar. It is widely used in the baking industry and for the preparation of different kind of sweets. Formulations of Marzipan with DM proteins are presented in Table 7.

TABLE 7
DM based Marzipan formulation (70% added sugar
reduction) compared to energy bar without DM

| Ingredients | percentage |
|---|---|
| White Almonds | 28-48% |
| Maltodextrin | 20-40% |
| Sugar Powder | 3-23% |
| Water | 1-20% |
| Fibers | 1-10% |
| Glucose | 1-5% |
| Lemon Juice | 0.1-0.6% |
| Almond Extract | 0.1-0.6% |
| DM | 0.01-0.05% |

### Preparation Instructions:

Almonds are grinded, all the powders re added gradually to the mixer and grinded well. All the liquid ingredients as well as the sweet protein are added to the mass and continued grinding until a crystalline dough is obtained, 0.01-0.05% by weight of protein is added to the recipe. The DM potency is 1000-3000 and can be equivalent to 25-45 brix.

### Example 5: Non-Dairy Milk Prototype with Designer-Monellin (DM) Proteins

Formulations of non-dairy milk with DM proteins are presented in Table 8.

Table 8: DM based non-dairy milk formulation 50% added sugar reduction compared to non-dairy milk with 50% added sugar reduction

### Formulations:

| Ingredients | Oat milk | |
|---|---|---|
| Oat milk no added sugar | 98-99.4 | g |
| Sugar | 0.6-2 | g |
| AMAI sweet protein DM-31 | 0.3-0.7 | mg |
| Ingredients | Almond milk | |
| Almond milk no added sugar | 98-99.4 | g |
| Sugar | 0.6-2 | g |
| AMAI sweet protein DM-31 | 0.6-1.4 | mg |

| Ingredients | Soy milk | |
|---|---|---|
| Soy milk no added sugar | 97.7-99.3 | g |
| Sugar | 0.7-2.3 | g |
| AMAI sweet protein Dm-31 | 0.8-1.6 | mg |

### Preparation Instructions:

Sugar and AMAI sweet protein DM are added to the unsweetened non-dairy milk and mixes into a homogeneous solution.

### Example 6: Granola Preparations

Formulations of granola with DM proteins are presented in Table 9.

TABLE 9
DM based granola

| Ingredients | Granola | |
|---|---|---|
| Whole oatmeal | 42-47 | g |
| Whole - rice crisped | 12-16 | g |
| Pecans | 9-12 | g |
| Almonds | 9-12 | g |
| Glucose syrup | 4-6 | g |
| powdered sugar (Sucrose) | 1-3 | g |
| Sunflower oil | 6-9 | g |
| Glycerol | 1-3 | g |
| lecithin | 0.2-1 | g |
| Salt | 0.05-0.2 | g |
| Maltodextrin | 2-5 | g |
| DM | 3-7 | mg |

### Preparation Instructions

Oatmeal, rice crisped, pecans, and almonds are toasted for 15 minutes at 160° C.

Glucose syrup, powdered sugar, sunflower oil, glycerol, lecithin, and salt are heated to a homogenous syrup.

The toasted pecans and almonds are crushed to small pieces. The dry ingredients (oatmeal, crisped rice, pecans, and almonds) added to the syrup and mixed. Maltodextrin and DM 31 are added at the end.

The mixture is poured into a baking dish.

The Granola mix is baked for 10 minutes at 90° C., then it is taken out, cooled down, and stored in a cool place in a closed container.

### Example 7: Peanut Butter Spread

Formulations of peanut butter spread for various filling options with DM proteins are presented in Table 10.

TABLE 10
DM based peanut butter spread

| Material | percentage |
|---|---|
| Peanuts | 56-76% |
| Polydextrose | 5-15% |
| Sugar | 3-14 |
| Maltodextrin | 2-13% |
| Fibers | 1-11% |
| Palm oil | 1-5% |
| Salt | 0.1-0.5% |
| DM | 0.1-0.5% |

### Preparation Instructions:

1. Grind the peanuts.
2. Add gradually ingredients 2-7 to the mixer and grind well until homogeneous dough is obtained.
3. Add sweet protein DM to the mass and continue grinding at slow rate to full assimilation.

1. A modified protein having an amino acid sequence comprising at least one amino acid deletion and at least one amino acid substitution as compared to a reference protein, wherein said reference protein is represented by an amino acid sequence set forth in SEQ ID NO:1, wherein said at least one amino acid deletion is at one or more amino acids located between T46 and I56 of said reference protein, and wherein said at least one amino acid substitution is at amino acid S76 of said reference protein.

2. The modified protein of claim 1, wherein said at least one amino acids deletion is at one or more of amino acid E50, F52, R53 or any combination thereof of said reference protein.

3. The modified protein of claim 1, wherein said at least one amino acids deletion comprises deletion of at least three amino acids located between amino acid T46 and amino acid 156.

4. The modified protein of any one of claim 1 to 3, wherein said at least one amino acids deletion comprises deletion of amino acids E50, F52 and R53.

5. The modified protein of any one of the preceding claims, wherein said at least one amino acid substitution comprises at least one amino acid substitution in addition to amino acid substitution is at amino acid S76 of said reference protein.

6. The modified protein of any one of the preceding claims, wherein said at least one amino acid substitution comprises at least two amino acid substitution in addition to amino acid substitution is at amino acid S76 of said reference protein.

7. The modified protein of any one of the preceding claims, wherein said at least one amino acid substitution comprises at least three amino acid substitution in addition to amino acid substitution is at amino acid S76 of said reference protein.

8. The modified protein of any one of the preceding claims, wherein said at least one amino acid substitution comprises amino acid substitution at one or more of amino acid G1, E2, E4, T12, A19, V20, E23, K25, I26, G27, Q28, T33, N35, C41, Q61, V64, Y65, D68, L70, A73, I75, R84, F89 or any combination thereof.

9. The modified protein of any one of the preceding claims, wherein said at least one amino acid substitution comprises one or more amino acid substitution (i) G1M (ii) A19V, (iii) V20I, (iv) K25R, (v) one or more of I26W, I26V or I26T, (vi) one or more of Q28R, Q28K, Q28S, Q28E, (vii) R31T, (viii) T33R, (ix) N35T, (x) one or more of C41A, C41V, C41T or C41S, (xi) one or more of E59T, E59V, E59I, E59Y, E59F, E59W or E59R, (xii) D68N or D68T, (xiii) A73F or A73V, (xiv) D74V, (xv) I75V or I75L, (xvi) E77V, (xvii) R84L.

10. The modified protein of any one of the preceding claims, wherein said at least one amino acid substitution comprises amino acid substitution at one or more of amino acid E2, E23, Y65, L70 or any combination thereof.

11. The modified protein of any one of the preceding claims, wherein said at least one amino acid substitution comprises amino acid substitution at one or more of amino acid E2, E23, Y65, L70.

12. The modified protein of any one of the preceding claims, wherein said amino acid substitution at amino acid S76 is one or more of S76Y, S76F, S76T, S76W, S76R, S76V, S76I, S76H or S76A.

13. The modified protein of any one of the preceding claims, wherein said at least one amino acid substitution comprises amino acid substitution at one or more of amino acid E2N, E23A, Y65R, L70I or any combination thereof.

14. The modified protein of any one of the preceding claims, wherein said at least one amino acid substitution comprises amino acid substitution at one or more of amino acid E2M, E23A, Y65R, L70I or any combination thereof.

15. The modified protein of any one of the preceding claims, wherein said at least one amino acid substitution comprises one or more of amino acid substitutions (i) E2N, E23A, Y65R, L70I, (ii) E2M, E23A, Y65R, L70I (iii) E2N, E23Q, Y65R, L70I or (iv) E2M, E23Q, Y65R, L70I.

16. The modified protein of any one of the preceding claims, wherein said at least one amino acid substitution comprises one or more amino acid substitution (i) G1M (ii) A19V, (iii) V20T, (iv) K25R, (v) one or more of T26W, T26V or T26T, (vi) one or more of Q28R, Q28K, Q28S, Q28E, (vii) R31T, (viii) T33R, (ix) N35T, (x) one or more of C41A, C41V, C41T or C41S, (xi) one or more of E59T, E59V, E59I, E59Y, E59F, E59W or E59R, (xii) D68N or D68T, (xiii) A73F or A73V, (xiv) D74V, (xv) I75V or I75L, (xvi) E77V, (xvii) R84L.

17. The modified protein of any one of the preceding claims, comprising an amino acid sequence set forth in one or more of SEQ ID NO:5, SEQ ID NO:6, SEQ ID NO:7, SEQ ID NO:221, SEQ ID NO:108, SEQ ID NO:9, SEQ ID NO:102, SEQ ID NO:105, SEQ ID NO:52, SEQ ID NO:182, SEQ ID NO:10, SEQ ID NO:69, SEQ ID NO:157, SEQ ID NO:114, SEQ ID NO:174, SEQ ID NO:162, SEQ ID NO:231, SEQ ID NO:57, SEQ ID NO:192, SEQ ID NO:68, SEQ ID NO:106, SEQ ID NO:8, SEQ ID NO:79, SEQ ID NO:76, SEQ ID NO:22, SEQ ID NO: 194, SEQ ID NO:262, SEQ ID NO:84, SEQ ID NO:239, SEQ ID NO:135, SEQ ID NO:211, SEQ ID NO:237, SEQ ID NO:198, SEQ ID NO:179, SEQ ID NO:172 or any combination thereof.

18. The modified protein of any one of the preceding claims, having increased stability as compared to the reference protein.

19. The modified protein of claim 18, wherein said stability is one or more of thermostability, chemical stability (in a range of pH values, varying hydrophobicity levels, in different food and beverage matrices, and in different levels of proteins, lipids, and preservatives in the matrix), functional stability (in terms of sensory profile, short or long term, and including in shelf-life studies).

20. The modified protein of any one of the preceding claims, for use in the preparation of a product for oral delivery.

21. The modified protein of any one of the preceding claims, for use as a flavor modifying agent, a flavor enhancing agent or a flavor masking agent.

22. The modified protein of any one of the preceding claims, for use as a sweetener.

23. The modified protein of any one of the preceding claims, for use as a stabilizer.

24. A food product comprising the modified protein of any one of the preceding claims.

25. A method of increasing stability of a reference protein, said method comprising deleting at least one amino acid of said reference protein and substituting at least one amino of said reference protein, wherein said reference protein is represented by an amino acid sequence set forth in SEQ ID NO:1, wherein said at least one deleted amino acid is at one or more amino acids located between T46 and I56 of said reference protein, and wherein said at least one substituted amino acid is at amino acid S76 of said reference protein.

26. The method of claim 25, wherein said at least one amino acids deletion is at one or more of amino acid E50, F52, R53 or any combination thereof of said reference protein.

27. The method of claim 25, wherein said at least one amino acids deletion comprises deletion of at least three amino acids located between amino acid T46 and amino acid 156.

28. The method of any one of the preceding claims, wherein said at least one amino acids deletion comprises deletion of amino acids E50, F52 and R53.

29. The method of any one of the preceding claims, wherein said at least one amino acid substitution comprises at least one amino acid substitution in addition to amino acid substitution is at amino acid S76 of said reference protein.

30. The method of any one of the preceding claims, wherein said at least one amino acid substitution comprises at least two amino acid substitution in addition to amino acid substitution is at amino acid S76 of said reference protein.

31. The method of any one of the preceding claims, wherein said at least one amino acid substitution comprises at least three amino acid substitution in addition to amino acid substitution is at amino acid S76 of said reference protein.

32. The method of any one of the preceding claims, wherein said at least one amino acid substitution comprises amino acid substitution at one or more of amino acid G1, E2, E4, T12, A19, V20, E23, K25, I26, G27, Q28, T33, N35, C41, Q61, V64, Y65, D68, L70, A73, I75, R84, F89 or any combination thereof.

33. The method of any one of the preceding claims, wherein said at least one amino acid substitution comprises one or more amino acid substitution (i) G1M (ii) A19V, (iii) V20I, (iv) K25R, (v) one or more of I26W, I26V or I26T, (vi) one or more of Q28R, Q28K, Q28S, Q28E, (vii) R31T, (viii) T33R, (ix) N35T, (x) one or more of C41A, C41V, C41T or C41S, (xi) one or more of E59T, E59V, E59I, E59Y, E59F, E59W or E59R, (xii) D68N or D68T, (xiii) A73F or A73V, (xiv) D74V, (xv) I75V or I75L, (xvi) E77V, (xvii) R84L.

34. The method of any one of the preceding claims, wherein said at least one amino acid substitution comprises amino acid substitution at one or more of amino acid E2, E23, Y65, L70 or any combination thereof.

35. The method of any one of the preceding claims, wherein said at least one amino acid substitution comprises amino acid substitution at one or more of amino acid E2, E23, Y65, L70.

36. The method of any one of the preceding claims, wherein said amino acid substitution at amino acid S76 is one or more of S76Y, S76F, S76T, S76W, S76R, S76V, S76I, S76H or S76A.

37. The method of any one of the preceding claims, wherein said at least one amino acid substitution comprises amino acid substitution at one or more of amino acid E2N, E23A, Y65R, L70I or any combination thereof.

38. The method of any one of the preceding claims, wherein said at least one amino acid substitution comprises amino acid substitution at one or more of amino acid E2M, E23A, Y65R, L70I or any combination thereof.

39. The method of any one of the preceding claims, wherein said at least one amino acid substitution comprises one or more of amino acid substitutions (i) E2N, E23A, Y65R, L70I, (ii) E2M, E23A, Y65R, L70I (iii) E2N, E23Q, Y65R, L70I or (iv) E2M, E23Q, Y65R, L70I.

40. The method of any one of the preceding claims, wherein said at least one amino acid substitution comprises one or more amino acid substitution (i) G1M (ii) A19V, (iii) V20I, (iv) K25R, (v) one or more of I26W, I26V or I26T, (vi) one or more of Q28R, Q28K, Q28S, Q28E, (vii) R31T, (viii) T33R, (ix) N35T, (x) one or more of C41A, C41V, C41T or C41S, (xi) one or more of E59T, E59V, E59I, E59Y, E59F, E59W or E59R, (xii) D68N or D68T, (xiii) A73F or A73V, (xiv) D74V, (xv) I75V or I75L, (xvi) E77V, (xvii) R84L.

41. The method of any one of the preceding claims, comprising an amino acid sequence set forth in one or more of SEQ ID NO:5, SEQ ID NO:6, SEQ ID NO:7, SEQ ID NO:221, SEQ ID NO:108, SEQ ID NO:9, SEQ ID NO:102, SEQ ID NO:105, SEQ ID NO:52, SEQ ID NO:182, SEQ ID NO:10, SEQ ID NO:69, SEQ ID NO:157, SEQ ID NO:114, SEQ ID NO:174, SEQ ID NO:162, SEQ ID NO:231, SEQ ID NO:57, SEQ ID NO:192, SEQ ID NO:68, SEQ ID NO:106, SEQ ID NO:8, SEQ ID NO:79, SEQ ID NO:76, SEQ ID NO:22, SEQ ID NO: 194, SEQ ID NO:262, SEQ ID NO:84, SEQ ID NO:239, SEQ ID NO:135, SEQ ID NO:211, SEQ ID NO:237, SEQ ID NO:198, SEQ ID NO:179, SEQ ID NO:172 or any combination thereof.


SEQUENCE LISTING (276 sequences)

SEQ ID NO: 1 - protein, 96 aa, synthetic construct [sequence omitted]

SEQ ID NO: 2 - protein, 96 aa, synthetic construct
  source 1..96: note = Synthetic protein DM129
GEWEIIDIGPFTQNLGKFAVDEENKIGQYGRLTFNKVIRPCMKKTIYENEGFREIKGYEYQLYVYASDKLFRADIYEDYKTRGRKLLRFNGPVPPP

SEQ ID NO: 3 - protein, 96 aa, synthetic construct
  source 1..96: note = Synthetic protein DM147
GEWEIIDIGPFTQNLGKFAVDEENKIGQYGRLTFNKVIRPCMKKTIYENEGFREIKGYEYQLYVYASDKLFRADIFEDYKTRGRKLLRFNGPVPPP

SEQ ID NO: 4 - protein, 96 aa, synthetic construct
  source 1..96: note = Synthetic protein DM149
GNWEIIDIGPFTQNLGKFAVDEANKIGQYGRLTFNKVIRPCMKKTIYENEGFREIKGYEYQLYVRASDKIFRADIYEDYKTRGRKLLRFNGPVPPP

SEQ ID NO: 5 - protein, 93 aa, synthetic construct
  source 1..93: note = Synthetic protein DM89
GNWEIIDIGPFTQNLGKFAVDEANKIGQYGRLTFNKVIRPCMKKTIYENGEIKGYEYQLYVRASDKIFRADIYEDYKTRGRKLLRFNGPVPPP

SEQ ID NO: 6 - protein, 93 aa, synthetic construct
  source 1..93: note = Synthetic protein DM114
GNWEIIDIGPFTQNLGKFAVDEANKIGQYGRLTFNKVIRPCMKKTIYENGEIKGYEYQLYVRASDKIFRADIFEDYKTRGRKLLRFNGPVPPP

SEQ ID NO: 7 - protein, 93 aa, synthetic construct
  source 1..93: note = Synthetic protein DM137
GNWEIIDIGPFTQNLGKFAVDEANKIGQYGRLTFNKVIRPCMKKTIYENGEIKGYEYQLYVRASDKIFRADIWEDYKTRGRKLLRFNGPVPPP

SEQ ID NO: 8 - protein, 93 aa, synthetic construct
  source 1..93: note = Synthetic protein DM90
GNWEIIDIGPFTQNLGKFAVDEANKIGQYGRLTFNKVIRPCMKKTIYENGEIKGYEYQLYVRASDKIFRADIYEDYKTRGLKLLRFNGPVPPP

SEQ ID NO: 9 - protein, 93 aa, synthetic construct
  source 1..93: note = Synthetic protein DM100
GNWEIIDIGPFTQNLGKFAVDEANKTGQYGRLTFNKVIRPCMKKTIYENGEIKGYEYQLYVRASDKIFRADIYEDYKTRGRKLLRFNGPVPPP

SEQ ID NO: 10 - protein, 93 aa, synthetic construct
  source 1..93: note = Synthetic protein DM101
GNWEIIDIGPFTQNLGKFAVDEANRIGQYGRLTFNKVIRPCMKKTIYENGEIKGYEYQLYVRASDKIFRADIYEDYKTRGRKLLRFNGPVPPP

SEQ ID NO: 11 - protein, 93 aa, synthetic construct
  source 1..93: note = Synthetic protein DM121
GNWEIIDIGPFTQNLGKFAVDEENKIGQYGRLTFNKVIRPCMKKTIYENGEIKGYEYQLYVRASDKIFRADIYEDYKTRGRKLLRFNGPVPPP

SEQ ID NO: 12 - protein, 93 aa, synthetic construct
  source 1..93: note = Synthetic protein DM122
GEWEIIDIGPFTQNLGKFAVDEANKIGQYGRLTFNKVIRPCMKKTIYENGEIKGYEYQLYVRASDKIFRADIYEDYKTRGRKLLRFNGPVPPP

SEQ ID NO: 13 - protein, 93 aa, synthetic construct
  source 1..93: note = Synthetic protein DM123
GNWEIIDIGPFTQNLGKFAVDEANKIGQYGRLTFNKVIRPCMKKTIYENGEIKGYEYQLYVYASDKIFRADIYEDYKTRGRKLLRFNGPVPPP

SEQ ID NO: 14 - protein, 93 aa, synthetic construct
  source 1..93: note = Synthetic protein DM124
GNWEIIDIGPFTQNLGKFAVDEANKIGQYGRLTFNKVIRPCMKKTIYENGEIKGYEYQLYVRASDKLFRADIYEDYKTRGRKLLRFNGPVPPP

SEQ ID NO: 15 - protein, 93 aa, synthetic construct
  source 1..93: note = Synthetic protein DM125
GEWEIIDIGPFTQNLGKFAVDEENKIGQYGRLTFNKVIRPCMKKTIYENGEIKGYEYQLYVYASDKIFRADIYEDYKTRGRKLLRFNGPVPPP

SEQ ID NO: 16 - protein, 93 aa, synthetic construct
  source 1..93: note = Synthetic protein DM148
GEWEIIDIGPFTQNLGKFAVDEENKIGQYGRLTFNKVIRPCMKKTIYENGEIKGYEYQLYVYASDKLFRADIYEDYKTRGRKLLRFNGPVPPP

SEQ ID NO: 17 - protein, 93 aa, synthetic construct
  source 1..93: note = Synthetic protein DM126
GEWEIIDIGPFTQNLGKFAVDEANKIGQYGRLTFNKVIRPAMKKTIYENGEIKGYEYQLYVRASDKLFRADIYEDYKTRGRKLLRFNGPVPPP

SEQ ID NO: 18 - protein, 93 aa, synthetic construct
  source 1..93: note = Synthetic protein DM127
GNWEIIDIGPFTQNLGKFAVDEANKWGEYGRLTFNKVIRPCMKKTIYENGEIKGYEYQLYVRASDKIFRADIYEDYKTRGRKLLRFNGPVPPP

SEQ ID NO: 19 - protein, 93 aa, synthetic construct
  source 1..93: note = Synthetic protein DM128
GNWEIIDIGPFTQNLGKFAVDEANKWGKYGRLTFNKVIRPCMKKTIYENGEIKGYEYQLYVRASDKIFRADIYEDYKTRGRKLLRFNGPVPPP

SEQ ID NO: 20 - protein, 93 aa, synthetic construct
  source 1..93: note = Synthetic protein DM164
GNWEIIDIGPFTQNLGKFAVDEANKTGKYGRLTFNKVIRPCMKKTIYENGEIKGYEYQLYVRASDKIFRADIWEDYKTRGRKLLRFNGPVPPP

SEQ ID NO: 21 - protein, 93 aa, synthetic construct
  source 1..93: note = Synthetic protein DM160
GNWEIIDIGPFTQNLGKFAVDEANRIGQYGRLTFNKVIRPCMKKTIYENGEIKGYEYQLYVRASDKIFRADIFEDYKTRGRKLLRFNGPVPPP

SEQ ID NO: 22 - protein, 93 aa, synthetic construct
  source 1..93: note = Synthetic protein DM162
GNWEIIDIGPFTQNLGKFAVDEANRIGQYGRLTFNKVIRPCMKKTIYENGEIKGYEYQLYVRASDKIFRADIWEDYKTRGRKLLRFNGPVPPP

SEQ ID NO: 23 - protein, 93 aa, synthetic construct
  source 1..93: note = Synthetic protein DM159
GNWEIIDIGPFTQNLGKFAVDEANKTGQYGRLTFNKVIRPCMKKTIYENGEIKGYEYQLYVRASDKIFRADIFEDYKTRGRKLLRFNGPVPPP

SEQ ID NO: 24 - protein, 93 aa, synthetic construct
  source 1..93: note = Synthetic protein DM163
GNWEIIDIGPFTQNLGKFAVDEANKTGKYGRLTFNKVIRPCMKKTIYENGEIKGYEYQLYVRASDKIFRADIFEDYKTRGRKLLRFNGPVPPP

SEQ ID NO: 25 - protein, 93 aa, synthetic construct
  source 1..93: note = Synthetic protein DM161
GNWEIIDIGPFTQNLGKFAVDEANKTGQYGRLTFNKVIRPCMKKTIYENGEIKGYEYQLYVRASDKIFRADIWEDYKTRGRKLLRFNGPVPPP

SEQ ID NO: 26 - protein, 96 aa, synthetic construct
  source 1..96: note = Synthetic protein DM227
GEWEIIDIGPFTQNLGKFAVDEENKIGQYGRLTFNKVIRPCMKKTIYENEGFREIKGYEYQLYVYASNKLFRADIYEDYKTRGRKLLRFNGPVPPP

SEQ ID NO: 27 - protein, 93 aa, synthetic construct
  source 1..93: note = Synthetic protein DM250
GNWEIIDIGPFTQNLGKFAIDEANKIGQYGRLTFNKVIRPCMKKTIYENGEIKGYEYQLYVRASDKIFRADIFEDYKTRGRKLLRFNGPVPPP

SEQ ID NO: 28 - protein, 93 aa, synthetic construct
  source 1..93: note = Synthetic protein DM627
GNWEIIDIGPFTQNLGKFAVDEANKIGQYGTLTFNKVIRPCMKKTIYENGEIKGYEYQLYVRASNKIFRADIYEDYKTRGRKLLRFNGPVPPP

SEQ ID NO: 29 - protein, 96 aa, synthetic construct
  source 1..96: note = Synthetic protein DM187
GEWEIIDIGPFTQNLGKFAVDEENRIGRYGRLTFNKVIRPCMKKTIYENEGFREIKGYEYQLYVYASDKLFRADIYEDYKTRGRKLLRFNGPVPPP

SEQ ID NO: 30 - protein, 96 aa, synthetic construct
  source 1..96: note = Synthetic protein DM09
GNWEIIDIGPFTQNLGKFAVDEANKIGQYGRLTFNKVIRPCMKKTIYENEGFREIKGYEYQLYVRASDKLFRADISEDYKTRGRKLLRFNGPVPPP

SEQ ID NO: 31 - protein, 96 aa, synthetic construct
  source 1..96: note = Synthetic protein DM14
GNWEIIDIGPFTQNLGKFAVDEANKIGQYGRLTFNKVIRPCMKKTIYENEGFREIKGYEYQLYVRASDKIFRADISEDYKTRGRKLLRFNGPVPPP

SEQ ID NO: 32 - protein, 93 aa, synthetic construct
  source 1..93: note = Synthetic protein DM636
GNWEIIDIGPFTQNLGKFAVDEANKIGQYGTLRFNKVIRPCMKKTIYENGEIKGYEYQLYVRASDKIFRADIYEDYKTRGRKLLRFNGPVPPP

SEQ ID NO: 33 - protein, 93 aa, synthetic construct
  source 1..93: note = Synthetic protein DM29
GEWEIIDIGPFTQNLGKFAVDEENKIGQYGRLTFNKVIRPCMKKTIYENGEIKGYEYQLYVYASDKLFRADISEDYKTRGRKLLRFNGPVPPP

SEQ ID NO: 34 - protein, 93 aa, synthetic construct
  source 1..93: note = Synthetic protein DM31
GNWEIIDIGPFTQNLGKFAVDEANKIGQYGRLTFNKVIRPCMKKTIYENGEIKGYEYQLYVRASDKIFRADISEDYKTRGRKLLRFNGPVPPP

SEQ ID NO: 35 - protein, 93 aa, synthetic construct
  source 1..93: note = Synthetic protein DM70
GNWEIIDIGPFTQNLGKFAVDEANKIGQYGRLTFNKVIRPCMKKTIYENGEIKGYEYQLYVRASDKIFRADISEDYKTRGLKLLRFNGPVPPP

SEQ ID NO: 36 - protein, 93 aa, synthetic construct
  source 1..93: note = Synthetic protein DM42
GNWEIIDIGPFTQNLGKFAVDEANKTGQYGRLTFNKVIRPCMKKTIYENGEIKGYEYQLYVRASDKIFRADISEDYKTRGRKLLRFNGPVPPP

SEQ ID NO: 37 - protein, 96 aa, synthetic construct
  source 1..96: note = Synthetic protein DM42b
GEWEIIDIGPFTQNLGKFAVDEENKTGQYGRLTFNKVIRPCMKKTIYENEGFREIKGYEYQLYVYASDKLFRADISEDYKTRGRKLLRFNGPVPPP

SEQ ID NO: 38 - protein, 93 aa, synthetic construct
  source 1..93: note = Synthetic protein DM43
GNWEIIDIGPFTQNLGKFAVDEANRIGQYGRLTFNKVIRPCMKKTIYENGEIKGYEYQLYVRASDKIFRADISEDYKTRGRKLLRFNGPVPPP

SEQ ID NO: 39 - protein, 93 aa, synthetic construct
  source 1..93: note = Synthetic protein DM115
GNWEIIDIGPFTQNLGKFAVDEANKWGEYGRLTFNKVIRPCMKKTIYENGEIKGYEYQLYVRASDKIFRADISEDYKTRGRKLLRFNGPVPPP

SEQ ID NO: 40 - protein, 93 aa, synthetic construct
  source 1..93: note = Synthetic protein DM116
GNWEIIDIGPFTQNLGKFAVDEANKWGKYGRLTFNKVIRPCMKKTIYENGEIKGYEYQLYVRASDKIFRADISEDYKTRGRKLLRFNGPVPPP

SEQ ID NO: 41 - protein, 96 aa, synthetic construct
  source 1..96: note = Synthetic protein DM130
GEWEIIDIGPFTQNLGKFAVDEANKIGQYGRLTFNKVIRPAMKKTIYENEGFREIKGYEYQLYVRASDKLFRADIYEDYKTRGRKLLRFNGPVPPP

SEQ ID NO: 42 - protein, 93 aa, synthetic construct
  source 1..93: note = Synthetic protein DM146
GNWEIIDIGPFTQNLGKFAVDEANKIGQYGRLTFNKVIRPVMKKTIYENGEIKGYEYQLYVRASDKIFRADIYEDYKTRGRKLLRFNGPVPPP

SEQ ID NO: 43 - protein, 96 aa, synthetic construct
  source 1..96: note = Synthetic protein DM280
GEWEIIDIGPFTQNLGKFAIDEENKIGQYGRLTFNKVIRPCMKKTIYENEGFREIKGYEYQLYVYASDKLFRADIWEDYKTRGRKLLRFNGPVPPP

SEQ ID NO: 44 - protein, 93 aa, synthetic construct
  source 1..93: note = Synthetic protein DM274
GNWEIIDIGPFTQNLGKFAVDEANKIGQYGRLTFNKVIRPAMKKTIYENGEIKGYEYQLYVRASDKIFRADIWEDYKTRGRKLLRFNGPVPPP

SEQ ID NO: 45 - protein, 93 aa, synthetic construct
  source 1..93: note = Synthetic protein DM363
GNWEIIDIGPFTQNLGKFAVDEANKIGKYGRLTFNKVIRPCMKKTIYENGEIKGYEYQLYVRASDKIFRADIYEDYKTRGRKLLRFNGPVPPP

SEQ ID NO: 46 - protein, 93 aa, synthetic construct
  source 1..93: note = Synthetic protein DM607
GNWEIIDIGPFTQNLGKFAVDEANKIGKYGRLTFNKVIRPCMKKTIYENGEIKGYEYQLYVRASTKIFRADIYEDYKTRGRKLLRFNGPVPPP

SEQ ID NO: 47 - protein, 93 aa, synthetic construct
  source 1..93: note = Synthetic protein DM530
GNWEIIDIGPFTQNLGKFAVDEANKIGRYGRLTFNKVIRPSMKKTIYENGEIKGYEYQLYVRASDKIFRADIYEDYKTRGRKLLRFNGPVPPP

SEQ ID NO: 48 - protein, 93 aa, synthetic construct
  source 1..93: note = Synthetic protein DM614
GNWEIIDIGPFTQNLGKFAVDEANKIGQYGRLRFNKVIRPCMKKTIYENGEIKGYEYQLYVRASNKIFRADIYEDYKTRGRKLLRFNGPVPPP

SEQ ID NO: 49 - protein, 93 aa, synthetic construct
  source 1..93: note = Synthetic protein DM594
GNWEIIDIGPFTQNLGKFAVDEANKIGQYGRLTFNKVIRPCMKKTIYENGEIKGYEYQLYVRASDKIFRADIYVDYKTRGRKLLRFNGPVPPP

SEQ ID NO: 50 - protein, 93 aa, synthetic construct
  source 1..93: note = Synthetic protein DM651
GNWEIIDIGPFTQNLGKFAVDEANKIGQYGRLTFNKVIRPCMKKTIYENGEIKGYTYQLYVRASDKIFRADITEDYKTRGRKLLRFNGPVPPP

SEQ ID NO: 51 - protein, 93 aa, synthetic construct
  source 1..93: note = Synthetic protein DM478
GNWEIIDIGPFTQNLGKFAVDEANKIGKYGRLTFNKVIRPTMKKTIYENGEIKGYEYQLYVRASDKIFRADIYEDYKTRGRKLLRFNGPVPPP

SEQ ID NO: 52 - protein, 93 aa, synthetic construct
  source 1..93: note = Synthetic protein DM224
GNWEIIDIGPFTQNLGKFAVDEANKIGQYGRLTFNKVIRPCMKKTIYENGEIKGYEYQLYVRASNKIFRADIYEDYKTRGRKLLRFNGPVPPP

SEQ ID NO: 53 - protein, 93 aa, synthetic construct
  source 1..93: note = Synthetic protein DM619
GNWEIIDIGPFTQNLGKFAVDEANKIGKYGRLRFNKVIRPCMKKTIYENGEIKGYEYQLYVRASDKIFRADIYEDYKTRGRKLLRFNGPVPPP

SEQ ID NO: 54 - protein, 93 aa, synthetic construct
  source 1..93: note = Synthetic protein DM46
GNWEIIDIGPFTQNLGKFAVDEANKIGQYGRLTFNKVIRPTMKKTIYENGEIKGYEYQLYVRASDKIFRADISEDYKTRGRKLLRFNGPVPPP

SEQ ID NO: 55 - protein, 93 aa, synthetic construct
  source 1..93: note = Synthetic protein DM254
GNWEIIDIGPFTQNLGKFAVDEANKIGQYGRLTFNKVIRPAMKKTIYENGEIKGYEYQLYVRASDKIFRADIFEDYKTRGRKLLRFNGPVPPP

SEQ ID NO: 56 - protein, 96 aa, synthetic construct
  source 1..96: note = Synthetic protein DM282
GEWEIIDIGPFTQNLGKFAVDEENKIGQYGRLTFNKVIRPCMKKTIYENEGFREIKGYEYQLYVYASDKLFRADIWEDYKTRGRKLLRMNGPVPPP

SEQ ID NO: 57 - protein, 93 aa, synthetic construct
  source 1..93: note = Synthetic protein DM635
GNWEIIDIGPFTQNLGKFAIDEANKIGQYGRLTFNKVIRPCMKKTIYENGEIKGYEYQLYVRASDKIFRADIYEDYKTRGLKLLRFNGPVPPP

SEQ ID NO: 58 - protein, 93 aa, synthetic construct
  source 1..93: note = Synthetic protein DM289
GNWEIIDIGPFTQNLGKFAVDEANKIGQYGRLTFTKVIRPCMKKTIYENGEIKGYEYQLYVRASDKIFRADIYEDYKTRGRKLLRFNGPVPPP

SEQ ID NO: 59 - protein, 93 aa, synthetic construct
  source 1..93: note = Synthetic protein DM561
GNWEIIDIGPFTQNLGKFAVDEANKIGQYGTLRFNKVIRPCMKKTIYENGEIKGYEYQLYVRASDKIFRADISEDYKTRGRKLLRFNGPVPPP

SEQ ID NO: 60 - protein, 93 aa, synthetic construct
  source 1..93: note = Synthetic protein DM362
GEWEIIDIGPFTQNLGKFAVDEANKIGQYGRLTFNKVIRPCMKKTIYENGEIKGYEYQLYVYASNKLFRADIYEDYKTRGRKLLRFNGPVPPP

SEQ ID NO: 61 - protein, 93 aa, synthetic construct
  source 1..93: note = Synthetic protein DM660
GNWEIIDIGPFTQNLGKFAVDEANKIGQYGRLTFNKVIRPCMKKTIYENGEIKGYFYQLYVRASDKIFRADIMEDYKTRGRKLLRFNGPVPPP

SEQ ID NO: 62 - protein, 93 aa, synthetic construct
  source 1..93: note = Synthetic protein DM57
GNWEIIDIGPFTQNLGKFAVDEANKIGQYGRLRFNKVIRPCMKKTIYENGEIKGYEYQLYVRASDKIFRADISEDYKTRGRKLLRFNGPVPPP

SEQ ID NO: 63 - protein, 93 aa, synthetic construct
  source 1..93: note = Synthetic protein DM364
GNWEIIDIGPFTQNLGKFAVDEANKIGQYGRLTFNKVIRPCMKKTIYENGEIKGYEYQLYVYASDKLFRADIYEDYKTRGRKLLRFNGPVPPP

SEQ ID NO: 64 - protein, 96 aa, synthetic construct
  source 1..96: note = Synthetic protein DM281
GEWEIIDIGPFTQNLGKFAVDEENKIGQYGRLTFNKVIRPCMKKTIYENEGFREIKGYEYQLYVYASDKLFRADLWEDYKTRGRKLLRFNGPVPPP

SEQ ID NO: 65 - protein, 93 aa, synthetic construct
  source 1..93: note = Synthetic protein DM601
GNWEIIDIGPFTQNLGKFAVDEANKIGQYGRLTFNKVIRPCMKKTIYENGEIKGYEYQLYVRASDKIFRADVSEDYKTRGRKLLRFNGPVPPP

SEQ ID NO: 66 - protein, 93 aa, synthetic construct
  source 1..93: note = Synthetic protein DM87
GNWEIIDIGPFTQNLGKFAVDEANKIGQYGRLTFNKVIRPCMKKTIYENGEIKGYEYQLYVRASNKIFRADISEDYKTRGRKLLRFNGPVPPP

SEQ ID NO: 67 - protein, 93 aa, synthetic construct
  source 1..93: note = Synthetic protein DM204
GNWEIIDIGPFTQNLGKFAVDEANKIGQYGRLTFNKVIRPCMKKTIYENGEIKGYEYQLYVRASDKIFRVDIYEDYKTRGRKLLRFNGPVPPP

SEQ ID NO: 68 - protein, 93 aa, synthetic construct
  source 1..93: note = Synthetic protein DM242
GNWEIIDIGPFTQNLGKFAVDEANKIGQYGRLTFNKVIRPCMKKTIYENGEIKGYEYQLYVRASNKIFRADIFEDYKTRGLKLLRFNGPVPPP

SEQ ID NO: 69 - protein, 93 aa, synthetic construct
  source 1..93: note = Synthetic protein DM472
GNWEIIDIGPFTQNLGKFAVDEANKIGKYGRLTFNKVIRPCMKKTIYENGEIKGYEYQLYVRASNKIFRADIYEDYKTRGRKLLRFNGPVPPP

SEQ ID NO: 70 - protein, 93 aa, synthetic construct
  source 1..93: note = Synthetic protein DM455
GNWEIIDIGPFTQNLGKFAVDEANKVGKYGRLTFNKVIRPCMKKTIYENGEIKGYEYQLYVRASDKIFRADIYEDYKTRGRKLLRFNGPVPPP

SEQ ID NO: 71 - protein, 93 aa, synthetic construct
  source 1..93: note = Synthetic protein DM664
GNWEIIDIGPFTQNLGKFAVDEANKIGQYGRLTFNKVIRPCMKKTIYENGEIKGYEYQLYVRASDKIFRADIIEDYKTRGRKLLRFNGPVPPP

SEQ ID NO: 72 - protein, 93 aa, synthetic construct
  source 1..93: note = Synthetic protein DM270
GNWEIIDIGPFTQNLGKFAIDEANKIGQYGRLTFNKVIRPCMKKTIYENGEIKGYEYQLYVRASDKIFRADIWEDYKTRGRKLLRFNGPVPPP

SEQ ID NO: 73 - protein, 93 aa, synthetic construct
  source 1..93: note = Synthetic protein DM690
GNWEIIDIGPFTQNLGKFAVDEANKIGQYGRLTFNKVIRPCMKKTIYENGEIKGYEYQLYVRASDKIFRADIAEDYKTRGRKLLRFNGPVPPP

SEQ ID NO: 74 - protein, 93 aa, synthetic construct
  source 1..93: note = Synthetic protein DM334
GEWEIIDIGPFTQNLGKFAVDEQNKIGKYGRLTFNKVIRPCMKKTIYENGEIKGYEYQLYVYASDKLFRADIYEDYKTRGRKLLRFNGPVPPP

SEQ ID NO: 75 - protein, 93 aa, synthetic construct
  source 1..93: note = Synthetic protein DM457
GNWEIIDIGPFTQNLGKFAVDEANKIGKYGRLTFNKVIRPCMKKTIYENGEIKGYEYQLYVRASNKIFRADISEDYKTRGRKLLRFNGPVPPP

SEQ ID NO: 76 - protein, 93 aa, synthetic construct
  source 1..93: note = Synthetic protein DM641
GNWEIIDIGPFTQNLGKFAVDEANKIGRYGRLTFNKVIRPCMKKTIYENGEIKGYEYQLYVRASDKIFRADIYEDYKTRGLKLLRFNGPVPPP

SEQ ID NO: 77 - protein, 96 aa, synthetic construct
  source 1..96: note = Synthetic protein DM200
GEWEIIDIGPFTQNLGKFAVDEENKWGEYGRLTFNKVIRPCMKKTIYENEGFREIKGYEYQLYVYASDKLFRADIYEDYKTRGRKLLRFNGPVPPP

SEQ ID NO: 78 - protein, 93 aa, synthetic construct
  source 1..93: note = Synthetic protein DM166
GNWEIIDIGPFTQNLGKFAVDEANRIGKYGRLTFNKVIRPCMKKTIYENGEIKGYEYQLYVRASDKIFRADIYEDYKTRGRKLLRFNGPVPPP

SEQ ID NO: 79 - protein, 93 aa, synthetic construct
  source 1..93: note = Synthetic protein DM240
GNWEIIDIGPFTQNLGKFAVDEANKIGQYGRLTFNKVIRPCMKKTIYENGEIKGYEYQLYVRASNKIFRADIYEDYKTRGLKLLRFNGPVPPP

SEQ ID NO: 80 - protein, 93 aa, synthetic construct
  source 1..93: note = Synthetic protein DM246
GNWEIIDIGPFTQNLGKFVVDEANKIGQYGRLTFNKVIRPCMKKTIYENGEIKGYEYQLYVRASDKIFRADIFEDYKTRGRKLLRFNGPVPPP

SEQ ID NO: 81 - protein, 93 aa, synthetic construct
  source 1..93: note = Synthetic protein DM267
GNWEIIDIGPFTQNLGKFAVDEANKIGQYGRLTFNKVIRPCMKKTIYENGEIKGYEYQLYIRASDKIFRADIWEDYKTRGRKLLRFNGPVPPP

SEQ ID NO: 82 - protein, 96 aa, synthetic construct
  source 1..96: note = Synthetic protein DM260
GEWEIIDIGPFTQNLGKFAIDEENKIGQYGRLTFNKVIRPCMKKTIYENEGFREIKGYEYQLYVYASDKLFRADIFEDYKTRGRKLLRFNGPVPPP

SEQ ID NO: 83 - protein, 93 aa, synthetic construct
  source 1..93: note = Synthetic protein DM168
GNWEIIDIGPFTQNLGKFAVDEANRIGKYGRLTFNKVIRPCMKKTIYENGEIKGYEYQLYVRASDKIFRADIFEDYKTRGRKLLRFNGPVPPP

SEQ ID NO: 84 - protein, 93 aa, synthetic construct
  source 1..93: note = Synthetic protein DM655
GNWEIIDIGPFTQNLGKFAVDEANKIGQYGRLTFNKVIRPCMKKTIYENGEIKGYVYQLYVRASDKIFRADIIEDYKTRGRKLLRFNGPVPPP

SEQ ID NO: 85 - protein, 93 aa, synthetic construct
  source 1..93: note = Synthetic protein DM288
GNWEIIDIGPFTQNLGKFAVDEANRTGKYGRLTFNKVIRPCMKKTIYENGEIKGYEYQLYVRASDKIFRADIYEDYKTRGRKLLRFNGPVPPP

SEQ ID NO: 86 - protein, 93 aa, synthetic construct
  source 1..93: note = Synthetic protein DM464
GNWEIIDIGPFTQNLGKFAVDEANRIGQYGRLTFNKVIRPCMKKTIYENGEIKGYEYQLYVRASNKIFRADISEDYKTRGRKLLRFNGPVPPP

SEQ ID NO: 87 - protein, 93 aa, synthetic construct
  source 1..93: note = Synthetic protein DM484
GNWEIIDIGPFTQNLGKFAVDEANKTGKYGRLTFNKVIRPCMKKTIYENGEIKGYEYQLYVRASNKIFRADIYEDYKTRGRKLLRFNGPVPPP

SEQ ID NO: 88 - protein, 93 aa, synthetic construct
  source 1..93: note = Synthetic protein DM395
GMWEIIDIGPFTQNLGKFAVDEANKIGQYGRLTFNKVIRPCMKKTIYENGEIKGYEYQLYVRASDKIFRADISEDYKTRGRKLLRFNGPVPPP

SEQ ID NO: 89 - protein, 93 aa, synthetic construct
  source 1..93: note = Synthetic protein DM177
GNWEIIDIGPFTQNLGKFAVDEANKWGKYGRLTFNKVIRPCMKKTIYENGEIKGYEYQLYVRASDKIFRADIFEDYKTRGRKLLRFNGPVPPP

SEQ ID NO: 90 - protein, 93 aa, synthetic construct
  source 1..93: note = Synthetic protein DM536
GNWEIIDIGPFTQNLGKFAVDEANKIGKYGRLTFNKVIRPAMKKTIYENGEIKGYEYQLYVRASDKIFRADIYEDYKTRGRKLLRFNGPVPPP

SEQ ID NO: 91 - protein, 93 aa, synthetic construct
  source 1..93: note = Synthetic protein DM682
GNWEIIDIGPFTQNLGKFAVDEANKIGKYGRLTFNKVIRPAMKKTIYENGEIKGYEYQLYVRASDKIFRADIWEDYKTRGRKLLRFNGPVPPP

SEQ ID NO: 92 - protein, 96 aa, synthetic construct
  source 1..96: note = Synthetic protein DM213
GEWEIIDIGPFTQNLGKFAVDEENKIGQYGRLTFNKVIRPCMKKTIYENEGFREIKGYEYQLYIYASDKLFRADIYEDYKTRGRKLLRFNGPVPPP

SEQ ID NO: 93 - protein, 93 aa, synthetic construct
  source 1..93: note = Synthetic protein DM178
GNWEIIDIGPFTQNLGKFAVDEANKWGKYGRLTFNKVIRPCMKKTIYENGEIKGYEYQLYVRASDKIFRADIWEDYKTRGRKLLRFNGPVPPP

SEQ ID NO: 94 - protein, 93 aa, synthetic construct
  source 1..93: note = Synthetic protein DM539
GNWEIIDIGPFTQNLGKFAVDEANKIGRYGRLRFNKVIRPCMKKTIYENGEIKGYEYQLYVRASDKIFRADISEDYKTRGRKLLRFNGPVPPP

SEQ ID NO: 95 - protein, 93 aa, synthetic construct
  source 1..93: note = Synthetic protein DM208
GNWEIIDIGPFTQNLGKFAVDEANKIGQYGRLTFNKVIRPCMKKTIYENGEIKGYEYQLYVRASDKIFRADIYEDYKTRGRKLLRMNGPVPPP

SEQ ID NO: 96 - protein, 93 aa, synthetic construct
  source 1..93: note = Synthetic protein DM397
GNWEIIDIGPFTQNLGKFAVDEANKIGQYGRLTFNKVIRPCMKKTIYENGEIKGYEYQLYVYASNKLFRADIYEDYKTRGRKLLRFNGPVPPP

SEQ ID NO: 97 - protein, 93 aa, synthetic construct
  source 1..93: note = Synthetic protein DM683
GNWEIIDIGPFTQNLGKFAVDEANKIGKYGRLTFNKVIRPAMKKTIYENGEIKGYEYQLYVRASDKIFRADIFEDYKTRGRKLLRFNGPVPPP

SEQ ID NO: 98 - protein, 93 aa, synthetic construct
  source 1..93: note = Synthetic protein DM526
GNWEIIDIGPFTQNLGKFAVDEANKTGRYGRLTFNKVIRPCMKKTIYENGEIKGYEYQLYVRASDKIFRADIYEDYKTRGRKLLRFNGPVPPP

SEQ ID NO: 99 - protein, 93 aa, synthetic construct
  source 1..93: note = Synthetic protein DM236
GNWEIIDIGPFTQNLGKFAVDEANKIGQYGRLTFNKVIRPCMKKTIYENGEIKGYEYQLYVRASNKIFRADIWEDYKTRGRKLLRFNGPVPPP

SEQ ID NO: 100 - protein, 96 aa, synthetic construct
  source 1..96: note = Synthetic protein DM264
GEWEIIDIGPFTQNLGKFAVDEENKIGQYGRLTFNKVIRPAMKKTIYENEGFREIKGYEYQLYVYASDKLFRADIFEDYKTRGRKLLRFNGPVPPP

SEQ ID NO: 101 - protein, 96 aa, synthetic construct
  source 1..96: note = Synthetic protein DM239
GEWEIIDIGPFTQNLGKFAVDEENKIGQYGRLTFNKVIRPCMKKTIYENEGFREIKGYEYQLYVYASNKLFRADIWEDYKTRGRKLLRFNGPVPPP

SEQ ID NO: 102 - protein, 93 aa, synthetic construct
  source 1..93: note = Synthetic protein DM165
GNWEIIDIGPFTQNLGKFAVDEANRIGRYGRLTFNKVIRPCMKKTIYENGEIKGYEYQLYVRASDKIFRADIYEDYKTRGRKLLRFNGPVPPP

SEQ ID NO: 103 - protein, 93 aa, synthetic construct
  source 1..93: note = Synthetic protein DM602
GNWEIIDIGPFTQNLGKFAVDEANKIGQYGRLTFNKVIRPCMKKTIYENGEIKGYVYQLYVRASDKIFRAVIVEDYKTRGRKLLRFNGPVPPP

SEQ ID NO: 104 - protein, 93 aa, synthetic construct
  source 1..93: note = Synthetic protein DM662
GNWEIIDIGPFTQNLGKFAVDEANKIGQYGRLTFNKVIRPCMKKTIYENGEIKGYYYQLYVRASDKIFRADIVEDYKTRGRKLLRFNGPVPPP

SEQ ID NO: 105 - protein, 93 aa, synthetic construct
  source 1..93: note = Synthetic protein DM361
GNWEIIDIGPFTQNLGKFAVDEANKIGQYGRLTFNKVIRPCMKKTIYENGEIKGYEYQLYVYASNKIFRADIYEDYKTRGRKLLRFNGPVPPP

SEQ ID NO: 106 - protein, 93 aa, synthetic construct
  source 1..93: note = Synthetic protein DM632
GNWEIIDIGPFTQNLGKFAVDEANKIGKYGRLTFNKVIRPCMKKTIYENGEIKGYEYQLYVRASDKIFRADIYEDYKTRGLKLLRFNGPVPPP

SEQ ID NO: 107 - protein, 93 aa, synthetic construct
  source 1..93: note = Synthetic protein DM654
GNWEIIDIGPFTQNLGKFAVDEANKIGQYGRLTFNKVIRPCMKKTIYENGEIKGYTYQLYVRASDKIFRADIVEDYKTRGRKLLRFNGPVPPP

SEQ ID NO: 108 - protein, 93 aa, synthetic construct
  source 1..93: note = Synthetic protein DM517
GNWEIIDIGPFTQNLGKFAVDEANKIGRYGRLTFNKVIRPCMKKTIYENGEIKGYEYQLYVRASDKIFRADIYEDYKTRGRKLLRFNGPVPPP

SEQ ID NO: 109 - protein, 93 aa, synthetic construct
  source 1..93: note = Synthetic protein DM174
GNWEIIDIGPFTQNLGKFAVDEANKIGQYGRLTFNKVIRPCMKKTIYENGEIKGYEYQLYVRASDKIFRADIWEDYKTRGLKLLRFNGPVPPP

SEQ ID NO: 110 - protein, 93 aa, synthetic construct
  source 1..93: note = Synthetic protein DM631
GNWEIIDIGPFTQNLGKFAVDEANKIGKYGRLTFTKVIRPCMKKTIYENGEIKGYEYQLYVRASDKIFRADIYEDYKTRGRKLLRFNGPVPPP

SEQ ID NO: 111 - protein, 96 aa, synthetic construct
  source 1..96: note = Synthetic protein DM278
GEWEIIDIGPFTQNLGKFAVDEENKIGQYGRLTFNKVIRPCMKKTIYENEGFREIKGYEYQLYVYASDKLFRVDIWEDYKTRGRKLLRFNGPVPPP

SEQ ID NO: 112 - protein, 96 aa, synthetic construct
  source 1..96: note = Synthetic protein DM197
GEWEIIDIGPFTQNLGKFAVDEENKWGKYGRLTFNKVIRPCMKKTIYENEGFREIKGYEYQLYVYASDKLFRADIFEDYKTRGRKLLRFNGPVPPP

SEQ ID NO: 113 - protein, 96 aa, synthetic construct
  source 1..96: note = Synthetic protein DM257
GEWEIIDIGPFTQNLGKFAVDEENKIGQYGRLTFNKVIRPCMKKTIYENEGFREIKGYEYQLYIYASDKLFRADIFEDYKTRGRKLLRFNGPVPPP

SEQ ID NO: 114 - protein, 93 aa, synthetic construct
  source 1..93: note = Synthetic protein DM210
GNWEIIDIGPFTQNLGKFAVDEANKIGQYGRLTFNKVIRPAMKKTIYENGEIKGYEYQLYVRASDKIFRADIYEDYKTRGRKLLRFNGPVPPP

SEQ ID NO: 115 - protein, 96 aa, synthetic construct
  source 1..96: note = Synthetic protein DM283
GEWEIIDIGPFTQNLGKFAVDEENKIGQYGRLTFNKVIRPCMKKTIYENEGFREIKGYEYQLYVYASDKLFRFDIWEDYKTRGRKLLRMNGPVPPP

SEQ ID NO: 116 - protein, 93 aa, synthetic construct
  source 1..93: note = Synthetic protein DM47
GNWEIIDIGPFTQNLGKFAVDEANKIGQYGTLTFNKVIRPCMKKTIYENGEIKGYEYQLYVRASDKIFRADISEDYKTRGRKLLRFNGPVPPP

SEQ ID NO: 117 - protein, 96 aa, synthetic construct
  source 1..96: note = Synthetic protein DM262
GEWEIIDIGPFTQNLGKFAVDEENKIGQYGRLTFNKVIRPCMKKTIYENEGFREIKGYEYQLYVYASDKLFRADIFEDYKTRGRKLLRMNGPVPPP

SEQ ID NO: 118 - protein, 93 aa, synthetic construct
  source 1..93: note = Synthetic protein DM271
GNWEIIDIGPFTQNLGKFAVDEANKIGQYGRLTFNKVIRPCMKKTIYENGEIKGYEYQLYVRASDKIFRADLWEDYKTRGRKLLRFNGPVPPP

SEQ ID NO: 119 - protein, 96 aa, synthetic construct
  source 1..96: note = Synthetic protein DM237
GEWEIIDIGPFTQNLGKFAVDEENKIGQYGRLRFNKVIRPCMKKTIYENEGFREIKGYEYQLYVYASDKLFRADIWEDYKTRGRKLLRFNGPVPPP

SEQ ID NO: 120 - protein, 96 aa, synthetic construct
  source 1..96: note = Synthetic protein DM214
GEWEIIDIGPFTQNLGKFAVDEENKIGQYGRLTFNKVIRPCMKKTIYENEGFREIKGYEYQLYVYASDKLFRVDIYEDYKTRGRKLLRFNGPVPPP

SEQ ID NO: 121 - protein, 93 aa, synthetic construct
  source 1..93: note = Synthetic protein DM41
GNWEIIDIGPFTQNLGKFAVDEANKSGQYGRLTFNKVIRPCMKKTIYENGEIKGYEYQLYVRASDKIFRADISEDYKTRGRKLLRFNGPVPPP

SEQ ID NO: 122 - protein, 93 aa, synthetic construct
  source 1..93: note = Synthetic protein DM249
GNWEIIDIGPFTQNLGKFAVDEANKIGQYGRLTFNKVIRPVMKKTIYENGEIKGYEYQLYVRASDKIFRADIFEDYKTRGRKLLRFNGPVPPP

SEQ ID NO: 123 - protein, 93 aa, synthetic construct
  source 1..93: note = Synthetic protein DM552
GNWEIIDIGPFTQNLGKFAVDEANKIGKYGTLTFNKVIRPCMKKTIYENGEIKGYEYQLYVRASDKIFRADISEDYKTRGRKLLRFNGPVPPP

SEQ ID NO: 124 - protein, 93 aa, synthetic construct
  source 1..93: note = Synthetic protein DM606
GNWEIIDIGPFTQNLGKFAVDEANKIGQYGRLTFNKVIRPCMKKTIYENGEIKGYEYQLYVRASDKIFRADIREDYKTRGRKLLRFNGPVPPP

SEQ ID NO: 125 - protein, 93 aa, synthetic construct
  source 1..93: note = Synthetic protein DM65
GNWEIIDIGPFTQNLGKFAVDEANKIGKYGRLTFNKVIRPCMKKTIYENGEIKGYEYQLYVRASDKIFRADISEDYKTRGRKLLRFNGPVPPP

SEQ ID NO: 126 - protein, 96 aa, synthetic construct
  source 1..96: note = Synthetic protein DM218
GEWEIIDIGPFTQNLGKFAVDEENKIGQYGRLTFNKVIRPCMKKTIYENEGFREIKGYEYQLYVYASDKLFRADIYEDYKTRGRKLLRMNGPVPPP

SEQ ID NO: 127 - protein, 93 aa, synthetic construct
  source 1..93: note = Synthetic protein DM295
GNWEIIDIGPFTQNLGKFAVDEANKIGQYGRLTFTKVIRPCMKKTIYENGEIKGYEYQLYVRASDKIFRADIFEDYKTRGRKLLRFNGPVPPP

SEQ ID NO: 128 - protein, 93 aa, synthetic construct
  source 1..93: note = Synthetic protein DM653
GNWEIIDIGPFTQNLGKFAVDEANKIGQYGRLTFNKVIRPCMKKTIYENGEIKGYIYQLYVRASDKIFRADIVEDYKTRGRKLLRFNGPVPPP

SEQ ID NO: 129 - protein, 93 aa, synthetic construct
  source 1..93: note = Synthetic protein DM207
GNWEIIDIGPFTQNLGKFAVDEANKIGQYGRLTFNKVIRPCMKKTIYENGEIKGYEYQLYVRASDKIFRADLYEDYKTRGRKLLRFNGPVPPP

SEQ ID NO: 130 - protein, 93 aa, synthetic construct
  source 1..93: note = Synthetic protein DM275
GNWEIIDIGPFTQNLGKFAVDEANKIGQYGRLTFNKVIRPSMKKTIYENGEIKGYEYQLYVRASDKIFRADIWEDYKTRGRKLLRFNGPVPPP

SEQ ID NO: 131 - protein, 93 aa, synthetic construct
  source 1..93: note = Synthetic protein DM272
GNWEIIDIGPFTQNLGKFAVDEANKIGQYGRLTFNKVIRPCMKKTIYENGEIKGYEYQLYVRASDKIFRADIWEDYKTRGRKLLRMNGPVPPP

SEQ ID NO: 132 - protein, 93 aa, synthetic construct
  source 1..93: note = Synthetic protein DM179
GNWEIIDIGPFTQNLGKFAVDEANKWGEYGRLTFNKVIRPCMKKTIYENGEIKGYEYQLYVRASDKIFRADIWEDYKTRGRKLLRFNGPVPPP

SEQ ID NO: 133 - protein, 93 aa, synthetic construct
  source 1..93: note = Synthetic protein DM269
GNWEIIDIGPFTQNLGKFAVDEANKIGQYGRLTFNKVIRPVMKKTIYENGEIKGYEYQLYVRASDKIFRADIWEDYKTRGRKLLRFNGPVPPP

SEQ ID NO: 134 - protein, 93 aa, synthetic construct
  source 1..93: note = Synthetic protein DM625
GNWEIIDIGPFTQNLGKFVVDEANKIGQYGRLTFTKVIRPCMKKTIYENGEIKGYEYQLYVRASDKIFRADIYEDYKTRGRKLLRFNGPVPPP

SEQ ID NO: 135 - protein, 93 aa, synthetic construct
  source 1..93: note = Synthetic protein DM633
GNWEIIDIGPFTQNLGKFAIDEANKIGQYGTLTFNKVIRPCMKKTIYENGEIKGYEYQLYVRASDKIFRADIYEDYKTRGRKLLRFNGPVPPP

SEQ ID NO: 136 - protein, 93 aa, synthetic construct
  source 1..93: note = Synthetic protein DM685
GNWEIIDIGPFTQNLGKFAVDEANKIGRYGRLTFNKVIRPAMKKTIYENGEIKGYEYQLYVRASDKIFRADIFEDYKTRGRKLLRFNGPVPPP

SEQ ID NO: 137 - protein, 93 aa, synthetic construct
  source 1..93: note = Synthetic protein DM640
GNWEIIDIGPFTQNLGKFAVDEANKIGRYGRLTFTKVIRPCMKKTIYENGEIKGYEYQLYVRASDKIFRADIYEDYKTRGRKLLRFNGPVPPP

SEQ ID NO: 138 - protein, 93 aa, synthetic construct
  source 1..93: note = Synthetic protein DM650
GNWEIIDIGPFTQNLGKFAVDEANKIGQYGRLTFNKVIRPCMKKTIYENGEIKGYIYQLYVRASDKIFRADITEDYKTRGRKLLRFNGPVPPP

SEQ ID NO: 139 - protein, 93 aa, synthetic construct
  source 1..93: note = Synthetic protein DM222
GNWEIIDIGPFTQNLGKFAVDEANKIGQYGRLRFNKVIRPCMKKTIYENGEIKGYEYQLYVRASDKIFRADIYEDYKTRGRKLLRFNGPVPPP

SEQ ID NO: 140 - protein, 93 aa, synthetic construct
  source 1..93: note = Synthetic protein DM360
MMWEIIDIGPFTQNLGKFAVDEANKIGQYGRLTFNKVIRPCMKKTIYENGEIKGYEYQLYVRASDKIFRADIYEDYKTRGRKLLRFNGPVPPP

SEQ ID NO: 141 - protein, 93 aa, synthetic construct
  source 1..93: note = Synthetic protein DM85
GNWEIIDIGPFTQNLGKFAVDEANKIGQYGRLTFNKVIRPCMKKTIYENGEIKGYEYQLYVRASDKIFRVDISEDYKTRGRKLLRFNGPVPPP

SEQ ID NO: 142 - protein, 93 aa, synthetic construct
  source 1..93: note = Synthetic protein DM151
GNWEIIDIGPFTQNLGKFAVDEANKIGQYGRLTFNKVIRPSMKKTIYENGEIKGYEYQLYVRASDKIFRADISEDYKTRGRKLLRFNGPVPPP

SEQ ID NO: 143 - protein, 93 aa, synthetic construct
  source 1..93: note = Synthetic protein DM513
GNWEIIDIGPFTQNLGKFAIDEANKIGQYGRLRFNKVIRPCMKKTIYENGEIKGYEYQLYVRASDKIFRADISEDYKTRGRKLLRFNGPVPPP

SEQ ID NO: 144 - protein, 96 aa, synthetic construct
  source 1..96: note = Synthetic protein DM212
GEWEIIDIGPFTQNLGKFVVDEENKIGQYGRLTFNKVIRPCMKKTIYENEGFREIKGYEYQLYVYASDKLFRADIYEDYKTRGRKLLRFNGPVPPP

SEQ ID NO: 145 - protein, 96 aa, synthetic construct
  source 1..96: note = Synthetic protein DM198
GEWEIIDIGPFTQNLGKFAVDEENKWGKYGRLTFNKVIRPCMKKTIYENEGFREIKGYEYQLYVYASDKLFRADIWEDYKTRGRKLLRFNGPVPPP

SEQ ID NO: 146 - protein, 96 aa, synthetic construct
  source 1..96: note = Synthetic protein DM243
GEWEIIDIGPFTQNLGKFAVDEENKIGQYGRLTFNKVIRPCMKKTIYENEGFREIKGYEYQLYVYASNKLFRADIYEDYKTRGLKLLRFNGPVPPP

SEQ ID NO: 147 - protein, 96 aa, synthetic construct
  source 1..96: note = Synthetic protein DM225
GEWEIIDIGPFTQNLGKFAVDEENKIGQYGRLRFNKVIRPCMKKTIYENEGFREIKGYEYQLYVYASDKLFRADIYEDYKTRGRKLLRFNGPVPPP

SEQ ID NO: 148 - protein, 93 aa, synthetic construct
  source 1..93: note = Synthetic protein DM91
GNWEIIDIGPFTQNLGKFAVDEANKIGQYGRLTFNKVIRPVMKKTIYENGEIKGYEYQLYVRASDKIFRADISEDYKTRGRKLLRFNGPVPPP

SEQ ID NO: 149 - protein, 93 aa, synthetic construct
  source 1..93: note = Synthetic protein DM661
GNWEIIDIGPFTQNLGKFAVDEANKIGQYGRLTFNKVIRPCMKKTIYENGEIKGYWYQLYVRASDKIFRADIYEDYKTRGRKLLRFNGPVPPP

SEQ ID NO: 150 - protein, 96 aa, synthetic construct
  source 1..96: note = Synthetic protein DM221
GEWEIIDIGPFTQNLGKFAVDEENKIGQYGRLTFNKVIRPSMKKTIYENEGFREIKGYEYQLYVYASDKLFRADIYEDYKTRGRKLLRFNGPVPPP

SEQ ID NO: 151 - protein, 96 aa, synthetic construct
  source 1..96: note = Synthetic protein DM201
GEWEIIDIGPFTQNLGKFAVDEENKWGKYGRLTFNKVIRPCMKKTIYENEGFREIKGYEYQLYVYASDKLFRADIYEDYKTRGRKLLRFNGPVPPP

SEQ ID NO: 152 - protein, 93 aa, synthetic construct
  source 1..93: note = Synthetic protein DM681
GNWEIIDIGPFTQNLGKFAIDEANKIGRYGRLTFNKVIRPCMKKTIYENGEIKGYEYQLYVRASDKIFRADIFEDYKTRGRKLLRFNGPVPPP

SEQ ID NO: 153 - protein, 93 aa, synthetic construct
  source 1..93: note = Synthetic protein DM252
GNWEIIDIGPFTQNLGKFAVDEANKIGQYGRLTFNKVIRPCMKKTIYENGEIKGYEYQLYVRASDKIFRADIFEDYKTRGRKLLRMNGPVPPP

SEQ ID NO: 154 - protein, 93 aa, synthetic construct
  source 1..93: note = Synthetic protein DM292
GNWEIIDIGPFTQNLGKFAVDEANKIGQYGRLTFTKVIRPCMKKTIYENGEIKGYEYQLYVRASDKIFRADIWEDYKTRGRKLLRFNGPVPPP

SEQ ID NO: 155 - protein, 93 aa, synthetic construct
  source 1..93: note = Synthetic protein DM330
GNWEIIDIGPFTQNLGKFAVDEANKIGSYGRLTFNKVIRPCMKKTIYENGEIKGYEYQLYVRASDKIFRADISEDYKTRGRKLLRFNGPVPPP

SEQ ID NO: 156 - protein, 96 aa, synthetic construct
  source 1..96: note = Synthetic protein DM276
GEWEIIDIGPFTQNLGKFVVDEENKIGQYGRLTFNKVIRPCMKKTIYENEGFREIKGYEYQLYVYASDKLFRADIWEDYKTRGRKLLRFNGPVPPP

SEQ ID NO: 157 - protein, 93 aa, synthetic construct
  source 1..93: note = Synthetic protein DM206
GNWEIIDIGPFTQNLGKFAIDEANKIGQYGRLTFNKVIRPCMKKTIYENGEIKGYEYQLYVRASDKIFRADIYEDYKTRGRKLLRFNGPVPPP

SEQ ID NO: 158 - protein, 93 aa, synthetic construct
  source 1..93: note = Synthetic protein DM593
GNWEIIDIGPFTQNLGKFAVDEANKIGQYGRLTFNKVIRPCMKKTIYENGEIKGYEYQLYVRASDKIFRADISVDYKTRGRKLLRFNGPVPPP

SEQ ID NO: 159 - protein, 93 aa, synthetic construct
  source 1..93: note = Synthetic protein DM396
GMWEIIDIGPFTQNLGKFAVDEANKIGQYGRLTFNKVIRPCMKKTIYENGEIKGYEYQLYVRASDKIFRADIYEDYKTRGRKLLRFNGPVPPP

SEQ ID NO: 160 - protein, 96 aa, synthetic construct
  source 1..96: note = Synthetic protein DM261
GEWEIIDIGPFTQNLGKFAVDEENKIGQYGRLTFNKVIRPCMKKTIYENEGFREIKGYEYQLYVYASDKLFRADLFEDYKTRGRKLLRFNGPVPPP

SEQ ID NO: 161 - protein, 93 aa, synthetic construct
  source 1..93: note = Synthetic protein DM337
GEWQIIDIGPFTQNLGKFAVDEENKIGQYGRLTFNKVIRPCMKKTIYENGEIKGYEYQLYVYASDKLFRADIYEDYKTRGRKLLRFNGPVPPP

SEQ ID NO: 162 - protein, 93 aa, synthetic construct
  source 1..93: note = Synthetic protein DM202
GNWEIIDIGPFTQNLGKFVVDEANKIGQYGRLTFNKVIRPCMKKTIYENGEIKGYEYQLYVRASDKIFRADIYEDYKTRGRKLLRFNGPVPPP

SEQ ID NO: 163 - protein, 93 aa, synthetic construct
  source 1..93: note = Synthetic protein DM77
GNWEIIDIGPFTQNLGKFVVDEANKIGQYGRLTFNKVIRPCMKKTIYENGEIKGYEYQLYVRASDKIFRADISEDYKTRGRKLLRFNGPVPPP

SEQ ID NO: 164 - protein, 96 aa, synthetic construct
  source 1..96: note = Synthetic protein DM245
GEWEIIDIGPFTQNLGKFAVDEENKIGQYGRLTFNKVIRPCMKKTIYENEGFREIKGYEYQLYVYASNKLFRADIFEDYKTRGLKLLRFNGPVPPP

SEQ ID NO: 165 - protein, 93 aa, synthetic construct
  source 1..93: note = Synthetic protein DM413
MNWEIIDIGPFTQNLGKFAVDEANKIGQYGRLTFNKVIRPCMKKTIYENGEIKGYEYQLYVRASDKIFRADIYEDYKTRGRKLLRFNGPVPPP

SEQ ID NO: 166 - protein, 93 aa, synthetic construct
  source 1..93: note = Synthetic protein DM203
GNWEIIDIGPFTQNLGKFAVDEANKIGQYGRLTFNKVIRPCMKKTIYENGEIKGYEYQLYIRASDKIFRADIYEDYKTRGRKLLRFNGPVPPP

SEQ ID NO: 167 - protein, 96 aa, synthetic construct
  source 1..96: note = Synthetic protein DM303
GEWEIIDIGPFTQNLGKFAVDEENKIGQYGRLTFTKVIRPCMKKTIYENEGFREIKGYEYQLYVYASDKLFRADIWEDYKTRGRKLLRFNGPVPPP

SEQ ID NO: 168 - protein, 93 aa, synthetic construct
  source 1..93: note = Synthetic protein DM477
GNWEIIDIGPFTQNLGKFAVDEANKIGQYGRLTFNKVIRPTMKKTIYENGEIKGYEYQLYVYASNKIFRADIYEDYKTRGRKLLRFNGPVPPP

SEQ ID NO: 169 - protein, 93 aa, synthetic construct
  source 1..93: note = Synthetic protein DM663
GNWEIIDIGPFTQNLGKFAVDEANKIGQYGRLTFNKVIRPCMKKTIYENGEIKGYEYQLYVRASDKIFRADIVEDYKTRGRKLLRFNGPVPPP

SEQ ID NO: 170 - protein, 93 aa, synthetic construct
  source 1..93: note = Synthetic protein DM338
GNWEIIDIGPFTQNLGKFAVDEENKIGQYGRLTFNKVIRPCMKKTIYENGEIKGYEYQLYVYASDKLFRADIYEDYKTRGRKLLRFNGPVPPP

SEQ ID NO: 171 - protein, 96 aa, synthetic construct
  source 1..96: note = Synthetic protein DM301
GEWEIIDIGPFTQNLGKFAVDEENKIGQYGRLTFNKVIRPTMKKTIYENEGFREIKGYEYQLYVYASDKLFRADIWEDYKTRGRKLLRFNGPVPPP

SEQ ID NO: 172 - protein, 93 aa, synthetic construct
  source 1..93: note = Synthetic protein DM286
GNWEIIDIGPFTQNLGKFAVDEANKIGQYGTLTFNKVIRPCMKKTIYENGEIKGYEYQLYVRASDKIFRADIYEDYKTRGRKLLRFNGPVPPP

SEQ ID NO: 173 - protein, 93 aa, synthetic construct
  source 1..93: note = Synthetic protein DM516
GNWEIIDIGPFTQNLGKFAVDEANKIGKYGRLRFNKVIRPCMKKTIYENGEIKGYEYQLYVRASDKIFRADISEDYKTRGRKLLRFNGPVPPP

SEQ ID NO: 174 - protein, 93 aa, synthetic construct
  source 1..93: note = Synthetic protein DM209
GNWEIIDIGPFTQNLGKFAVDEANKIGQYGRLTFNKVIRPCMKKTIYENGEIKGYEYQLYVRASDKIFRFDIYEDYKTRGRKLLRMNGPVPPP

SEQ ID NO: 175 - protein, 96 aa, synthetic construct
  source 1..96: note = Synthetic protein DM263
GEWEIIDIGPFTQNLGKFAVDEENKIGQYGRLTFNKVIRPCMKKTIYENEGFREIKGYEYQLYVYASDKLFRFDIFEDYKTRGRKLLRMNGPVPPP

SEQ ID NO: 176 - protein, 93 aa, synthetic construct
  source 1..93: note = Synthetic protein DM620
GNWEIIDIGPFTQNLGKFAIDEANKIGRYGRLTFNKVIRPCMKKTIYENGEIKGYEYQLYVRASDKIFRADIYEDYKTRGRKLLRFNGPVPPP

SEQ ID NO: 177 - protein, 93 aa, synthetic construct
  source 1..93: note = Synthetic protein DM658
GNWEIIDIGPFTQNLGKFAVDEANKIGQYGRLTFNKVIRPCMKKTIYENGEIKGYEYQLYVRASDKIFRADITEDYKTRGRKLLRFNGPVPPP

SEQ ID NO: 178 - protein, 93 aa, synthetic construct
  source 1..93: note = Synthetic protein DM473
GNWEIIDIGPFTQNLGKFAVDEANKIGKYGRLTFNKVIRPCMKKTIYENGEIKGYEYQLYVYASNKIFRADIYEDYKTRGRKLLRFNGPVPPP

SEQ ID NO: 179 - protein, 93 aa, synthetic construct
  source 1..93: note = Synthetic protein DM335
GEWEIIDIGPFTQNLGKFAVDEANKIGKYGRLTFNKVIRPCMKKTIYENGEIKGYEYQLYVYASDKLFRADIYEDYKTRGRKLLRFNGPVPPP

SEQ ID NO: 180 - protein, 93 aa, synthetic construct
  source 1..93: note = Synthetic protein DM247
GNWEIIDIGPFTQNLGKFAVDEANKIGQYGRLTFNKVIRPCMKKTIYENGEIKGYEYQLYIRASDKIFRADIFEDYKTRGRKLLRFNGPVPPP

SEQ ID NO: 181 - protein, 93 aa, synthetic construct
  source 1..93: note = Synthetic protein DM532
GNWEIIDIGPFTQNLGKFAVDEANKIGRYGRLTFNKVIRPAMKKTIYENGEIKGYEYQLYVRASDKIFRADIYEDYKTRGRKLLRFNGPVPPP

SEQ ID NO: 182 - protein, 93 aa, synthetic construct
  source 1..93: note = Synthetic protein DM346
GNWEIIDIGPFTQNLGKFAVDEANKIGQYGRLTFNKVIRPSMKKTIYENGEIKGYEYQLYVRASDKIFRADIYEDYKTRGRKLLRFNGPVPPP

SEQ ID NO: 183 - protein, 93 aa, synthetic construct
  source 1..93: note = Synthetic protein DM176
GNWEIIDIGPFTQNLGKFAVDEANKWGEYGRLTFNKVIRPCMKKTIYENGEIKGYEYQLYVRASDKIFRADIFEDYKTRGRKLLRFNGPVPPP

SEQ ID NO: 184 - protein, 93 aa, synthetic construct
  source 1..93: note = Synthetic protein DM605
GNWEIIDIGPFTQNLGKFAVDEANKIGQYGRLTFNKVIRPCMKKTIYENGEIKGYVYQLYVRASDKIFRADITEDYKTRGRKLLRFNGPVPPP

SEQ ID NO: 185 - protein, 96 aa, synthetic construct
  source 1..96: note = Synthetic protein DM277
GEWEIIDIGPFTQNLGKFAVDEENKIGQYGRLTFNKVIRPCMKKTIYENEGFREIKGYEYQLYIYASDKLFRADIWEDYKTRGRKLLRFNGPVPPP

SEQ ID NO: 186 - protein, 93 aa, synthetic construct
  source 1..93: note = Synthetic protein DM567
GNWEIIDIGPFTQNLGKFAVDEANKIGQYGTLTFNKVIRPCMKKTIYENGEIKGYEYQLYVRASTKIFRADISEDYKTRGRKLLRFNGPVPPP

SEQ ID NO: 187 - protein, 93 aa, synthetic construct
  source 1..93: note = Synthetic protein DM528
GNWEIIDIGPFTQNLGKFAVDEANKIGRYGRLTFNKVIRPTMKKTIYENGEIKGYEYQLYVRASDKIFRADIYEDYKTRGRKLLRFNGPVPPP

SEQ ID NO: 188 - protein, 93 aa, synthetic construct
  source 1..93: note = Synthetic protein DM268
GNWEIIDIGPFTQNLGKFAVDEANKIGQYGRLTFNKVIRPCMKKTIYENGEIKGYEYQLYVRASDKIFRVDIWEDYKTRGRKLLRFNGPVPPP

SEQ ID NO: 189 - protein, 93 aa, synthetic construct
  source 1..93: note = Synthetic protein DM652
GNWEIIDIGPFTQNLGKFAVDEANKIGQYGRLTFNKVIRPCMKKTIYENGEIKGYVYQLYVRASDKIFRADIVEDYKTRGRKLLRFNGPVPPP

SEQ ID NO: 190 - protein, 93 aa, synthetic construct
  source 1..93: note = Synthetic protein DM613
GNWEIIDIGPFTQNLGKFAIDEANKIGKYGRLTFNKVIRPCMKKTIYENGEIKGYEYQLYVRASDKIFRADIYEDYKTRGRKLLRFNGPVPPP

SEQ ID NO: 191 - protein, 96 aa, synthetic construct
  source 1..96: note = Synthetic protein DM244
GEWEIIDIGPFTQNLGKFAVDEENKIGQYGRLTFNKVIRPCMKKTIYENEGFREIKGYEYQLYVYASNKLFRADIWEDYKTRGLKLLRFNGPVPPP

SEQ ID NO: 192 - protein, 93 aa, synthetic construct
  source 1..93: note = Synthetic protein DM644
GNWEIIDIGPFTQNLGKFAVDEANKIGQYGRLTFNKVIRPCMKKTIYENGEIKGYEYQLYVRASTKIFRADIYEDYKTRGLKLLRFNGPVPPP

SEQ ID NO: 193 - protein, 93 aa, synthetic construct
  source 1..93: note = Synthetic protein DM273
GNWEIIDIGPFTQNLGKFAVDEANKIGQYGRLTFNKVIRPCMKKTIYENGEIKGYEYQLYVRASDKIFRFDIWEDYKTRGRKLLRMNGPVPPP

SEQ ID NO: 194 - protein, 93 aa, synthetic construct
  source 1..93: note = Synthetic protein DM630
GNWEIIDIGPFTQNLGKFAVDEANKIGKYGTLTFNKVIRPCMKKTIYENGEIKGYEYQLYVRASDKIFRADIYEDYKTRGRKLLRFNGPVPPP

SEQ ID NO: 195 - protein, 93 aa, synthetic construct
  source 1..93: note = Synthetic protein DM628
GNWEIIDIGPFTQNLGKFAVDEANKIGQYGRLTFTKVIRPCMKKTIYENGEIKGYEYQLYVRASNKIFRADIYEDYKTRGRKLLRFNGPVPPP

SEQ ID NO: 196 - protein, 93 aa, synthetic construct
  source 1..93: note = Synthetic protein DM234
GNWEIIDIGPFTQNLGKFAVDEANKIGQYGRLRFNKVIRPCMKKTIYENGEIKGYEYQLYVRASDKIFRADIWEDYKTRGRKLLRFNGPVPPP

SEQ ID NO: 197 - protein, 93 aa, synthetic construct
  source 1..93: note = Synthetic protein DM611
GNWEIIDIGPFTQNLGKFAIDEANKIGQYGRLTFNKVIRPCMKKTIYENGEIKGYEYQLYVRASNKIFRADIYEDYKTRGRKLLRFNGPVPPP

SEQ ID NO: 198 - protein, 93 aa, synthetic construct
  source 1..93: note = Synthetic protein DM638
GNWEIIDIGPFTQNLGKFAVDEANKIGQYGRLRFNKVIRPCMKKTIYENGEIKGYEYQLYVRASDKIFRADIYEDYKTRGLKLLRFNGPVPPP

SEQ ID NO: 199 - protein, 93 aa, synthetic construct
  source 1..93: note = Synthetic protein DM626
GNWEIIDIGPFTQNLGKFVVDEANKIGQYGRLTFNKVIRPCMKKTIYENGEIKGYEYQLYVRASDKIFRADIYEDYKTRGLKLLRFNGPVPPP

SEQ ID NO: 200 - protein, 93 aa, synthetic construct
  source 1..93: note = Synthetic protein DM171
GNWEIIDIGPFTQNLGKFAVDEANKIGRYGTLTFNKVIRPCMKKTIYENGEIKGYEYQLYVRASDKIFRADIYEDYKTRGRKLLRFNGPVPPP

SEQ ID NO: 201 - protein, 93 aa, synthetic construct
  source 1..93: note = Synthetic protein DM94
GNWEIIDIGPFTQNLGKFAVDEANKIGQYGTLTFNKVIRPCMKKTIYENGEIKGYEYQLYVRASNKIFRADISEDYKTRGRKLLRFNGPVPPP

SEQ ID NO: 202 - protein, 93 aa, synthetic construct
  source 1..93: note = Synthetic protein DM543
GNWEIIDIGPFTQNLGKFVVDEANKIGQYGTLTFNKVIRPCMKKTIYENGEIKGYEYQLYVRASDKIFRADISEDYKTRGRKLLRFNGPVPPP

SEQ ID NO: 203 - protein, 96 aa, synthetic construct
  source 1..96: note = Synthetic protein DM217
GEWEIIDIGPFTQNLGKFAVDEENKIGQYGRLTFNKVIRPCMKKTIYENEGFREIKGYEYQLYVYASDKLFRADLYEDYKTRGRKLLRFNGPVPPP

SEQ ID NO: 204 - protein, 96 aa, synthetic construct
  source 1..96: note = Synthetic protein DM183
GEWEIIDIGPFTQNLGKFAVDEENKTGQYGRLTFNKVIRPCMKKTIYENEGFREIKGYEYQLYVYASDKLFRADIWEDYKTRGRKLLRFNGPVPPP

SEQ ID NO: 205 - protein, 96 aa, synthetic construct
  source 1..96: note = Synthetic protein DM302
GEWEIIDIGPFTQNLGKFAVDEENKIGQYGRLTFNKVIRPCMKKTIYENEGFREIKGYEYQLYVYASDKLFRADIWEDYKTRGLKLLRFNGPVPPP

SEQ ID NO: 206 - protein, 93 aa, synthetic construct
  source 1..93: note = Synthetic protein DM167
GNWEIIDIGPFTQNLGKFAVDEANRIGRYGRLTFNKVIRPCMKKTIYENGEIKGYEYQLYVRASDKIFRADIFEDYKTRGRKLLRFNGPVPPP

SEQ ID NO: 207 - protein, 93 aa, synthetic construct
  source 1..93: note = Synthetic protein DM534
GNWEIIDIGPFTQNLGKFAVDEANKIGKYGRLTFNKVIRPSMKKTIYENGEIKGYEYQLYVRASDKIFRADIYEDYKTRGRKLLRFNGPVPPP

SEQ ID NO: 208 - protein, 96 aa, synthetic construct
  source 1..96: note = Synthetic protein DM256
GEWEIIDIGPFTQNLGKFVVDEENKIGQYGRLTFNKVIRPCMKKTIYENEGFREIKGYEYQLYVYASDKLFRADIFEDYKTRGRKLLRFNGPVPPP

SEQ ID NO: 209 - protein, 96 aa, synthetic construct
  source 1..96: note = Synthetic protein DM220
GEWEIIDIGPFTQNLGKFAVDEENKIGQYGRLTFNKVIRPAMKKTIYENEGFREIKGYEYQLYVYASDKLFRADIYEDYKTRGRKLLRFNGPVPPP

SEQ ID NO: 210 - protein, 93 aa, synthetic construct
  source 1..93: note = Synthetic protein DM294
GNWEIIDIGPFTQNLGKFAVDEANKIGQYGRLTFNKVIRPTMKKTIYENGEIKGYEYQLYVRASDKIFRADIFEDYKTRGRKLLRFNGPVPPP

SEQ ID NO: 211 - protein, 93 aa, synthetic construct
  source 1..93: note = Synthetic protein DM595
GNWEIIDIGPFTQNLGKFAVDEANKIGQYGRLTFNKVIRPCMKKTIYENGEIKGYEYQLYVRASDKIFRADVYVDYKTRGRKLLRFNGPVPPP

SEQ ID NO: 212 - protein, 93 aa, synthetic construct
  source 1..93: note = Synthetic protein DM634
GNWEIIDIGPFTQNLGKFAIDEANKIGQYGRLTFTKVIRPCMKKTIYENGEIKGYEYQLYVRASDKIFRADIYEDYKTRGRKLLRFNGPVPPP

SEQ ID NO: 213 - protein, 93 aa, synthetic construct
  source 1..93: note = Synthetic protein DM333
GEWEIIDIGPFTQNLGKFAVDEENKIGQYGRLTFNKVIRPCMKKTIYENGEIKGYEYQLYVYASNKLFRADIYEDYKTRGRKLLRFNGPVPPP

SEQ ID NO: 214 - protein, 96 aa, synthetic construct
  source 1..96: note = Synthetic protein DM181
GEWEIIDIGPFTQNLGKFAVDEENKTGQYGRLTFNKVIRPCMKKTIYENEGFREIKGYEYQLYVYASDKLFRADIFEDYKTRGRKLLRFNGPVPPP

SEQ ID NO: 215 - protein, 96 aa, synthetic construct
  source 1..96: note = Synthetic protein DM258
GEWEIIDIGPFTQNLGKFAVDEENKIGQYGRLTFNKVIRPCMKKTIYENEGFREIKGYEYQLYVYASDKLFRVDIFEDYKTRGRKLLRFNGPVPPP

SEQ ID NO: 216 - protein, 93 aa, synthetic construct
  source 1..93: note = Synthetic protein DM649
GNWEIIDIGPFTQNLGKFAVDEANKIGQYGRLTFNKVIRPCMKKTIYENGEIKGYEYQLYVRASTKIFRADIYEDYKTRGRKLLRFNGPVPPP

SEQ ID NO: 217 - protein, 93 aa, synthetic construct
  source 1..93: note = Synthetic protein DM542
GNWEIIDIGPFTQNLGKFAVDEANKIGRYGRLTFNKVIRPCMKKTIYENGEIKGYEYQLYVRASNKIFRADIYEDYKTRGRKLLRFNGPVPPP

SEQ ID NO: 218 - protein, 93 aa, synthetic construct
  source 1..93: note = Synthetic protein DM637
GNWEIIDIGPFTQNLGKFAVDEANKIGQYGRLRFTKVIRPCMKKTIYENGEIKGYEYQLYVRASDKIFRADIYEDYKTRGRKLLRFNGPVPPP

SEQ ID NO: 219 - protein, 96 aa, synthetic construct
  source 1..96: note = Synthetic protein DM284
GEWEIIDIGPFTQNLGKFAVDEENKIGQYGRLTFNKVIRPAMKKTIYENEGFREIKGYEYQLYVYASDKLFRADIWEDYKTRGRKLLRFNGPVPPP

SEQ ID NO: 220 - protein, 93 aa, synthetic construct
  source 1..93: note = Synthetic protein DM248
GNWEIIDIGPFTQNLGKFAVDEANKIGQYGRLTFNKVIRPCMKKTIYENGEIKGYEYQLYVRASDKIFRVDIFEDYKTRGRKLLRFNGPVPPP

SEQ ID NO: 221 - protein, 93 aa, synthetic construct
  source 1..93: note = Synthetic protein DM456
GNWEIIDIGPFTQNLGKFAVDEANKTGSYGRLTFNKVIRPCMKKTIYENGEIKGYEYQLYVRASDKIFRADIYEDYKTRGRKLLRFNGPVPPP

SEQ ID NO: 222 - protein, 96 aa, synthetic construct
  source 1..96: note = Synthetic protein DM219
GEWEIIDIGPFTQNLGKFAVDEENKIGQYGRLTFNKVIRPCMKKTIYENEGFREIKGYEYQLYVYASDKLFRFDIYEDYKTRGRKLLRMNGPVPPP

SEQ ID NO: 223 - protein, 93 aa, synthetic construct
  source 1..93: note = Synthetic protein DM481
GNWEIIDIGPFTQNLGKFAVDEANRIGQYGRLTFNKVIRPTMKKTIYENGEIKGYEYQLYVRASDKIFRADIYEDYKTRGRKLLRFNGPVPPP

SEQ ID NO: 224 - protein, 93 aa, synthetic construct
  source 1..93: note = Synthetic protein DM616
GNWEIIDIGPFTQNLGKFAIDEANKIGQYGRLRFNKVIRPCMKKTIYENGEIKGYEYQLYVRASDKIFRADIYEDYKTRGRKLLRFNGPVPPP

SEQ ID NO: 225 - protein, 96 aa, synthetic construct
  source 1..96: note = Synthetic protein DM305
GEWEIIDIGPFTQNLGKFAVDEENKIGQYGRLTFNKVIRPTMKKTIYENEGFREIKGYEYQLYVYASDKLFRADIFEDYKTRGRKLLRFNGPVPPP

SEQ ID NO: 226 - protein, 96 aa, synthetic construct
  source 1..96: note = Synthetic protein DM297
GEWEIIDIGPFTQNLGKFAVDEENKIGQYGRLTFNKVIRPTMKKTIYENEGFREIKGYEYQLYVYASDKLFRADIYEDYKTRGRKLLRFNGPVPPP

SEQ ID NO: 227 - protein, 96 aa, synthetic construct
  source 1..96: note = Synthetic protein DM285
GEWEIIDIGPFTQNLGKFAVDEENKIGQYGRLTFNKVIRPSMKKTIYENEGFREIKGYEYQLYVYASDKLFRADIWEDYKTRGRKLLRFNGPVPPP

SEQ ID NO: 228 - protein, 93 aa, synthetic construct
  source 1..93: note = Synthetic protein DM621
GNWEIIDIGPFTQNLGKFVVDEANKIGRYGRLTFNKVIRPCMKKTIYENGEIKGYEYQLYVRASDKIFRADIYEDYKTRGRKLLRFNGPVPPP

SEQ ID NO: 229 - protein, 96 aa, synthetic construct
  source 1..96: note = Synthetic protein DM233
GEWEIIDIGPFTQNLGKFAVDEENKIGQYGRLTFNKVIRPCMKKTIYENEGFREIKGYEYQLYVYASNKLFRADIFEDYKTRGRKLLRFNGPVPPP

SEQ ID NO: 230 - protein, 93 aa, synthetic construct
  source 1..93: note = Synthetic protein DM251
GNWEIIDIGPFTQNLGKFAVDEANKIGQYGRLTFNKVIRPCMKKTIYENGEIKGYEYQLYVRASDKIFRADLFEDYKTRGRKLLRFNGPVPPP

SEQ ID NO: 231 - protein, 93 aa, synthetic construct
  source 1..93: note = Synthetic protein DM479
GNWEIIDIGPFTQNLGKFAVDEANRIGQYGRLTFNKVIRPCMKKTIYENGEIKGYEYQLYVRASNKIFRADIYEDYKTRGRKLLRFNGPVPPP

SEQ ID NO: 232 - protein, 93 aa, synthetic construct
  source 1..93: note = Synthetic protein DM66
GNWEIIDIGPFTQNLGKFAVDEANKIGRYGRLTFNKVIRPCMKKTIYENGEIKGYEYQLYVRASDKIFRADISEDYKTRGRKLLRFNGPVPPP

SEQ ID NO: 233 - protein, 93 aa, synthetic construct
  source 1..93: note = Synthetic protein DM230
GNWEIIDIGPFTQNLGKFAVDEANKIGQYGRLTFNKVIRPCMKKTIYENGEIKGYEYQLYVRASNKIFRADIFEDYKTRGRKLLRFNGPVPPP

SEQ ID NO: 234 - protein, 93 aa, synthetic construct
  source 1..93: note = Synthetic protein DM241
GNWEIIDIGPFTQNLGKFAVDEANKIGQYGRLTFNKVIRPCMKKTIYENGEIKGYEYQLYVRASNKIFRADIWEDYKTRGLKLLRFNGPVPPP

SEQ ID NO: 235 - protein, 93 aa, synthetic construct
  source 1..93: note = Synthetic protein DM365
GEWQIIDIGPFTQNLGKFAVDEANKIGQYGRLTFNKVIRPCMKKTIYENGEIKGYEYQLYVYASDKLFRADIYEDYKTRGRKLLRFNGPVPPP

SEQ ID NO: 236 - protein, 96 aa, synthetic construct
  source 1..96: note = Synthetic protein DM182
GEWEIIDIGPFTQNLGKFAVDEENRIGQYGRLTFNKVIRPCMKKTIYENEGFREIKGYEYQLYVYASDKLFRADIFEDYKTRGRKLLRFNGPVPPP

SEQ ID NO: 237 - protein, 93 aa, synthetic construct
  source 1..93: note = Synthetic protein DM656
GNWEIIDIGPFTQNLGKFAVDEANKIGQYGRLTFNKVIRPCMKKTIYENGEIKGYIYQLYVRASDKIFRADIIEDYKTRGRKLLRFNGPVPPP

SEQ ID NO: 238 - protein, 93 aa, synthetic construct
  source 1..93: note = Synthetic protein DM486
GNWEIIDIGPFTQNLGKFAVDEANKTGKYGRLTFNKVIRPCMKKTIYENGEIKGYEYQLYVYASNKIFRADIYEDYKTRGRKLLRFNGPVPPP

SEQ ID NO: 239 - protein, 93 aa, synthetic construct
  source 1..93: note = Synthetic protein DM642
GNWEIIDIGPFTQNLGKFAVDEANKIGQYGTLTFNKVIRPCMKKTIYENGEIKGYEYQLYVRASTKIFRADIYEDYKTRGRKLLRFNGPVPPP

SEQ ID NO: 240 - protein, 93 aa, synthetic construct
  source 1..93: note = Synthetic protein DM287
GNWEIIDIGPFTQNLGKFAVDEANKIGQYGRLTFNKVIRPTMKKTIYENGEIKGYEYQLYVRASDKIFRADIYEDYKTRGRKLLRFNGPVPPP

SEQ ID NO: 241 - protein, 93 aa, synthetic construct
  source 1..93: note = Synthetic protein DM96
GNWEIIDIGPFTQNLGKFAIDEANKIGQYGRLTFNKVIRPCMKKTIYENGEIKGYEYQLYVRASDKIFRADISEDYKTRGRKLLRFNGPVPPP

SEQ ID NO: 242 - protein, 93 aa, synthetic construct
  source 1..93: note = Synthetic protein DM600
GNWEIIDIGPFTQNLGKFAVDEANKIGQYGRLTFNKVIRPCMKKTIYENGEIKGYEYQLYVRASDKIFRADVYEDYKTRGRKLLRFNGPVPPP

SEQ ID NO: 243 - protein, 93 aa, synthetic construct
  source 1..93: note = Synthetic protein DM659
GNWEIIDIGPFTQNLGKFAVDEANKIGQYGRLTFNKVIRPCMKKTIYENGEIKGYEYQLYVRASDKIFRADIHEDYKTRGRKLLRFNGPVPPP

SEQ ID NO: 244 - protein, 93 aa, synthetic construct
  source 1..93: note = Synthetic protein DM332
MMWEIIDIGPFTQNLGKFAVDEENKIGQYGRLTFNKVIRPCMKKTIYENGEIKGYEYQLYVYASDKLFRADIYEDYKTRGRKLLRFNGPVPPP

SEQ ID NO: 245 - protein, 96 aa, synthetic construct
  source 1..96: note = Synthetic protein DM199
GEWEIIDIGPFTQNLGKFAVDEENKWGEYGRLTFNKVIRPCMKKTIYENEGFREIKGYEYQLYVYASDKLFRADIWEDYKTRGRKLLRFNGPVPPP

SEQ ID NO: 246 - protein, 93 aa, synthetic construct
  source 1..93: note = Synthetic protein DM520
GNWEIIDIGPFTQNLGKFAVDEANKIGSYGRLTFNKVIRPCMKKTIYENGEIKGYEYQLYVRASDKIFRADIYEDYKTRGRKLLRFNGPVPPP

SEQ ID NO: 247 - protein, 93 aa, synthetic construct
  source 1..93: note = Synthetic protein DM228
GNWEIIDIGPFTQNLGKFAVDEANKIGQYGRLRFNKVIRPCMKKTIYENGEIKGYEYQLYVRASDKIFRADIFEDYKTRGRKLLRFNGPVPPP

SEQ ID NO: 248 - protein, 96 aa, synthetic construct
  source 1..96: note = Synthetic protein DM265
GEWEIIDIGPFTQNLGKFAVDEENKIGQYGRLTFNKVIRPSMKKTIYENEGFREIKGYEYQLYVYASDKLFRADIFEDYKTRGRKLLRFNGPVPPP

SEQ ID NO: 249 - protein, 96 aa, synthetic construct
  source 1..96: note = Synthetic protein DM196
GEWEIIDIGPFTQNLGKFAVDEENKWGEYGRLTFNKVIRPCMKKTIYENEGFREIKGYEYQLYVYASDKLFRADIFEDYKTRGRKLLRFNGPVPPP

SEQ ID NO: 250 - protein, 93 aa, synthetic construct
  source 1..93: note = Synthetic protein DM266
GNWEIIDIGPFTQNLGKFVVDEANKIGQYGRLTFNKVIRPCMKKTIYENGEIKGYEYQLYVRASDKIFRADIWEDYKTRGRKLLRFNGPVPPP

SEQ ID NO: 251 - protein, 93 aa, synthetic construct
  source 1..93: note = Synthetic protein DM610
GNWEIIDIGPFTQNLGKFVVDEANKIGKYGRLTFNKVIRPCMKKTIYENGEIKGYEYQLYVRASDKIFRADIYEDYKTRGRKLLRFNGPVPPP

SEQ ID NO: 252 - protein, 96 aa, synthetic construct
  source 1..96: note = Synthetic protein DM298
GEWEIIDIGPFTQNLGKFAVDEENKIGQYGRLTFNKVIRPCMKKTIYENEGFREIKGYEYQLYVYASDKLFRADIYEDYKTRGLKLLRFNGPVPPP

SEQ ID NO: 253 - protein, 96 aa, synthetic construct
  source 1..96: note = Synthetic protein DM185
GEWEIIDIGPFTQNLGKFAVDEENKTGKYGRLTFNKVIRPCMKKTIYENEGFREIKGYEYQLYVYASDKLFRADIFEDYKTRGRKLLRFNGPVPPP

SEQ ID NO: 254 - protein, 96 aa, synthetic construct
  source 1..96: note = Synthetic protein DM307
GEWEIIDIGPFTQNLGKFAVDEENKIGQYGRLTFTKVIRPCMKKTIYENEGFREIKGYEYQLYVYASDKLFRADIFEDYKTRGRKLLRFNGPVPPP

SEQ ID NO: 255 - protein, 93 aa, synthetic construct
  source 1..93: note = Synthetic protein DM480
GNWEIIDIGPFTQNLGKFAVDEANRIGQYGRLTFNKVIRPCMKKTIYENGEIKGYEYQLYVYASNKIFRADIYEDYKTRGRKLLRFNGPVPPP

SEQ ID NO: 256 - protein, 96 aa, synthetic construct
  source 1..96: note = Synthetic protein DM186
GEWEIIDIGPFTQNLGKFAVDEENKTGKYGRLTFNKVIRPCMKKTIYENEGFREIKGYEYQLYVYASDKLFRADIWEDYKTRGRKLLRFNGPVPPP

SEQ ID NO: 257 - protein, 93 aa, synthetic construct
  source 1..93: note = Synthetic protein DM604
GNWEIIDIGPFTQNLGKFAVDEANKIGQYGRLTFNKVIRPCMKKTIYENGEIKGYRYQLYVRASDKIFRADITEDYKTRGRKLLRFNGPVPPP

SEQ ID NO: 258 - protein, 93 aa, synthetic construct
  source 1..93: note = Synthetic protein DM622
GNWEIIDIGPFTQNLGKFAVDEANKIGRYGRLRFNKVIRPCMKKTIYENGEIKGYEYQLYVRASDKIFRADIYEDYKTRGRKLLRFNGPVPPP

SEQ ID NO: 259 - protein, 93 aa, synthetic construct
  source 1..93: note = Synthetic protein DM255
GNWEIIDIGPFTQNLGKFAVDEANKIGQYGRLTFNKVIRPSMKKTIYENGEIKGYEYQLYVRASDKIFRADIFEDYKTRGRKLLRFNGPVPPP

SEQ ID NO: 260 - protein, 96 aa, synthetic construct
  source 1..96: note = Synthetic protein DM231
GEWEIIDIGPFTQNLGKFAVDEENKIGQYGRLRFNKVIRPCMKKTIYENEGFREIKGYEYQLYVYASDKLFRADIFEDYKTRGRKLLRFNGPVPPP

SEQ ID NO: 261 - protein, 96 aa, synthetic construct
  source 1..96: note = Synthetic protein DM299
GEWEIIDIGPFTQNLGKFAVDEENKIGQYGRLTFTKVIRPCMKKTIYENEGFREIKGYEYQLYVYASDKLFRADIYEDYKTRGRKLLRFNGPVPPP

SEQ ID NO: 262 - protein, 93 aa, synthetic construct
  source 1..93: note = Synthetic protein DM657
GNWEIIDIGPFTQNLGKFAVDEANKIGQYGRLTFNKVIRPCMKKTIYENGEIKGYTYQLYVRASDKIFRADIIEDYKTRGRKLLRFNGPVPPP

SEQ ID NO: 263 - protein, 96 aa, synthetic construct
  source 1..96: note = Synthetic protein DM180
GEWEIIDIGPFTQNLGKFAVDEENKTGKYGRLTFNKVIRPCMKKTIYENEGFREIKGYEYQLYVYASDKLFRADIYEDYKTRGRKLLRFNGPVPPP

SEQ ID NO: 264 - protein, 93 aa, synthetic construct
  source 1..93: note = Synthetic protein DM253
GNWEIIDIGPFTQNLGKFAVDEANKIGQYGRLTFNKVIRPCMKKTIYENGEIKGYEYQLYVRASDKIFRFDIFEDYKTRGRKLLRMNGPVPPP

SEQ ID NO: 265 - protein, 93 aa, synthetic construct
  source 1..93: note = Synthetic protein DM291
GNWEIIDIGPFTQNLGKFAVDEANKIGQYGRLTFNKVIRPTMKKTIYENGEIKGYEYQLYVRASDKIFRADIWEDYKTRGRKLLRFNGPVPPP

SEQ ID NO: 266 - protein, 93 aa, synthetic construct
  source 1..93: note = Synthetic protein DM643
GNWEIIDIGPFTQNLGKFAVDEANKIGQYGRLTFTKVIRPCMKKTIYENGEIKGYEYQLYVRASTKIFRADIYEDYKTRGRKLLRFNGPVPPP

SEQ ID NO: 267 - protein, 93 aa, synthetic construct
  source 1..93: note = Synthetic protein DM540
GNWEIIDIGPFTQNLGKFAVDEANKIGRYGRLTFNKVIRPCMKKTIYENGEIKGYEYQLYVRASNKIFRADISEDYKTRGRKLLRFNGPVPPP

SEQ ID NO: 268 - protein, 96 aa, synthetic construct
  source 1..96: note = Synthetic protein DM216
GEWEIIDIGPFTQNLGKFAIDEENKIGQYGRLTFNKVIRPCMKKTIYENEGFREIKGYEYQLYVYASDKLFRADIYEDYKTRGRKLLRFNGPVPPP

SEQ ID NO: 269 - protein, 93 aa, synthetic construct
  source 1..93: note = Synthetic protein DM618
GNWEIIDIGPFTQNLGKFAVDEANRIGQYGRLRFNKVIRPCMKKTIYENGEIKGYEYQLYVRASDKIFRADIYEDYKTRGRKLLRFNGPVPPP

SEQ ID NO: 270 - protein, 93 aa, synthetic construct
  source 1..93: note = Synthetic protein DM69
GNWEIIDIGPFTQNLGKFAVDEANRIGKYGRLTFNKVIRPCMKKTIYENGEIKGYEYQLYVRASDKIFRADISEDYKTRGRKLLRFNGPVPPP

SEQ ID NO: 271 - protein, 93 aa, synthetic construct
  source 1..93: note = Synthetic protein DM150
GNWEIIDIGPFTQNLGKFAVDEANKIGQYGRLTFNKVIRPAMKKTIYENGEIKGYEYQLYVRASDKIFRADISEDYKTRGRKLLRFNGPVPPP

SEQ ID NO: 272 - protein, 93 aa, synthetic construct
  source 1..93: note = Synthetic protein DM158
GNWEIIDIGPFTQNLGKFAVDEANKTGKYGRLTFNKVIRPCMKKTIYENGEIKGYEYQLYVRASDKIFRADIYEDYKTRGRKLLRFNGPVPPP

SEQ ID NO: 273 - protein, 93 aa, synthetic construct
  source 1..93: note = Synthetic protein DM521
GNWEIIDIGPFTQNLGKFAVDEANKIGRYGRLTFNKVIRPCMKKTIYENGEIKGYEYQLYVYASNKIFRADIYEDYKTRGRKLLRFNGPVPPP

SEQ ID NO: 274 - protein, 93 aa, synthetic construct
  source 1..93: note = Synthetic protein DM608
GNWEIIDIGPFTQNLGKFAVDEANKIGRYGRLTFNKVIRPCMKKTIYENGEIKGYEYQLYVRASTKIFRADIYEDYKTRGRKLLRFNGPVPPP

SEQ ID NO: 275 - protein, 93 aa, synthetic construct
  source 1..93: note = Synthetic protein DM679
GNWEIIDIGPFTQNLGKFAIDEANKIGQYGRLTFNKVIRPCMKKTIYENGEIKGYEYQLYVRASNKIFRADIFEDYKTRGRKLLRFNGPVPPP

SEQ ID NO: 276 - protein, 93 aa, synthetic construct
  source 1..93: note = Synthetic protein DM688
GNWEIIDIGPFTQNLGKFAVDEANKIGRYGRLTFNKVIRPTMKKTIYENGEIKGYEYQLYVRASDKIFRADIWEDYKTRGRKLLRFNGPVPPP